(19) United States
(12) Patent Application Publication
(10) Pub. No.: US 2024/0308138 A1
(43) Pub. Date: Sep. 19, 2024

(54) MATERIAL MANIPULATION IN ADDITIVE MANUFACTURING

(71) Applicant: Velo3D, Inc., Fremont, CA (US)

(72) Inventors: Abraham SALDIVAR VALDES, Menlo Park, CA (US); Alexander John FISHER, San Jose, CA (US); Rahul KORPU, San Jose, CA (US); Joseph Andrew TRALONGO, El Cajon, CA (US); Michael Christopher ST DENNIS, Santa Clara, CA (US); Gregory Ferguson BROWN, San Jose, CA (US); Benyamin BULLER, Cupertino, CA (US); Thomas BREZOCZKY, Los Gatos, CA (US); James FRECHMAN, San Jose, CA (US); Yacov ELGAR, Sunnyvale, CA (US); Richard ROMANO, San Jose, CA (US); Alan Rick LAPPEN, Rio Rancho, NM (US)

(21) Appl. No.: 18/612,540

(22) Filed: Mar. 21, 2024

Related U.S. Application Data
(63) Continuation of application No. PCT/US22/51453, filed on Nov. 30, 2022.
(60) Provisional application No. 63/290,272, filed on Dec. 16, 2021.
(60) Provisional application No. 63/411,480, filed on Sep. 29, 2022.
(60) Provisional application No. 63/428,620, filed on Nov. 29, 2022.

(51) Int. Cl. B29C 64/321; B29C 64/255; B29C 64/357; B29C 64/364; B33Y 10/00; B33Y 30/00

(52) U.S. Cl. CPC B29C 64/321; B29C 64/255; B29C 64/357; B29C 64/364; B33Y 10/00; B33Y 30/00

(57) ABSTRACT

The present disclosure provides three-dimensional (3D) printing systems, apparatuses, software, and methods for the production of at least one requested 3D object. The 3D printer includes a material conveyance system, filtering system, and unpacking station. The material conveyance system may comprise transporting pre-transformed (e.g., powder) material against gravity, by directional conveyance (e.g., of a bounceable platform), and prolonged uninterrupted sieving while minimizing sieve blinding. The 3D printing described herein comprises facilitating non-interrupted (e.g., curbs interruptions of) material dispensing through a component of the 3D printer, such as a layer dispenser.

### PRIORITY APPLICATIONS

This application claims priority to International Patent Application Serial No. PCT/US22/51453 filed Nov. 30, 2022, which claims priority to U.S. Provisional Patent Application Ser. No. 63/290,272, filed Dec. 16, 2021; to U.S. Provisional Patent Application Ser. No. 63/411,480, filed Sep. 29, 2022; and to U.S. Provisional Patent Application Ser. No. 63/428,620, filed Nov. 29, 2022; each of which is incorporated herein by reference in its entirety.

### BACKGROUND

Three-dimensional (3D) printing (e.g., additive manufacturing) is a process for making a three-dimensional object of any shape from a design. The design may be in the form of a data source such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

At times, during the process of dispensing pre-transformed (e.g., particulate) material as part of the 3D printing, the pre-transformed material may be dispensed in a discontinuous manner, or cease to be dispensed. For examples, there may be one or more intermissions in the conveyance of the pre-transformed material during the 3D printing. The intermissions(s) may be unrequested. For example, the material dispenser may run out of pre-transformed material. For example, the material dispensing process may pause (e.g., stop) to refill the material dispenser. In some situations, it may be requested to diminish the number of (e.g., unrequested) interruptions to the material dispensing process. At times, it may be requested to facilitate a continuous movement (e.g., flow) of the pre-transformed material, e.g., to reduce the number of interruptions, to reduce the extent of interruptions, to allow non-interrupted deposition, to allow for smooth deposition, to allow for deposition of a material layer having a (e.g., substantially) low roughness profile, homogenous roughness profile, and/or to allow for deposition of a material layer having a (e.g., substantially) planar exposes surface. At times, it may be requested to convey an excess amount of pre-transformed material (e.g., as a result of leveling, vacuuming, or unused material) to the material dispenser. At times, there may be an excess of material that is not used during the 3D printing. The excess of material may be recycled and/or reused during the 3D printing. In some embodiments, there may be a need for a conveyance system of the excess material to the material dispenser.

In some embodiments, material is supplied in bulk qualities. There may be a need for a conveyance system that conveys material to the material dispenser. The conveyance system may facilitate uninterrupted function of the material dispenser. The conveyance system may facilitate continuous flow of pre-transformed material to the material dispenser.

In some embodiments, remainder material is recycled, e.g., during the three-dimensional printing. The remainder material may be an excess material. There may be a need for a directional conveyance system that conveys the remainder to the material recycling system, or as part of a material recycling system provided from one or more sources. For example, a need for uninterrupted operation of the three-dimensional printing, automatic control of remainder conveyance, remainder conveyance at a controlled atmosphere different from the ambient atmosphere (e.g., by content and/or pressure), or any combination thereof. At times, there may be a need for continuous recycling of the remainder. The recycling system may comprise a filter (e.g., comprising a sieve) configured to filter the remainder, e.g., for usage in another 3D printing operation. There may be a need for filtering (i) with minimal interruption of the 3D printing such as with no interruption of the 3D printing, (ii) at least in part during the 3D printing, (iii) uninterrupted filtering such as continuous filtering, or (iv) any combination of (i) to (ii).

In some examples, it may be beneficial to transport pre-transformed material against gravity (e.g., in an upwards direction). For example, it may be beneficial to transport the pre-transformed material from a reservoir containing a large amount of pre-transformed material, against gravity to a reservoir containing a smaller amount of pre-transformed material. For example, it may be beneficial to keep large quantities of the pre-transformed material in a large reservoir disposed at a low elevation (e.g., relative to a position of the material dispenser) for ease of operation (e.g., handling), and/or safety consideration.

### SUMMARY

In some aspects, the present disclosure resolves the aforementioned hardships. In an aspect, the present disclosure comprises a transporting of pre-transformed material from a reservoir during a portion of the 3D printing process. The transporting may be against gravity, e.g., against an environmental gravitational field.

In aspects, remainder material is recycled, e.g., during the three-dimensional printing. The remainder material may be an excess material. The recycling may comprise usage of a directional conveyance system that conveys the remainder to the material recycling system, or as part of a material recycling system. The remainder may be supplied from one or more sources. For example, the remainder may be supplied from the layer dispensing mechanism and/or from an unpacking mechanism such as when the unpacking mechanics is an integral part of the three-dimensional printing system. The remainder conveyance system may facilitate uninterrupted function of the three-dimensional printing, be automatically controlled, operate at a controlled atmosphere different from the ambient atmosphere (e.g., by content and/or pressure), or any combination thereof. The directional conveyance system may facilitate continuous recycling of remainder. The recycled material may be filtered (e.g., sieved) during the recycling process. The sieving may comprise usage of sonic wave guide(s). The sonic wave guide(s) may contact the filter. The sonic wave guide may operate during the printing, e.g., continuously. Sonic wave guide may facilitate transmission of vibrations (e.g., sonic waves). The vibrations may be generated by a generator, e.g., a sonic generator such as an ultrasonic generator. The generator may generate a sonic sequence of pulses to facilitate vibration of the filter (e.g., sieve), e.g., with minimal clogging of the filter by the remainder (e.g., comprising particulate matter). The generator may generate a sonic sequence of pulses to facilitate continuous filtration of the remainder during operation.

In another aspect, a system for three-dimensional printing of at least one three-dimensional object comprises: a material dispenser that dispenses a pre-transformed material towards a platform; a first pressure container that is configured to contain the pre-transformed material, which first pressure container is operatively coupled to the material dispenser; a gas conveyor channel that is operatively coupled to the first pressure container; a material conveyor channel that is operatively coupled to the first pressure container, the gas conveyor channel, and the material dispenser; and at least one controller that is operatively coupled to the material dispenser, the first pressure container, the gas conveyor channel, and the material conveyor channel, which at least one controller is programmed to direct performance of the following operations: operation (i) direct insertion of at least one gas into the first pressure container, through the gas conveyor channel, to elevate the pressure in the pressure container, operation (ii) direct conveying of the pre-transformed material from the pressure container to the material dispenser through the material conveyor channel, as a result of an elevated pressure in the pressure container, operation (iii) direct dispensing of conveyed pre-transformed material towards the platform, and operation (iv) direct printing, during dispensing or after dispensing, of at least a portion of the at least one three-dimensional object, from the pre-transformed material. In some embodiments, the system further comprises a second pressure container that is configured to contain the pre-transformed material, which second pressure container is operatively coupled to the material dispenser, and the material conveyor channel. In some embodiments, the at least one controller is programmed to direct performance of conveying the pre-transformed material from the second pressure container to the material dispenser. In some embodiments, conveying from the second pressure container comprises dense phase conveying. In some embodiments, the at least one controller is programmed to direct performance of alternatingly conveying the pre-transformed material to the material dispenser, from the first pressure container and from the second pressure container. In some embodiments, the at least one controller is programmed to direct performance of switching conveying from the first pressure container to the second pressure container. In some embodiments, at least two of operation (i), operation (ii), operation (iii), and operation (iv) are directed by the same controller. In some embodiments, the at least one controller is a plurality of controllers and wherein at least two of operation (i), operation (ii), operation (iii), and operation (iv) are directed by different controllers. In some embodiments, the material conveyor channel is operatively coupled to a sieving assembly comprising a sieve, e.g., as disclosed herein. In some embodiments, the sieve is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the material conveyor channel is operatively coupled to a device configured for directional powder displacement such as comprising a bounceable plate. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein.

In another aspect, an apparatus for three-dimensional printing of at least one three-dimensional object comprises: a material dispenser that dispenses pre-transformed material towards a platform, which pre-transformed material is used to print at least a portion of the at least one three-dimensional object, wherein the print is after the dispensing or during the dispensing; a first pressure container that is configured to contain the pre-transformed material, which first pressure container is operatively coupled to the material dispenser; a first gas conveyor channel that is operatively coupled to the first pressure container, which first gas conveyor channel is configured to at least facilitate an insertion of at least one gas into the first pressure container, wherein the insertion can form an elevated pressure in the first pressure container; and a material conveyor channel that is operatively coupled to the first pressure container, the first gas conveyor channel, and the material dispenser, which material conveyor channel conveys pre-transformed material from the first pressure container to the material dispenser, on insertion of the at least one gas into the first pressure container to form the elevated pressure in the pressure container. In some embodiments, elevated is relative to an ambient pressure. In some embodiments, the first pressure container is additionally configured to facilitate an extraction of the at least one gas from the first pressure container, wherein the extraction forms a reduced pressure in the first pressure container. In some embodiments, reduced is relative to an ambient pressure. In some embodiments, the apparatus further comprises a second pressure container that is configured to contain the pre-transformed material, which second pressure container is operatively coupled to the material dispenser, and the material conveyor channel. In some embodiments, the apparatus further comprises a second gas conveyor channel that is operatively coupled to the second pressure container, which second gas conveyor channel is configured to at least facilitate insertion of at least one gas into the second pressure container, wherein the insertion can form an elevated pressure in the second pressure container. In some embodiments, the second gas conveyor channel is different from the first gas conveyor channel. In some embodiments, the second gas conveyor channel is operatively coupled to the first gas conveyor channel. In some embodiments, the second gas conveyor channel is the same as the first gas conveyor channel. In some embodiments, at least a portion of the material conveyor channel is inserted into an interior of the first pressure container. In some embodiments, the material conveyor channel extends into an interior of the first pressure container. In some embodiments, the material conveyor channel comprises one or more boundaries that comprise a smooth internal surface, which smooth internal surface is configured to facilitate conveyance of the pre-transformed material. In some embodiments, the internal surface comprises a static dissipative surface. In some embodiments, the internal surface comprises a charge. In some embodiments, the charge is altered. In some embodiments, the charge is altered is during the conveyance of the pre-transformed material. In some embodiments, the apparatus further comprises a separator, which separator is operatively coupled to the material conveyor channel and the material dispenser, which separator is configured to at least partially separate the at least one gas from the pre-transformed material. In some embodiments, the apparatus further comprises a separator, which separator is operatively coupled to the material conveyor channel and a recycling mechanism, which separator is configured to at least partially separate the at least one gas from the pre-transformed material, wherein the recycling mechanism comprises an entrance port and/or an exit port. In some embodiments, the material conveyor channel is operatively coupled to a sieving assembly comprising a sieve, e.g., as disclosed herein. In some embodiments, the sieve is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the material conveyor channel is operatively coupled to a device configured for directional powder displacement. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein.

In another aspect, an apparatus for three-dimensional printing of at least one three-dimensional object comprises at least one controller that is programmed to perform the following operations: operation (a) direct conveying of a pre-transformed material from a first pressure container to a material dispenser, which conveying comprises dense phase conveying; operation (b) direct dispensing of a conveyed pre-transformed material from the material dispenser towards a platform; and operation (c) direct printing of at least a portion of the at least one three-dimensional object from the pre-transformed material after the dispensing or during the dispensing. In some embodiments, the at least two of operation (a), operation (b), and operation (c) are directed by the same controller. In some embodiments, the at least one controller is a plurality of controllers and wherein at least two of operation (a), operation (b), and operation (c) are directed by different controllers. In some embodiments, the at least one controller is configured to operatively couple to any system and/or device disclosed herein. In some embodiments, the at least one controller is configured to direct performance of any operation associated with any system, any other apparatus and/or any device disclosed herein.

In another aspect, a method for printing at least one three-dimensional object comprises: a. conveying a pre-transformed material from a first pressure container to a material dispenser, which conveying comprises dense phase conveying; b. dispensing a conveyed pre-transformed material from the material dispenser towards a platform; and c. printing at least a portion of the at least one three-dimensional object from the pre-transformed material after the dispensing or during the dispensing. In some embodiments, the method comprises performance, or directing performance, of any operation associated with any system, any apparatus, and/or any device disclosed herein. In some embodiments, dense phase conveying comprises (i) inserting pre-transformed material into the first pressure container, (ii) inserting at least one gas into the first pressure container to form a pressure gradient between the first pressure container and a target to facilitate dispensing the conveyed pre-transformed material, and (iii) conveying the pre-transformed material from the first pressure container to the target, across the pressure gradient. In some embodiments, the target includes a bulk reservoir, the material dispenser, a processing chamber, or any combination thereof. In some embodiments, the method further comprises conveying the pre-transformed material from a second pressure container to the material dispenser. In some embodiments, conveying from the second pressure container comprises dense phase conveying. In some embodiments, the method further comprises alternatingly conveying the pre-transformed material to the material dispenser, from the first pressure container and from the second pressure container. In some embodiments, the conveying is continuous. In some embodiments, the conveying is discontinuous. In some embodiments, the conveying includes packets of pre-transformed material. In some embodiments, the method further comprises switching conveying from the first pressure container to the second pressure container. In some embodiments, the method further comprises facilitating continuous flow of pre-transformed material into the material dispenser. In some embodiments, the method further comprises switching conveying from the second pressure container to the first pressure container. In some embodiments, the switching is alternating. In some embodiments, the switching is controlled. In some embodiments, the switching is during dispensing the conveyed pre-transformed material from the material dispenser. In some embodiments, the switching is coordinated with evacuating at least a portion of the pre-transformed material from the first pressure container or the second pressure container. In some embodiments, the switching is coordinated with filling of the first pressure container or the second pressure container with the pre-transformed material. In some embodiments, filling comprises filling with pre-transformed material from an external material source. In some embodiments, filling comprises filling with an excess of pre-transformed material from a processing chamber in which the at least one three-dimensional object is printed. In some embodiments, filling comprises filling with an excess of pre-transformed material from a leveler or from a material remover, wherein the leveler and/or the material remover planarize an exposed surface of a material bed that the material dispenser forms upon dispensing pre-transformed material. In some embodiments, evacuating comprises conveying pre-transformed material to the material dispenser. In some embodiments, evacuating comprises conveying pre-transformed material to a bulk reservoir. In some embodiments, evacuating comprises conveying pre-transformed material to an external material source. In some embodiments, the method further comprises conveying (i) pre-transformed material from the first pressure container to the material dispenser and (ii) pre-transformed material from the material dispenser to the second pressure container. In some embodiments, the conveying of (i) and (ii) is simultaneous. In some embodiments, the conveying of (i) and (ii) is sequential. In some embodiments, the method further comprises (i) evacuating pre-transformed material from the first pressure container, and (ii) filling pre-transformed material to the second pressure container. In some embodiments, the conveying of (i) and (ii) is simultaneous. In some embodiments, the conveying of (i) and (ii) is sequential. In some embodiments, conveying comprises conveying via a material conveying channel

In another aspect, program instructions (e.g., as part of at least one computer software product) for three-dimensional printing of at least one three-dimensional object, which program instructions, when read by at least one computer, cause the at least one computer to perform operations comprising: operation (a) directing conveying of a pre-transformed material from a first pressure container to a material dispenser, which conveying comprises dense phase conveying; operation (b) directing dispensing of a conveyed pre-transformed material from the material dispenser towards a platform; and operation (c) directing printing of at least a portion of the at least one three-dimensional object from the pre-transformed material after the dispensing or during the dispensing. The program instructions can be stored in a (e.g., non-transitory) medium or in media. In some embodiments, the at least one computer is configured to operatively couple to any system and/or device disclosed herein. In some embodiments, the program instructions are configured to direct performance of any operation associated with any system, any other apparatus and/or any device disclosed herein. In some embodiments, at least two of operation (a), operation (b), and operation (c) are directed by the same controller. In some embodiments, the computer software product further comprises a plurality of controllers configured to read the program instructions, and wherein at least two of operation (a), operation (b), and operation (c) are directed by different controllers.

In another aspect, a system for three-dimensional printing of at least one three-dimensional object comprises: a processing chamber that is configured to expel an excess amount of a pre-transformed material, which excess is generated during printing of at least a portion of the at least one three-dimensional object; a first pressure container, which first pressure container is operatively coupled to the processing chamber; a material conveyor channel, wherein the material conveyor channel is operatively coupled to the first pressure container and to the processing chamber; and at least one controller that is operatively coupled to the processing chamber, the first pressure container and the material conveyor channel, which at least one controller is programmed to collectively or separately direct performance of the following operations: operation (i) direct collecting an excess amount of pre-transformed material that is expelled from the processing chamber, and operation (ii) direct dilute phase conveyance of the excess pre-transformed material from the processing chamber to the first pressure container, through the material conveyor channel. In some embodiments, the material conveyor channel is operatively coupled to a sieving assembly comprising a sieve, e.g., as disclosed herein. In some embodiments, the sieve is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the material conveyor channel is operatively coupled to a device configured for directional powder displacement. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein. In some embodiments, the system further comprises a second pressure container that is configured to collect the excess amount of pre-transformed material that is expelled from the processing chamber, which second pressure container is operatively coupled to the processing chamber, and to the material conveyor channel. In some embodiments, the at least one controller is programmed to direct performance of conveying the pre-transformed material from the processing chamber to the second pressure container. In some embodiments, conveying to the second pressure container comprises dilute phase conveying.

In another aspect, an apparatus for three-dimensional printing of at least one three-dimensional object comprises: a processing chamber comprising an exit opening from which an excess amount of pre-transformed material in the processing chamber is expelled, which excess amount of pre-transformed material is generated during printing of at least a portion of the at least one three-dimensional object; a first pressure container that collects the excess amount of pre-transformed material that is expelled from the processing chamber, which first pressure container is operatively coupled to the processing chamber; and a material conveyor channel that is configured to convey the excess amount of the pre-transformed material from the processing chamber to the first pressure container by dilute phase conveyance, wherein the material conveyor channel is operatively coupled to the first pressure container and to the processing chamber. In some embodiments, the material conveyor channel is operatively coupled to a sieving assembly comprising a sieve, e.g., as disclosed herein. In some embodiments, the sieve is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the material conveyor channel is operatively coupled to a device configured for directional powder displacement. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein. In some embodiments, the apparatus further comprises a gas source that is configured to deliver at least one gas to the material conveyor channel to facilitate the dilute phase conveyance, wherein the material conveyor channel is operatively coupled to the gas source. In some embodiments, the apparatus further comprises a recycling mechanism that is configured to collect the excess amount of the pre-transformed material, which recycling mechanism is operatively coupled to the processing chamber, which recycling mechanism comprises an opening. In some embodiments, the apparatus further comprises a material remover that is configured to facilitate collection and/or expulsion of the excess amount of pre-transformed material. In some embodiments, the apparatus further comprises a material leveler that is configured to facilitate collection and/or expulsion of the excess amount of pre-transformed material. In some embodiments, the apparatus further comprises a second pressure container that is configured to collect the excess amount of pre-transformed material that is expelled from the processing chamber, which second pressure container is operatively coupled to the processing chamber, and to the material conveyor channel. In some embodiments, the apparatus further comprises a separator, which separator is operatively coupled to the material conveyor channel and the first pressure container, which separator is configured to at least partially separate the at least one gas from pre-transformed material. In some embodiments, the apparatus further comprises a separator, which separator is operatively coupled to the material conveyor channel and the second pressure container, which separator is configured to at least partially separate the at least one gas from pre-transformed material

In another aspect, an apparatus for three-dimensional printing of at least one three-dimensional object comprises at least one controller that is collectively or separately programmed to perform the following operations: operation (a) direct collecting an excess amount of pre-transformed material from a processing chamber, which excess is generated during printing of at least a portion of the at least one three-dimensional object; and operation (b) direct conveying a collected excess amount of pre-transformed material from the processing chamber to a first pressure container, which conveying comprises dilute phase conveying. In some embodiments, the at least one controller is configured to operatively couple to any system and/or device disclosed herein. In some embodiments, the at least one controller is configured to direct performance of any operation associated with any system, any other apparatus and/or any device disclosed herein.

In another aspect, a method for printing at least one three-dimensional object comprises: (a) collecting an excess amount of a pre-transformed material from a processing chamber, which excess is generated during printing of at least a portion of the at least one three-dimensional object; and (b) conveying a collected excess amount of the pre-transformed material from the processing chamber to a first pressure container, which conveying comprises dilute phase conveying. In some embodiments, the method comprises performance, or directing performance, of any operation associated with any system, any apparatus, and/or any device disclosed herein. In some embodiments, the method further comprises before (b), recycling and/or reconditioning the excess amount of the pre-transformed material. In some embodiments, the method further comprises after (a), recycling and/or reconditioning the excess amount of the pre-transformed material. In some embodiments, collecting comprises transferring an excess amount of the pre-transformed material into a recycling mechanism. In some embodiments, a material leveler transfers the excess amount of the pre-transformed material into the recycling mechanism. In some embodiments, a material remover transfers the excess amount of the pre-transformed material into the recycling mechanism. In some embodiments, dilute phase conveying comprises (i) inserting the pre-transformed material into a material conveying channel from the processing chamber, (ii) inserting at least one gas into the material conveying channel, which at least one gas comprises a conveying velocity to form a suspended pre-transformed material from at least a portion of the pre-transformed material, and (iii) conveying the suspended pre-transformed material from the processing chamber to the first pressure container. In some embodiments, the method further comprises maintaining the conveying velocity while conveying through the material conveying channel. In some embodiments, the conveying velocity is constant while conveying through the material conveying channel. In some embodiments, the conveying velocity is altered while conveying through the material conveying channel. In some embodiments, the method further comprises maintaining a suspension of the suspended pre-transformed material while conveying through the material conveying channel. In some embodiments, the inserting at least one gas comprises pressurizing the at least one gas. In some embodiments, the method further comprises conveying the collected excess amount of the pre-transformed material from the processing chamber to a second pressure container. In some embodiments, conveying to the second pressure container comprises dilute phase conveying. In some embodiments, the method further comprises conveying the excess amount of the pre-transformed material from a material dispenser to the first pressure container and the second pressure container. In some embodiments, the method further comprises simultaneously conveying (i) pre-transformed material from the first pressure container to a material dispenser and (ii) excess pre-transformed material from the material dispenser to the second pressure container. In some embodiments, the method further comprises simultaneously (i) evacuating pre-transformed material from the first pressure container, and (ii) filling excess pre-transformed material into the second pressure container. In some embodiments, the method further comprises alternatingly (i) evacuating pre-transformed material from the first pressure container, and (ii) filling excess pre-transformed material into the second pressure container. In some embodiments, the conveying is continuous. In some embodiments, the conveying is discontinuous. In some embodiments, the conveying includes packets of pre-transformed material. In some embodiments, the method further comprises switching conveying to the first pressure container from the second pressure container. In some embodiments, the method further comprises facilitating continuous dispensing of pre-transformed material from the material dispenser. In some embodiments, the method further comprises switching conveying to the second pressure container from the first pressure container. In some embodiments, the switching is alternating. In some embodiments, the switching is controlled. In some embodiments, the switching is during the printing of the at least one three-dimensional object. In some embodiments, the switching is during material dispensing from the material dispenser. In some embodiments, the switching is coordinated with emptying of the first pressure container or the second pressure container. In some embodiments, the switching is coordinated with filling of the first pressure container or the second pressure container.

In another aspect, program instructions (e.g., as part of at least one computer software product) for three-dimensional printing of at least one three-dimensional object, which instructions, when read by at least one computer, cause the at least one computer to perform operations comprising: operation (a) directing collecting an excess amount of pre-transformed material from a processing chamber, which excess is generated during printing of at least a portion of the at least one three-dimensional object; and operation (b) directing conveying the collected excess amount of pre-transformed material from the processing chamber to a first pressure container, which conveying comprises dilute phase conveying. The program instructions can be stored in a (e.g., non-transitory) medium or in media. In some embodiments, the at least one computer is configured to operatively couple to any system and/or device disclosed herein. In some embodiments, the program instructions are configured to direct performance of any operation associated with any system, any other apparatus and/or any device disclosed herein.

In another aspect, an apparatus for printing at least one three-dimensional object comprises: an enclosure comprising at least one wall that encloses a volume configured to accommodate a gas and the at least one three-dimensional object; an energy source that is configured to provide an energy beam that transforms a pre-transformed material to a transformed material to print the at least one three-dimensional object, which energy beam generates soot during transformation of the pre-transformed material to the transformed material; a channel configured to transport a first mixture that includes the gas, the soot, and the pre-transformed material which channel is operatively coupled to the enclosure; a separator that is operatively coupled to the channel, which separator is configured to separate the first mixture to a second mixture rich in the gas and the soot, and a third mixture rich in the pre-transformed material (and may comprise the soot), wherein the channel is configured to transport the first mixture between the enclosure and the separator; and a collector comprising an inlet opening operatively coupled to the separator and configured to facilitate flow of the second mixture therethrough, which collector is configured to collect at least a portion of the soot from the second mixture. In some embodiments, the channel is operatively coupled to a sieving assembly comprising a sieve, e.g., as disclosed herein. In some embodiments, the sieve is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the channel is operatively coupled to a device configured for directional powder displacement. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein. In some embodiments, the apparatus further comprising a layer dispenser that dispenses a planar layer of the pre-transformed material to form a material bed in which the at least one three-dimensional object is printed. In some embodiments, the layer dispenser is configured to extract the first mixture that additionally comprises spatter generated during the printing. In some embodiments, the soot is a byproduct of the transformation of the pre-transformed material to the transformed material. In some embodiments, the soot comprises particles having a fundamental length scale (FLS) of at most about 5 microns, and wherein the pre-transformed material comprises particles having a FLS of at least about 10 microns. In some embodiments, the first mixture further comprises spatter, which spatter is a byproduct of the transformation of the pre-transformed material to the transformed material. In some embodiments, the third mixture comprises the spatter. In some embodiments, the printing of the at least one three-dimensional object comprises a printing cycle, and wherein the collector is configured to collect the at least the portion of the soot from the second mixture at least during the printing cycle. In some embodiments, the collector is configured to collect the at least the portion of the soot during printing of at least a portion of the at least one three-dimensional object. In some embodiments, the printing cycle comprises layerwise printing of the at least one three-dimensional object, and wherein the collecting in (d) is following each layer. In some embodiments, the collector comprises a filter. In some embodiments, the apparatus further comprises one or more sensors operatively coupled with the separator and/or the collector, which one or more sensors are operable to detect a characteristic of the soot, spatter, and/or the pre-transformed material. In some embodiments, the characteristic comprises (i) a level, (ii) a volume, (iii) a flux, (iv) a chemical composition, or (v) any combination thereof. In some embodiments, the one or more sensors facilitate controlling one or more apparatuses of the printing by considering output of the one or more sensors. In some embodiments, the one or more apparatuses comprises a remover that removes the mixture by (i) attracting a gas and the material into an internal volume of the remover and (ii) cyclonically separating the material from the gas in the remover. In some embodiments, the apparatus further comprises a power connector coupled with the one or more apparatuses, which power connector comprises an outlet, an inlet, a wire, or any combination thereof. In some embodiments, the collector further comprises an outlet opening. In some embodiments, the outlet opening is configured to facilitate flow of the gas therethrough. In some embodiments, the channel is a first channel, and wherein the apparatus further comprises a second channel operatively coupled to the outlet opening and to the enclosure, which second channel is configured to transport the gas. In some embodiments, the apparatus further comprises one or more valves coupled with the first channel and/or the second channel, which one or more valves are configured to alternately block or allow flow of gas therethrough. In some embodiments, the first channel and the second channel are the same. In some embodiments, the separator is a cyclonic separator. In some embodiments, the separator comprises at least two cyclonic separators that are operatively coupled in parallel or sequentially. In some embodiments, the at least two cyclonic separators are arranged in a sequence, such that an outlet of a first cyclonic separator is coupled with an inlet of a following cyclonic separator of the sequence. In some embodiments, the separator comprises a wall enclosing an internal volume, which separator is configured to gravitationally collect the third mixture in the internal volume. In some embodiments, the internal volume comprises a reservoir. In some embodiments, the separator is configured to collect the third mixture in at least a portion of the internal volume that does not share a flow path with the second mixture through the internal volume.

In another aspect, an apparatus for printing at least one three-dimensional object comprises: at least one controller that is operatively coupled to an energy source, a separator, and an inlet opening, which at least one controller is programmed to (i) direct the energy source to generate an energy beam to transform a pre-transformed material to a transformed material to print the at least one three-dimensional object and generate soot in an enclosure that encloses a gas, (ii) facilitate transport of a first mixture comprising the pre-transformed material, the soot, and the gas, to the separator, (iii) direct the separator to separate the first mixture to a second mixture rich in gas and soot, and a third mixture rich in (soot and) pre-transformed material, and (iv) facilitate collection of at least part of the soot of the second mixture in a collector. In some embodiments, the at least one controller is configured to operatively couple to any system and/or device disclosed herein. In some embodiments, the at least one controller is configured to direct performance of any operation associated with any system, any other apparatus and/or any device disclosed herein. In some embodiments, the at least one controller is operatively coupled to a layer dispensing mechanism. In some embodiments, the controller is further configured to direct planarizing an exposed surface of a material bed in which the at least one three-dimensional object is printed, which planarizing comprises extracting the first mixture that additionally comprises spatter generated during the printing. In some embodiments, the apparatus comprises one or more valves and/or a compressed gas source coupled with the separator, the enclosure, and/or the collector, wherein the at least one controller is coupled with the one or more valves and/or the compressed gas source. In some embodiments, the at least one controller is programmed to direct at least one valve of the one or more valves and/or the compressed gas source to facilitate the transport in (ii). In some embodiments, the compress gas source is an active compressed gas source that comprises a blower, a fan, a compressor, or a pump. In some embodiments, the compress gas source is a passive compressed gas source (e.g., a gas cylinder). In some embodiments, to facilitate comprises controlling an opening or closing of the one or more valves, or a flow of the compressed gas. In some embodiments, the soot is a byproduct of a transformation of the pre-transformed material to the transformed material. In some embodiments, the soot comprises particles having a fundamental length scale (FLS) of at most about 5 microns, and wherein the pre-transformed material comprises particles having a FLS of at least about 10 microns. In some embodiments, the printing the at least one three-dimensional object comprises a printing cycle, wherein the printing cycle includes a layer-by-layer formation of the three-dimensional object. In some embodiments, the at least one controller is programmed to facilitate the collection in (iv) following formation of each layer. In some embodiments, the collection is from a remover that is configured to attract the mixture during the printing. In some embodiments, the at least one controller is programmed to facilitate at least two of the transport in (ii), the separation in (iii) and the collection in (iv) at least during the printing. In some embodiments, the apparatus further comprises the at least one controller operatively coupled with one or more sensors, which one or more sensors are configured to detect at least one characteristic of the soot the pre-transformed material and/or any spatter produced during the printing. In some embodiments, the at least one characteristic comprises (i) a level, (ii) a volume, (iii) a flux, (iv) an amount, (v) a chemical composition, or (vi) any combination thereof. In some embodiments, the at least one controller is configured to adjust at least one of the at least one characteristic (i)-(v), considering a detection of the at least one characteristic. In some embodiments, to adjust comprises a closed loop control scheme, which comprises a feedback or a feed-forward control scheme. In some embodiments, the closed loop control is in real time, which real time comprises during the printing at least a portion of the at least one three-dimensional object. In some embodiments, the at least one controller is configured utilize a closed loop control scheme that is utilized is in real time during printing of at least a portion of the at least one three-dimensional object. In some embodiments, the at least one controller is programmed to facilitate adjustment to a rate at which the first mixture is transported to the separator. In some embodiments, the adjustment is considering a detection of a rate at which second mixture is flowing to the collector. In some embodiments, at least two (i)-(iv) are directed by the same controller. In some embodiments, at least two of (i)-(iv) re directed by different controllers.

In another aspect, a method of printing at least one three-dimensional object comprises: (a) generating an energy beam to transform a pre-transformed material to a transformed material to print the at least one three-dimensional object in an enclosure and generate soot, which enclosure comprises a gas; (b) flowing a first mixture comprising the gas, the soot, and the pre-transformed material from the enclosure to a separator; (c) separating the first mixture to a second mixture rich in the gas and the soot, and a third mixture rich in the pre-transformed material (and may comprise soot); and (d) collecting at least part of the soot of the second mixture. In some embodiments, the method comprises performance, or directing performance, of any operation associated with any system, any apparatus, and/or any device disclosed herein. In some embodiments, the method further comprises before flowing the first mixture, planarizing an exposed surface of a material bed in which the at least one three-dimensional object is printed, which planarizing comprises extracting the first mixture that additionally comprises spatter generated during the printing. In some embodiments, the soot is a byproduct of transforming the pre-transformed material to the transformed material. In some embodiments, the soot comprises particles having a fundamental length scale (FLS) of at most about 5 microns, and wherein the pre-transformed material comprises particles having a FLS of at least about 10 microns. In some embodiments, the first mixture further comprises spatter, which spatter is a byproduct of transforming the pre-transformed material to the transformed material. In some embodiments, the separating in (c) comprises the third mixture to further be rich in the spatter. In some embodiments, the printing the at least one three-dimensional object comprises a printing cycle, wherein the collecting in (d) is during the printing cycle. In some embodiments, the collecting in (d) is during printing of a portion of the at least one three-dimensional object. In some embodiments, the printing cycle comprises layerwise printing of the at least one three-dimensional object, and wherein the collecting in (d) is following each layer. In some embodiments, the collecting in (d) comprises filtering. In some embodiments, the method further comprises detecting a characteristic of the soot, the pre-transformed material, and any spatter produced during the printing. In some embodiments, the characteristic comprises (i) a level, (ii) a volume, (iii) a flux, (iv) a chemical composition, (v) and amount, or (vi) any combination thereof. In some embodiments, the method further comprises flowing the gas to the enclosure, following the collecting in (d). In some embodiments, the separating comprises gravitationally collecting the third mixture in an internal volume of the separator. In some embodiments, the method further comprises storing the third mixture in a reservoir. In some embodiments, the collecting the third mixture is in a portion of the internal volume through which the second mixture does not flow. In some embodiments, the separating comprises cyclonic separation. In some embodiments, the separating in (c) comprises at least two separating operations, each separating operation reducing an amount of the soot and pre-transformed material from the first mixture. In some embodiments, each separating operation of the at least two separating operations comprises a respective collecting of the soot and pre-transformed material. In some embodiments, each separating operation is by a respective separator. In some embodiments, the at least two separating operations are performed sequentially. In some embodiments, the pre-transformed material comprises an elemental metal, metal alloy, ceramic, an allotrope of elemental carbon, a polymer, or a resin.

In another aspect, a system for printing a three-dimensional object comprises: an enclosure comprising at least one wall enclosing a volume that accommodates the three-dimensional object during the printing; a dispenser that is configured to dispense a dispensed amount of pre-transformed material through an opening of the dispenser toward a target surface that is disposed in the enclosure in which the three-dimensional object is printed, which dispensed amount of pre-transformed material is at least twice an amount of pre-transformed material required to form a material bed in which the three-dimensional object is printed, wherein an excess material comprise the dispensed pre-transformed material that did not form the material bed and/or the at least one three-dimensional object; and a recycling system comprising a sieve, wherein the recycling system is operatively coupled to the enclosure and is configured to (i) accommodate at least a portion of the excess material and (ii) recycle the at least a portion of the excess material at least in part by sieving the excess material through the sieve. In some embodiments, the recycling system is operatively coupled to a sieving assembly comprising the sieve, e.g., as disclosed herein. In some embodiments, the sieve is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the recycling system is operatively coupled to a device configured for directional powder displacement. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein. In some embodiments, the recycling system comprises an entrance opening configured to facilitate flow of the excess material therethrough. In some embodiments, the recycling system is operatively coupled to a remover that removes the excess material by (i) attracting a gas and the excess material into an internal volume of the remover and (ii) cyclonically separating the excess material from the gas in the remover. In some embodiments, the flow of the excess material comprises a mixture of a gas and the excess material. In some embodiments, the system further comprises a separator coupled with the enclosure and the entrance opening of the recycling system, which separator is configured to separate at least part of the excess material from the gas. In some embodiments, the separator comprises a cyclonic separator. In some embodiments, the excess material comprises any soot or any spatter produced in the printing. In some embodiments, the system further comprises a material reservoir having a material inlet coupled to an outlet of the recycling system, which material reservoir is configured to store a recycled pre-transformed material. In some embodiments, the material reservoir is configured to provide at least part of the recycle pre-transformed material during the printing of the three-dimensional object and/or during a subsequent printing. In some embodiments, the printing the three-dimensional object is during a print cycle, which print cycle comprises a layer-by-layer formation of the three-dimensional object. In some embodiments, the recycling system is configured to recycle in (ii) following each layer formation. In some embodiments, the recycling system is configured to recycle at least 40 cubic centimeters of the excess material following each layer formation. In some embodiments, the recycling system and/or sieve is configured to filter at least 50 kilograms. In some embodiments, the recycling system and/or sieve is configured to filter at least 500 kilograms. In some embodiments, the recycling system and/or sieve is configured to filter at a throughput of at least about six (6) cubic centimeters of material per hour (cc/hr). In some embodiments, the recycling system and/or sieve is configured to filter the excess material that has a fundamental length scale of at most 1000 micrometers. In some embodiments, the recycling system and/or sieve is configured to filter the excess material that has a fundamental length scale of at most 100 micrometers. In some embodiments, each layer of the layer-by-layer formation comprises a substantially equal layer height in the material bed. In some embodiments, a height of the dispensed amount of pre-transformed is at least five times a layer height. In some embodiments, the height of the dispensed amount of pre-transformed material comprises an average height across the target surface. In some embodiments, the system comprises a material removal member that is adjacent to the target surface, wherein the material removal member is operable to remove the excess material from the enclosure. In some embodiments, the excess material comprises at least five (5) times the layer height. In some embodiments, to remove is with aid of one or more a magnetic force, an electrostatic force, and a gas flow (e.g., vacuum). In some embodiments, the pre-transformed material comprises a particulate material. In some embodiments, the pre-transformed material comprises an elemental metal, metal alloy, ceramic, an allotrope of elemental carbon, a polymer, or a resin. In some embodiments, the system further comprises a power connector coupled with the dispenser and/or the recycling system, which power connector comprises an outlet, an inlet, a wire, or any combination thereof. In some embodiments, the apparatus further comprises a material remover that is configured to planarize an exposed surface of the material bed in which the three-dimensional object is printed to form the layer height. In some embodiments, the material remover attracts from the material bed the excess material and a gas and at least partially separates the excess material from the gas in the material remover by using a cyclonic separator integrated in the material remover.

In another aspect, an apparatus for printing at least one three-dimensional object comprises: at least one controller that is operatively coupled to a dispenser and to a recycling system, which at least one controller is configured (e.g., programmed) to (i) direct dispensing of a dispensed amount of a pre-transformed material in an enclosure to form (a) a material bed in which the at least one three-dimensional object is printed, and (b) an excess material, which dispensed amount is at least twice an amount of pre-transformed material required to form the material bed, which excess material comprises the dispensed material that does not form the material bed and/or the at least one three-dimensional object, and (ii) direct recycling of the excess material at least in part by sieving the excess material. In some embodiments, the at least one controller is configured to operatively couple to any system and/or device disclosed herein. In some embodiments, the at least one controller is configured to direct performance of any operation associated with any system, any other apparatus and/or any device disclosed herein. In some embodiments, the recycling system comprises an entrance opening configured to facilitate flow of the excess material therethrough, wherein in (ii) the at least one controller is programmed to facilitate entry of the excess material from the enclosure to the recycling system. In some embodiments, the excess material comprises any soot or any spatter produced in the printing. In some embodiments, the at least one controller is programmed to direct recycling of the excess material at least in part during the printing. In some embodiments, the at least one controller is programmed to direct recycling of the excess material to be continuous during the printing. In some embodiments, the at least one controller is programmed to direct recycling of the excess material to form a recycled pre-transformed material, and to direct use of the recycled pre-transformed material during the printing of the three-dimensional object and/or during a subsequent printing. In some embodiments, to facilitate comprises controlling (I) one or more valves to open or close, (II) a compressed gas source to selectively flow gas, or (III) a power source to selectively supply power. In some embodiments, the recycling system further comprises an outlet opening configured to facilitate conveyance of the recycled pre-transformed material to a material reservoir. In some embodiments, the material reservoir comprises a material port coupled with an inlet port of the dispenser, wherein the at least one controller is programmed to (iii) facilitate conveying the pre-transformed material to the dispenser from the material reservoir. In some embodiments, the conveying comprises a dense phase conveyance of the pre-transformed material. In some embodiments, the outlet opening is configured to facilitate conveyance of the recycled pre-transformed material to at least two material reservoirs. In some embodiments, the at least one controller is programmed to direct conveying the recycled excess to the at least two material reservoirs alternatingly. In some embodiments, the printing the three-dimensional object comprises a printing cycle, which printing cycle comprises layer-by-layer formation of the three-dimensional object. In some embodiments, the at least one controller is programmed to direct during the printing cycle recycling of a total amount of recycled excess material that is greater than a total material bed volume at the completion of the printing cycle. In some embodiments, the total amount of recycled excess material is at least 5 times the total material bed volume. In some embodiments, the at least one controller is programmed to direct the recycling in (ii) following at least one (e.g., each) layer of the layer-by-layer formation. In some embodiments, the at least one controller is programmed to direct the recycling to sieve at a rate of at least 0.5 cubic centimeters of the excess per minute, per square centimeter of a sieving area. In some embodiments, the at least one controller is programmed to direct the recycling to sieve at least 50 kilograms. In some embodiments, the at least one controller is programmed to direct the recycling to sieve at least 500 kilograms. In some embodiments, the at least one controller is programmed to direct the recycling to sieve at a throughput of at least about six (6) cubic centimeters of material per hour (cc/hr). In some embodiments, the at least one controller is programmed to direct the recycling to sieve the excess material that has a fundamental length scale of at most 1000 micrometers. In some embodiments, the at least one controller is programmed to direct the recycling to sieve the excess material that has a fundamental length scale of at most 100 micrometers. In some embodiments, the at least one controller is programmed to facilitate maintaining the enclosure at a first atmosphere, and a recycling system enclosure at a second atmosphere, which first atmosphere and second atmosphere are different than an external atmosphere that comprises a reactive agent. In some embodiments, the at least one controller is programmed to facilitate flow of a gas comprising an inert atmosphere for the maintaining the first atmosphere and the second atmosphere. In some embodiments, the apparatus further comprises a removal member comprising a removal opening disposed over the material bed, which at least one controller is programmed to facilitate removal of the excess material from the enclosure through the removal opening. In some embodiments, removal is with the aid of one or more of a magnetic force, an electrostatic force, and a gas flow.

In another aspect, a method for printing a three-dimensional object comprises: (a) dispensing a dispensed amount of a pre-transformed material to form (i) a material bed in which the three-dimensional object is printed and (ii) an excess amount of the pre-transformed material, which dispensed amount can fill at least twice a volume of the material bed; and (b) recycling the excess amount of the pre-transformed material at least in part by sieving the excess amount of the pre-transformed material, wherein the excess amount of the pre-transformed material comprises dispensed pre-transformed material that does not form the material bed and/or the at least one three-dimensional object. In some embodiments, the method comprises performance, or directing performance, of any operation associated with any system, any apparatus, and/or any device disclosed herein. In some embodiments, the recycling is at least in part during the printing. In some embodiments, the recycling is continuous during the printing. In some embodiments, the excess pre-transformed material comprises any soot or any spatter produced in the printing. In some embodiments, the recycling is to form a recycled pre-transformed material that is used during the printing of the three-dimensional object and/or during a subsequent printing. In some embodiments, the method further comprises providing the recycled pre-transformed material to a material reservoir, following the recycling in (b). In some embodiments, the method further comprises flowing the pre-transformed material to a dispenser from the material reservoir. In some embodiments, the flowing comprises a dense phase conveyance of the pre-transformed material. In some embodiments, the providing the recycled pre-transformed material is to at least two material reservoirs. In some embodiments, the method further comprises providing the recycled excess to the at least two material reservoirs alternatingly. In some embodiments, the printing the three-dimensional object comprises a printing cycle, which printing cycle comprises a layer-by-layer formation of the three-dimensional object. In some embodiments, a total amount of recycled excess pre-transformed material during the printing cycle is greater than a total material bed volume at the completion of the printing cycle. In some embodiments, the total amount of recycled excess pre-transformed material is at least 5 times the total material bed volume. In some embodiments, the recycling in (b) is following each layer of the layer-by-layer formation. In some embodiments, the recycling comprises sieving at a rate of at least 0.5 cubic centimeters of the excess amount of the pre-transformed material per minute, per square centimeter of a sieving area. In some embodiments, the pre-transformed material comprises a powder. In some embodiments, the dispensing in (a) is in a first enclosure at a first atmosphere, and the recycling in (b) is in a second enclosure at a second atmosphere, which first atmosphere and second atmosphere are different than an external atmosphere that comprises a reactive agent. In some embodiments, the reactive agent is reactive with respect to a reactant and/or to a product (e.g., byproduct) of the printing the three-dimensional object. In some embodiments, the first atmosphere and the second atmosphere are substantially the same. In some embodiments, the first atmosphere and the second atmosphere are different. In some embodiments, the method further comprises conveying the excess pre-transformed material from the first enclosure to the second enclosure in a dilute phase. In some embodiments, recycling and/or sieving is of at least 50 kilograms. In some embodiments, recycling system and/or sieving is of least 500 kilograms. In some embodiments, recycling and/or sieving is at a throughput of at least about six (6) cubic centimeters of material per hour (cc/hr). In some embodiments, recycling and/or sieving is of the excess pre-transformed material that has a fundamental length scale of at most 1000 micrometers. In some embodiments, recycling and/or sieving is of the excess pre-transformed material that has a fundamental length scale of at most 100 micrometers.

In another aspect, an apparatus for printing at least one three-dimensional object comprises: an enclosure configured to accommodate the three-dimensional object during printing; a compressed gas source configured to flow a gas in a direction; a material reservoir having at least one first wall that encloses a first volume configured to hold (i) a first atmosphere that has a gas content different from an ambient atmosphere and a first pressure, and (ii) a first material port disposed in the at least one first wall and configured to facilitate transport of a pre-transformed material therethrough, which material reservoir is operatively coupled (e.g., connected) to the enclosure and is configured to facilitate supply of the pre-transformed material to the enclosure to print the three-dimensional object; and a bulk reservoir configured to hold a second atmosphere having a pressure above the first pressure and a gas content different from an ambient atmosphere, which bulk reservoir comprises a second material port, a gas port, and at least one second wall that encloses a second volume configured to accommodate the pre-transformed material, which compressed gas source is operatively coupled to the bulk reservoir through the gas port to facilitate pressurized conveyance of the pre-transformed material from the bulk reservoir through the second material port to the first material port at least in part against the gravitational field. In some embodiments, the apparatus comprises a material conveyor channel configured to convey the pre-transformed material, e.g., comprising a remainder of the pre-transformed material from a three-dimensional printing process. In some embodiments, the material conveyor channel is operatively coupled to a sieving assembly comprising a sieve, e.g., as disclosed herein. In some embodiments, the sieve is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the material conveyor channel is operatively coupled to a device configured for directional powder displacement. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein. In some embodiments, the apparatus further comprises a vertically translatable platform configured to support the at least one three-dimensional object during the printing. In some embodiments, the platform is disposed in the enclosure. In some embodiments, the pressurized conveyance of the pre-transformed material comprises dense phase conveyance. In some embodiments, the bulk reservoir comprises a transportable container or a stationary reservoir, which stationary reservoir is configured to couple with at least one material reservoir through the second material port. In some embodiments, the first material port is coupled with a valve (e.g., pinch valve), which valve is operable to open to facilitate the pressurized conveyance of the pre-transformed material, and to close to prevent the pressurized conveyance. some embodiments, the material reservoir comprises one or more sensors, which one or more sensors are operable to detect a level, type, and/or volume of pre-transformed material within the material reservoir. In some embodiments, the material reservoir comprises one or more sensors. In some embodiments, the one or more sensors are operable to detect a reactive species within the reservoir (e.g., oxygen or humidity). In some embodiments, the valve is operable to open in response to a detection by the one or more sensors that the pre-transformed material is below a threshold level. In some embodiments, the first pressure is established by an operation of the valve. In some embodiments, the enclosure comprises a second material port configured to accept the pre-transformed material from the material reservoir during the printing without interruption to the printing of the at least one three-dimensional object, and/or without interruption of the pressurized conveyance. In some embodiments, without interruption to the printing comprises printing continuously for at least 8 hours. In some embodiments, without interruption to the printing comprises printing continuously for at least 15 days. In some embodiments, the printing comprises printing at a rate of at least 45 cubic centimeters per hour (cc/hr). In some embodiments, the apparatus further comprises a (e.g., vertically translatable) platform configured to support the at least one three-dimensional object during the printing. In some embodiments, the apparatus further comprises at least one valve operatively coupled with the gas port, which one valve is configured to open and close to facilitate and to prevent, respectively, ingress of the compressed gas. In some embodiments, the ambient atmosphere comprises a reactive agent that is reactive (e.g., during and/or after the printing) with a reactant and/or with a product of the printing. In some embodiments, the at least the one first wall and/or the at least the one second wall are hermetically sealed and/or comprise a sealant, wherein the first volume and/or the second volume are configured to hold a positive pressure with respect to an ambient pressure. In some embodiments, the apparatus further comprises a system frame enclosing a system frame volume, which system frame volume comprises the enclosure and the material reservoir. In some embodiments, the apparatus further comprises a recycling system coupled with an outlet port of the enclosure, which recycling system is configured to receive a mixture of an excess pre-transformed material and a debris from the printing through the outlet port, and to separate at least part of the debris from the excess pre-transformed material by cyclonic separation. In some embodiments, the recycling system is operatively coupled to a material remover to receive the mixture for filtration from the material remover and/or provide the filtered mixture to the material remover (e.g., before, after, and/or during the printing). In some embodiments, the material remover removes the mixture by (i) attracting a gas and the material into an internal volume of the remover and (ii) cyclonically separating the material from the gas in the remover. In some embodiments, the apparatus the apparatus further comprises a power connector coupled with the compressed gas source, which power connector comprises an outlet, an inlet, a wire, or any combination thereof.

In another aspect, an apparatus for printing at least one three-dimensional object comprises: one or more controllers that are operatively coupled to a compressed gas source, to a material reservoir, and to a bulk reservoir, which one or more controllers are individually or collectively configured to (i) direct the compressed gas source to flow a gas through a gas inlet port of the bulk reservoir to establish a first atmosphere that has a first gas content that is different from an ambient atmosphere and a first pressure, which first atmosphere is of an internal volume of the bulk reservoir; and (ii) facilitate pressurized transport of a pre-transformed material from the bulk reservoir to the material reservoir against a gravitational force, which material reservoir holds a second atmosphere that has a second gas content that is different from the ambient atmosphere and a second pressure lower than the first pressure, wherein pre-transformed material in the material reservoir is used for printing the three-dimensional object. In some embodiments, the one or more controllers are configured to operatively couple to any system and/or device disclosed herein. In some embodiments, the one or more controllers are configured to direct performance of any operation associated with any system, any other apparatus and/or any device disclosed herein. In some embodiments, the one or more controllers further direct vertically translating the platform that is configured to support the at least one three-dimensional object during the printing. In some embodiments, the one or more controllers are configured to direct facilitating addition of the pre-transformed material to the material reservoir through a material inlet port, which material inlet port is configured to accept pre-transformed material from a storage container during the printing. In some embodiments, the one or more controllers are configured to facilitate flowing the gas flow from the compressed gas source through a gas storage inlet of the storage container to establish a third atmosphere that has a third gas content that is different from the ambient atmosphere and a third pressure. In some embodiments, facilitate flowing comprises directing a compressed gas flow to flow the gas, or alerting an operator to initiate the flow of the gas. In some embodiments, the compressed gas flow is passive (e.g., a cylinder). In some embodiments, the compressed gas flow is active (e.g., a pump or blower). In some embodiments, the one or more controllers are operatively coupled with a sieve inlet port of a sieve assembly disposed between the bulk reservoir and the material reservoir, wherein the pressurized transport in (ii) comprises transport through the sieve inlet port for sieving at least part of the pre-transformed material. In some embodiments, the pressurized transport comprises a dense phase conveyance of the pre-transformed material. In some embodiments, the sieve assembly comprises an outlet opening configured to facilitate conveyance of sieved pre-transformed material to a respective storage inlet port of at least two storage containers. In some embodiments, the outlet opening and/or the respective storage inlet comprises a gate and/or a switch, wherein the one or more controllers are configured to control a position of the gate and/or the switch to direct the conveyance of sieved pre-transformed material to the at least two storage containers. In some embodiments, the one or more controllers are programmed to direct the conveyance of sieved pre-transformed material to the at least two storage containers alternatingly. In some embodiments, the one or more controllers are programmed to facilitate conveyance of pre-transformed material to the material reservoir from a storage container of the at least two storage containers that is not receiving pre-transformed material from the bulk reservoir and/or the sieve assembly. In some embodiments, the one or more controllers are programmed to alternate conveying from a first storage container of the at least two storage containers to a second storage of the at least two storage containers considering a level of the pre-transformed material in the first storage container, which level is detected by a sensor operatively coupled with the one or more controllers. In some embodiments, during the printing comprises without interruption of the printing, and/or without interruption of conveyance against the gravitational force of the pre-transformed material to the material reservoir. In some embodiments, without interruption comprises printing continuously for at least 8 hours. In some embodiments, without interruption comprises printing continuously for at least 15 days. In some embodiments, the printing comprises printing at a rate of at least 45 cubic centimeters per hour (cc/hr). In some embodiments, the pre-transformed material comprises an elemental metal, metal alloy, ceramic, an allotrope of elemental carbon, a polymer, or a resin. In some embodiments, the material reservoir is disposed within an enclosure in which the three-dimensional object is printing. In some embodiments, the one or more controllers are programmed to adjust the first atmosphere and/or the second atmosphere in response to a detection of one or more sensors, which one or more sensors are configured to detect at least one characteristic of the first atmosphere and/or the second atmosphere. In some embodiments, the at least one characteristic comprises (I) a pressure differential between the first atmosphere and the second atmosphere, and/or (II) an atmospheric level of a reactive agent. In some embodiments, the reactive agent is reactive (e.g., during and/or after the printing) with a reactant (e.g., pre-transformed material) and/or with a product (e.g., transformed and/or hardened material) of the printing. In some embodiments, the one or more controllers are configured to adjust the pressure differential between the first atmosphere and the second atmosphere such that the first pressure is higher than the second pressure. In some embodiments, to direct the compressed gas in (i) and to facilitate the pressurized transport in (ii) are performed by the same controller. In some embodiments, to direct the compressed gas in (i) and to facilitate the pressurized transport in (ii) are performed by different controllers.

In another aspect, a method of printing at least one three-dimensional object comprises: holding a first atmosphere in a first volume of a material reservoir which first atmosphere has a first gas content that is different from an ambient atmosphere, and a first pressure; flowing compressed gas into a bulk reservoir to establish a second atmosphere that has a second gas content that is different from the ambient atmosphere and a second pressure greater than the first pressure; and flowing a pre-transformed material from the bulk reservoir to the material reservoir, which pre-transformed material in the material reservoir is used for printing the three-dimensional object. In some embodiments, the method comprises performance, or directing performance, of any operation associated with any system, any apparatus, and/or any device disclosed herein. In some embodiments, the method further comprises (e.g., vertically) translating a platform supports the at least one three-dimensional object during the printing. In some embodiments, the flowing in (c) comprises dense phase conveyance of the pre-transformed material. In some embodiments, the method further comprises establishing the first pressure by flowing the compressed gas into the first volume. In some embodiments, the method further comprises establishing the first pressure in the first volume in response to the pre-transformed material being below a threshold level within the material reservoir. In some embodiments, the threshold level corresponds to an amount of material required to fill a material bed in which the at least one three-dimensional object is printing. In some embodiments, the method further comprises holding (e.g., maintaining) the bulk reservoir at the second pressure, such that the flowing in (c) commences upon the establishing of the first pressure in the first volume. In some embodiments, the second atmosphere comprises substantially the same gas as the first atmosphere. In some embodiments, the first atmosphere and/or the second atmosphere comprise an inert atmosphere. In some embodiments, the flowing in (c) comprises sieving the pre-transformed material between the bulk reservoir and the material reservoir. In some embodiments, the sieving is in a third atmosphere that has a third gas content that is different from the ambient atmosphere and at least by having a third pressure that is lower than the second pressure. In some embodiments, the method further comprises flowing the pre-transformed material from the bulk reservoir to at least two material reservoirs. In some embodiments, the method further comprises (d) conveying the pre-transformed material from the at least two material reservoirs to an enclosure within which the at least one three-dimensional object is printing. In some embodiments, flowing the pre-transformed material in (c) and/or conveyance of the pre-transformed material in (d) is against a gravitational field. In some embodiments, flowing the pre-transformed material in (c) is without interruption to the printing of the at least one three-dimensional object, and/or without interruption of conveyance of the pre-transformed material in (d). In some embodiments, without interruption to the printing comprises printing continuously for at least 8 hours. In some embodiments, without interruption to the printing comprises printing continuously for at least 15 days. In some embodiments, the printing comprises transforming the pre-transformed material to a transformed material at a rate of at least 45 cubic centimeters per hour (cc/hr). In some embodiments, conveyance of the pre-transformed material in (d) comprises switching from a first material reservoir to a second material reservoir. In some embodiments, flowing the pre-transformed material in (c) is to a material reservoir of the at least two material reservoirs that is not currently conveying the pre-transformed material in (d). In some embodiments, the conveying to the enclosure is continuous. In some embodiments, the conveying to the enclosure is discontinuous. In some embodiments, the ambient atmosphere comprises a reactive agent that is reactive (e.g., before and/or after the printing) with a reactant and/or with a product of the printing.

In another aspect, an apparatus (e.g., device) for printing at least one three-dimensional object comprises: a filtering enclosure (e.g., sieve assembly) comprising: (i) at least one wall enclosing a volume configured to accommodate an atmosphere, (ii) an inlet port disposed in the at least one wall, which inlet port is configured to facilitate ingress of a material into the volume, wherein the material comprises (1) a remainder of the printing of the three-dimensional object, or (2) a debris produced during the printing of the three-dimensional object, and (iii) a collection volume in the volume that facilitates collection of a filtered material and/or an exit port disposed in the at least one wall, which exit port is configured to facilitate egress of the filtered material from the volume; and a supportive structure configured to accommodate a filtration member having a filter (e.g., comprising a sieve) and a frame that is configured to support the filter, which filtration member is (a) disposed in the volume at an angle with respect to a normal to the gravitational field vector and (b) divides the volume into an upper portion and a lower portion, which upper portion is partially defined by a fraction of the at least one wall that includes the inlet port, and which lower portion is partially defined by a fraction of the at least one wall that includes the exit port and/or the collection volume. In some embodiments, the filter (e.g., sieve) is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the filtering enclosure is operatively coupled to a device configured for directional powder displacement. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein. In some embodiments, the apparatus further comprises a processing chamber configured to accommodate printing of the three-dimensional object. In some embodiments, the apparatus further comprises a vertically translatable platform configured to support the three-dimensional object during its printing. In some embodiments, the platform is disposed in the processing chamber. In some embodiments, the filtering enclosure is operatively coupled to a material remover to receive the material for filtration from the material remover. In some embodiments, the material remover removes the material by (i) attracting a gas and the material into an internal volume of the remover and (ii) cyclonically separating the material from the gas in the remover. In some embodiments, the supportive structure comprises a protrusion, depression, ledge, or a railing. In some embodiments, the supportive structure is configured to support the filtration member (e.g., cartridge) upon filtering at least 50 kilograms. In some embodiments, the supportive structure is configured to support the filtration member (e.g., cartridge) upon filtering at least 500 kilograms. In some embodiments, the supportive structure is configured to support the filtration member (e.g., cartridge) upon filtering at a throughput of at least about six (6) cubic centimeters of material per hour (cc/hr). In some embodiments, the supportive structure is configured to support the filtration member (e.g., cartridge) upon filtering a material having a fundamental length scale of at most 1000 micrometers. In some embodiments, the material comprises a pre-transformed material has a fundamental length scale of at most 1000 micrometers. In some embodiments, the debris comprises material having a fundamental length scale of above 50 micrometers. In some embodiments, the apparatus further comprises an enclosure configured to accommodate the three-dimensional object during the printing. In some embodiments, the apparatus further comprises a movable platform configured to support the three-dimensional object during its printing in the enclosure. In some embodiments, the apparatus further comprises an energy beam configured to transform a pre-transformed material to a transformed material to print the three-dimensional object. In some embodiments, the pre-transformed material comprises a particulate material. In some embodiments, the material comprises a small material and a large material. In some embodiments, the small material comprises a pre-transformed material, wherein the large material comprises a byproduct of printing the three-dimensional object by transforming the pre-transformed material to a transformed material. In some embodiments, the byproduct of the printing comprises spatter. In some embodiments, the at least one wall comprises a secondary exit opening disposed adjacent to the filtration member to accommodate egress of material therethrough (e.g., adjacent and/or at the top surface of the filtration member). In some embodiments, the filtration member is configured to filter the small material from the large material, wherein the angle facilitates simultaneous (1) filtration of any small material, and (2) eviction of any large material through the secondary exit opening. In some embodiments, the small material comprises particles having a maximal fundamental length scale (FLS), which maximal FLS is at most about 50 microns, and wherein the large material comprises particles having a larger FLS than the maximal FLS. In some embodiments, the angle is such that facilitates the simultaneous filtration and eviction. In some embodiments, the angle is from about 1 degree to about 8 degrees. In some embodiments, the filtering enclosure further comprises a leveling member to controllably dispose the filtration member at the angle. In some embodiments, the leveling member comprises a gas- or liquid-filled bladder, a pin, an actuator, a jack, a lever, or a screw. In some embodiments, the actuator comprises an (e.g., magnetic) encoder, or a (e.g., servo) motor. In some embodiments, the supportive structure, frame and/or the at least one wall comprises an isolation element operable for mechanical and/or thermal isolation of the frame from the at least one wall. In some embodiments, the isolation element comprises a gasket, a bumper, a spring, a sponge, a bellow, a cloth, a cork, or a membrane. In some embodiments, the frame comprises one or more skeleton structures (e.g., support structures, or scaffold structures) disposed to support the filter. In some embodiments, the one or more skeleton structures are configured to support a filter of the filtration member below the inlet port when the filtration member is engaged with the supportive structure in the volume, wherein below is with respect to the gravitational field vector, such that the ingress of the material is at least partially directed towards the one or more skeleton structures. In some embodiments, the inlet is disposed laterally adjacent to a first side of the supportive structure that places the filtration member that is angled at a more distant position from the gravitational center as compared to a second side of the filtration member that is angled. In some embodiments, the one or more skeleton structure(s) and/or supportive structure comprise a material that is durable with respect to filtering metallic particles. In some embodiments, the skeleton structure is configured to support a filter upon filtering at least 50 kilograms. In some embodiments, the skeleton structure is configured to support a filter upon filtering at least 500 kilograms. In some embodiments, the skeleton structure is configured to support a filter upon filtering at a throughput of at least about six (6) cubic centimeters of material per hour (cc/hr). In some embodiments, the skeleton structure is configured to support a filter upon filtering a material having a fundamental length scale of at most 1000 micrometers. In some embodiments, the one or more skeleton structures are operatively coupled (e.g., affixed) to the frame of the filtration member and/or to a filter operatively coupled (e.g., connected) to the filtration member. In some embodiments, the one or more skeleton structures are disposed to span at least a portion of a long and/or a short axis of the filtration member. In some embodiments, the apparatus further comprises at least one agitator having a controllably movable member, which movable member is coupled with the frame of the filtration member and is operable for moving the filtration member to facilitate filtration of the material thereby. In some embodiments, the at least one agitator comprises an ultrasonic transducer. In some embodiments, moving the filtration member comprises a vibration of the filtration member and/or a back and forth movement of the filtration member. In some embodiments, at least one wall comprises an outlet configured to facilitate travel of a filtered material therethrough, which outlet is disposed laterally adjacent to a second side of the supportive structure that places the filtration member that is angled at a more adjacent position to the gravitational center as compared to a first side of the filtration member that is angled.

In another aspect, an apparatus for printing at least one three-dimensional object comprises: one or more controllers that are operatively coupled to a filtration member and to an inlet port of a filtering enclosure, which one or more controllers are collectively or individually programmed to facilitate ingress of a material to the filtering enclosure through the inlet port to impinge upon the filtration member that is tilted at an angle with respect to a normal to the gravitational field vector, which filtration member is disposed in a volume of the filtering enclosure, the material comprising (1) a remainder of the printing of the three-dimensional object, or (2) a debris produced during the printing of the three-dimensional object. In some embodiments, the one or more controllers are configured to operatively couple to any system and/or device disclosed herein. In some embodiments, the one or more controllers are configured to direct performance of any operation associated with any system, any other apparatus and/or any device disclosed herein. In some embodiments, the one or more controllers are operatively coupled to a platform. In some embodiments, the platform is configured to support the at least one three-dimensional object during the printing, In some embodiments, the one or more controllers are further programmed to direct the platform to translate vertically during the printing of the at least one three-dimensional object. In some embodiments, the apparatus further comprises a sensor and wherein the sensor detects a characteristic of an atmosphere of the volume of the filtering enclosure, which characteristic of the atmosphere includes a temperature and/or a reactive agent, wherein the reactive agent comprises oxygen or humidity. In some embodiments, the apparatus further comprises a sensor. In some embodiments, the sensor detects a characteristic of the flow comprises a flow rate of (I) the remainder, (II) the first portion of the remainder and/or (III) the second portion of the remainder. In some embodiments, the sensor detects a characteristic of an accumulation of (I) the first portion of the remainder and/or (II) the second portion of the remainder. In some embodiments, the angle is configured to facilitate simultaneous separation between (i) a first portion of the remainder that flows through the filtration member from one exposed surface of the filtration member to an opposing exposed surface of the filtration member, and (ii) a second portion of the remainder that slides on the one exposed surface of the filtration member to (a) an outlet port of the filtering enclosure and/or (b) a collection volume. In some embodiments, the filtering enclosure further comprises a leveling member, wherein the one or more controllers are operatively coupled with the leveling member to controllably adjust the angle of the filtration member. In some embodiments, the first portion of the remainder comprises a pre-transformed material that is used as a starting material to form the three-dimensional object by transforming the pre-transformed material to a transformed material. In some embodiments, the second portion of the remainder comprises a material having a fundamental length scale that is larger than a fundamental length scale of the pre-transformed material, which material is a by-product of the printing. In some embodiments, the second material is spatter. In some embodiments, the apparatus further comprises a sensor. In some embodiments, the sensor detects a characteristic of the flow comprises a flow rate of (I) the remainder, (II) the first portion of the remainder and/or (III) the second portion of the remainder. In some embodiments, the sensor detects a characteristic of an accumulation of (I) the first portion of the remainder and/or (II) the second portion of the remainder. In some embodiments, the one or more controllers is configured to alter a function of at least one mechanism of the printing, by considering a signal detected by the sensor. In some embodiments, the at least one mechanism comprises an energy source, an optical element, a dispenser, a leveler, a remover, a gas source, or an actuator coupled to a platform. In some embodiments, the one or more controllers comprise a closed loop control scheme, which comprises a feedback or a feed-forward control scheme. In some embodiments, the controller is operatively coupled to a consolidation agent of the pre-transformed material that transforms the pre-transformed material into a transformed material to form the three-dimensional object. In some embodiments, the consolidation agent comprises an energy beam or a binding agent. In some embodiments, the controller controls one or more characteristics of the consolidation agent. In some embodiments, the one or more characteristics of the consolidation agent comprise translational speed, consolidation spot size, or consolidation rate. In some embodiments, the consolidation agent comprises an energy beam, wherein the one or more characteristics of the consolidation agent comprise translational speed, dwell time, intermission time, fundamental length scale of a cross-section, power density, or wavelength. In some embodiments, the controller is configured to control (e.g., the power of) an energy source configured to generate the energy beam. In some embodiments, the control is in real time during the printing. In some embodiments, the controller considers a signal detector by a sensor that is operatively coupled to the filter. In some embodiments, to controllably adjust the angle is from about 1 degree to about 8 degrees. In some embodiments, the one or more controllers are configured to controllably adjust the angle before, after, and/or during the printing the at least one three-dimensional object. In some embodiments, the leveling member comprises a gas- or liquid-filled bladder. In some embodiments, the one or more controllers are programmed to facilitate. filling at least a portion of the bladder with the gas or liquid to position the filtration member at the angle. In some embodiments, the one or more controllers are programmed to adjust the angle in response to a detection of one or more sensors, which one or more sensors are configured to detect at least one characteristic of the filtering. In some embodiments, the at least one characteristic comprises a flow rate and/or a level of (I) the first portion of the remainder and/or (II) the second portion of the remainder. In some embodiments, the filtration member is operatively coupled with a movable member of an agitator, wherein the one or more controllers are coupled with agitator and are programmed to facilitate the filtering by modulating the movable member. In some embodiments, the agitator comprises a transducer, which transducer comprises a transducer sensor operable to detect a power supply requirement of the transducer to achieve a setpoint movement (e.g., amplitude) of the movable member. In some embodiments, the one or more controllers are programmed to adjust the angle considering a detection of the transducer sensor. In some embodiments, at least two of (A) the ingress of the material, (B) modulating the movable member, and (C) adjust the angle are facilitated by the same controller. In some embodiments, at least two of (A) the ingress of the material, (B) modulating the movable member, and (C) adjust the angle are facilitated by different controllers. In some embodiments, the volume comprises an atmosphere that is different from an external atmosphere, which external atmosphere comprises a reactive agent. In some embodiments, the reactive agent is reactive with the pre-transformed material and/or a product of the printing. In some embodiments, the material comprises a pre-transformed material, which pre-transformed material is transformed to a transformed material by an energy beam during the printing. In some embodiments, the pre-transformed material comprises an elemental metal, metal alloy, ceramic, an allotrope of elemental carbon, a polymer, or a resin

In another aspect, a method of printing at least one three-dimensional object comprises: (a) flowing a material to a volume of a filtering enclosure comprising an atmosphere, wherein the material comprises (1) a remainder of a pre-transformed material used to print the three-dimensional object, or (2) a debris produced during the printing of the three-dimensional object; and (b) filtering the remainder through a filtration member disposed in the volume, which filtration member is disposed at an angle with respect to a normal to the environmental (e.g., Earth's) gravitational field vector. In some embodiments, the method comprises performance, or directing performance, of any operation associated with any system, any apparatus, and/or any device disclosed herein. In some embodiments, the method further comprises vertically translating a platform that supports the at least one three-dimensional object during the printing. In some embodiments, the angle facilitates simultaneous separation between (i) a first portion of the remainder that flows through the filtration member from one exposed surface of the filtration member to an opposing exposed surface of the filtration member, and (ii) a second portion of the remainder that slides on the one exposed surface of the filtration member to (a) an outlet port of the filtering enclosure and/or (b) a collection volume. In some embodiments, angle is adjustable. In some embodiments, adjustable is before, after, and/or during the printing the at least one three-dimensional object. In some embodiments, the method further comprises adjusting the angle in response to detecting a rate of the filtering of the remainder. In some embodiments, the method further comprises providing a filtered portion of the remainder to a material reservoir. In some embodiments, the method further comprises adjusting the angle in response to detecting a rate and/or a level of filtered material (e.g., in the material reservoir). In some embodiments, the method further comprises altering at least one mechanism of the printing in response to detecting a rate and/or a level of filtered material. In some embodiments, the level of the filtered material comprises the level of the first portion (e.g., collected at a first reservoir) and/or the level of the second portion (e.g., collected at a second reservoir). In some embodiments, the method further comprises alternatingly providing the filtered portion to at least two material reservoirs. In some embodiments, at least one of the at least two material reservoirs is providing at least a part of the filtered portion to a processing chamber for printing the at least one three-dimensional object. In some embodiments, the method further comprises providing the second portion of the remainder to a removal container. In some embodiments, the method further comprises adjusting the angle in response to detecting a rate and/or a level of removed material in the removal container. In some embodiments, the method further comprises isolating the filtration member from a remainder of the filtering enclosure. In some embodiments, the isolating comprises mechanically isolating or thermally isolating. In some embodiments, the method further comprises moving the filtration member within the volume to facilitate the filtering. In some embodiments, the moving comprises vibration. In some embodiments, the moving comprises a horizontal and/or vertical movement. In some embodiments, the moving comprises a cyclical movement. In some embodiments, the filtering comprises de-blinding a filter mesh of the filtration member. In some embodiments, the method further comprises filtering at a rate of at least about 0.5 cubic centimeters of material per minute, per square centimeter of filtration member filtering area. In some embodiments, the method further comprises filtering at a rate of at least about 50 kilograms of material. In some embodiments, the method further comprises separating at least some of the debris from the material prior to flowing the material to the volume in (a), wherein separating comprises cyclonic separation. In some embodiments, the material in (a) is from a processing chamber in which the at least one three-dimensional object is printing. In some embodiments, the debris is formed during transformation of the pre-transformed material (e.g., by an energy beam), during the printing. In some embodiments, filtering is during the printing. In some embodiments the filtering is during the printing and/or without (e.g., substantially) interrupting the printing.

In another aspect, a system for printing a three-dimensional object comprises: a filtering enclosure comprising: (i) at least one wall enclosing a volume that is configured to accommodate an internal atmosphere, wherein the internal atmosphere is different from an external atmosphere that comprises a reactive agent, (ii) an inlet port disposed in the at least one wall, which inlet port is configured to facilitate ingress of a material to the volume, which material comprises a remainder of a pre-transformed material used for printing the three-dimensional object, (iii) a cartridge opening disposed in the at least one wall, and (iv) a gas opening operatively coupled to the volume and configured to facilitate flow of gas there through; and a supportive structure configured to accommodate a cartridge comprising a filter (e.g., comprising a sieve) and a frame configured to support the filter, which cartridge is configured to: allow entry through the cartridge opening, allow exit through the cartridge opening, and fit in the volume; and one or more controllers operatively coupled to the inlet port, wherein the one or more controllers are individually or collectively configured to direct: (A) upon disposal of the cartridge in the volume and establishment of the internal atmosphere in the volume, facilitate flow of the remainder of the pre-transformed material from a processing chamber through the inlet port into the volume; and (B) upon exit of the cartridge through the opening (i) facilitate reducing a rate at which the reactive agent from the external atmosphere exits from the volume through the inlet port to the processing chamber, which reducing is at least during the printing to print the three-dimensional printing in a printing atmosphere, and (ii) facilitate flow of an internal atmosphere gas into the volume to purge the reactive agent of the external atmosphere from the volume. In some embodiments, the sieve is configured to vibrate using sonic vibrations, e.g., pulsed sonic vibrations such as ultrasonic vibrations. In some embodiments, the sonic vibrations are guided through strip(s) coupled to the sieve. In some embodiments, the sieve is supported by a frame. In some embodiments, the sonic vibrations are generated by a sonic generator that is distance from the sieve and/or from framing of the sieve. In some embodiments, the filtering enclosure (e.g., sieving assembly) is operatively coupled to a device configured for directional powder displacement. In some embodiments, the directional powder displacement device comprises: a planar body (e.g., carriage); springs coupled to the planar body; and an actuator configured to repeatedly alter a position of the planar body, e.g., using a pulsing sequence. The directional powder displacement device can be any of the ones disclosed herein. In some embodiments, the system further comprises a processing chamber configured to accommodate printing of the three-dimensional object. In some embodiments, the system further comprises a vertically translatable platform configured to support the three-dimensional object during its printing. In some embodiments, the platform is disposed in the processing chamber. In some embodiments, the one or more controllers are operatively coupled to the platform and are configured to direct the platform to translate vertically during the printing. In some embodiments, the filtering enclosure is operatively coupled to a material remover to receive the material for filtration from the material remover. In some embodiments, the material remover removes the material by (i) attracting a gas and the material into an internal volume of the remover and (ii) cyclonically separating the material from the gas in the remover. In some embodiments, the supportive structure comprises a protrusion, depression, ledge, or a railing. In some embodiments, the supportive structure is configured to support the cartridge upon filtering at least 50 kilograms. In some embodiments, the supportive structure is configured to support the cartridge upon filtering at least 500 kilograms. In some embodiments, the supportive structure is configured to support the cartridge upon filtering at a throughput of at least about six (6) cubic centimeters of material per hour (cc/hr). In some embodiments, the supportive structure is configured to support the cartridge upon filtering a material having a fundamental length scale of at most 1000 micrometers. In some embodiments, the pre-transformed material has a fundamental length scale of at most 1000 micrometers. In some embodiments, the debris comprises material having a fundamental length scale of above 50 micrometers. In some embodiments, the system further comprises an enclosure configured to accommodate the three-dimensional object during the printing. In some embodiments, the system further comprises a movable platform configured to support the three-dimensional object during its printing in the enclosure. In some embodiments, the system further comprises an energy beam configured to transform the pre-transformed material to a transformed material to print the three-dimensional object. In some embodiments, the pre-transformed material comprises a particulate material. In some embodiments, the remainder of the pre-transformed material comprises a debris that is generated during the printing of the three-dimensional object. In some embodiments, the system further comprises a secondary exit opening disposed in the at least one wall, wherein the filtering enclosure is configured to filter the pre-transformed material from a larger material and simultaneous eviction of any large material from the filtering enclosure through the secondary exit opening. In some embodiments, the larger material is a byproduct of the 3D printing. In some embodiments, (a) the inlet port comprises a first valve and/or (b) the gas opening comprise a second valve, wherein the one or more controllers are operatively coupled to the first valve and/or second valve. In some embodiments, the one or more controllers are configured to direct the first valve of the inlet port to open to facilitate the flow of the remainder of the pre-transformed material upon the disposal of the cartridge in (A). In some embodiments, the one or more controllers are configured to direct the second valve of the gas opening to open to facilitate establishing the internal atmosphere in the volume in (A). In some embodiments, the one or more controllers are configured to direct the first valve of the inlet port to close and/or the second valve of the gas opening to open, to facilitate reduction of the rate at which the reactive agent from the external atmosphere exits from the volume. In some embodiments, a gas flow is continuously provided to the inlet port and/or the gas opening, wherein the one or more controllers are configured to direct the first valve and/or second valve to open and close to allow and to prevent, respectively, the gas flow therethrough. In some embodiments, the system further comprises a gas source configured to supply gas via a source outlet coupled with the gas opening. In some embodiments, the gas is an active compressed gas source (e.g., a pump or a blower). In some embodiments, the gas is a passive compressed gas source (e.g., a compressed gas cylinder). In some embodiments, the one or more controllers are operatively coupled to the gas source and configured to direct the flow of gas therefrom. In some embodiments, the one or more controllers are configured to alternatively open or close the first valve to allow or to prevent the flow of gas therethrough. In some embodiments, a gas flow to the inlet port and the gas opening is the same, which gas flow comprises an inert atmosphere. In some embodiments, a gas flow to the inlet port and the gas opening are different, which gas flow comprises an inert atmosphere. In some embodiments, a gas flow to the inlet port is different than a second gas flow to the gas opening. In some embodiments, the reactive agent is reactive with the pre-transformed material and/or with a product of the printing. In some embodiments, the fit of the cartridge in the volume facilitates a filtering of the remainder of the pre-transformed material. In some embodiments, the fit of the cartridge in the volume facilitates a hermetic seal of the volume with respect to the external atmosphere. In some embodiments, the system further comprises a closure (e.g., face plate) that is configured to reversibly (e.g., hermetically) seal of the cartridge opening upon engagement. In some embodiments, the system further comprises at least one sensor disposed within the volume, the inlet port, and/or the gas opening, which at least one sensor is operable to detect a presence of the reactive agent and/or an operational condition of the filter. In some embodiments, the one or more controllers are configured to purge the reactive agent in (ii) considering a detection result from the at least one sensor. In some embodiments, the system further comprises a robotic arm operable to couple with the cartridge and to insert and remove the cartridge through the cartridge opening, wherein the one or more controllers are operatively coupled with the robotic arm, and are configured to direct the robotic arm to remove a first cartridge and/or to insert a second cartridge while: considering a detection result from the at least one sensor for operating the robotic arm, programmed to operate the robotic arm at predetermined time(s) (e.g., and manner(s)). In some embodiments, the inlet port is coupled to an outlet port of a recycling system, which recycling system comprises a cyclonic separator having an internal volume for cyclonically separating the remainder of the pre-transformed material from at least a part of a debris formed during the printing. In some embodiments, the system further comprises a faceplate operable to detachably couple with the filtering enclosure to seal the cartridge opening. In some embodiments, the faceplate is integrally formed with the frame of the cartridge.

In another aspect, a method of printing a three-dimensional object comprises at least while printing: (a) reducing a gas flow that flows from (1) an internal volume of a processing chamber in which the three-dimensional object is being printed to (2) an internal volume of a filtering enclosure; (b) removing a first filtering cartridge from the internal volume of the filtering enclosure to an external atmosphere comprising a reactive agent, which removing is through a cartridge opening, wherein a filtering cartridge is for filtering a remainder of a pre-transformed material used for printing the three-dimensional object; (c) inserting a second filtering cartridge from the external atmosphere through the cartridge opening to the internal volume of the filtering enclosure; and (d) purging the external atmosphere from the internal volume by flowing an internal atmosphere gas into the volume. In some embodiments, the method comprises performance, or directing performance, of any operation associated with any system, any apparatus, and/or any device disclosed herein. In some embodiments, the method further comprises vertically translating a platform for printing at least a portion of the three-dimensional object (e.g., in the processing chamber). In some embodiments, the method further comprises after (d) (e.g., and during the printing), increasing a gas flow that flows from (1) an internal volume of a processing chamber in which the three-dimensional object is being printed to (2) an internal volume of a filtering enclosure. In some embodiments, the removing the first filtering cartridge in (b), the inserting the second filtering cartridge in (c), and/or the purging the external atmosphere in (d) are during reduction of the gas flow in (a). In some embodiments, the method further comprises maintaining a printing atmosphere that is different from the external atmosphere in the internal volume of the processing chamber. In some embodiments, maintaining the printing atmosphere is during reduction of the gas flow in (a), removal of the first filtering cartridge in (b), insertion of the second filtering cartridge in (c), and/or purging of the external atmosphere in (d). In some embodiments, a same gas is used for maintaining the printing atmosphere and for purging the external atmosphere in (d). In some embodiments, a first gas used for maintaining the printing atmosphere is different than a second gas used for purging the external atmosphere in (d). In some embodiments, reducing the gas flow in (a) comprises closing a material inlet to the filtering enclosure, which material inlet is for receiving the remainder of the pre-transformed material. In some embodiments, the external atmosphere is an ambient atmosphere. In some embodiments, the reactive agent is reactive with a reactant and/or with a product of the printing (e.g., during the printing). In some embodiments, inserting the second filtering cartridge in (c) comprises hermetically sealing the filtering enclosure with respect to the external atmosphere. In some embodiments, removing the first filtering cartridge considers a (e.g., predetermined) duration over which the first filtering cartridge has been filtering the remainder of the pre-transformed material. In some embodiments, the method further comprises monitoring an operating condition of the first filtering cartridge, wherein (a)-(d) are performed considering the operating condition. In some embodiments, the operating condition comprises a filtering rate at which the first filtering cartridge is filtering the remainder of pre-transformed material. In some embodiments, the operating condition comprises any damage to the first filtering cartridge, which damage comprises a puncture, a tear, or a misalignment of the filtering cartridge. In some embodiments, the pre-transformed material comprises an elemental metal, metal alloy, ceramic, allotrope of elemental carbon, polymer, or a resin. In some embodiments, the method further comprises (e.g., prior to (a) and/or after (d)): simultaneously (i) separating the pre-transformed material from a larger byproduct of the 3D printing and (ii) evicting the larger byproduct from the filtering enclosure.

In another aspect, a device for powder sieving, the device comprises: a frame; a sieve coupled to the frame; and a strip (e.g., rod) configured to guide sonic (e.g., ultrasonic) waves therethrough to induce sonic (e.g., ultrasonic) vibrations to the sieve and/or to the powder dispensed on the sieve, which strip is coupled to the frame and/or the sieve. In some embodiments, the sieve is devoid of other supporting structure other than that of the frame. In some embodiments, the device comprises a housing in which the frame, the sieve, and the strip are disposed, and where the sieve coupled to the frame is reversibly retractable and insertable relative to the housing. In some embodiments, the strip comprises at least one portion, and where during operation of the strip, the at least one portion of the strip is (i) flexible and/or (ii) elastic. In some embodiments, the strip is configured to guide a pulsing sequence of the sonic waves, the pulsing sequence comprising one or more periods of high amplitude and one or more periods of low amplitudes, where the high amplitude and the low amplitude is in relation to each other. In some embodiments, the strip is configured to guide a pulsing sequence of sonic pulses separated by one or more delay periods, the sonic pulses comprising respective amplitudes and pulse duration periods. In some embodiments, the sonic waves comprise ultrasonic waves. In some embodiments, at least two of the sonic pulses comprise (e.g., substantially) a same amplitude. In some embodiments, at least two of the sonic pulses comprise different amplitudes. In some embodiments, at least two of the sonic pulses comprise (e.g., substantially) a same pulse duration period. In some embodiments, at least two of the sonic pulses comprise different pulse durations. In some embodiments, the delay periods between the sonic pulses comprise a delay amplitude. In some embodiments, the delay amplitude is (e.g., substantially) zero amplitude. In some embodiments, the delay amplitude is below a threshold to induce detectable vibrational motion in the sieve and/or the frame. In some embodiments, the respective amplitudes of the sonic pulses are sufficient to induce vibrational motion in the sieve. In some embodiments, a pulse delay period between at least two sonic pulses is at most about 50 milliseconds. In some embodiments, the strip comprises an acoustic waveguide (e.g., a sonic wave guide). In some embodiments, the strip comprises a mass, and where a force applied by the strip on the sieve at least in part due to the induced sonic vibration is less than a fatigue limit of a material of the sieve. In some embodiments, the sieve comprises openings each having a fundamental length scale of at most about 1.5 times, 1.2 times, 1.1 times, or 1.0 times a central tendency of a fundamental length scale of the powder dispensed on the sieve. In some embodiments, the device is configured to operate in an inert atmosphere and/or pressure above ambient pressure external to the device. In some embodiments, the ambient pressure is a pressure external to a three-dimensional printer housing in which the device is disposed. In some embodiments, the sieve, frame, and/or powder include material comprising elemental metal, metal alloy, an allotrope of elemental carbon, or a ceramic. In some embodiments, the device is configured to facilitate recycling of a remainder of powder utilized in printing a three-dimensional object, to be used for printing another three-dimensional object. In some embodiments, during operation of the device, the framing is tilted with respect to a horizon. In some embodiments, the device is operatively coupled to a sound generator. In some embodiments, the device is operatively coupled to a sound transducer. In some embodiments, the strip comprises a linear portion and/or a curved portion. In some embodiments, the curved portion comprises a flexible portion. In some embodiments, the device comprises a plurality of strips including the strip. In some embodiments, the sieve is a rectangular sieve, and where the powder is configured to be disposed on one side of the rectangular sieve. In some embodiments, the strip is disposed parallel to the one side, and along the sieve. In some embodiments, the device comprises strips including the strip, which strips are disposed parallel to the one side, and along the sieve. In some embodiments, the sonic vibrations are configured to facilitate sieving the powder while maintaining functionality of the sieve. In some embodiments, the device is operatively coupled to a powder conveyance system configured to convey the powder against an environmental gravitational force. In some embodiments, the device is operatively coupled to a layer dispensing mechanism comprising a cyclonic separator. In some embodiments, the device is operatively coupled, or included in, a three-dimensional printing system comprising a processing chamber having an ancillary chamber coupled to it, the ancillary chamber configured to house a layer dispensing mechanism. In some embodiments, the sonic vibrations are at a frequency of from about 10 KHz to about 80 KHz. In some embodiments, the device where the device further comprises a dispenser configured to deposit powder towards a target surface. In some embodiments, the device where the target surface comprises (i) an exposed surface of a material bed or (ii) a surface of a build platform. In some embodiments, the device where the material bed generated on the surface of the build platform comprises at least one fundamental length scale having a value of at least about 400 mm, 600 mm, 1000 mm, 1200 mm, 1500 mm, or 1750 mm. In some embodiments, the device where the material bed is generated on the surface of the build platform and supported by the build platform comprises a weight of at least about 1000 kg. In some embodiments, the device where the device is configured to facilitate deposition of the powder on the target surface at least in part by layerwise deposition. In some embodiments, the device further comprises, or is operatively coupled to, an elevation mechanism configured to vertically translate the build platform comprising an error in vertical positioning of the vertical translation at most about 10%, 5%, or 2% of the vertical translation of the build platform. In some embodiments, the device further comprises a remover configured to remove a second portion of the deposited powder from the target surface to generate a planar layer of powder as part of a material bed. In some embodiments, the remover is operatively coupled to an attractive force source sufficient to attract the powder from the target surface. In some embodiments, the attractive force comprises a magnetic, electric, electrostatic, or vacuum source. In some embodiments, the attractive force comprises a vacuum source. In some embodiments, the device is configured to operatively couple to a recycling system that (i) recycles at least a fraction of a portion of the powder removed by the remover and/or (ii) provides at least a portion of the powder utilized by the dispenser. In some embodiments, the portion removed by the remover is at least about 70%, 50% or 30% of the deposited powder. In some embodiments, the fraction recycled is at least about 70% or 90% of the portion removed by the remover. In some embodiments, the device where the device is configured to operate under a positive pressure atmosphere relative to an ambient atmosphere external to the device. In some embodiments, the device where the device is configured to operate under an atmosphere depleted of a reactive agent relative to its concentration in an ambient atmosphere external to the device, the reactive agent being configured to react with the powder at least during three-dimensional printing. In some embodiments, the device where the reactive agent comprises oxygen, water, or hydrogen sulfide. In some embodiments, the device where the device further comprises a seal. In some embodiments, the device where the seal is a gas tight seal. In some embodiments, the device where the seal is configured to facilitate retaining an internal atmosphere in the enclosure for a time period, the internal atmosphere being different from an ambient atmosphere external to the enclosure. In some embodiments, the device where the seal is configured to facilitate retaining for a time period (i) a positive pressure within the enclosure relative to an ambient atmosphere external to the enclosure and/or (ii) a reactive agent at a concentration lower than its concentration in an ambient atmosphere external to the enclosure, the reactive agent being configured to at least react with pre-transformed material of the three-dimensional printing during three-dimensional printing. In some embodiments, the device is operatively coupled to, or is part of, a three-dimensional printer configured to print one or more three-dimensional objects from the powder. In some embodiments, a portion of the printing of one or more three-dimensional objects comprises extruding. In some embodiments, extruding is by an extruder to facilitate printing the one or more three-dimensional objects. In some embodiments, the device is configured to comprise, or operatively coupled to, the extruder. In some embodiments, a portion of the printing of one or more three-dimensional objects comprises laminating. In some embodiments, laminating comprises depositing by a laminator configured to deposit layerwise laminated layers to facilitate printing the one or more three-dimensional objects. In some embodiments, the device is configured to comprise, or be operatively coupled to, the laminator. In some embodiments, a portion of the printing of one or more three-dimensional objects comprises arc welding. In some embodiments, arc welding is by an arc welder to print the one or more three-dimensional objects comprises: generating a powder stream and focusing an energy beam on the powder stream. In some embodiments, the device is configured to comprise, or operatively coupled to, the arc welder. In some embodiments, the device comprises, or is operatively coupled to, an energy source and/or a scanner configured to direct an energy beam to impinge on the material bed during the three-dimensional printing to transform the pre-transformed material to the transformed material that forms at least a portion of a three-dimensional object, and wherein the energy beam has a beam profile configured to be altered at least one time during the printing. In some embodiments, during the printing comprises during printing of a layer of transformed material as part of a 3D object. In some embodiments, alteration of the beam profile comprises alteration of a type of the beam profile. In some embodiments, the type of the beam profile comprises: a gaussian beam profile, a top hat beam profile, or a doughnut beam profile. In some embodiments, the type of the beam profile comprises: physical alteration or alteration via a computational scheme. In some embodiments, a portion of the printing of one or more three-dimensional objects comprises connecting the powder to facilitate printing the one or more three-dimensional objects. In some embodiments, at least a portion of the powder is disposed in a material bed during the three-dimensional printing. In some embodiments, a portion of the printing of one or more three-dimensional objects comprises a fusing process. In some embodiments, fusing comprises (i) sintering, (ii) melting, (iii) smelting, or (iv) any combination of (i)-(iii). In some embodiments, the powder comprises a super alloy. In some embodiments, the super alloy comprises Inconel, In718, Ti64, F357, Haynes282, GRCop-42, C22, CA6NM, or Hastelloy-X.

In another aspect, an apparatus for powder sieving, the apparatus comprising at least one controller configured to control, or direct control of, the device as in any of the devices above. For example, an apparatus for powder sieving, the apparatus comprising at least one controller configured to: direct guiding sonic waves through a strip to induce sonic vibrations to a sieve coupled to a frame and/or to a powder dispenser on the sieve, which strip is coupled to the frame and/or sieve. In some embodiments, the at least one controller is configured to (i) operatively couple to the strip, and (ii) direct the strip to guide sonic waves. In some embodiments, the at least one controller is configured to (I) operatively couple to and (II) direct: a three-dimensional printer, a sonic generator, and/or an sonic transducer. In some embodiments, the apparatus where the at least one controller comprises circuitry and/or power connectivity. In some embodiments, the apparatus where the at least one controller is part of, or is operatively coupled to, a hierarchical network of controllers. In some embodiments, the hierarchical network of controllers comprises three or more control hierarchical control levels. In some embodiments, the hierarchical network of controllers comprises a microcontroller. In some embodiments, the apparatus where the at least one controller is configured to control the powder sieving.

In another aspect, non-transitory computer readable program instructions for powder sieving, the non-transitory computer readable program instructions, when read by one or more processors, cause one or more processors to control, or direct control of, a device as in any of the devices of devices above. For example, a non-transitory computer readable program instructions for powder sieving, the non-transitory computer readable program instructions, when read by one or more processors, cause the one or more processors to execute operations comprising: directing guiding sonic waves through a strip to induce sonic vibrations to a sieve coupled to a frame and/or to a powder dispenser on the sieve, which strip is coupled to the frame and/or sieve. In some embodiments, the one or more processors are configured to operatively couple to a three-dimensional printer, a sonic generator, and/or a sonic transducer. In some embodiments, the program instructions are configured to respectively direct the three-dimensional printer, the sonic generator and/or the sonic transducer. In some embodiments, the non-transitory computer readable program instructions where the one or more processors are part of, or are operatively coupled to, a hierarchical network of processors. In some embodiments, the hierarchical network of processors comprises three or more hierarchical levels. In some embodiments, the hierarchical network of processors comprises a microprocessor. In some embodiments, the non-transitory computer readable program instructions where the one or more processors are configured to control the powder sieving.

In another aspect, a method for powder sieving, the method (i) employing a device as in any of the devices above and/or (ii) executing, or directing execution of, one or more operations of any of the devices. For example, a method for powder sieving, the method comprises: guiding sonic waves through a strip to induce sonic vibrations to a sieve coupled to a frame and/or to a powder dispenser on the sieve, which strip is coupled to the frame and/or to the sieve.

In another aspect, a device for directional powder displacement, the device comprises: a planar body; springs coupled to the planar body; and at least one actuator configured to repeatedly alter a position of the planar body in a first direction to cause powder disposed on the planar body to repeatedly displace in a second direction relative to the planar body, the at least one actuator operatively coupled to the planar body. In some embodiments, the at least one actuator is configured for tunability of at least one property comprising (I) force output, (II) frequency output, or (III) directional output. In some embodiments, the first direction is in three-dimensional space, and where the second direction is in the plane of the planar body. In some embodiments, the device is configured to translate powder along the bounceable plate, the powder being fed at a rate of at least 10 kilograms per minute. In some embodiments, the device is configured to displace the powder along the bounceable plate at a rate of at least 10 kilograms per minute. In some embodiments, the at least one actuator comprises a first actuator and a second actuator. In some embodiments, the first actuator and the second actuator are configured to repeatedly alter a position of the planar body in a controlled manner. In some embodiments, the controlled manner comprises a synchronized manner. In some embodiments, the first actuator and the second actuator are (i) of the same type, (ii) configured to rotate in a synchronized manner, (iii) configured to rotate at the same speed, (iv) configured to rotate opposing directions and/or phases, (v) configured to exert the same magnitude of forces, or (vi) any combination thereof. In some embodiments, at least a portion of the forces are combinable. In some embodiments, at least a portion of the forces cancel each other. In some embodiments, the first actuator and the second actuator are configured to operate in a synchronized matter to collectively exert linearly moving force towards and away from the planar body, at the first direction. In some embodiments, the first actuator and the second actuator are configured for rotary motion. In some embodiments, the first actuator is configured for rotary motion in a first rotary direction and the second actuator is configured to rotary motion in a second rotary direction opposing the first rotary direction. In some embodiments, a combined motion of the rotary motion of the first actuator and the rotary motion of the second actuator results in a linear motion. In some embodiments, the linear motion is incident on the planar body at the first direction with respect to a normal to the planar body. In some embodiments, the linear motion is incident to the planar body and causes the planar body to bounce in space comprising in the first direction. In some embodiments, the linear motion is incident to the planar body at the first direction at an angle with respect to a normal to the planar body, the angle being less than about 90 degrees, or at most about 70 degrees. In some embodiments, the first actuator and the second actuator are configured for tunability of at least one property comprising (I) force output or (II) frequency output. In some embodiments, altering the position of the planar body comprises perturbations by the first actuator and the second actuator, the perturbations comprising mechanical perturbations or acoustic perturbations. In some embodiments, the device further comprises, or is operatively coupled to, one or more flexible couplers configured to couple the device to a three-dimensional printing system. In some embodiments, the device is enclosed in, or is part of, an enclosure and where the flexible couplers are operatively coupled to the enclosure. In some embodiments, a flexible coupler of the flexible couplers is configured to couple a component of a three-dimensional printing system comprising (i) an ancillary chamber, (ii) a sieving assembly, (iii) a reservoir of the powder, (iv) a channel of a powder conveyance system, or (v) a channel of a gas conveyance system. In some embodiments, the flexible couplers are configured to damp vibrational motion of the device from one or more other components of the three-dimensional printing system, where damping of the vibrational motion is such that the three-dimensional printing system prints a three-dimensional object according to its requested tolerances. In some embodiments, the vibrational motion comprises (I) acoustic vibrational motion or (II) mechanical vibrational motion. In some embodiments, the device is enclosed in, or is part of, an enclosure comprising an internal atmosphere different from an ambient atmosphere external to the device. In some embodiments, the internal atmosphere comprises a pressure above ambient pressure external to the device. In some embodiments, the device is configured to retain the internal atmosphere during operation of the device. In some embodiments, the device is configured to operate under the internal atmosphere that is depleted of a reactive agent relative to its concentration in an ambient atmosphere external to the device, the reactive agent being configured to react with the powder at least during three-dimensional printing. In some embodiments, the reactive agent comprises oxygen, water, or hydrogen sulfide. In some embodiments, the device further comprises a seal. In some embodiments, the device where the seal is a gas tight seal. In some embodiments, the device where the seal is configured to facilitate retaining an internal atmosphere in an enclosure for a time period, the internal atmosphere being different from an ambient atmosphere external to the enclosure. In some embodiments, the device where the seal is configured to facilitate retaining for a time period (i) a positive pressure within the enclosure relative to an ambient atmosphere external to the enclosure and/or (ii) a reactive agent at a concentration lower than its concentration in an ambient atmosphere external to the enclosure, the reactive agent being configured to at least react with the powder during three-dimensional printing. In some embodiments, the enclosure is configured to enclose (i) the planar body, (ii) the springs, (iii) the at least one actuator, or (iv) any combination of (i) (ii) and (iii). In some embodiments, the enclosure is configured to include the planar body as part of a body of the enclosure. In some embodiments, components of the device are external to the enclosure, the components comprising (i) the springs or (ii) the at least one actuator. In some embodiments, the planar body constitutes a floor of the enclosure. In some embodiments, the planar body has a planar surface disposed internally to the enclosure and a fortified surface disposed externally to the enclosure. In some embodiments, the fortified surface comprises a reinforced skeleton. In some embodiments, the planar body is generated by three-dimensional printing and/or by machining. In some embodiments, the fortified surface comprises a repeating lattice. In some embodiments, the at least one actuator is configured to repeatedly alter a position of the planar body in the first direction in the same manner, or substantially in the same manner, with even time repetitions. In some embodiments, the at least one actuator comprises an electric, a pneumatic, or a magnetic, actuator. In some embodiments, the device is configured to even a distribution of the powder as it propagates along the planar body due to repeated actuations by the at least one actuator along the first directions. In some embodiments, the device is configured to function as a shaker configured to shake and homogenize the powder as it propagates along the planar body due to repeated actuations by the at least one actuator. In some embodiments, the at least one actuator causes the powder to eject from the planar body as a result of an actuation, which powder subsequently falls back onto the planar body while being gravitationally attracted to a gravitational center of the environment in which the device is disposed. In some embodiments, the device is operatively coupled to a powder conveyance system configured to convey the powder against a gravitational force of the environment in which the device is disposed. In some embodiments, the device is operatively coupled to a layer dispensing mechanism comprising a cyclonic separator. In some embodiments, the device is operatively coupled to a sieving assembly comprising a housing enclosing a sieve coupled to a frame, and where the coupled sieve and frame are reversibly retractable and insertable relative to the housing. In some embodiments, the device comprises an isolator configured to isolate at least a portion of the actuator from the powder. In some embodiments, the isolator comprises a flexible material. In some embodiments, the flexible material comprises silicone rubber or nitrile rubber. In some embodiments, the planar body is configured to receive powder from one or more sources on one or more locations of the planar body, which powder is configured to spread unevenly on the planar body upon receipt by the planar body. In some embodiments, the device is configured to even the distribution of powder on the planar body as the powder is being displaced on the planar body towards an edge of the planar body and away from the one or more locations. In some embodiments, the device is configured to apply a pulsing sequence to the planar body to even the distribution of powder on the planar body. In some embodiments, the device is configured to guide the pulsing sequence that comprises one or more periods of high amplitude and one or more periods of low amplitudes, where the high amplitude and the low amplitude is in relation to each other. In some embodiments, the low amplitude comprises zero amplitude. In some embodiments, the periods of the low amplitude are each equal in time, or substantially equal in time, to each of the periods of the high amplitude. In some embodiments, the device is configured to guide the pulsing sequence of pulses separated by one or more delay periods, the pulses comprising respective amplitudes and pulse duration periods. In some embodiments, the pulses comprise mechanical pulses or sonic waves. In some embodiments, the sonic waves comprise ultrasonic waves. In some embodiments, the mechanical pulses are activated using a force comprising a magnetic force, an electric force, or a pneumatic force. In some embodiments, at least two of the pulses comprise (e.g., substantially) a same amplitude. In some embodiments, at least two of the pulses comprise different amplitudes. In some embodiments, at least two of the pulses comprise (e.g., substantially) a same pulse duration period. In some embodiments, at least two of the pulses comprise different pulse durations. In some embodiments, the delay periods between the pulses comprise a delay amplitude. In some embodiments, the delay amplitude is zero amplitude. In some embodiments, the delay amplitude is below a threshold to induce detectable vibrational motion in the planar body. In some embodiments, respective amplitudes of the pulses are sufficient to induce vibrational motion in the planar body. In some embodiments, a pulse delay period between at least two pulses is at most about 50 milliseconds. In some embodiments, the planar body comprises (e.g., is) a rectangle, and where the edge is a side of the planar body. In some embodiments, the actuator is disposed at an angle with respect to a plane of the planar body. In some embodiments, the planar body has an aspect ratio different than a 1:1 aspect ratio of length to width. In some embodiments, the actuator is disposed such that it traverses the center of mass of the device. In some embodiments, the device further comprises angled powder receivers disposed at opposing sides of the planar body, which angled powder receivers are configured to mitigate spillage of the powder from sides of the planar body during power receipt and/or operation of the device. In some embodiments, the angled powder receivers comprise tilted planks. In some embodiments, the angled powder receivers occupy a portion of the planar body. In some embodiments, the angled powder receivers comprise planks disposed at an angle relative to the planar body. In some embodiments, the angle is an obtuse angle with respect to the planar body. In some embodiments, the device further comprises funnel walls disposed at opposing sides of the planar body, which funnel walls are configured to direct the walls towards an edge of the planar body. In some embodiments, the funnel walls comprise planks disposed at an angle relative to the planar body. In some embodiments, the angle is a perpendicular angle with respect to the planar body. In some embodiments, the funnel walls occupy a portion of the planar body. In some embodiments, the actuator is coupled to the planar body at least in part by a mount. In some embodiments, the device is operatively coupled to, or is part of, a three-dimensional printer configured to print one or more three-dimensional objects from the powder. In some embodiments, the device is configured to operate in an inert atmosphere and/or pressure above ambient pressure external to the device. In some embodiments, the ambient pressure is a pressure external to a three-dimensional printer housing in which the device is disposed. In some embodiments, the planar body, springs, and/or powder include material comprising elemental metal, metal alloy, an allotrope of elemental carbon, or a ceramic. In some embodiments, the planar body and springs are disposed in an enclosure. In some embodiments, the planar body is disposed in an enclosure, and the spring are disposed externally to the enclosure. In some embodiments, the planar body is included in a floor of the enclosure; and optionally wherein the planar body is configured to operate at an atmosphere different by at least one characteristic from ambient pressure external to the enclosure. In some embodiments, the at least one characteristic comprises (i) a positive pressure within the enclosure relative to an ambient atmosphere external to the enclosure or (ii) a reactive agent at a concentration lower than its concentration in an ambient atmosphere external to the enclosure, the reactive agent being configured to at least react with the powder during three-dimensional printing. In some embodiments, the device is configured to facilitate recycling of a remainder of powder utilized in printing a three-dimensional object, to be used for printing another three-dimensional object. In some embodiments, the device comprises, or is operatively coupled to, an energy source and/or a scanner configured to direct an energy beam to impinge on the material bed during the three-dimensional printing to transform the pre-transformed material to the transformed material that forms at least a portion of a three-dimensional object, and wherein the energy beam has a beam profile configured to be altered at least one time during the printing. In some embodiments, during the printing comprises during printing of a layer of transformed material as part of a 3D object. In some embodiments, alteration of the beam profile comprises alteration of a type of the beam profile. In some embodiments, the type of the beam profile comprises: a gaussian beam profile, a top hat beam profile, or a doughnut beam profile. In some embodiments, the type of the beam profile comprises: physical alteration or alteration via a computational scheme. In some embodiments, the device where the device further comprises, or is operatively coupled to, a dispenser configured to deposit powder towards a target surface. In some embodiments, the device where the target surface comprises (i) an exposed surface of a material bed or (ii) a surface of a build platform. In some embodiments, the device where the material bed generated on the surface of the build platform comprises at least one fundamental length scale having a value of at least about 400 mm, 600 mm, 1000 mm, 1200, 1500, or 1750 mm. In some embodiments, the device where the material bed generated on the surface of the build platform and supported by the build platform comprises a weight of at least about 1000 kg. In some embodiments, the device where the device is configured to facilitate deposition of the powder on the target surface at least in part by layerwise deposition. In some embodiments, the device further comprises, or is operatively coupled to, an elevation mechanism configured to vertically translate the build platform comprising an error in vertical positioning of the vertical translation at most about 10%, 5%, or 2% of the vertical translation of the build platform. In some embodiments, the device further comprises a remover configured to remove a second portion of the deposited powder from the target surface to generate a planar layer of powder as part of a material bed. In some embodiments, the remover is operatively coupled to an attractive force source sufficient to attract the powder from the target surface. In some embodiments, the attractive force comprises a magnetic, electric, electrostatic, or vacuum source. In some embodiments, the attractive force comprises a vacuum source. In some embodiments, the device is configured to operatively couple to a recycling system that (i) recycles at least a fraction of a portion of the powder removed by the remover and/or (ii) provides at least a portion of the powder utilized by a dispenser. In some embodiments, the portion removed by the remover is at least about 70%, 50% or 30% of the deposited powder. In some embodiments, the fraction recycled is at least about 70% or 90% of the portion removed by the remover. In some embodiments, the device where the device is configured to operate under a positive pressure atmosphere relative to an ambient atmosphere external to the device. In some embodiments, the device is operatively coupled to, or is part of, a three-dimensional printer configured to print one or more three-dimensional objects from the powder. In some embodiments, a portion of the printing of one or more three-dimensional objects comprises arc welding. In some embodiments, arc welding is by an arc welder to print the one or more three-dimensional objects comprises: generating a powder stream and focusing an energy beam on the powder stream. In some embodiments, the device is configured to comprise, or operatively coupled to, the arc welder. In some embodiments, a portion of the printing of one or more three-dimensional objects comprises connecting the powder to facilitate printing the one or more three-dimensional objects. In some embodiments, at least a portion of the powder is disposed in a material bed during the three-dimensional printing. In some embodiments, the portion of the printing of one or more three-dimensional objects comprises a fusing process. In some embodiments, fusing comprises (i) sintering, (ii) melting, (iii) smelting, or (iv) any combination of (i)-(iii). In some embodiments, the powder comprises a super alloy. In some embodiments, the super alloy comprises Inconel, In718, Ti64, F357, Haynes282, GRCop-42, C22, CA6NM, or Hastelloy-X.

In another aspect, an apparatus for directional powder displacement, the apparatus comprising at least one controller configured to control, or direct control of, the device of any of the above devices. For example, an apparatus for directional powder displacement, the apparatus comprising at least one controller configured to: (I) operatively couple to at least one actuator, and (II) direct the at least one actuator to cause repeated alteration of a position of a planar body in a first direction to cause powder disposed on the planar body to repeatedly displace in a second direction relative to the planar body, the at least one actuator operatively coupled to the planar body that is coupled to springs. In some embodiments, the at least one controller is configured to (i) operatively couple to the device, and (ii) to direct the device. In some embodiments, the at least one controller is configured to (I) operatively couple to and (II) direct a three-dimensional printer to which the device is operatively coupled to. In some embodiments, the apparatus where the at least one controller is part of, or is operatively coupled to, a hierarchical network of controllers. In some embodiments, the hierarchical network of controllers comprises three or more control hierarchical control levels. In some embodiments, the hierarchical network of controllers comprises a microcontroller. In some embodiments, the apparatus where the at least one controller is configured to control the directional powder displacement.

In another aspect, a non-transitory computer readable program instructions for directional powder displacement, the non-transitory computer readable program instructions, when read by one or more processors operatively coupled to the device, cause the one or more processors to control, or direct control of, the device in any of the devices above. For example, non-transitory computer readable program instructions for directional powder displacement, the non-transitory computer readable program instructions, when read by one or more processors operatively coupled to at least one actuator, cause the one or more processors to execute operations comprising: directing at least one actuator to cause repeated alteration of a position of a planar body in a first direction to cause powder disposed on the planar body to repeatedly displace in a second direction relative to the planar body, the at least one actuator operatively coupled to the planar body that is coupled to springs. In some embodiments, the one or more processors are configured to operatively couple to a three-dimensional printer. In some embodiments, the program instructions are configured to direct the three-dimensional printer to which the device is operatively coupled to. In some embodiments, the non-transitory computer readable program instructions where the one or more processors are part of, or are operatively coupled to, a hierarchical network of processors. In some embodiments, the hierarchical network of processors comprises three or more hierarchical levels. In some embodiments, the hierarchical network of processors comprises a microprocessor. In some embodiments, the non-transitory computer readable program instructions where the one or more processors are configured to control the directional powder displacement.

In another aspect, a method for directional powder displacement, the method (i) employing the device of any of the devices above and (ii) executing, or directing execution of, one or more operations associated with the device. For example, a method for directional powder displacement, the method comprises: using at least one actuator to cause repeated alteration of a position of a planar body in a first direction to cause powder disposed on the planar body to repeatedly displace in a second direction relative to the planar body, the at least one actuator operatively coupled to the planar body that is coupled to springs.

In another aspect, a method for directional powder displacement, the method comprises: repeatedly altering a position of a planar body with an actuator, which planar body is coupled to springs. In some embodiments, the method comprises performance, or directing performance, of any operation associated with any system, any apparatus, and/or any device disclosed herein.

Another aspect of the present disclosure provides a system for effectuating the methods, operations of an apparatus, and/or operations inscribed by a non-transitory computer readable program instructions (e.g., inscribed on a media/medium), disclosed herein.

In another aspect, a system for effectuating the methods, operations of an apparatus, operation of a device, and/or operations inscribed by a non-transitory computer readable program instructions (e.g., inscribed on a media/medium), disclosed herein.

In another aspect, device(s) (e.g., apparatus) for effectuating the methods, operations of an apparatus, and/or operations inscribed by a non-transitory computer readable program instructions (e.g., inscribed on a media/medium).

In another aspect, a system for effectuating the methods, operations of the device, operations of the apparatus, and/or operations inscribed by non-transitory computer readable program instructions (e.g., inscribed on a media/medium), disclosed herein.

In other aspects, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

Another aspect of the present disclosure provides methods, systems, apparatuses (e.g., controller(s)), and/or non-transitory computer-readable program instructions (e.g., software) that implement any operation associated with any of the devices disclosed herein. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled to the mechanism. In some embodiments, the controller(s) implements any of the methods and/or operations disclosed herein. In some embodiments, the at least one controller comprises, or be operatively coupled to, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled to the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations of the apparatus are directed by the same controller. In some embodiments, at least two of operations of the apparatus are directed by different controllers.

In some embodiments, at least operations (e.g., instructions) are carried out by the same processor and/or by the same sub-computer software product. In some embodiments, at least two of operations (e.g., instructions) are carried out by different processors and/or sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism. In some embodiments, the mechanism comprises an apparatus or an apparatus component.

In another aspect, a non-transitory computer-readable medium/media comprising machine-executable code that, upon execution by one or more computer processors, implements any of the methods and/or operations disclosed herein.

In another aspect, a non-transitory computer-readable medium/media comprising machine-executable code that, upon execution by one or more computer processors, effectuates directions of the controller(s) (e.g., as disclosed herein).

In another aspect, a computer system comprising one or more computer processors and a non-transitory computer-readable medium coupled thereto. In some embodiments, the non-transitory computer-readable medium comprises machine-executable code that, upon execution by the one or more computer processors, implements any of the methods disclosed herein and/or effectuates directions of the controller(s) disclosed herein.

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, non-transitory computer readable program instructions for three-dimensional printing, the non-transitory computer readable program instructions, when read by one or more processors operatively couped to the device, cause the one or more processors to direct executing one or more operations associated with at least one configuration of the device(s) disclosed herein.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.”, “FIGS.”, “FIG.”, and “FIGS.” herein), of which:

FIG. 1 schematically illustrates a vertical cross-sectional view of a three-dimensional (3D) printing system and its components;

FIG. 2 schematically illustrates a vertical cross-sectional view of a 3D printing system and its components;

FIG. 3 schematically illustrates components of a 3D printing systems;

FIG. 4 illustrates a path;

FIG. 5 illustrates various paths;

FIG. 6 schematically illustrates a computer control system that is programmed or otherwise configured to facilitate the formation of one or more 3D objects;

FIG. 7 schematically illustrates a processor and 3D printer architecture that facilitates the formation of one or more 3D objects;

FIG. 8A schematically illustrates a top view of a component of a 3D printing system, and FIG. 8B schematically illustrates a sectional view thereof;

FIG. 9A schematically illustrates a top view of a component of a 3D printing system, and FIG. 9B schematically illustrates a sectional view thereof;

FIGS. 10A-10D schematically illustrate variations of a component of a 3D printing system;

FIG. 11 schematically illustrates a control scheme of a 3D printing system;

FIGS. 12A-12D schematically illustrate operations in forming a 3D object;

FIG. 13 schematically illustrates a top view of a component of a 3D printing system;

FIGS. 14A-14C schematically illustrate variations of a component of a 3D printing system;

FIG. 15 schematically shows a portion of a 3D printing system;

FIG. 16 schematically shows components relating to a bounceable plate;

FIG. 17 schematically shows components relating to a bounceable plate;

FIG. 18 schematically shows components relating to a bounceable plate;

FIG. 19 schematically shows components relating to a bounceable plate;

FIG. 20 schematically shows various sieves and associated components;

FIG. 21 schematically shows a graph of amplitude as a function of time;

FIG. 22 schematically shows an example sieve and associated components;

FIG. 23 schematically shows a partial view of an example sieve assembly;

FIG. 24 schematically shows various partial views of example sieve assemblies;

FIG. 25 schematically shows a portion of a three-dimensional printing system and components in perspective view;

FIG. 26 schematically shows a portion of a three-dimensional printing system in perspective view;

FIG. 27 schematically shows components of a three-dimensional printing system in perspective views;

FIG. 28 schematically shows components of a three-dimensional printing system and an associated force diagram;

FIG. 29 schematically shows components of a three-dimensional printing system and associated forces;

FIG. 30 schematically shows components of a three-dimensional printing system and associated forces; and

FIG. 31 schematically shows various components of three-dimensional printing systems.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity but include the general class of which a specific example may be used for illustration. The terminology herein is used to describe specific embodiments in the present disclosure, but their usage does not delimit to the specific embodiments of the present disclosure.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in X and/or Y (including in the specification and claims) is meant to include (i) X, (ii) Y, and (iii) X and Y. The conjunction of “and/or” in the phrase “including X, Y, and/or Z” is meant to include any combination and plurality thereof. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

A central tendency as understood herein comprises mean, median, or mode. The mean may comprise a geometric mean.

“Real time” as understood herein may be during at least part of the printing of a 3D object. Real time may be during a print operation. Real time may be during a print cycle. Real time may comprise: during formation of (i) a 3D object, (ii) a layer of hardened material as part of the 3D object, (iii) a hatch line, or (iv) a melt pool.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter. For example, when a recoater reversibly translates in a first direction, that recoater can also translate in a second direction opposite to the first direction. For example, when a controller directs reversibly translating a recoater in a first direction, that recoater can translate in the first direction and can also translate in a second direction opposite to the first direction, e.g., when the controller directs the recoater to translate in the second direction.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, may comprise the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

The present disclosure provides three-dimensional (3D) printing apparatuses, systems, software, and methods for forming a 3D object. For example, a 3D object may be formed by sequential addition of material or joining of starting material (e.g., pre-transformed material or source material) to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid phase.

The 3D printing process may comprise printing one or more layers of hardened material in a building cycle, e.g., in a printing cycle. A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single material bed). The one or more 3D object(s) may or may not be physically anchored to the platform (e.g., a build platform) above which it/they are printed.

Pre-transformed material (also referred to herein as “starting material”), as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

In some embodiments, in a 3D printing process, the deposited pre-transformed material may be fused (e.g., sintered or melted), bound, or otherwise connected to form at least a portion of the requested 3D object. Fusing, binding, or otherwise connecting the material is collectively referred to herein as “transforming” the material. Fusing the material may refer to melting, smelting, or sintering a pre-transformed material.

In some embodiments, melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object but may be utilized to generate one or more 3D objects simultaneously (e.g., in parallel) or separately (e.g., sequentially). The plurality of 3D objects may be formed in one or more material beds (e.g., powder bed). In some embodiments, a plurality of 3D objects is formed in one material bed.

In some examples, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), arc welding (e.g., powder based arc welding), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In an aspect provided herein is a system for generating a 3D object comprising: an enclosure for accommodating at least one planar layer of pre-transformed material (e.g., powder); at least one energy (e.g., energy beam) capable of transforming the pre-transformed material to form a transformed material; and at least one controller (e.g., as part of a control system) that directs the energy beam(s) to impinge on the exposed surface of the layer of pre-transformed material and translate along a path (e.g., as described herein). The transformed material may be capable of hardening to form at least a portion of a 3D object. The system may comprise at least one energy source generating the energy beam(s), at least one optical system, a layer dispensing mechanism such as a recoater, gas source(s), pump(s), nozzle(s), valve(s), sensor(s), display(s), chamber(s), processor(s) comprising or software inscribed on a computer readable media/medium. The control system may be configured to control attributes including temperature, pressure, gas flow, optics, actuator(s), energy source(s), energy beam(s), and/or atmosphere(s). The chamber may comprise a base (e.g., build platform) and a substrate. The substrate may comprise a piston. The system for generating at least one 3D object (e.g., in a printing cycle) and its components may be any 3D printing system. Examples of 3D printers, their components, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the deposited pre-transformed material within the enclosure is a liquid material, semi-solid material (e.g., gel), or a solid material (e.g., powder). The deposited pre-transformed material within the enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, amorphous carbon, carbon fiber, carbon nanotube, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or a plurality of materials (e.g., a plurality of material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than member of a type of material.

In some examples, the material bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The material bed may comprise a particulate material (e.g., powder). In some examples the material (e.g., powder, and/or 3D printer component) may comprise a material characterized in having high electrical conductivity (e.g., at least about 1*10⁵ Siemens per meter (S/m)), low electrical resistivity (e.g., at most about 1*10⁻⁵ ohm times meter (Q*m)), high thermal conductivity (e.g., at least about 10 Watts per meter times Kelvin (W/mK)), or high density (e.g., at least about 1.5 grams per cubic centimeter (g/cm³)). The density can be measured at ambient temperature (e.g., at R.T., or 20° C.) and at ambient atmospheric pressure (e.g., at 1 atmosphere).

In some embodiments, the elemental metal is an alkali metal, an alkaline earth metal, a transition metal, a rare-earth element metal, a precious metal, or another elemental metal. The elemental metal may comprise Titanium, Copper, Platinum, Gold, Aluminum, or Silver.

In some embodiments, the metal alloy comprises iron-based alloy, nickel-based alloy, cobalt-based alloy, chrome-based alloy, cobalt chrome-based alloy, titanium-based alloy, magnesium-based alloy, or copper-based alloy. The alloy may comprise an oxidation or corrosion resistant alloy. The alloy may comprise a super alloy (e.g., Inconel, In718, Ti64, F357, Haynes282, GRCop-42, C22, CA6NM, Hastelloy-X). The alloy may comprise an alloy used for aerospace applications, automotive application, surgical application, or implant applications. The metal may include a metal used for aerospace applications, automotive application, surgical application, or implant applications.

In some embodiments, the metal alloys are refractory alloys. The refractory metals and alloys may be used for heat coils, heat exchangers, furnace components, or welding electrodes. The refractory alloys may comprise a high melting points, low coefficient of expansion, mechanically strong, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy. Examples of materials, 3D printers, associated methods, software, systems, devices, materials (e.g., alloys), and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the material comprises powder material (also referred to herein as a “pulverous material”). The powder material may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The central tendency of the fundamental length scale (abbreviated herein as “FLS”) of the particles can be from about 5 micrometers (μm) to about 100 μm, from about 10 μm to about 70 μm, or from about 50 μm to about 100 μm. The particles can have central tendency of the FLS of at most about 75 μm, 65 μm, 50 μm, 30 μm, 25 μm or less. The particles can have a central tendency of the FLS of at least 10 μm, 25 μm, 30 μm, 50 μm, 70 μm, or more. A central tendency of the distribution of an FLS of the particles (e.g., range of an FLS of the particles between largest particles and smallest particles) can be about at least about 5 μm, 10 μm, 20 μm, 30 μm, 40 μm, 53 μm, 60 μm, or 75 μm. The particles can have a central tendency of the FLS of at most about 65 μm. In some cases, the powder particles may have central tendency of the FLS between any of the afore-mentioned FLSs.

In some embodiments, the powder comprises a particle mixture, which particle comprises a shape. The powder can be composed of a homogenously shaped particle mixture such that all the particles have substantially the same shape and FLS magnitude within at most about 1%, 5%, 8%, 10%, 15%, 20%, 25%, 30%, 35%, or 40% distribution of FLS.

In some embodiments, during at least a portion of the 3D printing process, the atmospheres of the build module and processing chamber may be separate. The build plate and/or substrate may be separated from one or more walls (e.g., side walls) of the build module by a seal. The seal may be permeable to at least one gas, and impermeable to the pre-transformed (e.g., and to the transformed) material. The seal may not allow a solid material (e.g., a pre-transformed material and/or a transformed material) to pass through.

At times, a plurality of build modules may be situated in an enclosure comprising the processing chamber. At times, the build module may be connected to, or may comprise an autonomous guided vehicle (AGV). The AGV may have at least one of the following: a movement mechanism (e.g., wheels), positional (e.g., optical) sensor, and controller. The controller may enable self-docking (e.g., to a docking station) and/or self-driving of the AGV. The self-docking and/or self-driving may be to and from the processing chamber. The build module may reversibly engage with (e.g., couple to) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent.

In some embodiments, the pre-transformed material (e.g., starting material for the 3D printing) is deposited in an enclosure, e.g., a build module. The build module container can contain the pre-transformed material (e.g., without spillage). Material may be placed in or inserted to the container. The material may be deposited in, pushed to, sucked into, or lifted to a container. The material may be layered (e.g., spread) in the enclosure such as by using a layer dispensing mechanism. The build module container may be configured to enclosure a substrate (e.g., an elevator piston). The substrate may be situated adjacent to the bottom of the build module container. Bottom may be relative to the gravitational field along gravitational vector pointing towards gravitational center, or relative to the position of the footprint of the energy beam on the layer of pre-transformed material as part of a material bed. The build module container may comprise a platform comprising a base (e.g., a build plate). The platform may comprise a substrate or a base. The base may reside adjacent to the substrate. For example, the base may (e.g., reversibly) connect to the substrate. The pre-transformed material may be layer-wise deposited adjacent to a side of the build module container, e.g., above and/or on the bottom of the build module container. The pre-transformed material may be layered adjacent to the substrate and/or adjacent to the base. Adjacent to may be above. Adjacent to may be directly above, or directly on. The substrate may have one or more seals that enclose the material in a selected area within the build module container. The one or more seals may be flexible or non-flexible. The one or more seals may comprise a polymer or a resin. The build module container may comprise the base. The base may be situated within the build module container. The build module container may comprise the platform, which may be situated within the build module container. The enclosure, processing chamber, and/or building module container may comprise (I) a window (e.g., an optical window and/or a viewing window) or (II) an optical system. The optical window may allow the energy beam to pass through without (e.g., substantial) energetic loss. During the 3D printing, a ventilator and/or gas flow may prevent debris (e.g., spatter) from accumulating on the surface of the optical window that is disposed within the enclosure (e.g., within the processing chamber). A portion of the enclosure that is occupied by the energy beam (e.g., during the 3D printing) can define a processing cone (e.g., a truncated processing cone). During the 3D printing may comprise during the entire 3D printing. The processing cone can be the space that is occupied by a non-reflected energy beam during the (e.g., entire) 3D printing. The processing cone can be the space that is occupied by an energy beam that is directed towards the material bed during the (e.g., entire) 3D printing. During the 3D printing may comprise during printing of a layer of hardened material.

In some embodiments, the 3D printer comprises a gas conveyance system, e.g., comprising the gas conveyance channels. The gas conveyance system may be in fluidic contact with one or more enclosures of the 3D printer. For example, the gas conveyance system may be in fluidic contact with (i) a processing chamber, (ii) a build module, (iii) an optical enclosure, or (iv) any combination thereof. The gas conveyance system may be in fluidic contact with a processing chamber and/or a build module. The gas conveyance system may be in fluid communication with the optical enclosure. At times, a gas flow assembly may be in fluid communication with the optical enclosure. The gas flow assembly may be configured to flow gas into and out of the optical enclosure. The gas flow assembly may be separate from the gas conveyance system. For example, the gas conveyance system and the gas flow assembly may be isolated (e.g., fluidically separate) from each other. The gas conveyance system may be configured to flow gas into and out of the processing chamber.

At times, the methods described herein are performed in the enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled pressure. The enclosure may have a predetermined and/or controlled atmosphere. The control may be manual or via a control system. The atmosphere may comprise at least one gas.

In some embodiments, the 3D printer comprises a layer dispensing mechanism. The pre-transformed material may be deposited in the enclosure by a layer dispensing mechanism (also referred to herein as a “layer dispenser,” “layer forming apparatus,” or “layer dispensing mechanism”). The layer dispensing mechanism may comprise a recoater. In some embodiments, the layer dispensing mechanism includes one or more material dispensers (also referred to herein as “dispensers” and “material dispensing mechanism”), and/or at least one powder removal mechanism (also referred to herein as material “remover” or “material remover”) to form a layer of pre-transformed material (e.g., starting material) within the enclosure. The deposited starting material may be leveled by a leveling operation. The leveling operation may comprise using a powder removal mechanism that does not contact the exposed surface of the material bed. The material (e.g., powder) dispensing mechanism may comprise one or more dispensers. The material dispensing mechanism may comprise at least one material (e.g., bulk) reservoir. The material may be deposited by a layer dispensing mechanism (e.g., recoater). The layer dispensing mechanism may level the dispensed material without contacting the material bed (e.g., the top surface of the powder bed). The layer dispensing mechanism and energy beam can translate and form the 3D object adjacent to the platform, while the platform gradually lowers its vertical position to facilitate layer-wise formation of the 3D object. The layer dispensing mechanism and energy beam can translate and form the 3D object within the material bed (e.g., as described herein), while the platform gradually lowers its vertical position to facilitate layer-wise formation of the 3D object. The layer dispensing mechanism can be used to form at least a portion of the material bed. The layer dispensing mechanism can dispense material, remove material, and/or shape the material bed, e.g., shape an exposed surface of a layer of material of the material bed. The material can comprise a pre-transformed material or a debris. Shaping the material bed may comprise altering a shape of the exposed surface of the material bed, e.g., planarizing the exposed surface of the material bed. The layer dispensing mechanism can be in a layer forming mode when dispensing the material and/or shaping the material bed. The layer dispensing mechanism can be in a parked mode when the layer dispensing mechanism is in an idle position such as a parked position. The material dispensing mechanism (e.g., the dispenser) can comprise a reservoir configured to retain a volume of pre-transformed material. The volume of pre-transformed material may be equivalent to about the volume of pre-transformed material sufficient for at least one or more dispensed layers above the platform. For example, the volume of pre-transformed material may be equivalent to about the volume of starting material sufficient for at least an integer number of dispensed layers above the platform. For example, the volume of pre-transformed material retained within the reservoir can be at least about 2 cubic centimeters (cc), 4 cc, 5 cc, 10 cc, 15 cc, 20 cc, 25 cc, 50 cc, 75 cc, 100 cc, 150 cc, 200 cc, 250 cc, 350 cc, 500 cc, 750 cc, 1000 cc, 1250 cc, 1500 cc, 2000 cc, or 2500 cc. The material dispensing mechanism can comprise a reservoir configured to retain a volume of pre-transformed material can be between any of the afore-mentioned amounts, for example, from about 2 cc to about 1200 cc, from about 2 cc to about 50 cc, from about 25 cc to about 1000 cc, or from about 20 cc to about 1500 cc. The material dispensing mechanism can dispense material at a dispensing rate (e.g., flow rate from the material dispensing mechanism) of at least 0.2 cubic centimeters per second (cm3/sec) or (cc/sec), 0.4 cm3/sec, 0.5 cm3/sec, 1 cm3/sec, or 2 cm3/sec, 2 cc/sec, 2.5 cc/sec, 3.5 cc/sec, 5 cc/sec, 10 cc/sec, 30 cc/sec, 50 cc/sec, 75 cc/sec, 90 cc/sec, 100 cc/sec, 110 cc/sec, 125 cc/sec, or 150 cc/sec. The dispensing rate can be between any of the afore-mentioned dispensing rates (e.g., from about 2 cc/sec to about 150 cc/sec, from about 2.5 cc/sec to about 100 cc/sec, from about 3.5 cc/sec to about 125 cc/sec, or from about 2.5 cc/sec to about 90 cc/sec). The layer dispensing mechanism may include components comprising a material dispensing mechanism, material leveling mechanism, material removal mechanism, or any combination or permutation thereof.

In some embodiments, the layer dispensing mechanism includes a leveler to planarize (e.g., smooth, such as substantially planarize) an exposed surface of a material bed within the enclosure. In some embodiments, the layer dispensing mechanism is devoid of a leveler to planarize (e.g., smooth, such as substantially planarize) an exposed surface of a material bed within the enclosure. The layer dispensing mechanism and energy beam can translate (e.g., in a coordinated manner) to print the 3D object adjacent to the build platform, e.g., while the build platform gradually lowers its vertical position to facilitate layer-wise formation of the 3D object. The layer dispensing mechanism and energy beam can translate to print the 3D object in the material bed (e.g., as described herein), e.g., while the build platform gradually lowers its vertical position to facilitate layer-wise formation of the 3D object and expansion of the material bed. from the material bed, and/or shape the material bed, e.g., shape an exposed surface of a layer of material of the material bed. The material can comprise a pre-transformed material or debris. Examples of 3D printing systems, apparatuses, devices, and components (e.g., material dispensing mechanisms and material removal mechanisms), controllers, software, and 3D printing processes can be found in Patent Application serial number PCT/US15/36802 filed on Jun. 19, 2015; in U.S. patent application Ser. No. 17/881,797, filed Aug. 5, 2022; or in International Patent Application serial number PCT/US16/66000 filed on Dec. 9, 2016; each of which is incorporated herein in its entirety.

In some embodiments, the layer dispensing mechanism may reside within an ancillary chamber. The layer dispenser may be physically secluded from the processing chamber when residing in the ancillary chamber. The ancillary chamber may be connected (e.g., reversibly) to the processing chamber. The ancillary chamber may be connected (e.g., reversibly) to the build module. The ancillary chamber may convey the layer dispensing mechanism adjacent to a platform (e.g., that is disposed within the build module). The layer dispensing mechanism may be retracted into the ancillary chamber (e.g., when the layer dispensing mechanism does not perform dispensing). Examples of 3D printing systems, apparatuses, devices, and components (e.g., material dispensing mechanisms and material removal mechanisms), controllers, software, and 3D printing processes can be found in Patent Application serial number PCT/US15/36802 filed on Jun. 19, 2015; in U.S. patent application Ser. No. 15/374,318 filed Dec. 9, 2016; in International Patent Application serial number PCT/US16/66000 filed on Dec. 9, 2016; or in Provisional Patent Application Ser. No. 63/357,901, filed on Jul. 1, 2022; each of which is incorporated herein in its entirety.

In some embodiments, the 3D object(s) are printed from a material bed. At least one FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m or 5 m. The at least one FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS of the material bed can be between any of the afore-mentioned values (e.g., from about 50 mm to about 5 m, from about 250 mm to about 500 mm, from about 280 mm to about 1 m, or from about 500 mm to about 5 m). In some embodiments, a FLS of the material bed is in the direction of the gas flow.

In some embodiments, the 3D printer has a capacity to complete at least 1, 2, 3, 4, or 5 printing cycles before requiring human intervention. Human intervention may be required for refilling the pre-transformed (e.g., powder) material, unloading the build modules, unpacking the 3D object, removing the debris byproduct of the 3D printing, or any combination thereof. The 3D printer operator may condition the 3D printer at any time during operation of the 3D printing system (e.g., during the 3D printing process). Conditioning of the 3D printer may comprise refilling the pre-transformed material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some examples, the 3D printing system requires operation of maximum an operator during a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some embodiments, the enclosure and/or processing chamber of the 3D printing system may be opened to the ambient environment sparingly. In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer. In some embodiments, the 3D printer has a capacity of 1, 2, 3, 4, or 5 full prints in terms of pre-transformed material (e.g., starting material such as powder) reservoir capacity. The 3D printer may have the capacity to print a plurality of 3D objects in parallel, e.g., in one material bed. For example, the 3D printer may be able to print at least 2, 3, 4, 5, 6, 7, 8, 9, or 10 3D objects in parallel.

In some embodiments, the printed 3D object is retrieved soon after terminating the last transformation operation of at least a portion of the material bed. Soon after terminating may be at most about 1 day, 12 hours, 6 hours, 3 hours, 2 hours, 1 hour, 30 minutes, 15 minutes, 5 minutes, 240 seconds (sec), 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after terminating may be between any of the afore-mentioned time values (e.g., from about 1 s to about 1 day, from about 1 s to about 1 hour, from about 30 minutes to about 1 day, or from about 20 s to about 240 s).

Ambient refers to a condition to which people are generally accustomed. For example, ambient pressure may be about 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. it may denote 20° C., 25° C., or any value from about 20° C. to about 25° C.

In some embodiments, a time lapse between the end of printing in a first material bed, and the beginning of printing in a second material bed is at most about 60 minutes (min), 40 min, 30 min, 20 min, 15 min, 10 min, or 5 min. The time lapse between the end of printing in a first material bed, and the beginning of printing in a second material bed may be between any of the afore-mentioned times (e.g., from about 60 min to about 5 min, from about 60 min to about 30 min, from about 30 min to about 5 min, from about 20 min to about 5 min, from about 20 min to about 10 min, or from about 15 min to about 5 min). The speed during which the 3D printing process proceeds is disclosed in Patent Application serial number PCT/US15/36802 that is incorporated herein in its entirety.

In some embodiments, at least one (e.g., each) energy source of the 3D printing system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr). At times, the 3D printing increases in efficiency when a plurality of energy beams is used for the 3D printing. For example, the time for 3D printing may be shortened when at least two of the plurality of energy beams operate simultaneously at least in part (e.g., in parallel). For example, the time for 3D printing may be shortened by at least about 25%, 50%, 75% or 95% when at least two of the plurality of energy beams operate simultaneously at least in part. The time for 3D printing may be shortened by any value of the afore-mentioned values (e.g., by from about 25% to about 95%, about 25% to about 50%, or about 50% to about 95%) when at least two of the plurality of energy beams operate simultaneously at least in part. A shortened time may be relative to a 3D printing system that does not use a plurality of energy beams (e.g., uses only a single energy beam). Examples of 3D printing systems, apparatuses, devices, components, controllers, software, and 3D printing processes (e.g., speed of printing, throughput of printing processes) can be found in International Patent Application Serial No. PCT/US15/36802, and in International Patent Application Serial No. PCT/US19/226364, filed on May 16, 2019, each of which is incorporated herein by reference in its entirety.

In some embodiments, the at least one 3D object is removed from the material bed after the completion of the 3D printing process. For example, the 3D object(s) may be removed from the material bed when the transformed material that formed the 3D object hardens. For example, the 3D object may be removed from the material bed when the transformed material that formed the 3D object is no longer susceptible to deformation under standard handling operation (e.g., human and/or machine handling).

At times, the generated 3D object requires very little or no further processing after its retrieval. Further processing may be post printing processing. Further processing may comprise trimming, annealing, curing, or polishing, e.g., as disclosed herein. Further processing may comprise polishing such as sanding. In some cases, the generated 3D object can be retrieved and finalized without removal of transformed material and/or auxiliary support features.

In some examples, the generated 3D object adheres (e.g., substantially) to a requested model of the 3D object. Substantially may be with relation to the intended purpose of the 3D object. The 3D object (e.g., solidified material) that is generated can be formed with high fidelity, e.g., having a high fidelity (e.g., high accuracy) of one or more characteristics (e.g., dimensions) of the generated 3D object when compared to a model or simulation of the intended 3D object. For example, have an average deviation percentage from intended dimensions that are at most about 5%, 2%, 1%, 0.5%, 0.25%, 0.1%, 0.05%, or less. For example, the 3D object that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula D_v+L/K_dv, wherein D_v is a deviation value, L is the length of the 3D object in a specific direction, and K_dv is a constant. D_v can have a value of at most about 300 μm, 200 μm, 100 μm, 50 μm, 40 μm, 30 μm, 20 μm, 10 μm, 5 μm, 1 μm, or 0.5 μm. D_v can have a value of at least about 0.5 μm, 1 μm, 3 μm, 5 μm, 10 μm, 20 μm, 30 μm, 50 μm, 70 μm, 100 μm, 300 μm or less. D_v can have any value between the afore-mentioned values. For example, D_v can have a value that is from about 0.5 μm to about 300 μm, from about 10 μm to about 50 μm, from about 15 μm to about 85 μm, from about 5 μm to about 45 μm, or from about 15 μm to about 35 μm. K_dv can have a value of at most about 3000, 2500, 2000, 1500, 1000, or 500. K_dvcan have a value of at least about 500, 1000, 1500, 2000, 2500, or 3000. K_dv can have any value between the afore-mentioned values. For example, K_dv can have a value that is from about 3000 to about 500, from about 1000 to about 2500, from about 500 to about 2000, from about 1000 to about 3000, or from about 1000 to about 2500.

At times, the generated 3D object (i.e., the printed 3D object) does not require further processing following its generation by a method described herein. The printed 3D object may require reduced amount of processing after its generation by a method described herein. For example, the printed 3D object may not require removal of auxiliary support (e.g., since the printed 3D object was generated as a 3D object devoid of auxiliary support). The printed 3D object may not require smoothing, flattening, polishing, or leveling. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. Examples of 3D printing systems, apparatuses, devices, and components, controllers, software, and 3D printing processes (e.g., post-processing, post-generation treatment, and post-printing treatment) can be found in U.S. patent application Ser. No. 17/835,023, filed on Jun. 8, 2022, and U.S. Provisional Patent Application Ser. No. 63/289,787, filed Dec. 15, 2021, each of which are entirely incorporated herein by reference.

At times, the methods described herein are performed in the enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled (e.g., maintained) pressure. The enclosure may have a predetermined and/or controlled atmosphere, e.g., during the 3D printing. The control may be manual or via a control system.

In some embodiments, the 3D printer comprises a chamber having an interior space. The chamber may be referred to herein as a “processing chamber.” The processing chamber may facilitate ingress of at least one energy beam into the processing chamber. The energy beam(s) may be directed towards a target surface, e.g., an exposed surface of a material bed. The 3D printer may comprise one or more modules, e.g., build modules. At times, at least one build module may be situated in the enclosure and coupled with the processing chamber. At times, at least one build module engages with the processing chamber to expand an interior volume of the processing chamber, e.g., to form at least a portion of the chamber.

In some embodiments, the 3D printing system comprises a build module. The build module may be mobile or stationary. The build module may comprise an elevation mechanism, e.g., comprising a build platform assembly. The build module may comprise a build platform (e.g., a base) that may be coupled to the build platform assembly. The build platform may be disposed within the build module. The build platform may reside adjacent to a substrate, e.g., above the substrate relative to a gravitational center of the environment (e.g., Earth). The elevation mechanism may be reversibly connected to (and disconnected from) at least a portion of the build platform. The elevation mechanism may comprise a portion that vertically translates the build platform with respect to a gravitational center (e.g., a gravitational center of the Earth). The build platform may be disposed on the substrate. The build platform and the substrate may operatively couple (e.g., physically connect). A material bed may be disposed above build platform. The build platform may support the material bed. The build platform may comprise, or be configured to operatively couple to, an engagement mechanism. The substrate may comprise, or be configured to operatively couple to, an engagement mechanism. The engagement mechanism may facilitate engagement and/or dis-engagement between a base (e.g., of the build platform) and the substrate. The build platform may be configured to support one or more layers of pre-transformed material (e.g., as part of the material bed). The build platform may be configured to support at least a portion of the 3D object (e.g., during forming of the 3D object). The substrate and/or the base (e.g., build platform) may be removable or non-removable (e.g., from the 3D printing system and/or relative to each other). The substrate and/or base may be fastened (I) to the build module and/or (II) to each other. The build platform and/or substrate may be translatable. The translation of the build platform may be controlled and/or regulated by at least one controller (e.g., by a control system). The translation of the substrate may be controlled and/or regulated by at least one controller (e.g., by a control system). The build platform and/or substrate may be translatable horizontally, vertically, or at an angle (e.g., planar or compound angle). The control system may be any control system disclosed herein, e.g., a control system of the 3D printer such as the one controlling an energy beam. The substrate may comprise a piston. At times, the 3D printing system may comprise more than one substrate. At times, the 3D printing system may comprise more than one piston. The disclosure herein relating to the substrate may apply to the substrates.

In some embodiments, the build module, processing chamber, and/or enclosure comprises one or more seals. The seal may be a sliding seal or a stationary (e.g., top) seal. For example, the build module and/or processing chamber may comprise a sliding seal that meets with the exterior of the build module upon engagement of the build module with the processing chamber. At least a portion of the 3D printing process, the atmospheres of the build module and processing chamber may be separate. For example, the processing chamber may comprise a top seal that faces the build module and is pushed upon engagement of the processing chamber with the build module. For example, the build module may comprise a top seal that faces the processing chamber and is pushed upon engagement of the processing chamber with the build module. The seal may be a face seal, or compression seal. The seal may comprise an O-ring. For example, the build module and the processing chamber may be separated by a load lock. The seal may be impermeable or substantially impermeable to gas. The seal may be permeable to gas. The seal may be impermeable to the pre-transformed (e.g., and to the transformed) material. The seal may be flexible. The seal may be elastic. The seal may be bendable. The seal may be compressible. The seal may include a material comprising rubber (e.g., latex), Teflon, plastic, or silicon. The seal may comprise a mesh, membrane, sieve, paper (e.g., filter paper), cloth such as felt (e.g., Aramid felt, or another high temperature felt or fiber), or a brush. The mesh, membrane, paper and/or cloth may comprise randomly or non-randomly arranged fibers. The paper may comprise a HEPA filter. The seal may be permeable to at least one gas. The seal may be impermeable to the pre-transformed (e.g., and to the transformed) material. The seal may not allow a pre-transformed (e.g., and to the transformed) material to pass through.

In some embodiments, the substrate is separated from the base (e.g., build platform) assembly by a seal. The base and/or the substrate may be separated from the internal surface of the build module by one or more seals. The seal may be attached to the moving build platform and/or substrate (e.g., while the walls of the build module are devoid of a seal). The seal may be attached to the (e.g., vertical) walls of the build module (e.g., while the build platform and/or substrate is devoid of a seal). In some embodiments, both the build platform and/or substrate and the walls of the build module comprise a seal. The seal may be placed laterally (e.g., horizontally) between one or more walls (e.g., side walls) of the build module. The seal may be connected to a bottom plane of the build platform and/or substrate. The seal may be connected to a side (e.g., circumference) of the build platform and/or substrate. The seal may be permeable to gas. The seal may be impermeable to particulate material (e.g., powder). The seal may not allow permeation of particulate material into the build platform assembly and/or piston assembly. The build platform assembly may comprise a piston and a build platform. The piston assembly may comprise a piston. The seal may be flexible. The seal may be elastic. The seal may be bendable. The seal may be compressible. The seal may include a material comprising a polymeric material (e.g., nylon, polyurethane), Teflon, plastic, rubber (e.g., latex), or silicon. The seal may comprise a mesh, membrane, sieve, paper (e.g., filter paper), cloth (e.g., felt, or wool), or brush. The mesh, membrane, paper and/or cloth may comprise randomly and/or non-randomly arranged fibers. The paper may comprise a HEPA filter.

In some embodiments, the build platform is translated, e.g., before, during, and/or after printing one or more 3D objects in a print cycle. The translation may be in both directions (e.g., back and forth such as up and down relative to a gravitational vector). The translation may be vertical. The translation may be effectuated by a build platform assembly and/or an actuator (e.g., controlled by a control system). The build platform assembly may be configured to provide a high precision platform for building one or more 3D objects in a printing cycle with high fidelity. The build module may accommodate a material bed having at least one (e.g., two or more) FLS (e.g., diameter, width, and/or height) of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 2500 mm, 3000 mm, 3500 mm, 4000 mm, or 4500 mm. The FLS of the material bed accommodated by the build module may have a FLS value between any of the aforementioned values (e.g., from about 100 mm to about 4500 mm, from about 100 mm to about 2000 mm, from about 100 mm to about 700 mm, or from about 300 mm to about 4000 mm). In addition to the material bed, the build module may be configured to accommodate a base (e.g., build platform) and at least one substrate (e.g., piston). The build module may accommodate a build platform having an FLS (e.g., diameter or width) of at least about 100 millimeters (mm), 200 mm, 300 mm, 400 mm, 500 mm, 600 mm, 700 mm, 800 mm, 900 mm, 1000 mm, 1500 mm, or 2000 mm, 2500 mm, 3000 mm, 3500 mm, or 4000 mm. The build module may accommodate a build platform having at least one FLS (e.g., diameter, height and/or width), the FLS being of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 4000 mm, or 4500 mm. The FLS of the build platform accommodated by the build module may have a FLS value between any of the aforementioned values (e.g., from about 100 mm to about 4500 mm, from about 100 mm to about 1200 mm, from about 100 mm to about 1500 mm, or from about 300 mm to about 2000 mm). The build platform assembly may be able to translate in a continuous and/or discrete manner. The build platform assembly may be able to translate in discrete increments of at most about 5 micrometers (μm), 20 μm, 30 μm, 40 μm, 50 μm, 60 μm, 70 μm, or 80 μm. The build platform assembly may be able to translate in discrete increments having a value between any of the aforementioned values (e.g., from about 5 μm to about 80 μm, from about 10 μm to about 60 μm, or from about 40 μm to about 80 μm). The build platform assembly may have a precision (e.g., error +/−) of at most about 0.25 μm, 0.5 μm, 1 μm, 1.5 μm, 2 μm, 2.5 μm, 3 μm, 4 μm, or 5 μm. The build platform assembly may have a precision value between any of the aforementioned precision value (e.g., from about 0.25 μm to about 5 μm, from about 0.25 μm to about 2.5 μm, or from about 1.5 μm to about 5 μm). The build platform assembly may have a precision (e.g., error +/−) of at most about 0.5%, 1%, 2%, 3%, 4%, 5%, 6%, 8% or 10% of its incremental movement. The build platform assembly may have a precision value between any of the aforementioned precision value relative to its incremental movement (e.g., from about 0.5% to about 10%, from about 0.5% to about 5%, or from about 1% to about 10%). The weight of the material bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the material bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The build platform assembly may be configured to translate the build module at a speed of at most 3 millimeters per second (mm/sec), 5 mm/sec, 10 mm/sec, 20 mm/sec, 30 mm/sec, or 50 mm/sec. The build platform assembly may be configured to translate the build module at a speed of at least 1 mm/sec, 3 mm/sec, 5 mm/sec, 10 mm/sec, 20 mm/sec, 30 mm/sec, or 40 mm/sec. The build platform assembly may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The build platform assembly may be configured to translate the build module at a speed of at most 1 millimeter per second squared (mm/sec\hat{ }2), 2.5 mm/sec\hat{ }2, 5 mm/sec\hat{ }2, 7.5 mm/sec\hat{ }2, 10 mm/sec\hat{ }2, or 20 mm/sec\hat{ }2. The build platform assembly may be configured to translate the build module at an acceleration of at least 0.5 mm/sec\hat{ }2, 1 mm/sec\hat{ }2, 2 mm/sec\hat{ }2, 3 mm/sec\hat{ }2, 5 mm/sec\hat{ }2, 10 mm/sec\hat{ }2, or 15 mm/sec\hat{ }2. The build platform assembly may be configured to translate the build module at a speed between any of the aforementioned speeds (e.g., from about 0.5 mm/sec\hat{ }2 to about 20 mm/sec\hat{ }2, from about 0.5 mm/sec\hat{ }2 to about 10 mm/sec\hat{ }2, or from about 4 mm/sec\hat{ }2 to about 20 mm/sec\hat{ }2). The build platform assembly may be configured such that a time to complete a translation of a first portion of the build platform assembly relative to a second portion of the build platform assembly (e.g., to perform a block movement) is at most about 120 seconds (sec), 60 sec, 50 sec, 45 sec, 40 sec, 35 sec, 30 sec, 25 sec, 20 sec, 15 sec, or less. The build platform assembly may be configured such that a time to complete a translation of a first portion of the build platform assembly relative to a second portion of the build platform assembly is any value between the aforementioned values, for example, from about 120 sec to 40 sec, from about 60 sec to 25 sec, or from about 35 sec to 15 sec.

In some embodiments, the pre-transformed material (e.g., starting material for the 3D printing) is deposited in an enclosure to form a material bed. The enclosure may comprise a build module. Material may be placed in or inserted (e.g., deposited) to the build module. The material may be deposited in, pushed to, sucked into, or lifted to the build module. The pre-transformed material may be deposited by a layer dispensing mechanism. The platform may be configured to support one or more layers of pre-transformed material (e.g., as part of the material bed). The platform may be configured to support at least a portion of the 3D object (e.g., during forming of the 3D object). The pre-transformed material may be layer-wise deposited adjacent to a side of the build module, e.g., above and/or on the bottom of the build module. The pre-transformed material may be layered on a target surface, e.g., on an exposed surface of a material or on a surface of the build platform. The deposited layer of pre-transformed material may be substantially planar. For example, the deposited layer may have a central tendency of planarity (e.g., a surface roughness R_a) that is from about 15% to about 65% of a second central tendency of thickness of the deposited layer. The second central tendency of thickness of the deposited layer may be about equal to a discrete increment of vertical translation of the platform. The second central tendency of thickness of the deposited layer may be about equal to any discrete increment of vertical translation of the build platform assembly, e.g., as disclosed herein.

In some embodiments, the 3D printer comprises an energy source that generates an energy beam. The energy beam may project energy to the material bed. The apparatuses, systems, and/or methods described herein can comprise at least one energy beam. In some cases, the 3D printing system can comprise at least two, three, four, five, eight, twelve, sixteen, twenty-four, thirty-two, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. in some embodiments, the energy source is an energy beam source. The energy source may be a laser source. The laser may comprise a fiber laser, a solid-state laser or a diode laser (e.g., diode pumped fiber laser).

In some embodiments, the energy source is a laser source. The laser source may comprise a Nd: YAG, Neodymium (e.g., neodymium-glass), or an Ytterbium laser. The laser beam may comprise a corona laser beam, e.g., a laser beam having a footprint similar to a doughnut shape. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro laser sintering. Examples of 3D printing systems, apparatuses, devices, and components (e.g., energy beams), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the beam profile of the energy beam can be altered. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process. In some embodiments, the energy beam (e.g., laser) has a power of at least about 150 Watt (W), 200 W, 250 W, 350 W, 500 W, 750 W, 1000 W, or 1500 W. The energy source may have a power between any of the afore-mentioned energy beam power values (e.g., from about from about 150 W to about 1000 W, or from about 1000 W to about 1500 W). The energy beam may derive from an electron gun.

In some embodiments, an energy beam is utilized for the 3D printing. The energy beam(s) can translate vertically, horizontally, or in an angle (e.g., planar or compound angle). The energy beam(s) can be modulated. The energy beam(s) emitted by the energy source(s) can be modulated.

In some embodiments, the energy beam is moveable with respect to a material bed and/or 3D printing system. The energy beam can be moveable such that it can translate relative to the material bed. The energy beam can be moved by an optical system (e.g., comprising a scanner). The movement of the energy beam can comprise utilization of a scanner. In some embodiments, the energy source is stationary. In some embodiments, the energy beam (e.g., laser beam) impinges onto an exposed surface of a material bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply. The optical system may be configured to direct at least one energy beam from the at least one energy source to a position on a target surface such as an exposed surface of a material bed within the enclosure, e.g., to a predetermined position on the target surface. The 3D printing system may comprise a processor (e.g., a central processing unit). The processor can be programmed to control a trajectory of the at least one energy beam and/or energy source with the aid of the optical system. The systems and/or the apparatus described herein can comprise a control system in communication with the at least one energy source and/or energy beam. The control system can regulate a supply of energy from the at least one energy source to the material in the container. The control system may control the various components of the optical system. The various components of the optical system may include optical components comprising a mirror(s), a lens (e.g., concave or convex), a fiber, a beam guide, a rotating polygon, or a prism.

In some embodiments, the 3D printer comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The power supply can comprise rechargeable batteries.

In some embodiments, the 3D printing system can comprise two, three, four, five, eight, ten, sixteen, eighteen, twenty, twenty-four, thirty-two, thirty-six, or more energy sources that each generates an energy beam (e.g., laser beam). An energy source can be a source configured to deliver energy to an area (e.g., a confined area). An energy source can deliver energy to the confined area through radiative heat transfer. The energy source may comprise a laser source or an electron beam source.

In some embodiments, the 3D printing system can comprise at least one (e.g., a plurality of) optical windows. The optical window(s) may be arranged on a roof of the processing chamber. The optical window(s) may be arranged on a side wall of the processing chamber. The optical window(s) may be arranged with respect to the processing chamber to allow transmittance of energy beam(s) directed by the array of optical assemblies into the processing chamber. The optical window(s) may be arranged with respect to the processing chamber to allow transmittance of energy beam(s) directed by the array of optical assemblies into the processing chamber and incident on the target surface supported by the build platform. During the 3D printing, a ventilator and/or gas flow may deter (e.g., measurably and/or substantially prevent) debris from accumulating on the surface optical window(s) that are disposed within the enclosure (e.g., within the processing chamber). The debris may comprise soot, spatter, or splatter. The optical window may be supported by (or supportive of) a nozzle that directs debris away from the optical window, e.g., at towards the material bed. The processing cone may assume a shape of a truncated cone withing the processing chamber.

In some embodiments, the 3D printing system comprises one or more sensors. The one or more sensors may be at least about 500, 600, 900, or 1000 sensors. At least two of the sensors may be of the same type. At least two of the sensors may be of different type. The 3D printing system includes at least one enclosure. In some embodiments, the 3D printing system (e.g., its enclosure) comprises one or more sensors (alternatively referred to herein as one or more sensors). The enclosure described herein may comprise at least one sensor. The enclosure may comprise, or be operatively coupled to, the build module, the filtering mechanism, gas recycling system, the processing chamber, or the ancillary chamber. The sensor may be connected and/or controlled by the control system (e.g., computer control system, or controller(s)). The control system may be able to receive signals from the at least one sensor. The control system, e.g., through a control scheme, may act upon at least one signal received from the at least one sensor. The control scheme may comprise a feedback and/or feed forward control scheme, e.g., that has been pre-programmed. The feedback and/or feed forward control may rely on input from at least one sensor that is connected to the controller(s).

In some embodiments, the 3D printing system comprises one or more sensors. The one or more sensors can comprise a pressure sensor, a temperature sensor, a gas flow sensor, or an optical density sensor. The pressure sensor may measure the pressure of the chamber (e.g., pressure of the chamber atmosphere). The pressure sensor can be coupled to the control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, depth, angle, and/or volume). The metrology sensor may comprise a magnetic, acceleration, orientation, or optical sensor. The optical sensor may comprise a camera. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may measure the temperature without contacting the material bed (e.g., non-contact measurements). The weight of the enclosure (e.g., container), or any components within the enclosure can be monitored by at least one weight sensor in or adjacent to the material. One or more position sensors (e.g., height sensors) can measure the height of the material bed relative to the substrate. The position sensors can be optical sensors. The position sensors can determine a distance between one or more energy sources and a surface of the material bed. The exposed surface of the material bed can be the upper surface of the material bed relative to a gravitational center of the environment. Examples of 3D printing systems, apparatuses, devices, material beds, and components (e.g., sensors), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the 3D printer comprises one or more valves. The methods, systems and/or the apparatus described herein may comprise at least one valve. The valve may be shut or opened according to an input from the at least one sensor, or manually. The degree of valve opening or shutting may be regulated by the control system, for example, according to at least one input from at least one sensor. The systems and/or the apparatus described herein can include one or more valves, such as throttle valves. The valve may or may not comprise a sensor sensing the open/shut position of the valve. The valve may be a component of a gas conveyance system (e.g., gas flow mechanism), e.g., operable to control a flow of gas of the gas conveyance system (e.g., gas flow mechanism). A valve may be a component of gas flow assembly, e.g., operable to control a flow of gas of the gas flow assembly.

In some embodiments, the 3D printer comprises one or more actuators such as motors. The motor may be controlled by the controller(s) (e.g., by the control system) and/or manually. The motor may alter (e.g., the position of) the substrate and/or to the base. The motor may alter (e.g., the position of) the build platform assembly. The actuator may facilitate translation (e.g., propagation) of the layer dispenser, e.g., the actuator may facilitate reversible translation of the layer dispenser. The motor may alter an opening of the enclosure (e.g., its opening or closure). The motor may be a step motor or a servomotor. The actuator (e.g., motor) may alter (e.g., a position of) one or more optical components, e.g., mirrors, lenses, prisms, and the like. The servomotors may comprise actuated linear lead screw drive motors. The motors may comprise belt drive motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

In some embodiments, the 3D printer (e.g., its components) comprises one or more nozzles. The systems and/or the apparatus described herein may comprise at least one nozzle. For example, the material remover may comprise a nozzle. The nozzle may be regulated according to at least one input from at least one sensor. The nozzle may be controlled automatically or manually. The controller(s) may control the nozzle. The controller(s) may any controller(s) disclosed herein, e.g., as part of the control system of the 3D printer. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., at towards the material bed. The nozzle may comprise a venturi nozzle.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump.

In some embodiments, the 3D printer comprises at least one filter. The filter may be a ventilation filter. The ventilation filter may capture fine powder from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas borne pre-transformed material, or gas borne transformed material. The debris may result from the 3D printing process. The ventilator may direct the debris in a requested direction (e.g., by using positive or negative gas pressure). For example, the ventilator may use vacuum. For example, the ventilator may use gas flow.

In some embodiments, the 3D printer comprises a communication technology. The communication may comprise wired or wireless communication. For example, the systems, apparatuses, and/or parts thereof may comprise Bluetooth, wi-fi, global positioning system (GPS), or radio-frequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (e.g., USB). The systems, apparatuses, and/or parts thereof may comprise USB ports. The USB can be micro or mini-USB. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

In some embodiments, the 3D printer comprises a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may be part of a control system comprising multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may utilize one or more wired and/or wireless networks for communication, e.g., with other controllers or devices, apparatuses, or systems of the 3D printing system and its components. For example, wired ethernet technologies, e.g., a local area networks (LAN). For example, wireless communication technologies, e.g., a wireless local area network (WLAN). The controller may utilize one or more control protocols for communication, for example, with other controller(s) or one or more devices, apparatuses, or systems of the 3D printing system or any of its components. Control protocols can comprise one or more protocols of an internet protocol suite, e.g., transmission control protocol (TCP) or transmission control protocol/internet protocol (TCP/IP). Control protocols can comprise one or more serial communication protocols. Control protocols can comprise one or more of controller area networks or another message-based protocol, e.g., for communication with microcontrollers and devices. Control protocols can interface with one or more serial bus interfaces for communication with the 3D printing system and its components. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of controller, control protocols, control systems, 3D printing systems, apparatuses, devices, and any of their components, and 3D printing processes can be found in International Patent Application Serial No. PCT/US17/18191, filed Feb. 16, 2017, titled “ACCURATE THREE-DIMENSIONAL PRINTING,” which is incorporated herein by reference in their entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, device, software and/or the apparatuses described herein comprise a control system. The control system can be in communication with one or more components of the 3D printing system. The control system can be in communication with one or more components facilitating the 3D printing methodologies. The control system can be in communication with one or more energy sources, optical systems, gas flow system, material flow systems, energy (e.g., energy beams), build platform assembly, and/or with any other component of the 3D printing system.

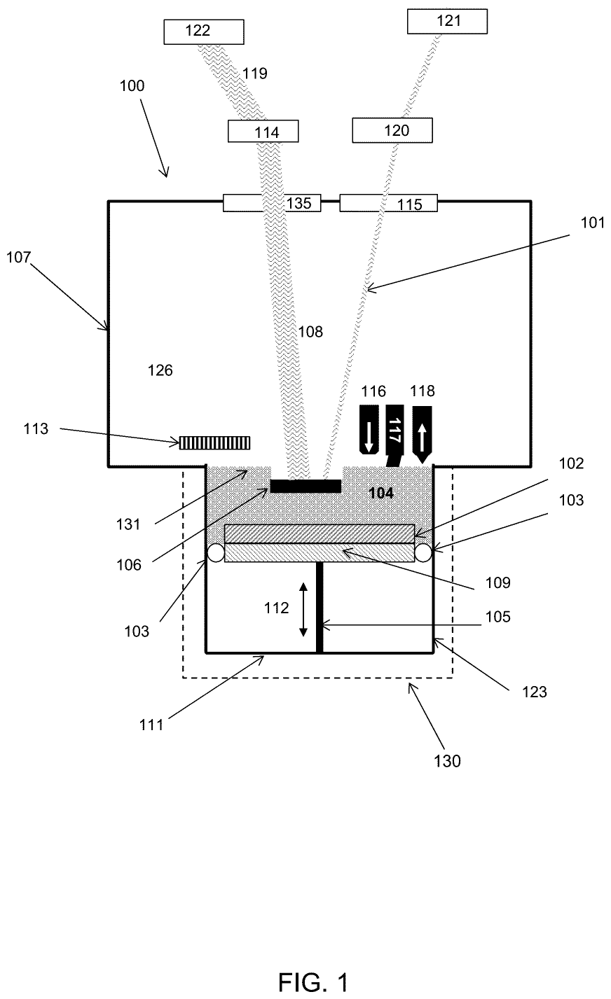

At times, the pre-transformed material is deposited in an enclosure (e.g., a container). FIG. 1 shows an example of a 3D printing system 100 and apparatuses, a (e.g., first) energy source 122 that emits a (e.g., first) energy beam 119. In the example of FIG. 1, the energy beam travels through an optical system 114 (e.g., comprising an aperture, lens, mirror, or deflector). A target surface may be a portion of a hardened material (e.g., 106) that was formed by transforming at least a portion of an exposed surface (e.g., 131) of a material bed (e.g., 104) by a (e.g., scanning) energy beam. In the example of FIG. 1 a (e.g., second) energy beam 101 is generated by a (e.g., second) energy source 121. The generated (e.g., second) energy beam may travel through an optical mechanism (e.g., 120) and/or an optical window (e.g., 115). FIG. 1 shows an example of a container 123. The container can contain the pre-transformed material (e.g., without spillage; FIG. 1, 104). The material may be placed in, or inserted to the container. The material may be deposited in, pushed to, sucked into, or lifted to the container. The material may be layered (e.g., spread) in the container. The container may comprise a substrate (e.g., FIG. 1, 109). The substrate may be situated adjacent to the bottom of the container (e.g., FIG. 1, 111). Bottom may be relative to the gravitational field, or relative to the position of the footprint of the energy beam (e.g., FIG. 1, 101, 108) on the layer of pre-transformed material as part of a material bed. The footprint of the energy beam may follow a Gaussian bell shape. In some embodiments, the footprint of the energy beam does not follow a Gaussian bell shape. The container may comprise a platform comprising a base (e.g., FIG. 1, 102). The platform may comprise a substrate. The base may reside adjacent to the substrate. The pre-transformed material may be layered adjacent to a side of the container (e.g., on the bottom of the container). The pre-transformed material may be layered adjacent to the substrate and/or adjacent to the base. Adjacent to may be above. Adjacent to may be directly above, or directly on. The substrate may have one or more seals that enclose the material in a selected area within the container (e.g., FIG. 1, 103). FIG. 1 shows an example of sealants 103 that hinders (e.g., prevent) the pre-transformed material from spilling from the material bed (e.g., 104) to the bottom 111 of an enclosure 107. The platform may translate (e.g., vertically, FIG. 1, 112) using a translating mechanism (e.g., an actuator, e.g., an elevator 105). The one or more seals may be flexible or non-flexible. The one or more seals may comprise a polymer or a resin. The one or more seals may comprise a round edge or a flat edge. The one or more seals may be bendable or non-bendable. The seals may be stiff. The container may comprise the base. The base may be situated within the container. The container may comprise the platform, which may be situated within the container. The enclosure, container, processing chamber, and/or building module may comprise an optical window. An energy beam may travel through an optical mechanism (e.g., 120). An example of an optical window can be seen in FIG. 1, 115, 135. The optical window may allow the energy beam (e.g., 101, 108) to pass through without (e.g., substantial) energetic loss. A ventilator may prevent spatter from accumulating on the surface optical window that is disposed within the enclosure (e.g., within the processing chamber) during the 3D printing. An opening of the ventilator may be situated within the enclosure 126.

At times, the pre-transformed material is deposited in the enclosure by a layer dispensing mechanism (e.g., FIGS. 1, 116, 117 and 118) to form a layer of pre-transformed material within the enclosure. The deposited material may be leveled by a leveling operation. The leveling operation may comprise using a material removal mechanism that does not contact the exposed surface of the material bed (e.g., FIG. 1, 118). The leveling operation may comprise using a leveling mechanism that contacts the exposed surface of the material bed (e.g., FIG. 1, 117). The material (e.g., powder) dispensing mechanism may comprise one or more dispensers (e.g., FIG. 1, 116). The material dispensing system may comprise at least one material (e.g., bulk) reservoir. The material may be deposited by a layer dispensing mechanism (e.g., recoater). The layer dispensing mechanism may level the dispensed material without contacting the material bed (e.g., the top surface of the powder bed). Examples of layer dispensing mechanism, 3D printers, related control system, related methods, apparatuses, systems, and program instructions (e.g., software), can be found in International Patent Application Serial No. PCT/US15/36802, or in U.S. patent application Ser. No. 15/435,065, both of which are entirely incorporated herein by references.

In some embodiments, the layer dispensing mechanism includes components comprising a material dispensing mechanism, material leveling mechanism, material removal mechanism, or any combination or permutation thereof. In some configurations, the material dispensing mechanism may comprise a material dispenser. The material dispenser may be operatively coupled to a mechanism that causes at least a portion of the pre-transformed material within the material dispenser to vibrate (also referred to herein as a “vibration mechanism”). Vibrate may comprise pulsate, throb, resonate, shiver, tremble, flutter or shake. Examples of vibration mechanisms, 3D printers, related control system, related methods, apparatuses, systems, and program instructions (e.g., software), can be found in International Patent Application Serial No. PCT/US17/57340, filed on Oct. 19, 2017, titled “OPERATION OF THREE-DIMENSIONAL PRINTER COMPONENTS,” which is entirely incorporated herein by reference.

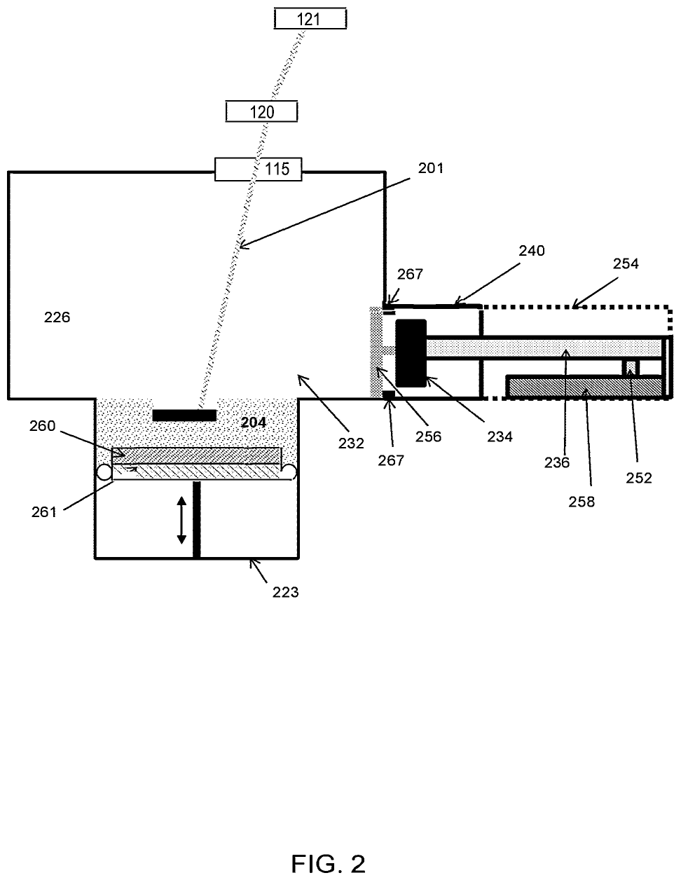

In some embodiments, the 3D printer comprises at least one ancillary chamber. The ancillary chamber may be an integral part of the processing chamber. At times, the ancillary chamber may be separate from the processing chamber. The ancillary chamber may be mounted to the processing chamber (e.g., before, after, or during the 3D printing). The mounting may be reversible mounting. The mounting may be controlled (e.g., manually or by a controller). The atmosphere of the ancillary and processing chamber may be (e.g., substantially) the same atmosphere. At times, the atmosphere of the ancillary chamber and the processing chamber may differ. The atmosphere of the ancillary chamber may be an inert atmosphere. The atmosphere in the ancillary chamber may be deficient by one or more reactive species (e.g., water and/or oxygen). The ancillary chamber may be a garage. The garage may be used to park one or more components of the 3D printer. The component may be a layer dispensing mechanism. The ancillary chamber (e.g., FIG. 2, 240) may be coupled to one of the side walls of the processing chamber (e.g., FIG. 2, 226). In some embodiments, the ancillary chamber may be incorporated in the processing chamber. The processing chamber may be similar to the one described herein. At times, the ancillary chamber may be a part of the processing chamber. At times, the ancillary chamber may be coupled to the processing chamber. At times, the ancillary chamber may be coupled to one of the side walls of the processing chamber. The ancillary chamber may be mounted to the processing chamber. The mounting may be reversible mounting. The mounting may be controlled (e.g., manually or by a controller). The atmosphere of the ancillary chamber and processing chamber may be (e.g., substantially) the same atmosphere. At times, the atmosphere of the ancillary chamber and the processing chamber may differ.

In some embodiments, the layer dispensing mechanism is coupled to one or more shafts (e.g., a rod, a pole, a bar, a cylinder, one or more spherical bearings coupled at a predetermined distance) (e.g., FIG. 2, 236). The shaft may comprise a vertical (e.g., small) cross section of a circle, triangle, square, pentagon, hexagon, octagon, or any other polygon. The vertical cross section may be of an amorphous shape. The one or more shafts may be movable. For example, the shaft may be movable to and from the ancillary chamber (e.g., before, during, and/or after the 3D printing). For example, the shaft may be movable from the ancillary chamber to the processing chamber (e.g., for deposition of a layer of material). For example, the shaft may be movable from the processing chamber to the ancillary chamber (e.g., in preparation for transforming at least a portion of the material bed). FIG. 2 shows an example of a shaft, 236. At times, at least a portion of the shaft may reside within the ancillary chamber (e.g., 240). At times, at least a portion of the shaft may reside out of the ancillary chamber (e.g., in the area 254). The atmosphere of the portion of the shaft residing within the ancillary chamber may be (e.g., substantially) the same atmosphere as the atmosphere of the ancillary chamber. The atmosphere of the ancillary chamber may be an inert atmosphere. The atmosphere in the ancillary chamber may be deficient by one or more reactive species (e.g., water and/or oxygen). The atmosphere of the portion of the shaft residing out of the ancillary chamber may differ from the atmosphere of the ancillary chamber. The atmosphere of the portion of the shaft residing out of the ancillary chamber may not be an inert atmosphere. The atmosphere of the portion of the shaft residing out of the ancillary chamber may be open to one or more reactive species (e.g., water and/or oxygen). The ancillary chamber may accommodate at least a portion of the shaft. FIG. 2 shows an example of components of an ancillary chamber including one or more shafts. The one or more shafts may comprise a conveying system. The one or more shafts may comprise a retracting system. The shaft may be (e.g., operatively) coupled to the layer dispensing mechanism (e.g., 234). Coupled may be physically attached to one of the components of the layer dispensing mechanism (also referred to herein as “layer dispensing system”). The attachment may be physical, magnetic, electrical, or any combination thereof. Coupled may comprise positional (e.g., optical) sensors to one or more components of the layer dispensing mechanism. The shaft may assist in moving the layer dispensing mechanism from the ancillary chamber to a position adjacent to the material bed. The position adjacent to the material bed may be within the processing chamber. The position adjacent to the material bed may be within the build module. The shaft may comprise an internal cavity. The internal cavity may be a channel. For example, the shaft may comprise one or more channels. A portion of the one or more shaft channels may be enclosed within the shaft. A portion of the one or more shaft channels may be external to the shaft. The external portion of the shaft may be coupled to a reduced pressure (e.g., vacuum) system. The reduced pressure system may comprise a pump (e.g., as disclosed herein). The one or more shaft channels may comprise a transit system. The vacuum system may insert positive pressure through the shaft channel to transit pre-transformed material. The vacuum system may insert negative pressure through the shaft channel to remove pre-transformed material from the ancillary chamber. The vacuum system may insert negative pressure through the shaft channel to remove pre-transformed material from the layer dispensing mechanism. The vacuum system may insert negative pressure through the shaft channel to remove pre-transformed material from the shaft. The vacuum system may transit the collected pre-transformed material to a recycling system. The recycling system may recycle a collected pre-transformed material back to the layer dispensing mechanism (e.g., the pre-transformed material may be transferred manually to the bulk reservoir (e.g., doser). At times, the transfer of pre-transformed material (e.g., conveying) back to the layer dispensing mechanism may be automated and/or controlled. Controlling may be performed before, after, and/or during the 3D printing. The recycling system may comprise a sieve. The recycling system may comprise a material re-conditioning system. The material re-conditioning system may recondition (e.g., remove any reactive species such as oxygen, water, etc.) the collected pre-transformed material. The reconditioned material may be recycled and used in the 3D printing. Recycling may comprise transporting the material to the layer dispensing mechanism. The recycling may be continuous during the 3D printing. For example, the recycling may be continuous during the time at which the layer dispensing mechanism is parked in the garage.

At times, the methods described herein are performed in an enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled pressure. The enclosure may have a predetermined and/or controlled atmosphere. The control may be manual or via a control system.

In some embodiments, the enclosure comprises an atmosphere having an ambient pressure (e.g., 1 atmosphere), or positive pressure. The atmosphere may have a negative pressure (i.e., vacuum). Different portions of the enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the enclosure may comprise the processing chamber, build module, or enclosure volume excluding the processing chamber and/or build module. The vacuum may comprise pressure below 1 bar, or below 1 atmosphere. The positively pressurized environment may comprise pressure above 1 bar or above 1 atmosphere. In some cases, the chamber pressure can be standard atmospheric pressure. The pressure may be measured at an ambient temperature (e.g., room temperature such as 20° C., or 25° C.).

In some embodiments, the enclosure comprises an atmosphere. The atmosphere within the enclosure may comprise a positive pressure. The atmosphere within the enclosure may be different that an atmosphere outside the enclosure. At times, a differential atmosphere (e.g., a difference in atmospheres between the inside of the enclosure and the outside of the enclosure) depends in part on a processing conditions of the three-dimensional printing. Processing conditions can include, for example, (i) a composition of the pre-transformed material, (ii) an internal temperature of the material bed during the three-dimensional processing, (iii) a number of energy beams (e.g., an average number of energy beams) transforming (e.g., incident on) the target surface during the three-dimensional processing, (iv) an amount of contamination by debris during the three-dimensional processing, (v) temperature in the material bed during 3D printing, (vi) temperature in the processing chamber during the printing, (vii) amount of energy supplied by the energy beams to the material bed, or (vii) any combination thereof. For example, a differential atmosphere between the interior of the enclosure (e.g., within the processing chamber) and an ambient environment external to the enclosure may depend at least in part on an average number of energy beams utilized during the three-dimensional process.

In some embodiments, the 3D printing takes place in a 3D printing system comprising an enclosure (e.g., chamber) having an atmosphere different from the ambient atmosphere external to the enclosure. FIG. 1 depicts an example of a system that can be used to generate a 3D object using a 3D printing process disclosed herein. The system can include an enclosure (e.g., 107). At least a fraction of the components in the system can be enclosed in the chamber (e.g., comprising the enclosure). At least a fraction of the chamber can be filled with at least one gas to create a gaseous environment (e.g., an atmosphere). The gas can comprise an inert gas (e.g., Argon, Neon, Helium, Nitrogen). The chamber can be filled with another gas or mixture of gases. The gas can be a non-reactive gas (e.g., an inert gas). The gaseous environment can comprise argon, nitrogen, helium, neon, krypton, xenon, hydrogen, carbon monoxide, or carbon dioxide. The gas can be an ultrahigh purity gas. For example, the ultrahigh purity gas can be at least about 99%, 99.9%, 99.99%, or 99.999% pure. The gas may comprise less than about 2 ppm oxygen, less than about 3 ppm moisture, less than about 1 ppm hydrocarbons, or less than about 6 ppm nitrogen. In some examples, the pressure in the chamber is at least about 10 Torr, 100 Torr, 150 Torr, 200 Torr, 300 Torr, or 400 Torr, above atmospheric pressure (e.g., above 760 Torr). In some examples, the pressure in the chamber is at least about 10 Torr, 100 Torr, 150 Torr, 200 Torr, 300 Torr, 400 Torr, 500 Torr, or 600 Torr, above atmospheric pressure (e.g., above 760 Torr). The pressure in the chamber can be at a range between any of the afore-mentioned pressure values above atmospheric pressure, e.g., from about 10 Torr to about 600 Torr, from about 100 Torr to about 200 Torr, the values representing a pressure difference above atmospheric pressure (e.g., above 760 Torr). The pressure in the chamber is at least about 20 Kilo Pascal (KPa), 18 KPa, 16 KPa, 14 KPa, 12 KPa, 10 KPa, or 5 KPa above ambient pressure external to the chamber such as above atmospheric pressure, e.g., above 101 KPa. The pressure in the chamber can be at a range between any of the afore-mentioned pressure values above atmospheric pressure, e.g., from about 5 KPa to about 20 KPa, the values representing a pressure difference above atmospheric pressure, e.g., above 101 KPa. The pressure can be measured by a pressure gauge. The pressure can be measured at ambient temperature, e.g., Room Temperature. In some cases, the pressure in the chamber can be standard atmospheric pressure. In some cases, the pressure in the chamber can be ambient pressure (e.g., pressure at the surrounding environment outside of the chamber). In some examples, the chamber can be under vacuum pressure. In some examples, the chamber can be under a positive pressure (e.g., above ambient pressure external to the chamber). The pressure in the enclosure may be maintained at a (e.g., substantially) constant value at least during a portion of the 3D printing process, e.g., during the entire 3D printing. In some embodiments, the 3D printing takes place in a (e.g., substantially) constant pressure. Constant pressure excludes pressure gradients in the material bed during the 3D printing. The sieve assembly and/or the bounceable plate enclosure, may have the same atmosphere as the processing chamber, e.g., during the 3D printing. The sieve assembly and/or the bounceable plate enclosure, may be purge together with purging the processing chamber.

In some embodiments, the enclosure includes an atmosphere that is greater than (e.g., at a positive pressure with respect to) an ambient atmosphere external to the enclosure. The atmosphere within the enclosure may comprise a positive pressure of at least about 100 Kilopascals (kPa), 120 kPa, 150 kPa, 200 kPa, 300 kPa, 325 kPa, 350 kPa, 400 kPa, 450 kPa, 500 kPa, 550 kPa, 600 kPa, 650 kPa, 700 kPa, 750 kPa, 800 kPa, 850 kPa, 900 kPa, 950 kPa, or 1000 kPa. The atmosphere within the enclosure may comprise a positive pressure of any value between the aforementioned values, for example, from about 100 kPa to about 1000 kPa, from about 100 kPa to about 400 kPa, from about 550 kPa to about 900 kPa, or from about 700 kPa to about 1000 kPa. The composition of the atmosphere within the enclosure may comprise any one or more of the gases described herein, for example, clean dry air (CDA), argon, and/or nitrogen. The enclosure may comprise a gas flow, e.g., before, after, and/or during three-dimensional printing. The gas flow within the enclosure may comprise at least about 150 liters per minute (LPM), 200 LPM, 250 LPM, 300 LPM, 350 LPM, 400 LPM, 450 LPM, 500 LPM, 550 LPM, 600 LPM, 650 LPM, 700 LPM, 750 LPM, 800 LPM, 900 LPM, 1000 LPM, or 1200 LPM. The gas flow within the enclosure may comprise any value between the aforementioned values, for example, from about 150 LPM to about 500 LPM, from about 450 LPM to about 750 LPM, or from about 700 LPM to about 1200 LPM. The composition of the gas may comprise any one or more of the gases described herein, for example, clean dry air (CDA), argon, or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of the reactive agent (gas) between the afore-mentioned percentages of hydrogen gas.

In some embodiments, the enclosure includes an atmosphere. The enclosure may comprise a processing chamber, a bounceable plate enclosure, a sieve assembly enclosure (e.g., housing), a build module, or any other enclosure disclosed herein, e.g., in relation to the three-dimensional printing system. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 0.1 parts per million (ppm), 1 ppm, 3 ppm, 10 ppm, 50 ppm, 100 ppm, 500 ppm, 1000 ppm, 3000 ppm, or 5000 ppm volume by volume (v/v). The level of the depleted or reduced level gas may be at least about 1 ppm, 10 ppm, 50 ppm, 100 ppm, 500 ppm, 1000 ppm, or 5000 ppm (v/v). The level of the oxygen gas may be at most about 1 ppm, 10 ppm, 50 ppm, 100 ppm, 500 ppm, 1000 ppm, or 2000 ppm (v/v). The level of the water vapor may be at most about 1 ppm, 10 ppm, 50 ppm, 100 ppm, 500 ppm, 700 ppm, 800 ppm, 900 ppm, or 1000 ppm, (v/v). The level of the gas (e.g., depleted or reduced level gas, oxygen, or water) may be between any of the afore-mentioned levels of gas. The atmosphere may comprise air. The atmosphere may be inert. The atmosphere in the enclosure (e.g., processing chamber) may have reduced reactivity (e.g., be non-reactive) as compared to the ambient atmosphere external to the processing chamber and/or external to the printing system. The atmosphere may have reduced reactivity with the material (e.g., the pre-transformed material deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the pre-transformed material within the layer of pre-transformed material before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be about one (1) atmosphere. The concentration of oxygen and/or humidity in the enclosure (e.g., chamber) can be minimized, e.g., below a predetermined threshold value. For example, the gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 50 ppm to about 5 ppm, from about 1500 ppm to about 500 ppm, or from 500 ppm to about 50 ppm). For example, the gas composition of the chamber can contain a level of humidity that correspond to a dew point of at most about −5° C., −10° C., −15° C., −20° C., −25° C., −30° C., −35° C., −40° C., −50° C., −60° C., or −70° C. The gas composition of the chamber can contain a level of humidity that correspond to a dew point of between any of the aforementioned values, e.g., from about −70° C. to about −5° C., from about −60° C. to about −10° C., or from about −30° C. to about −20° C. The gas composition may be measures by one or more sensors (e.g., an oxygen and/or humidity sensor.). In some cases, the chamber can be opened at or after printing the 3D object. When the processing chamber is opened, ambient air containing oxygen and/or humidity can enter the chamber. Exposure of one or more components inside of the chamber to air can be reduced by, for example, flowing an inert gas while the chamber is open (e.g., to prevent entry of ambient air), or by flowing a heavy gas (e.g., argon) that rests on the surface of the powder bed. In some cases, components that absorb oxygen and/or humidity on to their surface(s) can be sealed while the chamber is open. In some embodiments, the chamber is minimally exposed to the external environment by usage of one or more load lock chambers. In a load lock chamber, the purging of gas may be done in a smaller gas volume as compared to the chamber gas volume.

In some embodiments, material utilized in the 3D printing undergoes passivation, e.g., using a passivation systems. A passivation system may comprise (A) an in-situ passivation system, (B) an ex-situ passivation system, Ior (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, humidity levels and/or oxygen levels in at least a portion of the enclosure, (e.g., processing chamber, ancillary chamber, and/or build module) can be regulated such that an oxygenation and/or humidification of powder in the powder conveyance system is controlled. For example, oxygenation and/or humidification levels of recycled pre-transformed material (e.g., recycled powder material) can be about 5 parts per million (ppm) to about 1500 ppm. For example, oxygenation and/or humidification levels of recycled pre-transformed material can be at most about 1500 ppm, 1200 ppm, 1000 ppm, 500 ppm, 250 ppm, or less. For example, oxygenation and/or humidification levels of pre-transformed material can be about zero ppm. For example, oxygen content in pre-transformed material can be about 0 weight percent (wt %), 0.1 wt %, 0.25 wt %, 0.3 wt %, 0.5 wt %, 0.75 wt %, 1.0 wt %, or more. At times, atmospheric conditions can, in part, influence a flowability of pre-transformed material (e.g., powder material) from the layer dispensing mechanism. A dew point of an internal atmosphere of an enclosure (e.g., of the processing chamber) can be (I) below a level in which the powder particles absorb water such that they become reactive under condition of 3D printing process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder material and/or on processing condition(s) of the 3D printing process(es). For example, a dew point of an internal atmosphere of the enclosure (e.g., of the processing chamber) can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the enclosure. For example, a dew point of an internal atmosphere of the enclosure can be any value within or including the afore-mentioned values. The 3D printing system may comprise an in-situ passivation system, e.g., to passivate filtered debris and/or any other gas borne material before their disposal. Examples of gas conveyance system and components (including control components), in-situ passivation systems, controlled oxidation methods and systems, 3D printing systems, control systems, software, and related processes, can be found in International Patent Applications Serial Nos. PCT/US17/60035 and PCT/US21/35350, each of which is incorporated herein by reference in its entirety.

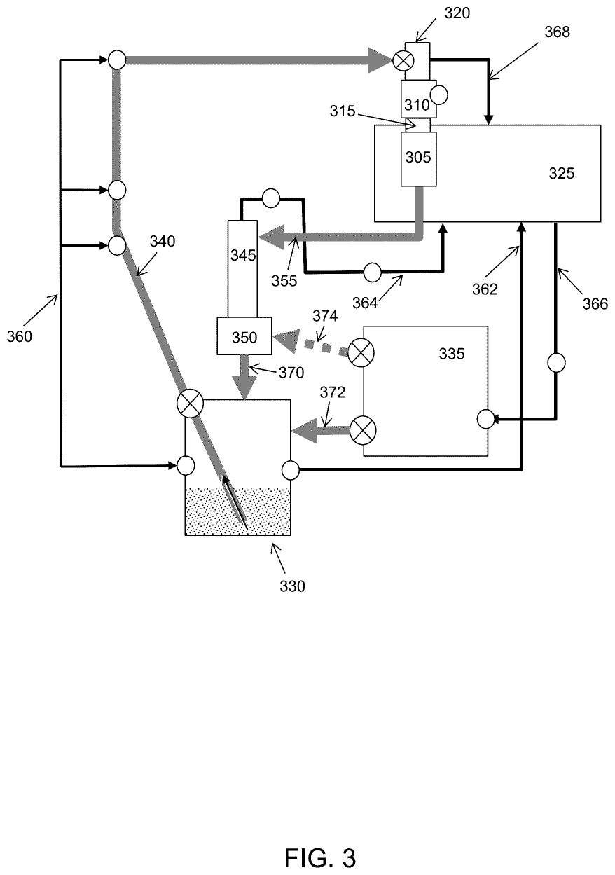

In some embodiments, the 3D printing system comprises a pre-transformed material conveyor system. The pre-transformed material conveyor system may be operatively coupled to a processing chamber, a build module, an ancillary chamber, a layer dispensing mechanism and/or a recycling mechanism. The one or more components of the pre-transformed material conveyor system may be replaceable, exchangeable, and/or modular. FIG. 3 shows an example of a pre-transformed material conveyor system coupled to a processing chamber (e.g., 325). The pre-transformed material conveyor system comprises a pressure container (e.g., 330). The pressure container comprises pre-transformed material. The pre-transformed material may be conveyed (e.g., directly, or indirectly) into the pressure container from (i) an external material source (e.g., a bulk feed 335) and/or from (ii) a layer dispensing mechanism (e.g., 305). The layer dispensing mechanism (also referred to herein as “layer dispenser”) may be coupled to a bulk reservoir (e.g., 310) via a channel (e.g., 315). The bulk reservoir may be optionally coupled to a secondary separator (e.g., 320). The pre-transformed material may be conveyed (e.g., in a first loop) from the pressure container to the secondary separator (e.g., 310) via a material conveying channel (e.g., 340). The pre-transformed material conveyor system may comprise one or more material conveying channels. In some examples, the pre-transformed material conveyor system may comprise a plurality of material conveying channels (e.g., including 340, 355, 370, 372, and/or 374). At least two of the plurality of material conveying channels may be of the same characteristics. The channel characteristic may comprise a material from which the channel is constructed, cross-section, flow capacity, or internal surface finish. At least two of the plurality of material conveying channels may be different in at least one of the channel characteristic. At least two of the plurality of material conveying channels may be (e.g., substantially) the same in at least one of the channel characteristic. The material conveying channel may convey pre-transformed material to one or more components of the pre-transformed material conveyor system. In some examples, the material conveying channel may be coupled to the bulk reservoir and/or the layer dispensing mechanism. The pre-transformed material may be conveyed (e.g., in a second loop) from the layer dispensing mechanism to the pressure container. The pre-transformed material conveyance system may comprise at least one separator. The separator may comprise a cyclonic-separator, a sorter, classifier, or a sieve (e.g., filter). The classifier may comprise a gas classifier (e.g., air-classifier). For example, the second loop may comprise a first separator (e.g., 345) and/or a filter (e.g., 350). The filter may sieve pre-transformed material (e.g., that was not used during the 3D printing, that arrives from the bulk feed (e.g., from a supplier)) prior to conveying it to the pressure container and/or to the processing chamber (e.g., by using the material dispenser). In some examples, the filter may be operatively coupled to the bulk feed (e.g., 335) via a material conveying channel (e.g., 374). The pre-transformed material from an external material source (e.g., stored in the bulk feed 335) may be filtered, prior to conveying it to the pressure container and/or to the processing chamber. The pre-transformed material may be conveyed from the layer dispensing mechanism to the first separator via a material conveying channel (e.g., 355). Optionally, the separator may be operatively coupled to a buffer container. The pre-transformed material may reside in the buffer container while the first loop may be in operation of conveying pre-transformed material into the secondary separator. On completion of the first loop, the pre-transformed material from the buffer container into the pressure container. In some examples, the buffer container may convey pre-transformed material into the pressure container during the first loop. The buffer container may be inserted with pre-transformed material from the external material source (e.g., a bulk feed 335). The pre-transformed material conveyor system may comprise a gas conveying channel. In some examples, the pre-transformed material conveyor system may comprise a plurality of gas conveying channels (e.g., that are fluidly coupled, e.g., to allow flow of the pre-transformed material). The gas conveying channel may convey gas to one or more components of the pre-transformed material conveyor system. The gas may comprise a pressure. The gas conveying channel may equilibrate pressure and/or content within one or more components of the pre-transformed material conveyor system. For example, a gas conveying channel may equilibrate a first atmosphere of a processing chamber with a second atmosphere of the bulk feed, separator, and/or pressure chamber (in certain instances). The first atmosphere and/or second atmosphere may be a (e.g., substantially) inert, oxygen depleted, humidity depleted, organic material depleted, or any combination thereof. The gas conveying channel (e.g., 360, 362, 364, 366, and/or 368) may be operatively coupled to the material conveying channel, pressure container, processing chamber, external material source, separator, bulk reservoir, layer dispenser (e.g., material dispenser), and/or the buffer container. The channel (e.g., shaft channel, gas channel, and/or material conveyance channel may be a tube, hose, tunnel, duct, chute, or conduit). The pre-transformed material conveyor system may comprise one or more valves. A valve may be coupled to a material conveying channel and/or a gas conveying channel. For example, FIG. 3 shows examples of material conveying channel valves (e.g., denoted by a white circle comprising an X) and gas conveying channel valves (e.g., denoted by a white circle).

In some examples, the pre-transformed material conveyor system comprises a (e.g., optional) separator. The pre-transformed material conveyor system may comprise a plurality of separators. The separator may be exchangeable, replaceable, and/or modular. The separator may separate between a gas and a pre-transformed material. The separator may separate between various sizes (or size groups) of particulate material. The separator may separate between various types of material. The separator may comprise separation, sorting, and/or reconditioning the pre-transformed material. The separator may comprise a cyclonic separator, velocity reduction separator (e.g., screen, mesh, and/or baffle), and/or a separation column. The separator may utilize a gravitational force. The separator may utilize an artificially induced force (e.g., pneumatic, electronic, magnetic, hydraulic, and/or electrostatic force). The cyclonic separator may comprise using vortex separation. The cyclonic separator may comprise using centrifugal separation. Examples of material separators, 3D printing systems, control systems, software, and related processes, can be found in U.S. patent application Ser. No. 15/374,318, filed on Dec. 9, 2016, titled “SKILLFUL THREE-DIMENSIONAL PRINTING,” or in International Patent Application serial number PCT/US16/66000, filed on Dec. 9, 2016, titled “SKILLFUL THREE-DIMENSIONAL PRINTING,” each of which is entirely incorporated herein by reference. The separator may comprise a filter (e.g., sieve, column, and/or membrane). The separation may comprise separating the pre-transformed material from debris and/or gas. The pre-transformed material may be sorted as to material type and/or size. The pre-transformed material may be sorted using a gas classifier that classifies gas-borne material (e.g., liquid, or particulate) material. For example, using an air-classifier. For example, using a powder gas classifier. The reconditioning may comprise removing of an oxide layer forming on the pre-transformed material. Reconditioning may comprise physical and/or chemical reconditioning. The physical reconditioning may comprise ablation, spattering, blasting, or machining. The chemical reconditioning may comprise reduction. The separator and/or filter may be controlled. The controlling may be done manually and/or automated. Controlling may be performed before, after, and/or during at least a portion of the 3D printing. Controlling may be performed during, before and/or after the operation of the pre-transformed material conveyor system. The separator may comprise a sensor. The sensor may detect a system state of the separator. The sensor may detect the velocity of the pre-transformed material and/or gas during operation. In some examples, a plurality of separators may be operatively coupled to each other. A first separator may be connected to a second separator (e.g., in a serial manner). The separator may be optimized to operate with different types of material flow and/or pneumatic flows. For example, the separator may be optimized to operate with a number of pre-transformed material properties (e.g., particulate material size, material type, FLS of a particulate material, and/or particulate material shape). The pre-transformed material may comprise a particulate material (e.g., powder, or vesicles). The pre-transformed material may comprise a solid, semi-solid, or liquid. For examples, the separator may be optimized to operate with a number of material flow properties (e.g., material density and/or material friction).

In some examples, a portion of a first separator is operatively coupled to the processing chamber, a recycling system, a build module, and/or at least one component of the layer dispensing mechanism. A portion of the separator may be operatively coupled to a pressure container. The separator may receive pre-transformed material (e.g., spillage, or an excess amount of material) from the processing chamber, a component of the layer dispensing mechanism and/or the build module. The separator may receive a remainder of the pre-transformed material that did not transform to form at least a portion of the 3D object. The separator may receive recycled pre-transformed material from the recycling system. In some examples, the separator may be coupled to the processing chamber, recycling system, build module and/or at least one component of the layer dispensing mechanism, via a channel (e.g., pipe). The channel may comprise one or more sensors. The sensor may be any sensor described herein. The channel may comprise one or more valves. The valve may be any valve described herein. The sensor and/or the valve may be controlled. The controlling may be done manually and/or automated. Controlling may be performed before, after, and/or during at least a portion of the 3D printing. Controlling may be performed during, before and/or after the operation of the pre-transformed material conveyor system. In some examples, the pre-transformed material conveyor system may optionally comprise a secondary separator. For example, the pre-transformed material conveyor system may comprise (i) a gas separator (e.g., cyclonic separator) and (ii) a particulate material size separator (e.g., sieve). A portion of the secondary separator (e.g., sieve) may be coupled to a material conveyor channel. A portion of the secondary separator may be coupled to the at least one component of the layer dispensing mechanism (e.g., material leveler, material remover, and/or material dispenser). The pre-transformed material from one or more pressure containers may be conveyed into the secondary separator via the material conveyor channel. The pre-transformed material may be sorted, separated and/or reconditioned by the (e.g., secondary) separator, and conveyed to at least one component of the layer dispensing mechanism.

In some embodiments, the pressure container can withstand a pressure different from an ambient pressure (e.g., positive, or negative pressure relative to the ambient pressure). For example, the pressure container may be a container that can withstand elevated pressure and/or vacuum. The pressure container may withstand an ambient pressure, a positive pressure (e.g., above the ambient pressure) and/or a negative pressure (e.g., below the ambient pressure). In some instances, the pressure in the container and the pressure in the processing chamber may be the same. In some instances, the pressure in the container and the pressure in the processing chamber may be different. In some examples, the pressure in the pressure container may be greater than the pressure in the processing chamber by at least 1.1 times, 5 times, 10 times, 25 times, 30 times, 50 times, 75 times, 100 times, 200 times, 300 times, 500 times, 700 times, 900 times or, 1000 times. In some examples, the pressure in the container may be smaller than the pressure in the processing chamber by at least 1.1 times, 5 times, 10 times, 25 times, 30 times, 50 times, 75 times, 100 times, 200 times, 300 times, 500 times, 700 times, 900 times, or 1000 times.

The pressure container may have an internal 3D shape. The internal shape may be the same or different as the external 3D shape of the pressure container. The pressure container may have a uniform or a non-uniform internal 3D shape. The 3D shape may comprise a cuboid (e.g., cube), a tetrahedron, a polyhedron (e.g., primary parallelohedron), at least a portion of an ellipse (e.g., circle), a cone, a triangular prism, hexagonal prism, cube, truncated octahedron, or gyrobifastigium, a pentagonal pyramid, or a cylinder. The polyhedron may be a prism (e.g., hexagonal prism), or octahedron (e.g., truncated octahedron). A vertical cross section (e.g., side cross section) of the 3D shape may comprise a circle, triangle, rectangle (e.g., square), pentagon, hexagon, octagon, or any other polygon. The vertical cross section may be of an amorphous shape. The polygon may comprise at least 3, 4, 5, 6, 7, 8, 9, or 10 faces. The polygon may comprise at least 3, 4, 5, 6, 7, 8, 9, or 10 vertices. The cross-section may comprise a convex polygon. The polygon may be a closed polygon. The polygon may be equilateral, equiangular, regular convex, cyclic, tangential, edge-transitive, rectilinear, or any combination thereof. For example, the (e.g., vertical) cross-section of the 3D shape may comprise a square, rectangle, triangle, pentagon, hexagon, heptagon, octagon, nonagon, octagon, circle, or icosahedron. The container may comprise an internal 3D shape that may facilitates a maximum amount of pre-transformed material evacuation. The internal 3D shape of the pressure container may facilitate concentration of the pre-transformed material to be conveyed.

In some embodiments, the pressure container comprises a gas port. In some embodiments, the pressure container is operatively (e.g., physically) coupled to a gas source and/or to a chamber/enclosure/channel that facilitates pressure equilibration. The pressure container may comprise a gas port. The gas port may be operatively coupled to a surface (e.g., top, side or a bottom) of the pressure container. The gas port may comprise an (e.g., controlled) opening. The gas port opening may be operatively coupled to a gas source. The gas source may be an external gas source. The gas source may be exchangeable (e.g., before, during, and/or after at least a portion of the 3D printing). The gas source may be replaceable. The gas port may allow insertion of gas into the container. The vent port may allow removal of gas from the container. Optionally, the vent port may be connected to a gas conveyor channel (e.g., a tube, pipe, duct, or a carrier). The gas may be conveyor channel may be inserted into the container. The gas channel (e.g., 360, and 362) may allow transporting (e.g., conveying and/or extracting) gas to and/or from the pressure container. The gas may flow through the pressure container. The gas may be at an ambient, positive, or a negative pressure. The gas pressure may be controlled (e.g., by a controller). Controlling may comprise using a (e.g., controllable) valve. The controlling may be done manually and/or automated. Controlling may be performed before, after, and/or during the 3D printing. Controlling may be performed during, before and/or after the operation of the pre-transformed material conveyor system. The vent port may be operatively coupled to a valve. The valve may facilitate control of gas pressure. The valve may facilitate control of gas insertion and/or removal. The valve may be controlled manually and/or automated. The valve may be in operation during, before, and/or after 3D printing. The valve may be in operation during, before, and/or after operation of the pre-transformed material conveyor system. The valve may comprise a pressure relief, pressure release, pressure safety, safety relief, pilot-operated relief, low pressure safety, vacuum pressure safety, low and vacuum pressure safety, pressure vacuum release, snap acting, pinch, metering, flapper, needle, check, control, solenoid, flow control, butterfly, bellows, ball, piston, plug, popping, rotary, manual, or modulating valve. The valve may comply with the legal industry standards presiding the jurisdiction. The pressure within the container may cause the pre-transformed material to flow (e.g., through the material conveyor channel). The flow of the pre-transformed material may be with or against gravity. The flow of the pre-transformed material may be from a high-pressure area (e.g., the area within the pressure container) to a low-pressure area (e.g., the area external to the pressure container, and/or the area within the material conveyor channel outside of the pressure container). The flow of the pre-transformed material may be to a (e.g., secondary) separator. The flow of the pre-transformed material may be to a material conveyor channel. The pressure may create a suction of the pre-transformed material to the low-pressure area (e.g., bulk reservoir, and/or material dispenser).

In some examples, the pressure container comprises a material port (e.g., through which pre-transformed material travels). The material port may be operatively coupled to a surface (e.g., top, side, or bottom) of the pressure container. The material port may comprise an opening. The opening may be operatively coupled to a pre-transformed material source. The pre-transformed material source may be an external material source (e.g., a bulk feed). The material source may be exchangeable (e.g., before, after, and/or during at least a portion of the 3D printing). The material source may be replaceable (e.g., before, after, and/or during at least a portion of the 3D printing). The material source may be operatively coupled to a controller. The controller may control insertion and/or removal of the pre-transformed material to/from the container. The insertion and/or removal of the pre-transformed material may be manual and/or automated. The material port may allow insertion of pre-transformed material into the container. The material port may allow removal of pre-transformed material from the container. The material port may be operatively coupled to a valve. The valve may facilitate insertion and/or removal of material. The valve may facilitate (e.g., control) a flow of material. The valve may be controlled manually and/or automated. The valve may be in operation during, before, and/or after 3D printing. The valve may be in operation during, before, and/or after operation of the pre-transformed material conveyor system. The valve may be any valve described herein.

In some examples, the material port may be connected to a material conveyor channel (e.g., tube, pipe, duct, or a carrier). The material conveyor channel may facilitate insertion and/or removal of pre-transformed material to/from the pressure container. At least a portion of the material conveyor channel may be inserted within the pressure container. The material conveyor channel may have an extension that extends into the container (e.g., close to a bottom surface of the container). In some examples, the material conveyor channel may not have an extension. In some examples, the material conveyor channel may not be inserted into the container (e.g., when the material port is at a side or bottom surface of the container). In some examples, the pre-transformed material is conveyed to the material conveyor channel through a bottom or side opening in the pressure container. In some example, the pressure conveyor does not have a material port at an upper portion of the pressure container (e.g., relative to the gravitational center). The upper portion of the container may comprise the top of the container, or a portion of the container close to the top of the container. In some embodiments, the container is rotatable upon an axis (e.g., that is different from a vertical axis). The rotational axis may allow rotation of the pressure container to allow pre-transformed material to concentrate at the material port (e.g., to be evacuated from the pressure container). The rotation may be manual and/or automatically controlled (e.g., by a controller); before, after, and/or during at least a portion of the 3D printing. In some embodiments, the pressure container is stationary (e.g., before, after, and/or during at least a portion of the 3D printing). In some examples, the material conveyor channel may be (e.g., externally) connected to a surface of the pressure container (e.g., to an opening at the bottom surface of the pressure container, or to an opening at the side surface of the pressure container). In some examples, the pressure container may comprise a plurality of material ports, for example, at the top and at the bottom of the pressure container. A portion of the material conveyor channel may be connected to a recycling system. The pre-transformed material from the recycling system may be conveyed into the container from the recycling system. A portion of the material conveyor channel may be connected to at least one component of the layer dispensing mechanism (e.g., to a material dispenser and/or material remover). The pre-transformed material (e.g., an excess amount of pre-transformed material) from the component of the layer dispensing mechanism (e.g., material dispenser, and/or the material leveler) may be conveyed into the pressure container from the layer dispensing mechanism. The pre-transformed material from the at least one component of the layer dispensing mechanism may be an excess amount of material (e.g., spillage, unused portions and/or overflow portions of pre-transformed material). A portion of the material conveyor channel may be connected to a (e.g., secondary) separator. The one or more boundaries (e.g., walls) of the material conveyor channel may comprise a smooth (e.g., polished) internal surface (e.g., that comes in contact with at least a portion of the pre-transformed material during its conveyance through the material conveyor channel). Smooth surface may be of an Ra value of at most about 3 μm, 4 μm, 5 μm, 6 μm, 7 μm, 8 μm, 9 μm, 10 μm, 30 μm, 40 μm, 50 μm, 75 μm, or 100 μm. Smooth surface may be of an Ra value that is between any of the afore-mentioned values (e.g., from about 3 μm to about 100 μm, from about 3 μm to about 40 μm, or from about 3 μm to about 10 μm). The smooth internal surface may exhibit a small, negligible, and/or insubstantial amount of friction with the pre-transformed material (e.g., relative to the intended purpose of conveying the pre-transformed material through the material conveyor channel, for example, from the pressure container to the processing chamber and/or vice versa). The small, negligible, and/or insubstantial amount of friction may facilitate (e.g., easy, uninterrupted, and/or continuous) conveying of the pre-transformed material in a requested manner. The one or more smooth walls of the material conveyor channel may be formed by a polishing process (e.g., soda-blasting, vapor polishing, flame polishing, paste polishing, or chemical-mechanical polishing). The one or more smooth walls of the material conveyor channel may be formed by coating a wall with a coating. Examples of polished material include mirror, or, polished stainless steel. The coating may alter the surface properties of the channel boundary. For example, the coating may alter the adhesion, attraction and/or repulsion of the pre-transformed material to the internal surface of the channel. For example, the coating may reduce the adhesion and/or attraction of the pre-transformed material to the internal surface. For example, the coating may cause the pre-transformed material to repel from the internal surface. The surface structure of the internal surface may comprise a low attachment surface (e.g., a Lilly pad, or shark skin type surfaces). The surface structure of the internal surface may be a static dissipative surface. The static dissipative surface may dissipate (e.g., repel) the pre-transformed material that may be statically charged. The static dissipative surface may facilitate conveying of the pre-transformed material, by reducing adhering of the pre-transformed material to the internal surface. The one or more boundaries of the material conveyor channel may be configured to withstand pressure (e.g., ambient, positive, and/or negative pressure). The amount of pressure inserted and/or released within the material conveyor channel may be adjustable (e.g., manually, and/or automatically, e.g., controlled by a controller). Adjustment may be performed to facilitate conveying of the pre-transformed material. The amount of adjustment may depend on the material type of the material conveyor channel and/or the pre-transformed material. The material type from which the material conveyor channel is constructed may comprise an elemental metal, metal alloy, glass, ceramic, elemental carbon, polymer, or resin. The polymer may comprise polyurethane. The material may be a composite material. The material type may be any material disclosed herein. In some examples, the charge (e.g., magnetic, electric, and/or electrostatic) on one or more walls of the material conveyor channel may be altered. Altering may comprise charging with gas. Altering may comprising grounding and/or connecting to a voltage. Altering may comprise facilitating ease of conveying (e.g., by dissipating, repelling, reducing adherence, and/or not attracting) the pre-transformed material to the internal surface of the material conveyor channel. In some examples, the material conveyor channel (also herein “material conveying channel”) may comprise a flexible material. The material conveying channel may comprise a flexible (e.g., bendable, malleable, and/or pliable) portion. The material conveying channel may comprise a non-flexible (e.g., bendable, malleable, and/or pliable) portion. The non-flexible portion may resist structural alteration of the channel during conveying of the pre-transformed material through the material conveyor channel. The pre-transformed material may be conveyed through the material conveyor channel at a velocity of at least about 1 cm (centimeter)/sec(second), 2 cm/sec, 3 cm/sec, 5 cm/sec, 6 cm/sec, 7 cm/sec, 8 cm/sec, 9 cm/sec, 10 cm/sec, 30 cm/sec, 40 cm/sec, 50 cm/sec, 75 cm/sec, 80 cm/sec, 90 cm/sec, 95 cm/sec, 1 m (meter)/sec, 2 m/sec, 3 m/sec, 4 m/sec, 5 m/sec, 10 m/sec, 15 m/sec, 20 m/sec, 25 m/sec, 30 m/sec, 35 m/sec, 40 m/sec, 45 m/sec, 50 m/sec, 55 m/sec, 60 m/sec, 70 m/sec, 80 m/sec, or 90 m/sec. The pre-transformed material may be conveyed through the material conveyor channel at a velocity of at most about 2 cm/sec, 3 cm/sec, 5 cm/sec, 6 cm/sec, 7 cm/sec, 8 cm/sec, 9 cm/sec, 10 cm/sec, 30 cm/sec, 40 cm/sec, 50 cm/sec, 75 cm/sec, 80 cm/sec, 90 cm/sec, 95 cm/sec, 1 m (meter)/sec, 2 m/sec, 3 m/sec, 4 m/sec, 5 m/sec, 10 m/sec, 15 m/sec, 20 m/sec, 25 m/sec, 30 m/sec, 35 m/sec, 40 m/sec, 45 m/sec, 50 m/sec, 55 m/sec, 60 m/sec, 70 m/sec, 80 m/sec, 90 m/sec, or 100 m/sec. The velocity of conveying the pre-transformed material through the material conveyor channel may be between any of the afore-mentioned values (e.g., from about 1 cm/sec to about 100 m/sec, from about 1 cm/sec to about 30 cm/sec, from about 30 cm/sec to about 95 cm/sec, from about 1 m/sec to about 30 m/sec, or from about 30 m/sec to about 100 m/sec).

In some embodiments, the temperature of the pre-transformed material is altered and/or maintained before, after, and/or during at least a portion of the 3D printing. The material conveyed through the channel may be at a temperature below, above, or at ambient temperature. For example, the material in the bulk feed, separator, and/or pressure container may be cooled, heated, and/or maintained at a temperature. The bulk feed, separator, pressure container, and/or at least one component of the layer dispensing mechanism may be operatively coupled to a temperature alteration and/or maintenance source (e.g., heat transfer device, e.g., a cooling member). In some configurations, the channel (e.g., gas channel and/or material conveyor channel) may be coupled to the temperature alteration and/or maintenance source (e.g., comprising a thermostat). The temperature alteration and/or maintenance source may comprise a heat exchanger (e.g., active, or passive heat exchanger). The cooling member may comprise an energy conductive material. The cooling member may comprise an active energy transfer, or a passive energy transfer. The cooling member may comprise a cooling liquid (e.g., aqueous or oil), cooling gas or cooling solid. The cooling member may be further connected to a cooler or a thermostat. The gas or liquid comprising the cooling member may be stationary or circulating. The heat exchanger can circulate a cooling/heating fluid through a plumbing system. The plumbing system may comprise one or more channels (e.g., pipe, or coil). The cooling/heating fluid (e.g., coolant, or oil) can be configured to absorb/release heat from the heat exchanger through any one or combination of heat transfer mechanisms (e.g., conduction, natural convection, forced convection, and radiation).

In some examples, the pressure container comprises an outlet port. The outlet port may be operatively coupled to a surface (e.g., top, side, or bottom) of the container. The outlet port may comprise an opening. The outlet port may be coupled to the material conveyor channel. In some examples, the material port and the outlet port may be the same opening. The outlet port may be located adjacent to the material port (e.g., near a bottom surface of the container). The outlet port may facilitate removal (e.g., evacuation) of a portion pre-transformed material. In some examples, the outlet port may facilitate removal of gas and/or pressure from the container. A portion of the outlet port (e.g., the opening) may be controlled manually and/or automated. The outlet port may be in operation during, before, and/or after 3D printing (e.g., by using a valve). The outlet port may be in operation during, before, and/or after operation of the pre-transformed material conveyor system.

In some examples, the bulk feed is an external material source (e.g., comprising large quantity of pre-transformed material). For example, the quantity of material in the bulk feed may be larger than the quantity of material in the bulk reservoir, that is larger than the quantity of material in the material dispenser. For example, the bulk feed may contain pre-transformed material sufficient for to print tens, hundreds, or thousands of layers (e.g., an entire build), the bulk reservoir may contain material sufficient to print a plurality of layers (e.g., at most about 2, 3, 4, 6, 7, 8, 9, or 10 layers), and the material dispenser may comprise one or a few layers (e.g., at most 1, 2, or 3 layers). The bulk feed may comprise pre-transformed material sufficient to print at least about 10, 11, 15, 20, 50, 80, 100, 500, 1000, 5000, or 10000 layers. The bulk feed may be connected (e.g., operatively coupled to, and/or physically coupled) to one or more pressure container. The bulk feed may be located above, below or to the side of a pressure container. In some embodiments, the bulk feed is located below the bulk reservoir, and/or the material dispenser. The bulk feed may be under an ambient atmosphere. The bulk feed may be under oxygen depleted, humidity depleted, and/or inert atmosphere. Pre-transformed material can be stored in the bulk feed. Pre-transformed material from the bulk feed can travel to the pressure container via a conveyor mechanism (e.g., material conveyor channel). The material from the bulk feed may be inserted into the pressure container before, after, and/or during at least a portion of the 3D printing. The pre-transformed material from the bulk feed may be inserted into the pressure container before, after, and/or during operation of the pre-transformed material conveyor system. The pre-transformed material may be re-conditioned prior to its entry into the bulk feed. Re conditioning may comprise physical and/or chemical re-conditioning. For example, removal of oxide surface layer(s), and/or size sorting (e.g., sieving). Pre-transformed material from the recycling system and/or from at least one component of the layer dispensing mechanism (e.g., leveler and/or material remover) may enter the bulk feed. At least one component of the material conveying system is under oxygen depleted, humidity depleted, and/or inert atmosphere (e.g., during operation of the material conveyance system). In some examples, the (e.g., entire) material conveying system is under oxygen depleted, humidity depleted, and/or inert atmosphere (e.g., during operation of the material conveyance system).

In some examples, the pre-transformed material conveying system (also herein “material conveyance system”) comprises pneumatic conveyance of the pre-transformed material. The pre-transformed material may be conveyed from the pressure containers to the processing chamber. The conveying may include using dense phase conveying. In some examples, the dense phase conveying includes (i) inserting pre-transformed material into one or more pressure containers, (ii) inserting a (e.g., inert) gas, which gas comprises a pressure, which pressure forms a pressure gradient between the one or more containers and a target (e.g., an apparatus in the processing chamber), and (iii) as a result of the pressure gradient, the pre-transformed material from the pressure container to an apparatus in the processing chamber (e.g., material dispenser) is being conveyed across the pressure gradient. The pressure of gas (e.g., in the pressure container) can be at least about 5 pound-force per square inch (psi), 6 psi, 7 psi, 8 psi, 9 psi, 10 psi, 12 psi, 15 psi, 20 psi, 25 psi, 30 psi, 35 psi, 40 psi, 45 psi, 50 psi, 55 psi, 60 psi, 70 psi, 80 psi, 90 psi, or 100 psi. The pressure of gas (e.g., in the pressure container) can be between any of the afore-mentioned pressure values (e.g., from about 5 psi to about 100 psi, from about 5 psi to about 15 psi, from about 15 psi to about 25 psi, from about 25 psi to about 70 psi, or from about 70 psi to about 100 psi). The pressure in the processing chamber (e.g., in an apparatus in the processing chamber) may be ambient pressure.

In some embodiments, the conveyed pre-transformed material may be inserted into at least one (e.g., secondary) separator prior to being inserted to the bulk reservoir and/or material dispenser. The secondary separator may be a part of the processing chamber. The secondary separator may be operatively coupled to the processing chamber. The secondary separator may facilitate separation of the pre-transformed material from the (e.g., carrying) gas. The separator may recycle, sort and/or recondition the pre-transformed material. The conveyed pre-transformed material may be dispensed from a position above a platform (e.g., from the secondary separator) via at least one component of the layer dispenser (e.g., material dispenser), to form a material bed. In some examples, the pre-transformed material may be conveyed from the pressure containers to the bulk reservoir (e.g., a doser). The doser may be a part of the ancillary chamber. The doser may be a part of the processing chamber. In some examples, the doser may be operatively coupled to the ancillary chamber, the processing chamber, and/or at least one component of the layer dispensing mechanism. The doser may convey the pre-transformed material to the layer dispensing mechanism, e.g., via a channel (e.g., that fluidly couples the doser with the layer dispenser). The channel may be stationary or translating (e.g., during at least a portion of the 3D printing). Examples of this channel can be found in Patent Application Serial Number PCT/US17/57340 that is incorporated herein it its entirety. For example, this channel may be a perforation in a translatable plate, or be a lateral gap between two adjacent plates. Translation of this channel may facilitate closing and/or opening an exit opening of the doser, through which pre-transformed material flows to the material dispenser. Translation of this channel may facilitate closer and/or opening an entrance opening of the material dispenser, through which pre-transformed material flows from the doser. In some embodiments, the pre-transformed material flows from the pressure container to the material dispenser (e.g., without passing through one or more separators, and/or without passing through a bulk reservoir). In some embodiments, the material conveyance system excludes one or more separators, and/or a bulk reservoir. The layer dispensing mechanism may dispense the pre-transformed material above the platform to form the material bed. The conveyed pre-transformed material may be used for building at least a portion of the 3D object.

In some embodiments, conveying the pre-transformed material is done through the material conveying channel. Conveying may comprise forcing out (e.g., ejecting, extruding, thrusting, expelling, evicting, and/or throwing out) the material from the pressure container.

Conveying may comprise flow (e.g., at a low velocity) of the pre-transformed material. Low velocity may be a velocity value of at least about 1 cm (centimeter)/sec(second), 2 cm/sec, 3 cm/sec, 5 cm/sec, 6 cm/sec, 7 cm/sec, 8 cm/sec, 9 cm/sec, 10 cm/sec, 30 cm/sec, 40 cm/sec, 50 cm/sec, 75 cm/sec or 100 cm/sec. Low velocity may be of a velocity value that is between any of the afore-mentioned values (e.g., from about 1 cm/sec to about 100 cm/sec, from about 5 cm/sec to about 25 cm/sec, or from about 25 cm/sec to about 100 cm/sec). Conveying may comprise suction of the pre-transformed material into the material conveying channel. The processing chamber, the layer dispensing mechanism, the ancillary chamber, the bulk reservoir (e.g., doser), and/or the (e.g., secondary) separator may comprise an ambient atmosphere. In some instances (e.g., during operation of the powder conveyance system) the material conveying channel and/or the pressure containers may comprise an ambient atmosphere. At times, the processing chamber, the layer dispensing mechanism, the ancillary chamber, the doser, the secondary separator, the material conveying channel and/or the pressure containers comprise an inert atmosphere (e.g., during operation of the powder conveyance system). At least two of the processing chamber, the layer dispensing mechanism, the ancillary chamber, the doser, the secondary separator, the material conveying channel and/or the pressure containers may have the same atmosphere (e.g., during at least a portion of the operation of the powder conveyance system). At least two of the processing chamber, the layer dispensing mechanism, the ancillary chamber, the doser, the secondary separator, the material conveying channel and/or the pressure containers may have a different atmosphere (e.g., during at least a portion of the operation of the powder conveyance system). At least two of the processing chamber, the layer dispensing mechanism, the ancillary chamber, the doser, the secondary separator, the material conveying channel and/or the pressure containers may have the same pressure (e.g., during at least a portion of the operation of the powder conveyance system). At least two of the processing chamber, the layer dispensing mechanism, the ancillary chamber, the doser, the secondary separator, the material conveying channel and/or the pressure containers may have a different pressure (e.g., during at least a portion of the operation of the powder conveyance system).

In some examples, the pre-transformed material is inserted into the one or more pressure containers from an external material source (e.g., a bulk feed). In some examples, the pre-transformed material may be conveyed from the processing chamber, build module, and/or layer dispensing mechanism to the one or more pressure containers. The conveying may include using dilute phase conveying. In some examples, the dilute phase conveying includes (i) inserting pre-transformed material into the material conveying channel from a portion of the processing chamber, (ii) inserting a (e.g., inert) gas, which gas comprises a conveying velocity, which conveying velocity is high enough to suspend at least a portion of pre-transformed material, and (iii) conveying the suspended pre-transformed material from the portion of the processing chamber to a pressure container. The pre-transformed material may be suspended in the gas during conveyance (e.g., from the processing chamber to the separator and/or the pressure container). For example, the pre-transformed material may be suspended in the gas (e.g., in a dilute conveying phase) during conveyance from the processing chamber to the cyclonic separator. Conveying may comprise continuous conveying. Conveying may comprise flowing of the pre-transformed material into the material conveying channel. Conveying may comprise maintaining the conveying velocity within the material conveying channel. Conveying may include maintaining suspension of the pre-transformed material within the material conveying channel. In some examples, a centrifugal force (e.g., a blower, fan, or a vacuum) may be used (e.g., to maintain conveyance and/or suspension of the pre-transformed material in the material conveying channel). At least one gas may be blown to the material conveying channel (e.g., to maintain suspension and/or flow of the pre-transformed material in the material conveying channel). The inserted gas to the material conveying channel may comprise a pressure. The pressure may be lower than a pressure used for dense phase conveying (e.g., used to convey pre-transformed material from the pressure container to the material dispenser and/or bulk reservoir). An excess amount of pre-transformed material from a portion of the processing chamber (e.g., FIG. 2, 226) and/or ancillary chamber (e.g., 240) may be collected into an overflow container and/or a recycling mechanism. The excess amount of pre-transformed material may be optionally conveyed to at least one (e.g., a first) separator. The first separator (e.g., FIG. 3, 345) may be operatively coupled between the processing chamber (e.g., 325) and the one or more pressure containers (e.g., 330). The first separator may separate the pre-transformed material from gas. The first separator may separate, sort, and/or recondition the pre-transformed material. The first separator may convey the pre-transformed material to a pressure container. In some examples, the pre-transformed material may be conveyed directly into the pressure container from the portion of the processing chamber, the overflow container, and/or the recycling mechanism. Conveying directly may include conveying via the material conveying channel.

In some examples, the pre-transformed material conveying system maintains a continuous (e.g., uninterrupted, looped, stable, or steady) flow of material. The continuous flow of material facilitates uninterrupted availability of pre-transformed material when building a 3D object. Continuous flow may include (e.g., simultaneously) conveying (i) pre-transformed material from one or more pressure containers to a portion of the processing chamber and (ii) pre-transformed material from the processing chamber into the one or more pressure containers. Simultaneously conveying may include alternating between a dense phase conveying and a dilute phase conveying. In some embodiments, a single pressure container is used in the material conveyance system. Simultaneously conveying with a single pressure container may include (i) performing a dense phase conveying to convey pre-transformed material from a pressure container to a portion of the processing chamber, (ii) optionally inserting the pre-transformed material from the processing chamber, into a buffer container, and (iii) on completion of the dense phase conveyance to the processing chamber, performing a dilute phase conveyance to convey the pre-transformed material from the processing chamber (or from the optional buffer container) to the pressure container. Simultaneous conveying may include performing operation (i) and optional operation (ii) in parallel. In some examples, the layer dispensing mechanism may not be dispensing pre-transformed material during operation (i) and/or operation (ii). In some examples, the layer dispensing mechanism may be dispensing pre-transformed material during operation (ii) and/or operation (iii). Operation (iii) may be performed in parallel with dispensing of material from the layer dispensing mechanism. At least two of operation (i), operation (ii), and operation (iii) may be performed simultaneously during printing of the 3D object. At least two of operation (i), operation (ii), and operation (iii) may be performed simultaneously before and/or after printing the 3D object. Simultaneously conveying may comprise using one or more sensors. The one or more sensors may detect a state of the pre-transformed material conveying system (e.g., material quantity and/or level within the container, state of a valve within the system, presence of a component within the system, and/or conveying state of a material conveying channel). Simultaneously conveying may comprise using one or more valves. The valves may be any valves described herein. The valves may be used to control one or more operations of alternating conveying.

In some embodiments, maintaining (e.g., continuous) flow of pre-transformed material comprises alternating pre-transformed material conveying between multiple (e.g., two) pressure containers. The flow of pre-transformed material in the material conveying system may include (e.g., simultaneously) conveying (i) pre-transformed material from a first (e.g., set of) pressure container(s) to a portion of the processing chamber and (ii) pre-transformed material from the processing chamber into a second (e.g., set of) pressure container(s). The flow of pre-transformed material in the material conveying system may include (e.g., simultaneously) (i) evacuating pre-transformed material from a first (e.g., set of) pressure container(s) to a portion of the processing chamber and (ii) filling pre-transformed material from the processing chamber into a second (e.g., set of) pressure container(s). The flow of pre-transformed material in the material conveying system may be continuous or discontinuous. For example, the flow may be in packets of pre-transformed material. The continuity of the flow may be controlled and/or pre-determined. For example, the continuity of the flow may be altered during the 3D printing. The flow of pre-transformed material may allow continuous operation of the material dispenser. The flow may ensure that the powder dispenser does not wait for a supply of pre-transformed material to perform the material dispensing operation. The flow may ensure that the powder dispenser is not idle due to lack of pre-transformed material. Alternating conveyance may comprise (i) conveying pre-transformed material from a first pressure container into the portion of the processing chamber (e.g., doser), (ii) conveying pre-transformed material (e.g., excess amount of material) from the recycling mechanism and/or the portion of the processing chamber to a second pressure container, and (iii) alternatingly switch conveying from the first pressure container to the second pressure container and/or vice-versa (e.g., when the first pressure container and/or the second pressure container is depleted of pre-transformed material; and/or when the second pressure container and/or the first pressure container is filled with the pre-transformed material respectively). The alternating switch may be coupled to (e.g., coordinated with) the emptying of the first container and the filling of the second container. The alternating switch may be coupled to (e.g., coordinated with) the emptying of the second container and the filling of the first container. Conveying may include a dense phase conveying and/or a dilute phase conveying. For example, when performing operation (i), dense phase conveying may be performed. For example, when performing operation (ii) and/or operation (iii), dilute phase conveying may be performed. Operation (ii) may comprise filling up the second container with pre-transformed material. In some examples, the alternating conveying may additionally comprise (alternatively) filling the first and/or second pressure container with pre-transformed material from an external material source (e.g., a bulk feed). Filling from the external material source may be (e.g., controllably) performed before, during, and/or after at least one of operation (i), operation (ii) or operation (iii). The control may be manual and/or automatic (e.g., using a controller). The continuous flow of material into the portion of the processing chamber may be facilitated by alternatingly conveying from the first container and the second container. The first container may be refilled when the second container performs the conveying. The second container may be refilled when the first container performs conveying. Filling and/or refilling of the container may be during, before, and/or after the material conveying operation. Filling and/or refilling of the container may be during, before, and/or after at least a portion of 3D printing. Alternating conveying may comprise using one or more sensors. The one or more sensors may detect a state of the pre-transformed material conveying system (e.g., pressure within the pressure container, material quantity and/or level within the pressure container, state of a valve within the system (e.g., coupled to the pressure container), presence of a component within the system, and/or conveying state of a material conveying channel). The conveying state of a material conveying channel may comprise the (1) amount of material per unit time that is conveyed, (2) velocity of the material conveyed, density of the material conveyed, (3) pressure within the channel, (4) state of internal channel surface, or (5) a charge (e.g., electric, and/or magnetic) within the channel and/or internal channel surface. The alternating conveying operations may be manual and/or automated (e.g., controlled). Controlling may be using a processor. Controlling may include using one or more (e.g., controllable) valves. The valves may be any valves described herein.

In some embodiments, the material conveyance system comprises pneumatic conveyance. The conveyance system may convey pre-transformed material from a material source to a destination (e.g., target location). The conveyance may comprise conveying against gravity. The conveyance may comprise conveyance using one or more gasses. The gas may be pressurized. The conveyance may comprise conveying in the process of equilibrating a pressure gradient. The conveyance may comprise (e.g., artificially) forming a pressure gradient (e.g., between a position in the material conveyance system and the target destination). The position in the material conveyance system may comprise a pressurized container. The artificially induced pressure gradient comprises pressurizing a gas and/or reducing the pressure of a gas. The material conveyance system may transfer a pre-transformed material comprising powders, granules, or dry material. The material conveyance system may transfer a pre-transformed material comprising a liquid. The conveyance may be through conveying lines (e.g., channels). The channels may be vertical, horizontal, or at an angle with respect to the horizon. The material conveyance system may comprise a gas supplier and/or gas mover (e.g., gas pump, blower, or fan). The gas supplier and/or mover may be controlled (e.g., manually and/or automatically). The material conveyance system may environmentally exclude the pre-transformed material from the ambient environment (e.g., at least during the material conveying process). The material conveyance system may form an environment that is protected and/or excluded from the ambient environment (e.g., at least during the material conveying process). The material conveyance system may separate the pre-transformed material from the ambient environment (e.g., at least during the material conveying process). The material conveyance system may comprise mechanical conveyance (e.g., screw, chute, belt (e.g., magnetic belt), troughed, stepper, or bucket conveyor. The conveyor (e.g., channel) may vibrate (e.g., during the conveyance). The conveyor (e.g., channel) may be operatively coupled to one or more vibrators.

The material conveyance system may comprise dilute phase conveying or dense phase conveying. The conveying may comprise dense/dilute pressure conveying, or dense/dilute vacuum conveying. The dilute phase conveying (e.g., from the layer dispenser to the pressure container) may comprise pre-transformed material that is mostly (e.g., fully) suspended in the conveying gas. The dilute phase conveyance may include low pressure (as compared to the dense phase), small pressure gradient (as compared to the dense phase), low material density, and/or high velocity conveyance of the pre-transformed material through a channel (as compared to the dense phase). For example, the material density in the channel during the dilute phase conveying may be at most about 50 pounds per cubic feet (lb/ft³), 55 lb/ft³, 60 lb/ft³, 65 lb/ft³, 70 lb/ft³, or 75 lb/ft³. The material density in the channel may be any value within a range of the aforementioned values (e.g., at most about 50 lb/ft³ to about 75 lb/ft³, about 50 lb/ft³ to about 65 lb/ft³, or about 65 lb/ft³ to about 75 lb/ft³). The dense phase conveying may comprise pre-transformed material that is not suspended in the conveying gas, is transported at high pressure (as compared to the dilute phase), is transported along larger pressure gradient (as compared to the dilute phase), and/or low velocity conveyance (as compared to the dilute phase) through the material conveying channel. Material conveyed by this method is loaded into a pressure vessel (also called a blow pot or transporter), as shown in FIG. 1b. When the vessel is full, its material inlet valve and vent valve are closed and compressed air is metered into the vessel. The compressed air extrudes the material from the pressure vessel into the conveying line and to the destination. Once the vessel and conveying line are empty, the compressed air is turned off and the vessel is reloaded. This cycle continues until all of the materials required for the process have been transferred.

In some instances, resistance to the flow is formed in the material conveyance system. At times, the material conveyance channel comprises one or more gas inlets, through which gas is injected and/or removed to facilitate flow of the pre-transformed material to the target destination. The gas inlets may be gas boosters, or gas assists. The gas inlets along the channel may control (e.g., maintain) a material conveying velocity, and reduce plugging of the material conveyance channel. The gas inlets may facilitate removing pre-transformed material from the channel (e.g., after 3D printing), and/or maintenance of the material conveyance channel.

In some examples, the pre-transformed material conveyor system comprises one or more sensors. The sensors may be operatively coupled to one or more components of the pre-transformed material conveyor system. For example, the sensor may be coupled to at least one of a material conveying channel, the pressure containers, the processing chamber, the external material source, the separator (e.g., the first separator, the secondary separator), the bulk reservoir, the layer dispensing mechanism, the channel between the bulk reservoir and the layer dispensing mechanism, gas channel, and/or the buffer container. At least one sensor may be operatively coupled to at least one position between one or more components. At least one sensor may be disposed between one or more components. For example, a sensor may be coupled between a layer dispensing mechanism and a first separator. Examples of sensors include a level (guided, wave, and/or radar), pressure, flow, gas, pneumatic, physical, optical, and/or sound sensor.

In some examples, the pre-transformed material conveyor system comprises one or more valves (e.g., flow, pressure, stopper, and/or control valve). The valve may be operated manually and/or automated. The valves may be operatively coupled to one or more components of the pre-transformed material conveyor system. For example, the valve may be coupled to a material conveying channel, gas channel, pressure container, processing chamber, external material source (e.g., bulk feed), separator (e.g., first separator, and/or secondary separator), bulk reservoir, at least one component of the layer dispensing mechanism, channel between the bulk reservoir and the layer dispensing mechanism, buffer container, or any combination thereof. The valve may be operatively coupled to a position between one or more components. The valve may be disposed between one or more components. For example, a valve may be operatively coupled (e.g., physically coupled) between a pressure container and an external material source. Examples of valves include a pressure relief, pressure release, pressure safety, safety relief, pilot-operated relief, low pressure safety, vacuum pressure safety, low and vacuum pressure safety, pressure vacuum release, snap acting, pinch, metering, flapper, needle, check, control, solenoid, flow control, butterfly, ball, piston, plug, popping, rotary, manual, or modulating valve.

In some examples, the shaft is coupled to an actuator (e.g., FIG. 2, 252). The actuator may move the shaft. The actuator may move the shaft to convey the coupled layer dispensing mechanism adjacent to the build module. The actuator may move the shaft to retract the coupled layer dispensing mechanism into the ancillary chamber. Examples of an actuator include a linear motor, pneumatic motors, electric motors, solar motors, hydraulic motors, thermal motors, magnetic motors, or mechanical motors. The actuator may reside on a stage (e.g., FIG. 2, 258). The stage may be stationary. The stage may be movable (e.g., before, after, and/or during the 3D printing). The stage may comprise a rail system. The stage may allow smooth movement of the shaft. The shaft may be coupled to one or more bearings. The bearing may be a machine element that constrains relative motion to a requested motion. The bearing may be a machine element that reduces friction between moving components. For example, the bearing may allow a smooth movement of the shaft. The bearing may comprise elements that physically contact the shaft. For example, the bearing (e.g., ball bearing) may comprise balls that contact the shaft in one or more points. The bearing may not contact the shaft (e.g., gas bearing, or magnetic bearing). The bearings may facilitate a directional path for the shaft. The movable rear bearings may facilitate (e.g., a directional) movement of the shaft.

In some embodiments, the stage optionally comprises a stopper. The stopper may be a bearing, a valve, a plug, a pop-up stopper, a trip lever, or a plunger style stopper. The stopper may control the movable distance of the shaft (e.g., maximum, and/or minimum movement span).

In some embodiments, the ancillary chamber comprises a vibration mechanism. The vibration mechanism may include a motor. The motor may be any motor described herein. The motor may be a motor that exhibits linear motion. The motor exhibiting the linear motion may comprise a linear motor, a rotary motor (e.g., coupled to a conveyor or an escalator), an absolute encoder with motor, an incremental encoder with motor, or a stepper motor. The motor may comprise an electric motor, or a pneumatic motor. The motor may comprise an electro-mechanical motor. The vibration mechanism may include a mechanism that exhibits linear motion (e.g., a drive mechanism). Examples of vibration mechanisms, 3D printing systems, control systems, software, and related processes, can be found in International Patent Applications Serial no. PCT/US17/57340, which is entirely incorporated herein by reference.

In some embodiments, the vibration mechanism is operatively coupled to a first controller. In some embodiments, the layer dispensing mechanism may be operatively coupled to a second controller. At times, a component of the layer dispensing mechanism may be operatively coupled to a third controller. At times, the first controller, second controller and the third controller may be the same controller. At times, the first controller, second controller and the third controller may be different controllers. At times, at least two of the (i) vibration mechanism, (ii) shaft, and (iii) at least one component of the layer dispensing mechanism, may be controlled by the same controller. At times, at least two of the (i) vibration mechanism, (ii) shaft, and (iii) at least one component of the layer dispensing mechanism, may be controlled by a different controller. The controller may control the operation of one or more components of the layer dispensing mechanism. For example, the controller may turn on a component of the layer dispensing mechanism (e.g., the material dispensing mechanism), for example, when the ancillary chamber is open. The controller may control the operation of the vibration mechanism. For example, the vibration mechanism may be turned on when the material dispensing system may be in operation, or when the material levelling system may be in operation. In some embodiments, the vibration mechanism is turned off when the material removal system may be in operation.

In some embodiments, the actuator is coupled to at least one controller (herein collectively “controller”). The controller may be coupled to a sensor (e.g., positional, optical, weight). The controller may control the starting of the actuator. The controller may control the stopping of the actuator. The controller may detect a position of the layer dispensing mechanism. The controller may dynamically (e.g., in real-time during the 3D printing) control the actuator to adjust the position of the layer dispensing mechanism. The controller may control the amount of movable distance of the shaft (e.g., by controlling the actuator). The controller may detect the need to perform dispensing and/or planarization of a pre-transformed material. The controller may activate the actuator to move the shaft and the coupled layer dispensing mechanism to a position adjacent to the platform. The controller may detect the completion of dispensing a layer adjacent to the platform (e.g., comprising a base FIG. 1, 102 and a substrate FIG. 1, 109). The controller may activate the actuator to move the shaft to retract the layer dispensing mechanism into the ancillary chamber.

In some embodiments, the material dispensing mechanism is operatively coupled to one or more shafts. The one or more shaft channels may be operatively coupled (e.g., fluidly connected) to one or more material conveying channels within the pre-transformed material conveying system. For example, the pre-transformed material from one or more pressure containers may be conveyed into the layer dispensing mechanism via the one or more channels within the shaft. In some examples, the material conveying channel within the pre-transformed material and the channel within the shaft may be the same. In some examples, the material conveying channel within the pre-transformed material and the channel within the shaft may be different. The one or more shaft channels may be operatively coupled (e.g., fluidly connected) to one or more gas conveying channels within the pre-transformed material conveying system. For example, the gas from one or more components of the pre-transformed material conveyor system (e.g., separator, external gas source, and/or gas conveying channel) may be conveyed into the layer dispensing mechanism via the one or more channels within the shaft. In some examples, the gas conveying channel and the pre-transformed material conveying channel within the shaft may be the same. In some examples, the gas conveying channel and the channel conveying the pre-transformed material within the shaft may be different.

In some embodiments, the 3D printer comprises an ancillary chamber. FIG. 2 shows an example of an ancillary chamber 240 coupled to the processing chamber 226. In some embodiments, the layer dispensing mechanism (e.g., 234) is parked within the ancillary chamber, when the layer dispensing mechanism does not perform dispensing adjacent to a platform, which platform comprises a substrate 261 and a base 260. The layer dispensing mechanism may be conveyed to the processing chamber (e.g., FIG. 2, 226). When conveyed, the layer dispensing mechanism may move from a first position (e.g., a position within the ancillary chamber to a position adjacent to the build module). When conveyed, the one or more shafts may move from a first position (e.g., a position within the ancillary chamber) to a position adjacent to the processing chamber. When conveyed, the actuator may move from a first position (e.g., a position within the ancillary chamber) to a position adjacent to the build module. When conveyed, the layer dispensing mechanism may dispense a layer of pre-transformed material adjacent to the platform (e.g., FIG. 2, 204). The layer dispensing mechanism may park within the ancillary chamber. For example, the layer dispensing mechanism may part in the ancillary chamber when the layer dispensing mechanism is not performing a dispersion of a layer of pre-transformed material. For example, the layer dispensing mechanism may part in the ancillary chamber when the material dispenser does not dispense pre-transformed material. For example, the layer dispensing mechanism may part in the ancillary chamber when the leveling mechanism does not level (e.g., planarize) the material bed. For example, the layer dispensing mechanism may part in the ancillary chamber when the material removal mechanism does planarize the material bed. For example, the layer dispensing mechanism may part in the ancillary chamber when the material bed is exposed to an energy beam (e.g., FIG. 2, 201).

In some embodiments, the ancillary chamber (e.g., also referred to herein as “ancillary enclosure,” e.g., 254) is dimensioned to accommodate the layer dispensing mechanism (e.g., FIG. 2, 240). The ancillary chamber may be dimensioned to enclose the layer dispensing mechanism, one or more bearings and at least a portion of the one or more shafts (e.g., FIG. 2, 236). The layer dispensing mechanism may comprise at least one of a material dispensing mechanism (e.g., FIG. 1, 116), leveling mechanism (e.g., FIG. 1, 117), and a material removal mechanism (e.g., FIG. 1, 118). The ancillary chamber may be separated from the processing chamber through a closable opening that comprises a closure (e.g., a shield, door, or window). The opening may comprise a closure (e.g., FIG. 2, 256). The closure may relocate to allow the layer dispensing mechanism to travel from the ancillary chamber to a position adjacent to (e.g., above) the material bed. The closure may open to allow the atmosphere of the ancillary chamber and the processing chamber to merge. The closure may open to allow debris from the processing chamber to enter the ancillary chamber. The closure may be (e.g., physically, and/or operatively) coupled to the layer dispensing mechanism. The closure may be coupled via a mechanical connector, a controlled sensor, a magnetic connector, an electro-magnetic connector, or an electrical connector. The layer dispensing mechanism may push the closure open when conveyed adjacent to the material bed. The closure may slide, tilt, flap, roll, or be pushed to allow the layer dispensing mechanism to travel to and from the ancillary chamber. The closure may relocate to a position adjacent to the opening. Adjacent may be below, above, to the side, or distant from the opening. Distant from the opening may comprise in a position more distant from the ancillary chamber. The closure may at least partially (e.g., fully) open the opening (e.g., before, after, and/or during the 3D printing).

In some examples, the 3D printer comprises a layer dispensing mechanism. FIG. 2 shows an example of a layer dispensing mechanism (e.g., FIG. 2, 234) that can travel from a position in the ancillary chamber (e.g., FIG. 2, 240) to a position adjacent to the material bed (e.g., FIG. 2, 232). The separator (e.g., closure) may change its position to allow the movement of the layer dispensing mechanism to and/or from the ancillary chamber. The change of position may be by sliding, flapping, pushing, magnetic opening or rolling. For example, the separator may be a sliding, flapping, or rolling door. The separator may be operatively coupled to an actuator. The actuator may cause the separator to alter its position (e.g., as described herein). The actuator may cause the separator to slide, flap, or roll (e.g., in a direction). The direction may be up/down or sideways with respect to a prior position of the separator. The actuator may be controlled (e.g., by a controller and/or manually). Altering the position may be laterally, horizontally, or at an angle with respect to an exposed surface of the material bed and/or build platform. For example, the actuator may be controlled via at least one sensor (e.g., as disclosed herein). The sensor may comprise a position or motion sensor. The sensor may comprise an optical sensor. For example, the separator may be coupled to the layer dispensing mechanism. Coupling may be using mechanical, electrical, electro-magnetic, electrical, or magnetic connectors. The separator may slide, open or roll when pushed by the layer dispensing mechanism. The separator may slide, close or roll in place when the layer dispensing mechanism retracts into the ancillary chamber.

At times, the layer dispensing mechanism causes (e.g., directly, or indirectly) the closure to open and/or close the opening. Indirectly can be via at least one controller (e.g., comprising a sensor and/or actuator). Directly may comprise directly attached to the layer dispensing mechanism. FIG. 2 shows an example of an opening bordered by stoppers 267, which opening is closed by a shield type closure that is connected to the layer dispensing mechanism 234. In the example of FIG. 2, the layer dispensing opening causes the shield type closure to open the opening as the layer dispensing mechanism travels away from the ancillary chamber 240 toward a position adjacent to the platform (e.g., comprising the base 260). In the example of FIG. 2, the layer dispensing opening causes the shield type closure to close the opening as the layer dispensing mechanism travels into the ancillary chamber 240 (e.g., to park).

At times, a physical property (e.g., comprising velocity, speed, direction of movement, or acceleration) of one or more components of the layer dispensing mechanism is controlled. Controlling may include using at least one controller. Controlling may include modulation of the physical property (e.g., within a predetermined time frame). Controlling may include modulation of the physical property within a translation cycle of the layer dispensing mechanism. The translation cycle may comprise moving from one side of the material bed to the opposing side. The translation cycle may comprise moving from one side of the material bed to the opposing side, and back to the one side. At times, one or more components (e.g., the material dispensing mechanism, the material leveling mechanism, and/or the material removal mechanism) of the layer dispensing mechanism may be controlled to operate at a (e.g., substantially) constant velocity (e.g., throughout the translation cycle, throughout a material dispensing cycle, throughout a material leveling cycle and/or throughout a material removal cycle). At times, one or more components may be controlled to operate at a variable velocity. At times, one or more components may be controlled to operate at variable velocity within a portion of time of the translation cycle. At times, the velocity of one or more components of the layer dispensing mechanism, within a first-time portion of the translation cycle and a second time portion of the translation cycle may be same. At times, the velocity of one or more components of the layer dispensing mechanism, within a first-time portion of the translation cycle and a second time portion of the translation cycle may be different. At times, within the translation cycle, the velocity of one or more components of the layer dispensing mechanism at a first position may be different than the velocity of the one or more components at a second position. At times, within the translation cycle, the velocity of one or more components of the layer dispensing mechanism at a first position may be the same as the velocity of the one or more components at a second position. At times, a component of the layer dispensing mechanism may be individually controlled. At times, at least two or more components of the layer dispensing mechanism may be collectively controlled. At times, at least two components of the layer dispensing mechanism may be controlled by the same controller. At times, at least two components of the layer dispensing mechanism may be controlled by a different controller.

In some configurations, the 3D printer comprises a bulk reservoir (e.g., FIG. 3, 310) (e.g., a tank, a pool, a tub, or a basin). The bulk reservoir may comprise pre-transformed material. The bulk reservoir may comprise a mechanism configured to deliver the pre-transformed material from the bulk reservoir to at least one component of the layer dispensing mechanism (e.g., material dispenser). The bulk reservoir can be connected or disconnected from the layer dispensing mechanism (e.g., from the material dispenser). The disconnected pre-transformed material dispenser can be located above, below or to the side of the material bed. The disconnected pre-transformed material dispenser can be located above the material bed, for example above the material entrance opening to the material dispenser within the layer dispensing mechanism. Above may be in a position away from the gravitational center.

The bulk reservoir may be connected to the material dispensing mechanism (e.g., FIG. 3, 310) that is a component of the layer dispensing mechanism. The bulk reservoir may be located above, below or to the side of the layer dispensing mechanism. The bulk reservoir may be connected to the material dispensing mechanism via a channel (e.g., FIG. 3, 315) The layer dispensing mechanism and/or the bulk reservoir have at least one opening port (e.g., for the pre-transformed material to move to and/or from). Pre-transformed material can be stored in the bulk reservoir. The bulk reservoir may hold at least an amount of material sufficient for one layer, or sufficient to build the entire 3D object. The bulk reservoir may hold at least about 200 grams (gr), 400 gr, 500 gr, 600 gr, 800 gr, 1 Kilogram (Kg), or 1.5 Kg of pre-transformed material. The bulk reservoir may hold at most 200 gr, 400 gr, 500 gr, 600 gr, 800 gr, 1 Kg, or 1.5 Kg of pre-transformed material. The bulk reservoir may hold an amount of material between any of the afore-mentioned amounts of bulk reservoir material (e.g., from about 200 gr to about 1.5 Kg, from about 200 gr to about 800 gr, or from about 700 gr to about 1.5 kg). Material from the bulk reservoir can travel to the layer dispensing mechanism via a force. The force can be natural (e.g., gravity), or artificial (e.g., using an actuator such as, for example, a pump). The force may comprise friction. Examples of bulk reservoirs, 3D printing systems, control systems, software, and related processes, can be found in International Patent Applications Serial no. PCT/US15/36802 that is incorporated herein by reference in its entirety.

In some embodiments, the pre-transformed material dispenser (e.g., FIG. 3, 305) resides within the layer dispensing mechanism. The pre-transformed material dispenser may hold at least an amount of powder material sufficient for at least one, two, three, four or five layers. The pre-transformed material dispenser (e.g., an internal reservoir) may hold at least an amount of material sufficient for at most one, two, three, four or five layers. The pre-transformed material dispenser may hold an amount of material between any of the afore-mentioned amounts of material (e.g., sufficient to a number of layers from about one layer to about five layers). The pre-transformed material dispenser may hold at least about 20 grams (gr), 40 gr, 50 gr, 60 gr, 80 gr, 100 gr, 200 gr, 400 gr, 500 gr, or 600 gr of pre-transformed material. The pre-transformed material may hold at most about 20 gr, 40 gr, 50 gr, 60 gr, 80 gr, 100 gr, 200 gr, 400 gr, 500 gr, or 600 gr of pre-transformed material. The pre-transformed material dispenser may hold an amount of material between any of the afore-mentioned amounts of pre-transformed material dispenser reservoir material (e.g., from about 20 gr to about 600 gr, from about 20 gr to about 300 gr, or from about 200 gr to about 600 gr.). Pre-transformed material may be transferred from the bulk reservoir to the material dispenser by any analogous method described herein for exiting of pre-transformed material from the material dispenser. At times, the exit opening ports (e.g., holes) in the bulk reservoir exit opening may have a larger FLS relative to those of the pre-transformed material dispenser exit opening port. For example, the bulk reservoir may comprise an exit opening comprising a mesh or a surface comprising at least one hole. The mesh (or a surface comprising at least one hole) may comprise a hole with a fundamental length scale of at least about 0.25 mm, 0.5 mm. 1 mm, 2 mm, 3 mm, 4 mm, 5 mm, 6 mm, 7 mm, 8 mm, 9 mm or 1 centimeter. The mesh (or a surface comprising at least one hole) may comprise a hole with a fundamental length scale of at most about 0.25 mm, 0.5 mm. 1 mm, 2 mm, 3 mm, 4 mm, 5 mm, 6 mm, 7 mm, 8 mm, 9 mm or 1 centimeter. The mesh (or a surface comprising at least one hole) may comprise a hole with a fundamental length scale of any value between the afore-mentioned values (e.g., from about 0.25 mm to about 1 cm, from about 0.25 mm to about 5 mm, or from about 5 mm to about 1 cm). The bulk reservoir may comprise a plane that may have at least one edge that is translatable into or out of the bulk reservoir. The bulk reservoir may comprise a plane that may pivot into or out of the bulk reservoir (e.g., a flap door). Such translation may create an opening, which may allow pre-transformed material in the reservoir to flow out of the reservoir (e.g., using gravity).

At times, a controller is operatively coupled to the bulk reservoir. The controller may control the time (e.g., time period, duration, and/or an indication/signal received from a sensor) for filling the bulk reservoir. The controller may control the amount of pre-transformed material released from the bulk reservoir by controlling, for example, the amount of time the conditions for allowing pre-transformed material to exit the bulk reservoir are in effect. In some examples, the pre-transformed material dispenser dispenses an excess amount of powder that is retained within the pre-transformed material dispenser reservoir, prior to the loading of pre-transformed material from the bulk reservoir to the pre-transformed material dispenser reservoir. In some examples, the pre-transformed material dispenser does not dispense of any excess amount of pre-transformed material that is retained within the pre-transformed material dispenser reservoir, prior to loading of pre-transformed material from the bulk reservoir to the pre-transformed material dispenser reservoir. Pre-transformed material may be transferred from the bulk reservoir to the pre-transformed material dispenser using a scooping mechanism that scoops pre-transformed material from the bulk reservoir and transfers it to the pre-transformed material dispenser. The scooping mechanism may scoop a fixed or predetermined amount of material. The scooped amount may be adjustable. The scooping mechanism may pivot (e.g., rotate) in the direction perpendicular to the scooping direction. The bulk reservoir may be exchangeable, removable, non-removable, or non-exchangeable. The bulk reservoir may comprise exchangeable components. The layer dispensing mechanism and/or any of its components may be exchangeable, removable, non-removable, or non-exchangeable. The powder dispensing mechanism may comprise exchangeable components.

At times, the pre-transformed material in the bulk reservoir or in the material dispensing mechanism is preheated, cooled, is at an ambient temperature or maintained at a predetermined temperature. A leveling mechanism (e.g., FIG., 1, 117, comprising a rake, roll, brush, spatula, or blade) can be synchronized with the material dispensing mechanism to deliver and planarize the pre-transformed material to form the material bed. The leveling mechanism can planarize (e.g., level), distribute and/or spread the pre-transformed material on the platform (as the pre-transformed material is dispensed by the material dispensing mechanism). The leveling mechanism may push an excess of pre-transformed material and/or other debris to the ancillary chamber. The pre-transformed material and/or other debris that resides in the ancillary chamber may be evacuated via a closable opening port. The evacuation may be active (e.g., using an actuator activating a pump, scooper, blade, squeegee, brush, or broom). The evacuation may be passive (e.g., using gravitational force). For example, the floor of the ancillary chamber may be tilted towards the opening. The tilted floor may allow any pre-transformed material and/or other debris to slide towards the opening with or without any additional energy (e.g., a suction device, or any other energy activated device).

At times, the bulk reservoir is stationary. The bulk reservoir may be located at least partially within the ancillary chamber. The bulk reservoir may be located at least partially outside of the ancillary chamber. The bulk reservoir may be located at a position adjacent to (e.g., above) the layer dispensing mechanism, when the layer dispensing mechanism resides (e.g., parks) within the ancillary chamber. The bulk reservoir may be located at least partially within the processing chamber. The bulk reservoir may be located at least partially outside of the processing chamber. The bulk reservoir may comprise a top surface and a bottom surface. Bottom may be in a direction towards the gravitational center and/or the platform. Tom may be in a direction opposite to the gravitational center and/or the platform. The top surface may have an entrance opening. The entrance opening may include a closure. The closure may be coupled to the top surface. The bulk reservoir may have a volume that is greater than the volume of the material dispensing mechanism within the layer dispensing mechanism. The bulk reservoir may be filled with pre-transformed material from the entrance opening. The bulk reservoir may be filled during, after or before 3D printing. At times, the bulk reservoir may be refilled during, after, or before a layer deposition cycle (e.g., after a plurality of translation cycles). At times, the entrance opening may be on a side surface of the reservoir. At times, the bulk reservoir may be operatively coupled to at least one sensor. The sensor may indicate the amount of material within the bulk reservoir. The sensor may be a positional sensor. The sensor may sense a position of the material dispenser (e.g., in the ancillary chamber). The sensor may sense an engagement of the material dispenser with the bulk reservoir. The bottom surface of the bulk reservoir may be optionally coupled (e.g., operatively, and/or physically) to a channel (e.g., FIG. 3, 315). Coupled may comprise fluidly (e.g., flowabley) connected. The bottom surface may be optionally coupled to a plate (e.g., a flat surface). In some examples, the bottom surface may be coupled to more than one plates. The plate may facilitate a flow of pre-transformed material from the bulk reservoir to the material dispensing mechanism. The plate(s) may be translatable. The plate(s) may translate in a lateral direction (e.g., along the X-axis). The plate(s) may be located at a position between a bottom surface of the bulk reservoir and a top surface of the material dispensing mechanism. The plurality of plates may translate simultaneously. The movement of the plurality of plates may be synchronized. The plurality of plates may translate independently. The movement of the one or more plates may be controlled (e.g., manually and/or by a controller). At times, the plate may facilitate the closure of the bottom surface of the bulk reservoir. At times, the plate may facilitate the closure of the top surface of the material dispensing mechanism. At times, the plate may simultaneously facilitate the closure of the top surface of the material dispensing mechanism and the bottom surface of the bulk reservoir.

In some embodiments, the plate comprises a perforation. The perforation may be a lateral (e.g., horizontal) gap between two or more plates. The perforation may be an aperture within a single plate. The perforation may form a channel between the bulk reservoir and the material dispensing mechanism. Examples of perforations, channels, 3D printing systems, control systems, software, and related processes, can be found in International Patent Applications Serial no. PCT/US17/57340, which is entirely incorporated herein by reference.

At times, the layer dispensing mechanism is parked in the ancillary chamber. The layer dispensing mechanism may comprise a material removal mechanism that may include pre-transformed material (e.g., powder) and/or other debris (e.g., soot, or other debris), collectively termed herein as “debris.” The debris may be dispersed on the floor of the ancillary chamber when the layer dispensing mechanism may be parked in the ancillary chamber. The floor of the ancillary chamber may be coupled to a recycling system. The floor of the ancillary chamber may be optionally coupled to the recycling system via a vacuum. The floor of the ancillary chamber may be optionally coupled to a reconditioning system. The recycling and/or reconditioning system may comprise a sieve. The recycling system may comprise a reservoir that holds the recycled material. The recycled material may be reconditioned (e.g., having reduced reactive species such as oxygen, or water). The recycled material may be sieved through the sieving system. In some examples, material may not be reconditioned. The material may be sucked by a vacuum (e.g., from the floor of the ancillary chamber). The floor of the ancillary chamber may be tilted. The floor of the ancillary chamber may be sloped at an angle. The floor of the ancillary chamber may be built to assist removal of the material by way of gravity. The debris on the floor of the ancillary chamber may be transported away from the ancillary chamber (e.g., into the recycling system). Transportation may be via the opening port. Transportation may be via a pipe, hole, channel, or a conveyor system.

At times, the layer dispensing mechanism is disposed within the ancillary chamber (e.g., when it does not perform an operation adjacent to the build platform and/or that affects the build module). The layer dispensing mechanism may slide in and out of the side chamber through a position which the separator previously occupied. The separator may be actuated by at least one sensor and/or controller.

In some embodiments, when there is a need to perform dispensing and/or leveling adjacent to the build platform (e.g., material dispensing to the material bed, and/or leveling of the material bed), the layer dispensing mechanism slides out of the side chamber (e.g., FIG. 2, 240) via a sliding mechanism. The side chamber may be referred to herein as an ancillary chamber. Examples of sliding mechanisms, 3D printing systems, control systems, software, and related processes, can be found in International Patent Applications Serial no. PCT/US17/57340, which is entirely incorporated herein by reference.

The systems and/or apparatuses disclosed herein may comprise one or more motors. The motors may comprise servomotors. The servomotors may comprise actuated linear lead screw drive motors. The motors may comprise belt drive motors. The motors may comprise stepper motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

At times, the ancillary chamber comprises one or more bearings. The bearings may allow smooth movement of the shaft. Examples of bearings, 3D printing systems, control systems, software, and related processes, can be found in International Patent Applications Serial no. PCT/US17/57340, which is entirely incorporated herein by reference.

At times, the platform (also herein, “printing platform” or “building platform”) is disposed in the enclosure (e.g., in the build module and/or processing chamber). The platform may comprise a substrate or a base. The substrate and/or the base may be removable or non-removable. The building platform may be (e.g., substantially) horizontal, (e.g., substantially) planar, or non-planar. The platform may have a surface that points towards the deposited pre-transformed material (e.g., powder material), which at times may point towards the top of the enclosure (e.g., away from the center of gravity). The platform may have a surface that points away from the deposited pre-transformed material (e.g., towards the center of gravity), which at times may point towards the bottom of the container. The platform may have a surface that is (e.g., substantially) flat and/or planar. The platform may have a surface that is not flat and/or not planar. The platform may have a surface that comprises protrusions or indentations. The platform may have a surface that comprises embossing. The platform may have a surface that comprises supporting features (e.g., auxiliary support). The platform may have a surface that comprises a mold. The platform may have a surface that comprises a wave formation. The surface may point towards the layer of pre-transformed material within the material bed. The wave may have an amplitude (e.g., vertical amplitude or at an angle). The platform (e.g., base) may comprise a mesh through which the pre-transformed material (e.g., the remainder) is able to flow through. The platform may comprise a motor. The platform (e.g., substrate and/or base) may be fastened to the container. The platform (or any of its components) may be transportable. The transportation of the platform may be controlled and/or regulated by a controller (e.g., control system). The platform may be transportable horizontally, vertically, or at an angle (e.g., planar or compound).

At times, the platform is vertically transferable, for example using an actuator. The actuator may cause a vertical translation (e.g., an elevator). An actuator causing a vertical translation (e.g., an elevation mechanism) is shown as an example in FIG. 1, 105. The up and down arrow next to the elevation mechanism 105 signifies a possible direction of movement of the elevation mechanism, or a possible direction of movement effectuated by the elevation mechanism.

In some cases, auxiliary support(s) adheres to the upper surface of the platform. In some examples, the auxiliary supports of the printed 3D object may touch the platform (e.g., the bottom of the enclosure, the substrate, or the base). Sometimes, the auxiliary support may adhere to the platform. In some embodiments, the auxiliary supports are an integral part of the platform. At times, auxiliary support(s) of the printed 3D object, do not touch the platform. In any of the methods described herein, the printed 3D object may be supported only by the pre-transformed material within the material bed (e.g., powder bed, FIG. 1, 104). Any auxiliary support(s) of the printed 3D object, if present, may be suspended adjacent to the platform. Occasionally, the platform may have a pre-hardened (e.g., pre-solidified) amount of material. Such pre-solidified material may provide support to the printed 3D object. At times, the platform may provide adherence to the material. At times, the platform does not provide adherence to the material. The platform may comprise elemental metal, metal alloy, elemental carbon, or ceramic. The platform may comprise a composite material (e.g., as disclosed herein). The platform may comprise glass, stone, zeolite, or a polymeric material. The polymeric material may include a hydrocarbon or fluorocarbon. The platform (e.g., base) may include Teflon. The platform may include compartments for printing small objects. Small may be relative to the size of the enclosure. The compartments may form a smaller compartment within the enclosure, which may accommodate a layer of pre-transformed material.

At times, the energy beam projects energy to the material bed. The apparatuses, systems, and/or methods described herein can comprise at least one energy beam. In some cases, the apparatuses, systems, and/or methods described can comprise two, three, four, five, or more energy beams. The energy beam may include radiation comprising electromagnetic, electron, positron, proton, plasma, or ionic radiation. The electromagnetic beam may comprise microwave, infrared, ultraviolet, or visible radiation. The ion beam may include a cation or an anion. The electromagnetic beam may comprise a laser beam. The energy beam may derive from a laser source. The energy source may be a laser source. The laser may comprise a fiber laser, a solid-state laser, or a diode laser. The laser source may comprise a Nd: YAG, Neodymium (e.g., neodymium-glass), or an Ytterbium laser. The laser may comprise a carbon dioxide laser (CO₂ laser). The laser may be a fiber laser. The laser may be a solid-state laser. The laser can be a diode laser. The energy source may comprise a diode array. Examples of energy beams, 3D printing systems, control systems, software, and related processes, can be found in International Patent Applications Serial no. PCT/US15/36802, which is entirely incorporated herein by reference.

At times, the energy beam (e.g., transforming energy beam) comprises a Gaussian energy beam. The energy beam may have any cross-sectional shape comprising an ellipse (e.g., circle), or a polygon (e.g., as disclosed herein). The energy beam may have a cross section with a FLS (e.g., diameter) of at least about 50 micrometers (μm), 100 μm, 150 μm, 200 μm, or 250 μm. The energy beam may have a cross section with a FLS of at most about 60 micrometers (μm), 100 μm, 150 μm, 200 μm, or 250 μm. The energy beam may have a cross section with a FLS of any value between the afore-mentioned values (e.g., from about 50 μm to about 250 μm, from about 50 μm to about 150 μm, or from about 150 μm to about 250 μm). The power per unit area of the energy beam may be at least about 100 Watt per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the tiling energy flux may be at most about 110 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the energy beam may be any value between the afore-mentioned values (e.g., from about 100 W/mm² to about 3000 W/mm², from about 100 W/mm² to about 5000 W/mm², from about 100 W/mm² to about 10000 W/mm², from about 100 W/mm² to about 500 W/mm², from about 1000 W/mm² to about 3000 W/mm², from about 1000 W/mm² to about 3000 W/mm², or from about 500 W/mm² to about 1000 W/mm²). The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the energy beam may any value between the afore-mentioned values (e.g., from about 50 mm/sec to about 50000 mm/sec, from about 50 mm/sec to about 3000 mm/sec, or from about 2000 mm/sec to about 50000 mm/sec). The energy beam may be continuous or non-continuous (e.g., pulsing). The energy beam may be modulated before and/or during the formation of a transformed material as part of the 3D object. The energy beam may be modulated before and/or during the 3D printing process.

In some embodiments, the energy source (e.g., laser) has a power of at least about 10 Watt (W), 30 W, 50 W, 80 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy source may have a power of at most about 10 W, 30 W, 50 W, 80 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy source may have a power between any of the afore-mentioned energy beam power values (e.g., from about 10 W to about 100 W, from about 100 W to about 1000 W, or from about 1000 W to about 4000 W). The energy beam may derive from an electron gun. The energy beam may include a pulsed energy beam, a continuous wave energy beam, or a quasi-continuous wave energy beam. The pulse energy beam may have a repetition frequency of at least about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHZ, 3 MHz, 4 MHZ, or 5 MHz. The pulse energy beam may have a repetition frequency of at most about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHZ, 3 MHz, 4 MHZ, or 5 MHz. The pulse energy beam may have a repetition frequency between any of the afore-mentioned repetition frequencies (e.g., from about 1 KHz to about 5 MHz, from about 1 KHz to about 1 MHZ, or from about 1 MHz to about 5 MHz).

In some embodiments, the methods, apparatuses and/or systems disclosed herein comprise Q-switching, mode coupling or mode locking to effectuate the pulsing energy beam. The apparatus or systems disclosed herein may comprise an on/off switch, a modulator, or a chopper to effectuate the pulsing energy beam. The on/off switch can be manually or automatically controlled. The switch may be controlled by the control system. The switch may alter the “pumping power” of the energy beam. The energy beam may be at times focused, non-focused, or defocused. In some instances, the defocus is substantially zero (e.g., the beam is non-focused).

In some embodiments, the energy source(s) projects energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

In some embodiments, the energy beam(s), energy source(s), and/or the platform of the energy beam array are moved via a galvanometer scanner, a polygon, a mechanical stage (e.g., X-Y stage), a piezoelectric device, gimbal, or any combination of thereof. The galvanometer may comprise a mirror. The galvanometer scanner may comprise a two-axis galvanometer scanner. The scanner may comprise a modulator (e.g., as described herein). The scanner may comprise a polygonal mirror. The scanner can be the same scanner for two or more energy sources and/or beams. At least two (e.g., each) energy source and/or beam may have a separate scanner. The energy sources can be translated independently of each other. In some cases, at least two energy sources and/or beams can be translated at different rates, and/or along different paths. For example, the movement of a first energy source may be faster as compared to the movement of a second energy source. The systems and/or apparatuses disclosed herein may comprise one or more shutters (e.g., safety shutters), on/off switches, or apertures.

In some embodiments, the energy beam (e.g., laser) has a FLS (e.g., a diameter) of its footprint on the on the exposed surface of the material bed of at least about 1 micrometer (μm), 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the layer of its footprint on the exposed surface of the material bed of at most about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the exposed surface of the material bed between any of the afore-mentioned energy beam FLS values (e.g., from about 5 μm to about 500 μm, from about 5 μm to about 50 μm, or from about 50 μm to about 500 μm). The beam may be a focused beam. The beam may be a dispersed beam. The beam may be an aligned beam. The apparatus and/or systems described herein may further comprise a focusing coil, a deflection coil, or an energy beam power supply. The defocused energy beam may have a FLS of at least about 1 mm, 5 mm, 10 mm, 20 mm, 30 mm, 40 mm, 50 mm, or 100 mm. The defocused energy beam may have a FLS of at most about 1 mm, 5 mm, 10 mm, 20 mm, 30 mm, 40 mm, 50 mm, or 100 mm. The energy beam may have a defocused cross-sectional FLS on the layer of pre-transformed material between any of the afore-mentioned energy beam FLS values (e.g., from about 5 mm to about 100 mm, from about 5 mm to about 50 mm, or from about 50 mm to about 100 mm).

The power supply to any of the components described herein can be supplied by a grid, generator, local, or any combination thereof. The power supply can be from renewable or non-renewable sources. The renewable sources may comprise solar, wind, hydroelectric, or biofuel. The powder supply can comprise rechargeable batteries.

In some embodiments, the exposure time of the energy beam is at least 1 microsecond (μs), 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be most about 1 μs, 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be any value between the afore-mentioned exposure time values (e.g., from about 1 μs to about 1000 μs, from about 1 μs to about 200 μs, from about 1 μs to about 500 μs, from about 200 μs to about 500 μs, or from about 500 μs to about 1000 μs).

At times, the controller controls one or more characteristics of the energy beam (e.g., variable characteristics). The control of the energy beam may allow a low degree of material evaporation during the 3D printing process. For example, controlling one or more energy beam characteristics may (e.g., substantially) reduce the amount of spatter generated during the 3D printing process. The low degree of material evaporation may be measured in grams of evaporated material and compared to a Kilogram of hardened material formed as part of the 3D object. The low degree of material evaporation may be evaporation of at most about 0.25 grams (gr.), 0.5 gr, 1 gr, 2 gr, 5 gr, 10 gr, 15 gr, 20 gr, 30 gr, or 50 gr per every Kilogram of hardened material formed as part of the 3D object. The low degree of material evaporation per every Kilogram of hardened material formed as part of the 3D object may be any value between the afore-mentioned values (e.g., from about 0.25 gr to about 50 gr, from about 0.25 gr to about 30 gr, from about 0.25 gr to about 10 gr, from about 0.25 gr to about 5 gr, or from about 0.25 gr to about 2 gr).

In some embodiments, the methods, systems, and/or the apparatus described herein further comprise at least one energy source. In some cases, the system can comprise two, three, four, five, or more energy sources. An energy source can be a source configured to deliver energy to an area (e.g., a confined area). An energy source can deliver energy to the confined area through radiative heat transfer.

In some embodiments, the energy source supplies any of the energies described herein (e.g., energy beams). The energy source may deliver energy to a point or to an area. The energy source may include an electron gun source. The energy source may include a laser source. The energy source may comprise an array of lasers. In an example, a laser can provide light energy at a peak wavelength of at least about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength between the afore-mentioned peak wavelengths (e.g., from 100 nm to 2000 nm, from 100 nm to 1100 nm, or from 1000 nm to 2000 nm). The energy beam can be incident on the top surface of the material bed. The energy beam can be incident on, or be directed to, a specified area of the material bed over a specified time period. The energy beam can be substantially perpendicular to the top (e.g., exposed) surface of the material bed. The material bed can absorb the energy from the energy beam (e.g., incident energy beam) and, as a result, a localized region of the material in the material bed can increase in temperature. The increase in temperature may transform the material within the material bed. The increase in temperature may heat and transform the material within the material bed. In some embodiments, the increase in temperature may heat and not transform the material within the material bed. The increase in temperature may heat the material within the material bed.

In some embodiments, the energy beam and/or source is moveable such that it can translate relative to the material bed. The energy beam and/or source can be moved by a scanner. The movement of the energy beam and/or source can comprise utilization of a scanner.

In some embodiments, at one point in time, and/or (e.g., substantially) during the entire build of the 3D object: At least two of the energy beams and/or sources are translated independently of each other or in concert with each other. At least two of the multiplicity of energy beams can be translated independently of each other or in concert with each other. In some cases, at least two of the energy beams can be translated at different rates such that the movement of the one is faster compared to the movement of at least one other energy beam. In some cases, at least two of the energy sources can be translated at different rates such that the movement of the one energy source is faster compared to the movement of at least another energy source. In some cases, at least two of the energy sources (e.g., all of the energy sources) can be translated at different paths. In some cases, at least two of the energy sources can be translated at substantially identical paths. In some cases, at least two of the energy sources can follow one another in time and/or space. In some cases, at least two of the energy sources translate substantially parallel to each other in time and/or space. The power per unit area of at least two of the energy beams may be (e.g., substantially) identical. The power per unit area of at least one of the energy beams may be varied (e.g., during the formation of the 3D object). The power per unit area of at least one of the energy beams may be different. The power per unit area of at least one of the energy beams may be different. The power per unit area of one energy beam may be greater than the power per unit area of a second energy beam. The energy beams may have the same or different wavelengths. A first energy beam may have a wavelength that is smaller or larger than the wavelength of a second energy beam. The energy beams can derive from the same energy source. At least one of the energy beams can derive from different energy sources. The energy beams can derive from different energy sources. At least two of the energy beams may have the same power (e.g., at one point in time, and/or (e.g., substantially) during the entire build of the 3D object). At least one of the beams may have a different power (e.g., at one point in time, and/or substantially during the entire build of the 3D object). The beams may have different powers (e.g., at one point in time, and/or (e.g., substantially) during the entire build of the 3D object). At least two of the energy beams may travel at (e.g., substantially) the same velocity. At least one of the energy beams may travel at different velocities. The velocity of travel (e.g., speed) of at least two energy beams may be (e.g., substantially) constant. The velocity of travel of at least two energy beams may be varied (e.g., during the formation of the 3D object or a portion thereof). The travel may refer to a travel relative to (e.g., on) the exposed surface of the material bed (e.g., powder material). The travel may refer to a travel close to the exposed surface of the material bed. The travel may be within the material bed. The at least one energy beam and/or source may travel relative to the material bed.

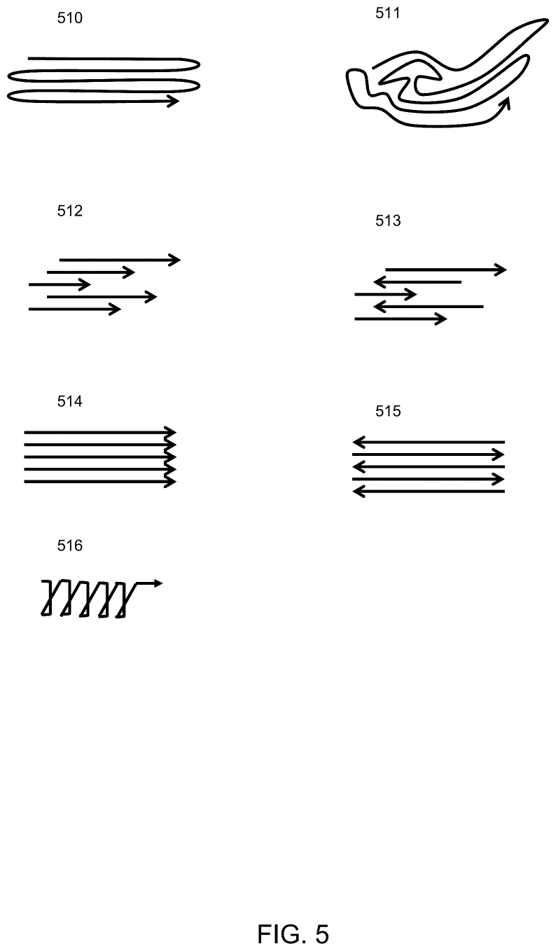

At times, the energy (e.g., energy beam) travels in a path. The path may comprise a hatch. The path of the energy beam may comprise repeating a path. For example, the first energy may repeat its own path. The second energy may repeat its own path, or the path of the first energy. The repetition may comprise a repetition of 1, 2, 3, 4, 5, 6, 7, 8, 9, 10 times or more. The energy may follow a path comprising parallel lines. For example, FIG. 5, 515 or 514 show paths that comprise parallel lines. The lines may be hatch lines. The distance between each of the parallel lines or hatch lines, may be at least about 1 μm, 5 μm, 10 μm, 20 μm, 30 μm, 40 μm, 50 μm, 60 μm, 70 μm, 80 μm, 90 μm, or more. The distance between each of the parallel lines or hatch lines, may be at most about 1 μm, 5 μm, 10 μm, 20 μm, 30 μm, 40 μm, 50 μm, 60 μm, 70 μm, 80 μm, 90 μm, or less. The distance between each of the parallel lines or hatch lines may be any value between any of the afore-mentioned distance values (e.g., from about 1 μm to about 90 μm, from about 1 μm to about 50 μm, or from about 40 μm to about 90 μm). The distance between the parallel or parallel lines or hatch lines may be substantially the same in every layer (e.g., plane) of transformed material. The distance between the parallel lines or hatch lines in one layer (e.g., plane) of transformed material may be different than the distance between the parallel lines or hatch lines respectively in another layer (e.g., plane) of transformed material within the 3D object. The distance between the parallel lines or hatch lines portions within a layer (e.g., plane) of transformed material may be substantially constant. The distance between the parallel lines or hatch lines within a layer (e.g., plane) of transformed material may be varied. The distance between a first pair of parallel lines or hatch lines within a layer (e.g., plane) of transformed material may be different than the distance between a second pair of parallel lines or hatch lines within a layer (e.g., plane) of transformed material respectively. The first energy beam may follow a path comprising two hatch lines or paths that cross in at least one point. The hatch lines or paths may be straight or curved. The hatch lines or paths may be winding. FIG. 5, 510 or 511 show examples of winding paths. The first energy beam may follow a hatch line or path comprising a U-shaped turn (e.g., FIG. 5, 510). The first energy beam may follow a hatch line or path devoid of U-shaped turns (e.g., FIG. 512). The hatch line may have varied length (e.g., 512 or 513). The path may be overlapping (e.g., FIG. 5, 516) or non-overlapping. The path may comprise at least one overlap. The path may be substantially devoid of overlap (e.g., FIG. 5, 510).

In some embodiments, the formation of the 3D object includes transforming (e.g., fusing, binding, or connecting) the pre-transformed material (e.g., powder material) using an energy beam. The energy beam may be projected on to a particular area of the material bed, thus causing the pre-transformed material to transform. The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material.

In some embodiments, the methods described herein further comprises repeating the operations of material deposition and material transformation operations to produce a 3D object (or a portion thereof) by at least one 3D printing (e.g., additive manufacturing) method. For example, the methods described herein may further comprise repeating the operations of depositing a layer of pre-transformed material and transforming at least a portion of the pre-transformed material to connect to the previously formed 3D object portion (e.g., repeating the 3D printing cycle), thus forming at least a portion of a 3D object. The transforming operation may comprise utilizing an energy beam to transform the material. In some instances, the energy beam is utilized to transform at least a portion of the material bed (e.g., utilizing any of the methods described herein).

In some embodiments, the transforming energy is provided by an energy source. The transforming energy may comprise an energy beam. The energy source can produce an energy beam. The energy beam may include a radiation comprising electromagnetic, electron, positron, proton, plasma, or ionic radiation. The electromagnetic beam may comprise microwave, infrared, ultraviolet, or visible radiation. The ion beam may include a charged particle beam. The ion beam may include a cation, or an anion. The electromagnetic beam may comprise a laser beam. The laser may comprise a fiber, or a solid-state laser beam. The energy source may include a laser. The energy source may include an electron gun. The energy depletion may comprise heat depletion. The energy depletion may comprise cooling. The energy may comprise an energy flux (e.g., energy beam. E.g., radiated energy). The energy may comprise an energy beam. The energy may be the transforming energy. The energy may be a warming energy that is not able to transform the deposited pre-transformed material (e.g., in the material bed). The warming energy may be able to raise the temperature of the deposited pre-transformed material. The energy beam may comprise energy provided at a (e.g., substantially) constant or varied energy beam characteristics. The energy beam may comprise energy provided at (e.g., substantially) constant or varied energy beam characteristics, depending on the position of the generated hardened material within the 3D object. The varied energy beam characteristics may comprise energy flux, rate, intensity, wavelength, amplitude, power, cross-section, or time exerted for the energy process (e.g., transforming or heating). The energy beam cross-section may be the average (or mean) FLS of the cross section of the energy beam on the layer of material (e.g., powder). The FLS may be a diameter, a spherical equivalent diameter, a length, a height, a width, or diameter of a bounding circle. The FLS may be the larger of a length, a height, and a width of a 3D form. The FLS may be the larger of a length and a width of a substantially two-dimensional (2D) form (e.g., wire, or 3D surface).

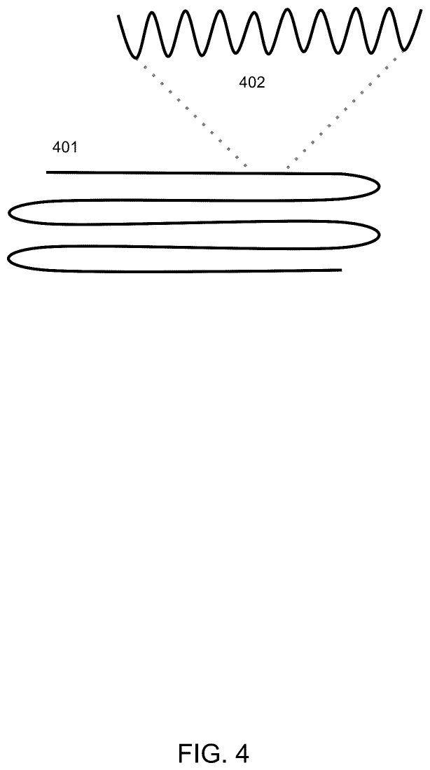

At times, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave. FIG. 4 shows an example of a path 401 of an energy beam comprising a zigzag sub-pattern (e.g., 402 shown as an expansion (e.g., blow-up) of a portion of the path 401). The sub-path of the energy beam may comprise a wave (e.g., sine or cosine wave) pattern. The sub-path may be a small path that forms the large path. The sub-path may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof.

At times, the path comprises successive lines. The successive lines may touch each other. The successive lines may overlap each other in at least one point. The successive lines may substantially overlap each other. The successive lines may be spaced by a first distance (e.g., hatch spacing). FIG. 5 shows an example of a path 514 that includes five hatches wherein each two immediately adjacent hatches are separated by a spacing distance. Examples of hatch spacings, 3D printing systems, control systems, software, and related processes, can be found in U.S. patent application Ser. No. 15/374,318, which is entirely incorporated herein by reference.

The term “auxiliary support,” as used herein, generally refers to at least one feature that is a part of a printed 3D object, but not part of the requested, intended, designed, ordered, and/or final 3D object. Auxiliary support may provide structural support during and/or after the formation of the 3D object. The auxiliary support may be anchored to the enclosure. For example, an auxiliary support may be anchored to the platform (e.g., building platform), to the side walls of the material bed, to a wall of the enclosure, to an object (e.g., stationary, or semi-stationary) within the enclosure, or any combination thereof. The auxiliary support may be the platform (e.g., the base, the substrate, or the bottom of the enclosure). The auxiliary support may enable the removal or energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, platform, or another stabilization feature. In some instances, the auxiliary support may be mounted, clamped, or situated on the platform. The auxiliary support can be anchored to the building platform, to the sides (e.g., walls) of the building platform, to the enclosure, to an object (stationary or semi-stationary) within the enclosure, or any combination thereof.

In some examples, the generated 3D object is printed without auxiliary support. In some examples, overhanging feature of the generated 3D object can be printed without (e.g., without any) auxiliary support. The generated object can be devoid of auxiliary supports. The generated object may be suspended (e.g., float anchorlessly) in the material bed (e.g., powder bed). The term “anchorlessly,” as used herein, generally refers to without or in the absence of an anchor. In some examples, an object is suspended in a powder bed anchorlessly without attachment to a support. For example, the object floats in the powder bed. The generated 3D object may be suspended in the layer of pre-transformed material (e.g., powder material). The pre-transformed material (e.g., powder material) can offer support to the printed 3D object (or the object during its generation). Sometimes, the generated 3D object may comprise one or more auxiliary supports. The auxiliary support may be suspended in the pre-transformed material (e.g., powder material). The auxiliary support may provide weights or stabilizers. The auxiliary support can be suspended in the material bed within the layer of pre-transformed material in which the 3D object (or a portion thereof) has been formed. The auxiliary support (e.g., one or more auxiliary supports) can be suspended in the pre-transformed material within a layer of pre-transformed material other than the one in which the 3D object (or a portion thereof) has been formed (e.g., a previously deposited layer of (e.g., powder) material). The auxiliary support may touch the platform. The auxiliary support may be suspended in the material bed (e.g., powder material) and not touch the platform. The auxiliary support may be anchored to the platform. The distance between any two auxiliary supports can be at least about 1 millimeter, 1.3 millimeters (mm), 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, or 45 mm. The distance between any two auxiliary supports can be at most 1 millimeter, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, or 45 mm. The distance between any two auxiliary supports can be any value in between the afore-mentioned distances (e.g., from about 1 mm to about 45 mm, from about 1 mm to about 11 mm, from about 2.2 mm to about 15 mm, or from about 10 mm to about 45 mm). At times, a sphere intersecting an exposed surface of the 3D object may be devoid of auxiliary support. The sphere may have a radius XY that is equal to the distance between any two auxiliary supports mentioned herein.

In some examples, the diminished number of auxiliary supports or lack of auxiliary support, facilitates a 3D printing process that requires a smaller amount of material, produces a smaller amount of material waste, and/or requires smaller energy as compared to commercially available 3D printing processes. The reduced number of auxiliary supports can be smaller by at least about 1.1, 1.3, 1.5, 2, 3, 4, 5, 6, 7, 8, 9, or 10 as compared to conventional 3D printing. The smaller amount may be smaller by any value between the aforesaid values (e.g., from about 1.1 to about 10, or from about 1.5 to about 5) as compared to conventional 3D printing.

In some embodiments, the generated 3D object has a surface roughness profile. The generated 3D object can have various surface roughness profiles, which may be suitable for various applications. The surface roughness may be the deviations in the direction of the normal vector of a real surface from its ideal form. The generated 3D object can have a Ra value of as disclosed herein.

At times, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, or 500 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, or 500 μm. The pores may be of an average FLS between any of the afore-mentioned FLS values (e.g., from about 1 nm to about 500 μm, or from about 20 μm, to about 300 μm). The 3D object (or at least a layer thereof) may have a porosity of at most about 0.05 percent (%), 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at a face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on a face of the generated 3D object. For example, pore may start on a face of the plane and not extend to the opposing face of that 3D object.

At times, the formed plane comprises a protrusion. The protrusion can be a grain, a bulge, a bump, a ridge, or an elevation. The generated 3D object may comprise protrusions. The protrusions may be of an average FLS of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The protrusions may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The protrusions may be of an average FLS between any of the afore-mentioned FLS values. The protrusions may constitute at most about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the generated 3D object. The protrusions may constitute at least about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the 3D object. The protrusions may constitute a percentage of an area of the 3D object that is between the afore-mentioned percentages of 3D object area. The protrusion may reside on any surface of the 3D object. For example, the protrusions may reside on an external surface of a 3D object. The protrusions may reside on an internal surface (e.g., a cavity) of a 3D object. At times, the average size of the protrusions and/or of the holes may determine the resolution of the printed (e.g., generated) 3D object. The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2%, 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

In some embodiments, a newly formed layer of material (e.g., comprising transformed material) reduces in volume during its hardening (e.g., by cooling). Such reduction in volume (e.g., shrinkage) may cause a deformation in the requested 3D object. The deformation may include cracks, and/or tears in the newly formed layer and/or in other (e.g., adjacent) layers. The deformation may include geometric deformation of the 3D object or at least a portion thereof. The newly formed layer can be a portion of a 3D object. The one or more layers that form the 3D printed object (e.g., sequentially) may be (e.g., substantially) parallel to the building platform. An angle may be formed between a layer of hardened material of the 3D printed object and the platform. The angle may be measured relative to the average layering plane of the layer of hardened material. The platform (e.g., building platform) may include the base, substrate, or bottom of the enclosure. The building platform may be a carrier plate.

In an aspect provided herein is a 3D object comprising a layer of hardened material generated by at least one 3D printing method described herein, wherein the layer of material (e.g., hardened) is different from a corresponding cross section of a model of the 3D object. For example, the generated layers differ from the proposed slices. The layer of material within a 3D object can be indicated by the microstructure of the material. Examples of material microstructures, 3D printing systems, control systems, software, and related processes, can be found in International Patent Application serial number PCT/US15/36802, which is entirely incorporated herein by reference.

Energy (e.g., heat) can be transferred from the material bed to the cooling member (e.g., heat sink) through any one or combination of heat transfer mechanisms. FIG. 1, 113 shows an example of a cooling member. The heat transfer mechanism may comprise conduction, radiation, or convection. The convection may comprise natural or forced convection. The cooling member can be solid, liquid, gas, or semi-solid. In some examples, the cooling member (e.g., heat sink) is solid. The cooling member may be located above, below, or to the side of the material layer. The cooling member may comprise an energy conductive material. The cooling member may comprise an active energy transfer or a passive energy transfer. The cooling member may comprise a cooling liquid (e.g., aqueous or oil), cooling gas, or cooling solid. The cooling member may be further connected to a cooler and/or a thermostat. The gas, semi-solid, or liquid comprised in the cooling member may be stationary or circulating. The cooling member may comprise a material that conducts heat efficiently. The heat (thermal) conductivity of the cooling member may be at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mk, 700 W/mK, 800 W/mK, 900 W/mK, or 1000 W/mK, The heat conductivity of the heat sink may be at most about 20 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The heat conductivity of the heat sink may be any value between the afore-mentioned heat conductivity values. The heat (thermal) conductivity of the cooling member may be measured at ambient temperature (e.g., room temperature) and/or pressure. For example, the heat conductivity may be measured at about 20° C. and a pressure of 1 atmosphere. The heat sink can be separated from the powder bed or powder layer by a gap. The gap can be filled with a gas. Examples of cooling members, 3D printing systems, control systems, software, and related processes, can be found in International Patent Application serial number PCT/US15/36802, and in U.S. patent application Ser. No. 15/435,065, each of which is entirely incorporated herein by reference.

When the energy source is in operation, the material bed can reach a certain (e.g., average) temperature. The average temperature of the material bed can be an ambient temperature or “room temperature.” The average temperature of the material bed can have an average temperature during the operation of the energy (e.g., beam). The average temperature of the material bed can be an average temperature during the formation of the transformed material, the formation of the hardened material, or the generation of the 3D object. The average temperature can be below or just below the transforming temperature of the material. Just below can refer to a temperature that is at most about 1° C., 2° C., 3° C., 4° C., 5° C., 6° C., 7° C., 8° C., 9° C., 10° C., 15° C., or 20° C. below the transforming temperature. The average temperature of the material bed (e.g., pre-transformed material) can be at most about 10° C. (degrees Celsius), 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 10° C., 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be any temperature between the afore-mentioned material average temperatures. The average temperature of the material bed (e.g., pre-transformed material) may refer to the average temperature during the 3D printing. The pre-transformed material can be the material within the material bed that has not been transformed and generated at least a portion of the 3D object (e.g., the remainder). The material bed can be heated or cooled before, during, or after forming the 3D object (e.g., hardened material). Bulk heaters can heat the material bed. The bulk heaters can be situated adjacent to (e.g., above, below, or to the side of) the material bed, or within a material dispensing system. For example, the material can be heated using radiators (e.g., quartz radiators, or infrared emitters). The material bed temperature can be substantially maintained at a predetermined value. The temperature of the material bed can be monitored. The material temperature can be controlled manually and/or by a control system.

In some embodiments, the pre-transformed material within the material bed is heated by a first energy source such that the heating will transform the pre-transformed material. The remainder of the material that did not transform to generate at least a portion of the 3D object (e.g., the remainder) can be heated by a second energy source. The remainder can be at an average temperature that is less than the liquefying temperature of the material (e.g., during the 3D printing). The maximum temperature of the transformed portion of the material bed and the average temperature of the remainder of the material bed can be different. The solidus temperature of the material can be a temperature wherein the material is in a solid state at a given pressure (e.g., ambient pressure). Ambient may refer to the surrounding. After the portion of the material bed is heated to the temperature that is at least a liquefying temperature of the material by the first energy source, that portion of the material may be cooled to allow the transformed (e.g., liquefied) material portion to harden (e.g., solidify). In some cases, the liquefying temperature can be at least about 100° C., 200° C., 300° C., 400° C., or 500° C., and the solidus temperature can be at most about 500° C., 400° C., 300° C., 200° C., or 100° C. For example, the liquefying temperature is at least about 300° C. and the solidus temperature is less than about 300° C. In another example, the liquefying temperature is at least about 400° C. and the solidus temperature is less than about 400° C. The liquefying temperature may be different from the solidus temperature. In some instances, the temperature of the pre-transformed material is maintained above the solidus temperature of the material and below its liquefying temperature. In some examples, the material from which the pre-transformed material is composed has a super cooling temperature (or super cooling temperature regime). In some examples, as the first energy source heats up the pre-transformed material to cause at least a portion of it to melt, the molten material will remain molten as the material bed is held at or above the material super cooling temperature of the material, but below its melting point. When two or more materials make up the material layer at a specific ratio, the materials may form a eutectic material on transformation of the material. The liquefying temperature of the formed eutectic material may be the temperature at the eutectic point, close to the eutectic point, or far from the eutectic point. Close to the eutectic point may designate a temperature that is different from the eutectic temperature (i.e., temperature at the eutectic point) by at most about 0.1° C., 0.5° C., 1° C., 2° C., 4° C., 5° C., 6° C., 8° C., 10° C., or 15° C. A temperature that is farther from the eutectic point than the temperature close to the eutectic point is designated herein as a temperature far from the eutectic Point. The process of liquefying and solidifying a portion of the material can be repeated until the entire object has been formed. At the completion of the generated 3D object, it can be removed from the remainder of material in the container. The remaining material can be separated from the portion at the generated 3D object. The generated 3D object can be hardened and removed from the container (e.g., from the substrate or from the base).

At times, the methods described herein further comprise stabilizing the temperature within the enclosure. For example, stabilizing the temperature of the atmosphere or the pre-transformed material (e.g., within the material bed). Stabilization of the temperature may be to a predetermined temperature value. The methods described herein may further comprise altering the temperature within at least one portion of the container. Alteration of the temperature may be to a predetermined temperature. Alteration of the temperature may comprise heating and/or cooling the material bed. Elevating the temperature (e.g., of the material bed) may be to a temperature below the temperature at which the pre-transformed material fuses (e.g., melts or sinters), connects, or bonds.

In some embodiments, the apparatus and/or systems described herein comprise an optical system. The optical components may be controlled manually and/or via a control system (e.g., a controller). The optical system may be configured to direct at least one energy beam from the at least one energy source to a position on the material bed within the enclosure (e.g., a predetermined position). A scanner can be included in the optical system. The printing system may comprise a processor (e.g., a central processing unit). The processor can be programmed to control a trajectory of the at least one energy beam and/or energy source with the aid of the optical system. The systems and/or the apparatus described herein can further comprise a control system in communication with the at least one energy source and/or energy beam. The control system can regulate a supply of energy from the at least one energy source to the material in the container. The control system may control the various components of the optical system. The various components of the optical system may include optical components comprising a mirror, a lens (e.g., concave or convex), a fiber, a beam guide, a rotating polygon, or a prism. The lens may be a focusing or a dispersing lens. The lens may be a diverging or converging lens. The mirror can be a deflection mirror. The optical components may be tiltable and/or rotatable. The optical components may be tilted and/or rotated. The mirror may be a deflection mirror. The optical components may comprise an aperture. The aperture may be mechanical. The optical system may comprise a variable focusing device. The variable focusing device may be connected to the control system. The variable focusing device may be controlled by the control system and/or manually. The variable focusing device may comprise a modulator. The modulator may comprise an acousto-optical modulator, mechanical modulator, or an electro optical modulator. The focusing device may comprise an aperture (e.g., a diaphragm aperture).

In some embodiments, the container described herein comprises at least one sensor. The sensor may be connected and/or controlled by the control system (e.g., computer control system, or controller). The control system may be able to receive signals from the at least one sensor. The control system may act upon at least one signal received from the at least one sensor. The control may rely on feedback and/or feed forward mechanisms that has been pre-programmed. The feedback and/or feed forward mechanisms may rely on input from at least one sensor that is connected to the control unit.

In some embodiments, the sensor detects the amount of material (e.g., pre-transformed material) in the enclosure. The controller may monitor the amount of material in the enclosure (e.g., within the material bed). The systems and/or the apparatus described herein can include a pressure sensor. The pressure sensor may measure the pressure of the chamber (e.g., pressure of the chamber atmosphere). The pressure sensor can be coupled to a control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, angle, and/or volume). The metrology sensor may comprise a magnetic, acceleration, orientation, or optical sensor. The optical sensor may comprise a camera (e.g., IR camera, or CCD camera (e.g., single line CCD camera)). or CCD camera (e.g., single line CCD camera). The sensor may transmit and/or receive sound (e.g., echo), magnetic, electronic, or electromagnetic signal. The electromagnetic signal may comprise a visible, infrared, ultraviolet, ultrasound, radio wave, or microwave signal. The metrology sensor may measure the tile. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, Pyrometer, IR camera, or CCD camera (e.g., single line CCD camera). The temperature sensor may measure the temperature without contacting the material bed (e.g., non-contact measurements). The pyrometer may comprise a point pyrometer, or a multi-point pyrometer. The Infrared (IR) thermometer may comprise an IR camera. The pressure sensor may comprise Barograph, Barometer, Boost gauge, Bourdon gauge, hot filament ionization gauge, Ionization gauge, McLeod gauge, Oscillating U-tube, Permanent Downhole Gauge, Piezometer, Pirani gauge, Pressure sensor, Pressure gauge, tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode as light sensor, Light-addressable potentiometric sensor, Nichols radiometer, Fiber optic sensors, optical position sensor, photo detector, photodiode, photomultiplier tubes, phototransistor, photoelectric sensor, photoionization detector, photomultiplier, photo resistor, photo switch, phototube, scintillometer, Shack-Hartmann, single-photon avalanche diode, superconducting nanowire single-photon detector, transition edge sensor, visible light photon counter, or wave front sensor. The weight of the enclosure (e.g., container), or any components within the enclosure can be monitored by at least one weight sensor in or adjacent to the material. For example, a weight sensor can be situated at the bottom of the enclosure. The weight sensor can be situated between the bottom of the enclosure and the substrate. The weight sensor can be situated between the substrate and the base. The weight sensor can be situated between the bottom of the container and the base. The weight sensor can be situated between the bottom of the container and the top of the material bed. The weight sensor can comprise a pressure sensor. The weight sensor may comprise a spring scale, a hydraulic scale, a pneumatic scale, or a balance. At least a portion of the pressure sensor can be exposed on a bottom of the container. In some cases, the at least one weight sensor can comprise a button load cell. Alternatively, or additionally a sensor can be configured to monitor the weight of the material by monitoring a weight of a structure that contains the material (e.g., a material bed). One or more position sensors (e.g., height sensors) can measure the height of the material bed relative to the substrate. The position sensors can be optical sensors. The position sensors can determine a distance between one or more energy sources and a surface of the material bed. The surface of the material bed can be the upper surface of the material bed. For example, FIG. 1, 131 shows an example of an upper (e.g., exposed) surface of the material bed 104.

At times, a 3D printing process comprises a sieve that provides pre-transformed material having maximal FLS. Following sieving the particulate material may have a FLS that is at most the size of the holes of the sieve. Following sieving the particulate (e.g., powder) material can comprise particles of average FLS of at most about 1000 micrometers (μm), 500 μm, 100 μm, 50 μm, 45 μm, 40 μm, 35 μm, 30 μm, 25 μm, 20 μm, 15 μm, or 10 μm. The material can comprise particles of an average FLS of any value within a range of the aforementioned values (e.g., from at most about 1000 μm to about 10 μm, from about 1000 μm to about 500 μm, or from about 500 μm to about 10 μm). The pre-transformed material may be used as a starting material in the 3D printing process. The maximal FLS may correspond with a size of the pre-transformed material (e.g., powder). A pre-transformed material that has a maximal FLS may contribute to (e.g., improved) transformation into a transformed material (e.g., at least a portion of a 3D object) during 3D printing. For example, a pre-transformed material having a maximal FLS may prevent formation of (e.g., material and/or structural) defects during 3D printing. A pre-transformed material that has a maximal FLS may contribute to a smooth flowability of the pre-transformed material in the material conveyance system. The smooth flowability may comprise a constant velocity, non-interrupted, continuous, or flow having minimal clogging, during the 3D printing cycle. The smooth flowability may be improved relative to a pre-transformed material that (e.g., substantially) comprises particles having also a larger FLS than the maximal FLS (e.g., arising from agglomerated particles). The particles having larger FLS may refer to a range of particle sizes (e.g., a distribution) that spans at least 200 microns from an average particle size of the pre-transformed material. The pre-transformed material may comprise particulate material (e.g., vesicles, beads, or powder). In some embodiments, pre-transformed (e.g., particulate) material is passed through the sieve to provide the maximal FLS particulate material. The sieve may comprise one or more holes. The sieve can comprise a mesh (e.g., a screen). The sieve can have a pore size that defines a (e.g., maximum) particle size that passes therethrough. The mesh may be formed of a durable material (e.g., durable with regard to passing the particulate material during at least one 3D printing cycle). For example, the durable material may have an operating lifetime (e.g., before replacement) that facilitates filtering at least about: 4 liters of material filtered per square centimeter of filter material (L/cm2), 5 L/cm2, 6 L/cm2, 7 L/cm2, 10 L/cm2, or 15 L/cm2. The operating lifetime of the durable material may be any value within a range of the aforementioned values (e.g., from about 4 L/cm2 to about 15 L/cm2, from about 4 L/cm2 to about 10 L/cm2, or from about 10 L/cm2 to about 15 L/cm2). The filter material may be the sieve. For example, the mesh may be formed of stainless steel or brass. The mesh may be formed from any material disclosed herein. Durable may be with respect to operation of a 3D printing system. For example, durable may refer to a volume of material that is passed through the mesh prior to a failure condition of the mesh. A failure condition may alter at least one aspect of the sieve. For example, an aspect of the sieve may be a rate at which the sieve passes material therethrough (e.g., a sieving rate). In some embodiments, a nominal (e.g., typical operation) sieve rate is at least about: 1 milliliter/(centimeter squared*minute) (mL/(cm2*min)) (where ‘*’ denotes the mathematical multiplication operation), 1.5 mL/(cm2*min), 2 mL/(cm2*min), 3 mL/(cm2*min), 4 mL/(cm2*min), 5 mL/(cm2*min) or 6 mL/(cm2*min). The nominal sieve rate may be any value within a range of the aforementioned rates (e.g., from about 1 mL/(cm2*min) to about 6 mL/(cm2*min), from about 1 mL/(cm2*min) to about 4 mL/(cm2*min), or from about 4 mL/(cm2*min) to about 6 mL/(cm2*min)). A failure condition may correspond to a (e.g., detected) change in a sieve rate. A change in the sieve rate may be caused by at least one puncture in the mesh, at least one blockage in the mesh, and/or a de-coupling of the mesh with a surrounding element (e.g., a sieve cartridge frame). A volume of material may correspond with a number of layers deposited by a layer dispenser of the 3D printing system. The number of layers deposited corresponding to a durable mesh may be at least about: 10000 layers, 20000 layers, 25000 layers, 30000 layers, or 35000 layers. The number of layers deposited corresponding to a durable mesh may be any number of layers within a range of the afore-mentioned layers (e.g., from about 10000 layers to about 35000 layers, from about 10000 layers to about 25000 layers, or from about 25000 layers to about 35000 layers). For example, the sieve can have a pore size that is at least about 30 micrometers (μm), 40 μm, 60 μm, 80 μm, 100 μm, 500 μm or 1000 μm. The pore size of the sieve may be variable (e.g., the sieve having a range of pore sizes across the sieve). The pore size of the sieve may be (e.g., substantially) constant (e.g., during sieving). A fundamental length scale (FLS) of the particulate material may be at most about 100 μm, 80 μm, 40 μm, 20 μm, 10 μm or 1 μm in size.

In some embodiments, the agitator causes the sieve (e.g., via a frame) to move. The movement may comprise a translation (e.g., along an x-axis, along a y-axis, along a z-axis, or any combination thereof). The movement may comprise a vibration. The movement may comprise a rotation (e.g., about an x-axis, about a y-axis, about a z-axis, or a combination thereof). The agitator may be configured to induce mechanical agitation. Mechanical agitation may comprise movement of the sieve that is at most about 1 millimeter (mm), 2 mm, 5 mm, 10 mm, or 20 mm. Mechanical agitation may comprise movement of any distance within a range of the aforementioned distances (e.g., about 1 mm to about 20 mm, about 10 mm to about 20 mm, or about 1 mm to about 10 mm). Mechanical agitation may comprise vibration. Vibration may comprise de-blinding of the sieve (e.g., mesh). De-blinding may comprise causing clogged hole(s) in the sieve to open and allow flow of particulates therethrough. Vibration may comprise movement that is at least about 10 μm, 50 μm, 100 μm, 500 μm or 1000 μm. Vibration may comprise movement within any of the aforementioned values (e.g., from about 10 μm to about 1000 μm, from about 500 μm to about 1000 μm, from about 10 μm to about 500 μm). The agitator may comprise a motor coupled to a shaft, a cam, and/or a transducer (e.g., an ultrasonic transducer). In some embodiments the agitator comprises a controller operable to control one or more movement parameters. The movement parameters can comprise an amplitude of movement, a direction of movement, or a frequency of movement. The control may comprise control of an output power (e.g., amplitude and/or frequency) of the agitator. The controller may adjust the output power to maintain one or more values of one or more movement parameters. For example, the controller may adjust an output power to maintain an amplitude and/or frequency of agitator movement. For example, a power output may vary to maintain a given agitator movement amplitude and/or frequency as an inertial mass of the sieve (e.g., cartridge) changes. The amplitude may be an amplitude in a direction (e.g., X, Y or Z). The controller may adjust an output power to maintain a plurality of amplitudes and/or frequencies of agitator movement (e.g., each having another directional component, e.g., from X, Y and Z). An inertial mass of the sieve cartridge may change due to material buildup or removal (e.g., during filtering). In some embodiments, an output power of a transducer may be from about 50 W to about 600 W. The control may comprise a booster (e.g., an attenuator) that is operable to adjust the output power by a factor. The factor may be greater than or less than 1. For example, the factor may be about 1.5, about 3, about 5, or about 10. The factor may be any value within a range of the aforementioned values (e.g., from about 1.5 to about 10, from about 1.5 to about 5, from about 5 to about 10). For example, the factor may be about 0.25, about 0.5, about 0.75, or about 0.9. The factor may be any value within a range of the aforementioned values (e.g., from about 0.25 to about 0.9, from about 0.25 to about 0.5, from about 0.5 to about 0.9).

In some embodiments, the sieve is a part of a sieve assembly. A sieve assembly may comprise several portions. For example, a sieve assembly may comprise (i) a portion for receiving pre-transformed material (e.g., new and/or recycled), (ii) a portion for separating larger particles from those having the maximal FLS, (iii) a portion for receiving the sieved particles to provide to a material conveyance system (e.g., directly or via at least one container), (iv) a portion for receiving (e.g., discarding) the material (e.g., particles or agglomerates) having a FLS larger than the requested maximal FLS, (v) a portion for securing at least one sieve screen, (vi) a portion for coupling with at least one agitator (e.g., device for translating one or more sieve screens), or (vii) a portion for detection and/or monitoring performance of a sieve operation of the sieve. In some embodiments, at least two of portions (i)-(vii) are included in the same portion of the sieve assembly. In some embodiments, at least two of portions (i)-(vii) are included in different portions of the sieve assembly. In some embodiments, the sieve assembly comprises at least two of a given portion (e.g., at least two sieve portions, (ii)). In some embodiments, the pre-transformed material is sieved through a plurality of sieving assemblies are arranged in parallel (e.g., to facilitate continuous sieving, e.g., in case at least one sieving assembly of the plurality is not operational and at least one other sieving assembly of the plurality is operational). In some embodiments, a sieving assembly may comprise a plurality of sieves that are arranged sequentially, to facilitate quicker sieving. In the plurality of sieves, a given sieve has an average hole size that is larger than a sieve arranged subsequent thereto. In some embodiments at least two of the plurality of sieves are agitated by the same agitator. In some embodiments at least two of the plurality of sieves are each agitated by a different agitator.

At times, the sieve screen forms a part (e.g., portion) of a sieve cartridge. The sieve cartridge may comprise a cartridge frame. The cartridge frame may surround and/or support the sieve screen. The cartridge frame may surround the sieve screen at least in part (e.g., around a circumference of the screen). The cartridge frame may be configured to couple with an (e.g., at least one) agitator. In some embodiments, (e.g., at least one of) the agitator or the cartridge frame comprises an agitation shaft that passes through at least a portion of a securing portion (e.g., portion (v)) to form the coupling. An agitator may cause the sieve to move (e.g., directly by moving the sieve, and/or indirectly by moving the cartridge frame). The movement may comprise a translation (e.g., along an x-axis, along a y-axis, along a z-axis, or any combination thereof). The movement may comprise a vibration. The movement may comprise a rotation (e.g., about an x-axis, about a y-axis, about a z-axis, or any combination thereof). Coupling may be via at least one: threaded fastener, snap-fit fastener, press fit, and/or compression fit. In some embodiments, a perimeter of the cartridge frame is drafted (e.g., having a smaller width at one side compared to a width at an opposing side). A drafted cartridge frame may facilitate (e.g., reversible) coupling with a sieve assembly body. Reversible coupling may comprise retractable coupling (e.g., insertion and removal).

At times, at least a portion of the sieve assembly is formed for isolation (e.g., mechanical decoupling) from another (e.g., remaining) portion(s) of a sieve assembly. For example, the sieve cartridge may be (e.g., mechanically) isolated from a remainder of the sieve assembly. Isolation of the portion (e.g., the sieve cartridge) from a remainder of the sieve assembly may reduce energy transmission from the sieve cartridge (e.g., as it is agitated) to the remainder of the sieve assembly. For example, isolation may reduce the heat generated or transferred to the remaining portions of the sieve assembly (e.g., from the moving sieve cartridge). For example, isolation may reduce the sound generated by the sieve assembly (e.g., reduce compared to non-isolated sieve cartridge movement). For example, isolation may reduce vibration generated or transferred to the remaining portions of the sieve assembly (e.g., from the moving sieve cartridge). In some embodiments, isolation is produced by one or more isolation elements coupled to the at least the portion of the sieve assembly formed for isolation. Th one or more isolation elements may be configured to absorb energy (e.g., mechanical, thermal, or acoustic). Th one or more isolation elements may be configured to absorb vibrations, heat, and/or sound. The one or more isolation elements may comprise a gasket, bumper, spring, sponge, bellow, cloth, cork, and/or a membrane. An isolation element may be a (substantially) inelastic material that is formed in a conformation to behave as a spring (e.g., in a coil, in a wave). An isolation element may be formed of a flexible material. For example, an isolation element may absorb vibrations (e.g., in like manner to a dampened spring, felt, and/or a sponge). The flexible material may be an elastic material (e.g., comprising natural rubber, synthetic rubber, fluoropolymer elastomer, or silicone). The flexible material may be elastic (e.g., an elastomer). The flexible material may comprise an organic or silicon-based material (e.g., polymer or resin).

In some embodiments, the cartridge frame is (e.g., substantially) isolated from a remainder of the sieve assembly. Isolation may be mechanically, thermally, and/or acoustically (e.g., isolation inter terms of vibration, heat, and/or sounds). The cartridge frame may comprise (e.g., at least one) isolation element coupled with (e.g., at least one) external face of the cartridge frame. In some embodiments the isolation element surrounds an (e.g., at least a portion of the) external face of the cartridge frame. The isolation element may facilitate placement of the cartridge frame into its proper position within a sieve assembly. The isolation element may (e.g., substantially) prevent transmission of un-sieved particles to the material conveyance system. The cartridge frame may comprise at least one isolation element (e.g., bumper) disposed for the sieve cartridge to rest upon. For example, the bumper may comprise an O-ring or a plug.

At times, the sieve assembly is configured to facilitate atmospheric isolation on an interior volume of the sieve assembly. In some embodiments the sieve assembly is configured to be reversibly (e.g., substantially) sealed from an external environment (e.g., atmosphere). At times, the sieve assembly atmosphere is the same as the atmosphere in a remainder of the material conveyor system. For example, the atmosphere may be a non-reactive and/or inert atmosphere. Non-reactive may be with the pre-transformed material and/or with the transformed material (e.g., before, after and/or during printing). At times, the sieve assembly atmosphere is different than the atmosphere in a remainder of the material conveyor system. For example, the sieve assembly may comprise one or more valves for selective opening and closing of material and/or gas flow channels from the sieve assembly to other portions of the material conveyor system. The valves may be controlled manually and/or automatically (e.g., using at least one controller). For example, valves may be located above and/or below the sieve assembly (e.g., where above and below are with respect to a direction of material and/or gas flow). For example, one or more valves may be disposed upstream of one or more separating units (e.g., cyclones) that input material into the sieve assembly inlet(s) for filtering. At least two separating units that input material into the sieve assembly may be disposed in parallel and/or in series. For example, a valve may be disposed at an opening of (e.g., pressurized) container for storing filtered (e.g., sieved) particles having the maximal FLS (e.g., filtered pre-transformed material). For example, a valve may be disposed along a channel. The channel may be configured for movement of a gas within the channel. The channel may be one that connects the material conveyance system to the sieve assembly. The channel may be configured to transmit material to the sieve and/or from the sieve assembly. The valve may be disposed along the channel, at an opening of the channel, and/or at the connection of the channel with the sieving assembly. An inert atmosphere may be maintained in the (e.g., pressurized) container by closing the container valve prior to exposing any portion of the sieve assembly to external atmosphere. During operation, the atmosphere in the sieving assembly may be at or above atmospheric pressure. Atmospheric isolation of the sieve assembly may enable one or more (e.g., maintenance) operations to be performed on the sieve assembly without affecting an atmosphere in another (e.g., remaining) portion of the material conveyor system. For example, a maintenance operation may comprise a sieve cartridge insertion or removal (e.g., a sieve cartridge swap). The sieve assembly may comprise a (e.g., at least one) gas inlet channel for receiving a (e.g., inert) gas. The gas inlet channel may comprise a valve. An atmosphere of the sieve assembly may be purged following an opening and/or closure of one or more (e.g., material and/or gas channel) valves. Purging the internal atmosphere of the sieve assembly may facilitate exchange of the gaseous content of the atmosphere (e.g., from ambient atmosphere to insert atmosphere). The sieve assembly may be configured to hold a pressure above atmospheric pressure during the sieving. For example, the sieve assembly may be hermetically sealed. The sieving assembly may comprise a closable opening that is gas tight (e.g., upon closure). Gas tight may be at least during a duration of uninterrupted operation of the sieve assembly.

At times, performance of the filtering is monitored to assess one or more characteristics of the material conveyor system operation. For example, the material conveyor system characteristics may comprise (a) a rate at which a sieve assembly is filtering newly introduced and/or recycled material, (b) a rate at which discarded material is accumulating (e.g., in a removal container), (c) a rate at which filtered material is accumulating (e.g., in a storage container), or (d) a performance parameter of an agitator coupled with a sieve cartridge. The performance parameter may comprise power output from the agitator. Monitoring may include (e.g., human) inspection and/or one or more measurements by a monitoring device. The inspection can be manual and/or using a detector. The detector may comprise a sensor. The sensor may comprise a material sensor, flow sensor, or optical sensor (e.g., optical density sensor). The inspection may be facilitated using a window coupled to the sieve assembly. The window may facilitate detecting (e.g., viewing) the sieve. Filtering (e.g., sieving) performance may be considered to assess a (e.g., operating) condition of one or more components of the sieve assembly. For example, a condition of a sieve screen, an agitator, a sieve cartridge-agitator coupling, a material removal container (e.g., a trash can), a (e.g., sieved particles) material storage (e.g., pressure) container, and/or a material conveyance channel may be assessed.

At times, data regarding the filtering performance are gathered by one or more sensors. The sensor may be disposed within or outside of (e.g., adjacent to) the sieve assembly. The sensor(s) may be integrated in one or more walls of the sieve assembly. The one or more sensors may detect a material level (e.g., a fill level), a volume of material, a rate at which a material moves (e.g., is filtered and/or removed), and/or a material type. The one or more sensors may comprise a flow sensor, a distance sensor (e.g., an optical, interferometric, laser, inductance and/or capacitance), or an optical path density detector (e.g., an optical flow sensor). The one or more sensors may comprise an oxygen and/or humidity sensor. The one or more sensors may be disposed at one or more locations within a material conveyor system. For example, one or more sensors may be disposed before and/or after a sieve cartridge (e.g., with respect to the direction of a material flow). For example, the one or more sensors may be disposed in a channel, a chamber, or an opening (e.g., formed in a wall) of one or more components of the material conveyor system. For example, one or more sensors may be disposed in a chamber of the sieve assembly above a sieve cartridge and/or in a chamber below the sieve cartridge. The one or more sensors may be disposed to monitor (i) a filtered material (e.g., particles having the maximal FLS) container, (ii) a (debris and/or detritus) material removal container, and/or (iii) a sieve assembly (e.g., chamber). In some embodiments a sensor comprises a monitor of a power output of an agitator (e.g., a transducer).

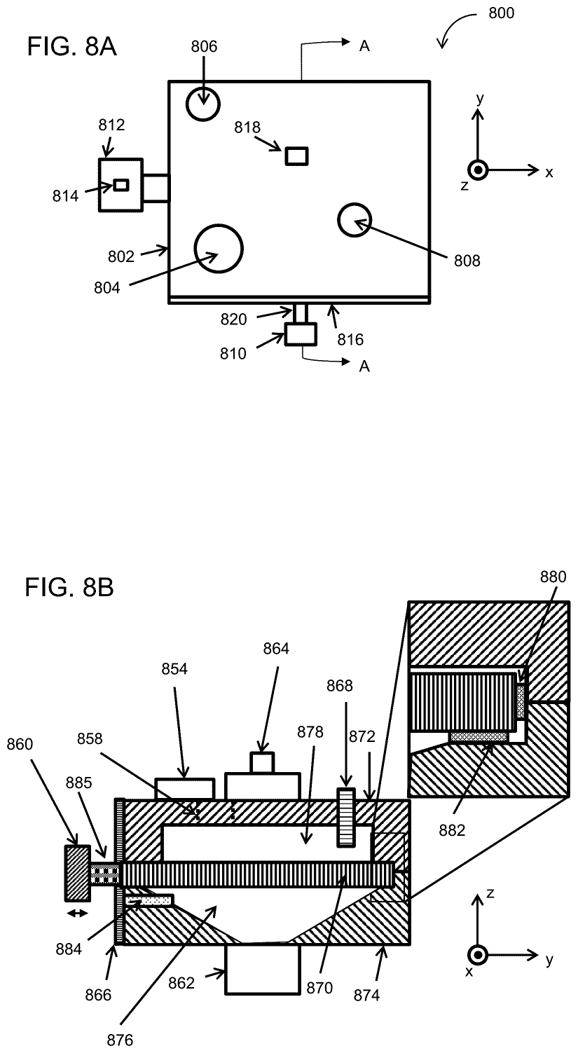

FIG. 8A depicts an example of a sieve assembly 800 (also referred to herein as “filtering enclosure”). In the example of FIG. 8A, a first (e.g., top) portion 802 of the sieve assembly comprises (e.g., inlet and/or fill) ports 806 and 808 for receiving material. The material receiving port may be elliptical or rectangular. The material receiving port may be round or elongated (e.g., along at least a portion of a face of the screen). The material received may be (e.g., newly introduced) pre-transformed material. The material received may be from another portion of the 3D printing system (e.g., from a processing chamber, e.g., from the material remover). For example, the material received may be from a separating unit (e.g., at least one cyclone) that conveys material as part of a gas flow. The material received may comprise a combination (e.g., mixture) of pre-transformed material and debris (e.g., detritus). The debris may be generated during a transformation process of the 3D printing. The pre-transformed material and/or debris may comprise inhomogeneous particle sizes. Particles above the maximal FLS may be separated by the sieve assembly and removed (e.g., to a removal container, e.g., trash can). In the example of FIG. 8A, a removal container 812 is disposed adjacent to the (e.g., first portion of) the sieve assembly. In some embodiments the (e.g., sieve channel to the) removal container and the inlet port(s) are arranged to maximize a travel distance of the material across the sieve screen. The example of FIG. 8A depicts a removable (e.g., faceplate) portion 816 coupled with the first portion of the sieve assembly, and an agitator 810 coupled with the portion 816 (e.g., via an agitator shaft 820). In some embodiments the faceplate secures a sieve screen (e.g., cartridge) of the sieve assembly. In some embodiments the sieve cartridge is coupled with the agitator through at least a portion of the faceplate. In the example of FIG. 8A, sieve performance monitoring portions 804 and 818 are coupled with the first portion of the sieve assembly, and sieve performance monitoring portion 814 is coupled with the removal container. The sieve performance monitoring portions may be configured for manual inspection (e.g., a viewing window, 804). The sieve performance monitoring portions may comprise one or more sensors (e.g., 818). In the example of FIG. 8B a first portion 872 is disposed adjacent to (e.g., above) a second (e.g., bottom) portion 874, and a separating portion (e.g., sieve cartridge) 870 is disposed therebetween. In the example of FIG. 8B, the separating portion is coupled with an agitator 860 via an agitator shaft 885, which agitator shaft is operable for movement. In the example of FIG. 8B, a portion 878 for receiving (e.g., inhomogeneous) material within the sieve assembly is formed by a region (e.g., volume) between the top portion and the sieve cartridge. The material may be introduced (e.g., fed) via one or more inlet ports (e.g., via inlet port 858, in dashed line). FIG. 8B depicts an example of a removal container 862 coupled with the sieve assembly. In the example of FIG. 8B, a portion 876 for receiving sieved (e.g., particles having the maximal FLS) material within the sieve assembly is formed by a region (e.g., volume) between the bottom portion and the sieve cartridge. The portion for receiving the sieved material may comprise at least one slanted surface that facilitates translation of the sieved material to the removal container (e.g., using gravity), which slanted surface is slanted towards an opening that fluidly couples the portion for receiving the sieved material with the removal container. In some embodiments, fluid coupling refers to a connection that facilitates flow (e.g., of the pre-transformed material). FIG. 8B depicts an example of a sieve performance monitoring portion 854 coupled with the first portion of the sieve assembly, a sieve performance monitoring portion 868 disposed to penetrate through (e.g., a top surface) of the first portion, a sieve performance monitoring portion 884 disposed within (e.g., to penetrate through an inner wall) of the portion for receiving the sieved material, and a sieve performance monitoring portion 864 coupled with the removal container. In an inset, the example of FIG. 8B depicts the sieve cartridge comprising isolation elements 880 and 882. The isolation elements may be any isolation element as described herein. The isolation elements may be disposed on and/or in one or more faces of the sieve cartridge. The isolation elements may be in contact with the top portion of the sieve assembly, the bottom portion of the sieve assembly, the faceplate, or a combination thereof.

In some embodiments, the filtering enclosure (also referred to herein as “sieve assembly”) comprises a closure (e.g., door or window) that closes the cartridge opening. In some embodiments, the filtering enclosure and the cartridge opening door engage and/or disengage (e.g., reversibly engageable and separable). In some embodiments, the door is fastened to the filtering enclosure (e.g., by a hinge or hook). In some embodiments, the apparatus further comprises a closure that is configured to close the opening. In some embodiments, the closure reduces an exposure of the mechanism housed in the ancillary chamber from a reactive agent in the ambient (e.g., external) environment. The reactive agent may comprise oxygen, or water. The reactive agent may react with the reactant (e.g., pre-transformed material) or product (e.g., transformed material) of the printing, e.g., during, before, and/or after the printing. In some embodiments, the closure comprises a flapping, rolling, sliding door, or revolving door. In some embodiments, the closure is gas tight. In some embodiments the closure and/or filtering enclosure is made of any material disclosed herein (e.g., elemental metal or metal alloy). The closure and/or filtering enclosure may be opaque (e.g., non-transparent). The closure and/or filtering enclosure may comprise at least one section that is transparent section (e.g., comprising glass or a polymer). In some embodiments, the closure is a physical barrier. In some embodiments, the closure comprises a compressible and/or elastic material that seals the closure upon the cartridge opening by pressure. The pressure is formed by a closure of at least one hinge, level, and/or screw. The pressure may be by a pressing mechanism. The pressure may be by a fastener. In some embodiments, the closure is configured to disengage from the filtering enclosure during printing of the at least one three-dimensional object. In some embodiments, the closure is configured to engage and/or disengage from the filtering enclosure during printing of the at least one three-dimensional object without (e.g., substantially) disrupting the printing. The elastic material may comprise a polymer or resin. For example, the elastic material may comprise Teflon, rubber, or latex.

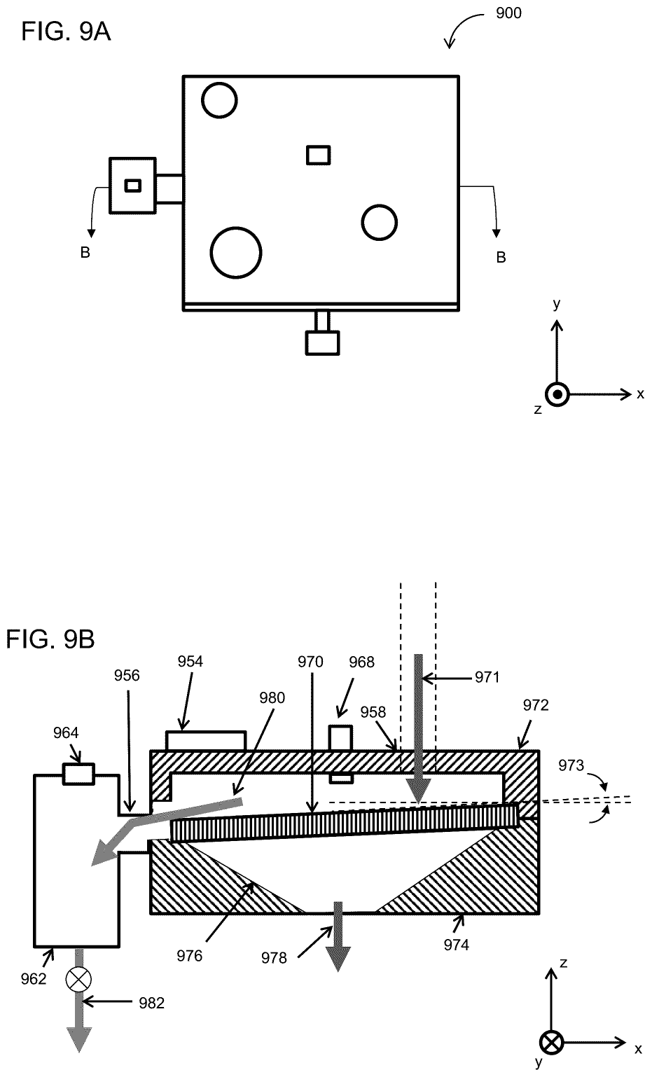

FIG. 9A depicts an example of a horizontal view of a sieve assembly 900. FIG. 9B depicts an example of a vertical cross section of the sieve assembly depicted in FIG. 9A. The sieve assembly shown in the example of FIG. 9B, comprises a top portion 972, a bottom portion 974, a sieve cartridge 970, and a removal container 962. Bottom is in a direction of a gravitational field vector. Top is in the direction opposite to the direction of the gravitational field vector. FIG. 9B depicts an example of a material introduction path 971 along which enters into the sieve assembly (e.g., via inlet port 958). FIG. 9B depicts an example of a removal path 980 from a (e.g., top) sieve cartridge surface to an interior of the removal container. In the example of 9B, an optional channel element 956 is formed between the (e.g., body of the) sieve assembly and the removal container. In some embodiments, a removal path from the sieve assembly to the removal container is defined by one or more openings in walls between the sieve assembly and the removal container (e.g., with no channel element intervening). In some embodiments a removal path from the sieve assembly to the removal container comprises a valve that is controllably opened to receive material at the removal container, and/or controllably closed to isolate the interior of the sieve assembly. FIG. 9B depicts an example of a (e.g., debris, detritus) removal path 982 along which discarded material is removed from the removal container. In some embodiments, the removal path comprises a valve operable for maintaining a selected atmosphere in the removal container. In some embodiments a removal container valve may be selectively (e.g., controllably) opened for removing material from the removal container. FIG. 9B depicts an example of a (e.g., sloped and/or conical) surface 976 for receiving separated (e.g., sieved) material. For example, the lower portion of the sieve assembly may funnel filtered (e.g., particles having the maximal FLS) material toward a (e.g., pressure) container of the material conveyor system. FIG. 9B depicts an example of a material conveyance path 978 along which separated (e.g., particles having the maximal FLS) material is removed from the sieve assembly toward (e.g., a container of) a material conveyor system. FIG. 9B depicts an example of the sieve cartridge disposed at an angle 973. The sieve cartridge may be angled within the sieve assembly such that a portion of the sieve cartridge that is adjacent to the removal container is lower than a (e.g., remaining) portion of the sieve cartridge that is distal from the removal container. In the example of FIG. 9B, the sieve cartridge is tilted about the y-axis such that a z height of a top surface of the sieve cartridge adjacent to the removal container is lower than a z height of the top surface of the sieve cartridge that is distal from the removal container.

At times, the particles having an FLS larger than the maximal FLS comprise debris. The debris may comprise fused particles or spatter from the transformation process of the 3D printing system. Fuse may comprise molten or sintered. A removal time of the debris may comprise a period that is initiated when the debris enters the sieving assembly, or when the debris contacts the sieve screen; and is terminated when the debris is removed off the sieve screen toward the removal container (e.g., trash can). In some embodiments, the removal of larger particle sizes from atop the sieve screen may occur within at most about 5 seconds (sec), 10 sec, 30 sec, 60 sec, 2 minutes (min), or 5 min. Removal of larger particles may occur at any time within a range of the aforementioned times (e.g., at most about 5 sec to about 5 min, at most about 5 sec to about 2 min, or at most about 2 min to about 5 min). In some embodiments at least about 80%, 90%, 95% or 99% of the larger than maximal FLS particles are removed to the trash container. In some embodiments, (e.g., inadvertent) removal of (e.g., non-debris) particles having at most the maximal FLS (e.g., pre-transformed material) to the trash container is minimal. For example, a percentage of non-debris particles inadvertently removed to the trash container may be limited to at most about 0.01%, 0.05%, 0.1%, 0.3%, or 0.5% of the total volume removed. The percentage of non-debris particles inadvertently removed may be any value within a range of the aforementioned values (e.g., from about 0.01% to about 0.5%, from about 0.01% to about 0.3%, or from about 0.3% to about 0.5%). The percentage may be a volume per volume percentage.

In some embodiments, the sieve cartridge is angled (e.g., pitched) such that a region of a top surface of the sieve cartridge onto which material is input is higher than a region of the top surface of the sieve cartridge that is adjacent to the removal container. At times, a sieve cartridge disposed at an angle (e.g., tilted) increases a sieve surface area over which material is filtered, and/or facilitates self-removal of debris from the sieve. The angle may be with respect to a direction normal to the gravitational field. The angle may be with respect to the horizon. Filtering a given volume of material over an increased surface area of the sieve may increase an operating lifetime of the sieve. Material that contacts (e.g., travels across) an increased surface area of the sieve may be filtered at a faster rate by the sieve. A faster rate may be relative to a rate of material filtering for a sieve cartridge that is not tilted (e.g., upon which material impinges in a normally incident manner). For example, the sieve cartridge may be angled such that it facilitates filtering (e.g., sieving) of material to provide particle sizes having the maximal FLS, and removal of larger particle sizes (e.g., those larger than the maximal FLS). At times (e.g., debris) particles having a size larger than a fundamental length scale (FLS) of a sieve screen pore may be retained by the sieve screen (e.g., without removal therefrom). For example, the debris particles may oscillate (e.g., bounce) and/or translate (e.g., roll) within a region of the sieve screen, without being removed (e.g., to the trash can). For example, the oscillating and/or translational movement of the debris particles may comprise a component (e.g., substantially) along one axis (e.g., a vertical, or z-axis). Vertical may be parallel to a gravitational field vector. The oscillating and/or translational movement may comprise a lateral (e.g., a horizontal) component. The (e.g., retained) debris particles may cause (e.g., at least a portion of) the particles having the maximal FLS to remain above the sieve screen. For example, the debris particles may obstruct at least some of the sieve screen pores. A tilted (e.g., vibrating) surface may facilitate filtering (e.g., sieving) of the particles having the maximal FLS. A tilted vibrating surface may facilitate movement of the debris particles along a given (e.g., horizontal) axis. The tilt may be with respect to the vertical or z-axis. The tilt may be with respect to the horizonal (e.g., X or Y axis). For example, a tilted vibrating surface may impart a force to the debris particles along the given axis. The force may facilitate movement of material along to the sieve screen. For example, the tilt may increase an area (e.g., of the sieve screen) over which material is filtered. For example, the tilt may facilitate movement of the debris particles toward the trash can. The force(s) imparted to the debris particles may depend upon an angle at which the sieve screen is tilted. The angle may be selected such that the filtering (e.g., of the maximal FLS particles) and removal (e.g., of the debris particles) occur (e.g., substantially) simultaneously. For example, the angle may be at least about 0.5 degrees (deg.), 1 deg., 1.5 deg., 2 deg., 3 deg., 5 deg., or 10 deg. with respect to a direction normal to the gravitational field (e.g., a horizontal direction). The angle may be any angle within the aforementioned angles (e.g., from at least about 0.5 deg. to about 10 deg., about 0.5 deg. to about 5 deg., or about 5 deg. to about 10 deg.). In some embodiments, the angle of the sieve cartridge is variable (e.g., before, after, and/or during sieving). In some embodiments, the (e.g., variable) angle is selected according to a relationship between the retained (e.g., filtered, sieved) particle size(s) and the larger (e.g., debris, detritus) particles sizes. For example, the relationship may be a ratio of (e.g., the fundamental length scale, FLS) of the (e.g., respective) particle sizes.

At times, a variable sieve cartridge angle is achieved by one or more elements coupled with or disposed adjacent to the sieve cartridge. For example, at least one pin, screw, threaded fastener, expandable membrane (e.g., bladder), bellow, gear, and/or actuator may be adjusted to cause the angle of the sieve cartridge to vary. For example, a bladder may be disposed below (e.g., a perimeter) of the sieve cartridge, wherein an expansion of one or more portions of the bladder causes the sieve cartridge to tilt (e.g., pitch) in a selected direction and magnitude. The variable angle of the sieve cartridge may be controlled (e.g., before, after, and/or during sieving). The controlling may be done manually and/or automatically. The controlling may be performed before, after, and/or during at least a portion of the 3D printing. The controlling may be performed before, after, and/or during the operation of the pre-transformed material conveyor system.

At times, one or more controllers are configured to control (e.g., direct) one or more apparatuses and/or operations. Control may comprise regulate, modulate, adjust, maintain, alter, change, govern, manage, restrain, restrict, direct, guide, oversee, manage, preserve, sustain, restrain, temper, or vary. The control configuration (e.g., “configured to”) may comprise programming. The configuration may comprise facilitating (e.g., and directing) an action or a force. The force may be magnetic, electric, pneumatic, hydraulic, and/or mechanic. Facilitating may comprise allowing use of ambient (e.g., external) forces (e.g., gravity). Facilitating may comprise alerting to and/or allowing: usage of a manual force and/or action. Alerting may comprise signaling (e.g., directing a signal) comprising a visual, auditory, olfactory, or a tactile signal.

In some embodiments, at least a portion of the sieve assembly is formed to be reversibly retractable within the 3D printing system. For example, the sieve cartridge may be reversibly retractable. For example, the sieve may be included in a retractable cassette. A reversibly retractable sieve cartridge may enable a replacement of a sieve cartridge in the sieve assembly (e.g., in real time during printing and/or during operation of the material conveyance system). The replacement may be in response to a (e.g., detected) failure condition and/or at a predetermined time. In some embodiments, a replacement may comprise a swap operation. A swap operation may be performed while maintaining an inert atmosphere in a remainder of the material conveyor system and/or the 3D printing system. A swap operation may comprise the following operations: (i) closure of gas and/or material channel valve(s) that are upstream and downstream of the sieve cartridge chamber (e.g., isolation of sieve cartridge chamber from a remainder of material conveyor system); (ii) de-coupling and removal of the agitator; (iii) removal of the faceplate; (iv) removal and replacement of a (e.g., at least one) sieve cartridge from the sieve cartridge chamber; (v) replacement of the faceplate; (vi) coupling and replacement of the agitator; and (vii) opening of the gas and/or material channel valves coupled with the sieve cartridge chamber.

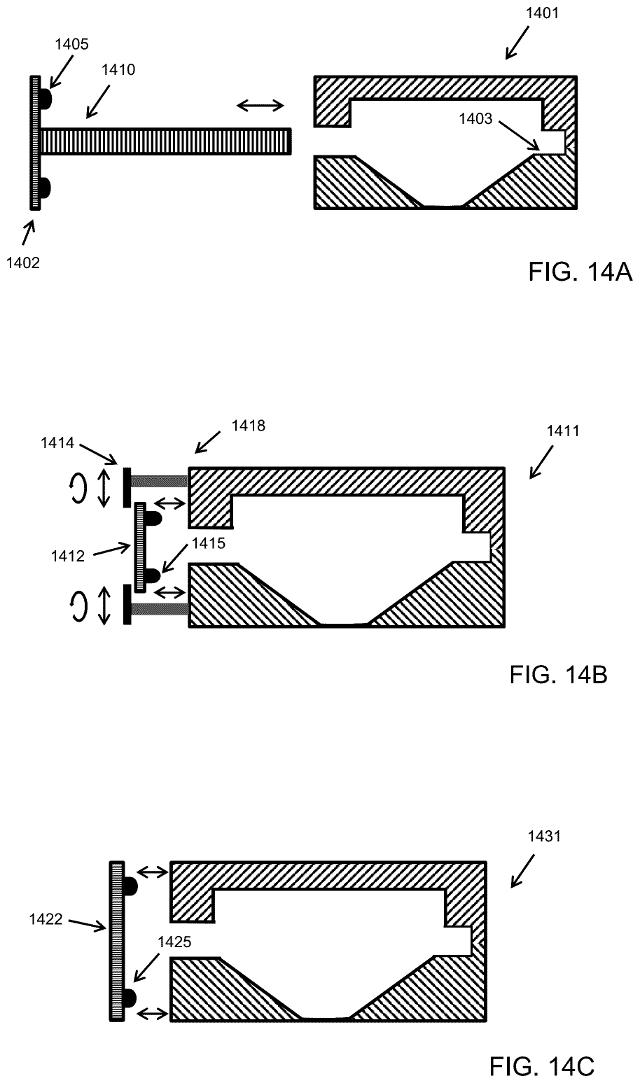

FIGS. 14A-14B depicts examples of a sealing a sieve assembly internal volume with a faceplate. In some embodiments the faceplate is adapted to hermetically seal an internal volume of the sieve assembly (e.g., by one or more seals). In some embodiments a sieving cartridge is operable for reversible insertion (e.g., engagement) within the internal volume of the sieve assembly. In some embodiments a faceplate (e.g., portion) is configured for reversible coupling with the sieve assembly. In some embodiments, the faceplate is sized to be larger than (e.g., to fully cover) a sieve cartridge opening in a face of the sieve assembly. The faceplate may be sized to be (e.g., substantially) a same size, to be larger than, or to be smaller than, the size of a face of the sieve assembly to which it couples. The reversible coupling may comprise (e.g., hermetically) sealing (e.g., when the faceplate is fully coupled and/or engaged with the sieve assembly). FIG. 14A depicts an example of a sieve assembly enclosure 1401 having a surface (e.g., a ledge) 1403 configured for securing a (e.g., inserted) sieve cartridge (e.g., 1410). The example sieve cartridge 1410 comprises a seal 1405 and a faceplate portion 1402, integrally formed with the sieve cartridge. The sieve cartridge may be reversibly engageable with the sieve assembly (e.g., FIG. 14A, double-headed arrow). In the example of FIG. 14A the sieve cartridge, upon (e.g., complete) insertion into the sieve assembly enclosure, In some embodiments, the faceplate forms a separate portion from the sieve assembly and/or the sieve cartridge. In some embodiments, the faceplate portion may be controlled to couple and to de-couple (e.g., detach) from the sieve assembly. One or more coupling members may be disposed on the sieve assembly and/or the faceplate, the coupling members configured to reversibly secure the faceplate to the sieve assembly. The coupling members may comprise a lever, a pin, a threaded fastener, a flap, a button, a valve, or a spring. To reversibly secure may comprise, (i) in a secured position, mating a face of the faceplate with a (e.g., corresponding) face of a sieve assembly to seal the sieve assembly, and (ii) in an open (e.g., released) position, freeing the faceplate from the sieve assembly. In some embodiments, the freeing comprises maintaining at least one coupling between the faceplate and the sieve assembly. In some embodiments, the freeing comprises removal of the faceplate from the sieve assembly. Control may be manual and/or automatic. Control may be by at least one controller. Control may comprise manipulation of at least one coupling member by a control member (e.g., comprising an actuator, a motor, a drive, or a pump). FIG. 14B depicts an example of a sieve assembly 1411 having a reversibly attachable (e.g., coupled) faceplate 1412, the faceplate having one or more seals 1415. In the example of FIG. 14B a coupling member 1414 is attached to the sieve assembly, and to a control member 1418. The control member may be operable to cause the coupling member to move to (e.g., controllably) adjust a position of the faceplate. To move may comprise to turn (e.g., FIG. 14B, semi-circular arrows), extend, retract, flex, or translate (e.g., FIG. 14B, vertical double-headed arrows). FIG. 14C depicts an example of a sieve assembly 1431 with a faceplate 1422 comprising seals 1425. In the example of FIG. 14C the faceplate is sized to be (e.g., substantially) the same size as the face of the sieve assembly.

At times, a swap operation comprises removal of (e.g., at least a first) sieve cartridge and replacement with (e.g., at least a second) sieve cartridge. The sieve cartridge may be one of at least two sieve cartridges of a sieve assembly. The at least two cartridges may comprise an arrangement that is in series. In some embodiments, at least one sieve cartridge continues to operate during a swap of a (e.g., at least one) parallel sieve cartridge. For example, a parallel sieve cartridge may be disposed within a parallel chamber of the sieve assembly. At least two parallel chambers of the sieve assembly may be configured to be isolated (e.g., atmospherically) from one another and from a remainder of the material conveyor system. In some embodiments, at least two (e.g., parallel and/or serial) sieve cartridges are replaced during a swap operation.

At times, a swap operation is performed in a (e.g., relatively) short time period. For example, a short time period may be at most about 20 minutes, 15 minutes, 10 minutes, or 5 minutes from the initiation of the swap to termination of the swap. Termination of the swap may be when the sieve assembly initiates sieving. The initiation of the swap may be when an exchange is determined (e.g., when a fault in the sieving is detected, and/or when the swap is scheduled). A short time period for a sieve cartridge swap operation may be any value of the aforementioned values (e.g., from about 20 minutes to about 5 minutes, from about 20 minutes to about 10 minutes, or from about 10 minutes to about 5 minutes). In some embodiments, the sieve screen is removable from the sieve cartridge frame. For example, the sieve screen and/or cartridge may be a consumable of the 3D printing system. The sieve screen may be coupled with the sieve cartridge frame via a glue, a (e.g., at least one) fastener, and/or by press fit (e.g., snap fit). In some embodiments, a swap operation comprises removal of a (e.g., first) sieve screen coupled with a sieve cartridge, and replacement with a (e.g., second) sieve screen.

At times, the sieve cartridge comprises one or more elements to reduce (e.g., prevent) sag of a sieve screen (e.g., during sieving). In some embodiments, the one or more elements comprise support structures coupled to the sieve screen and/or to the cartridge frame. The support structure(s) may support the sieve screen (e.g., during sieving). The support structures may be located at one or more portions of the sieve screen that correspond to one or more material inlets. For example, the support structures may be disposed (e.g., directly) below inlet ports of an upper portion of the sieve assembly when the sieve cartridge is inserted in the sieve assembly. The support structures may comprise a bar or a frame. The support structures may comprise a durable material (e.g., durable for filtering metallic particles). The support structures may be affixed to a surrounding frame and/or to the sieve mesh.

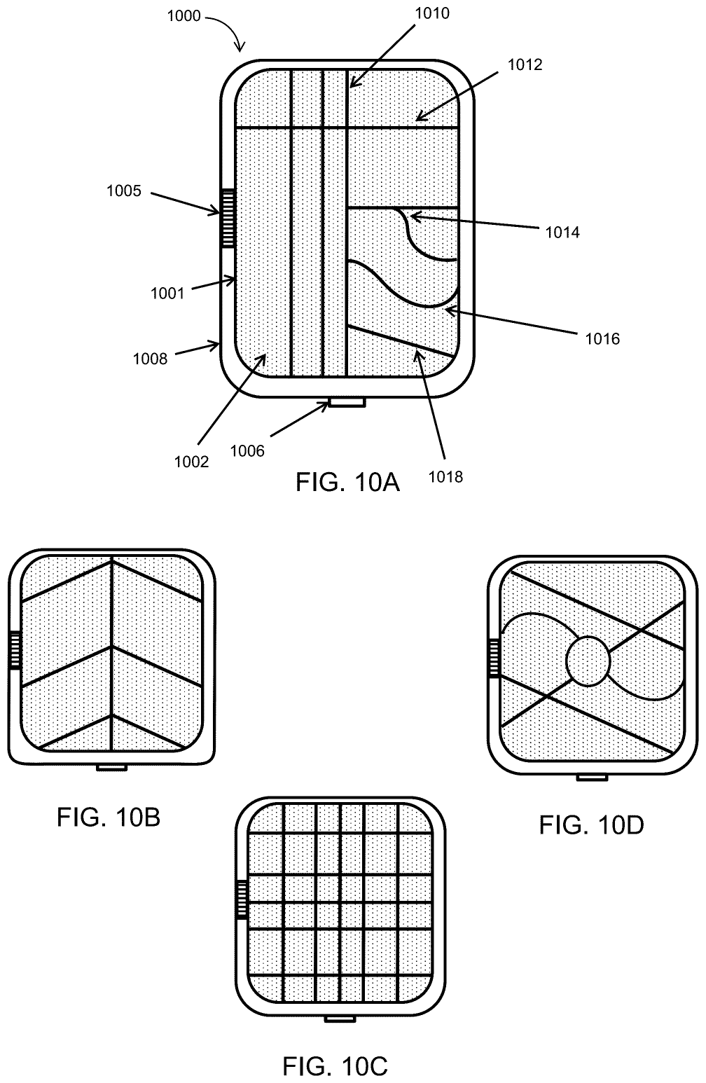

FIG. 10A depicts an example of horizontal view of a sieve cartridge 1000 comprising a mesh 1001 disposed within a surrounding frame 1008. In the example of FIG. 10A the sieve cartridge comprises: a portion 1005 that is configured for (e.g., debris, or detritus) material removal (e.g., toward a removal container); a portion 1006 that is configured for coupling with an agitator (e.g., agitator shaft); a region 1002 of the sieve mesh that is devoid of support structures; and a plurality of support structures disposed across the sieve mesh (e.g., 1010, 1012, 1014, 1016, and 1018). The support structure(s) may span a (e.g., an entire) long axis of a sieve mesh (e.g., 1010). The support structure(s) may span a (e.g., an entire) short axis of a sieve mesh (e.g., 1012). The support structure(s) may span a portion of a sieve mesh and/or form a junction with one or more other support structures (e.g., 1014). The support structure may comprise a (e.g., substantially) straight structure. The support structure may comprise a curve (e.g., 1016). The support structure may be disposed at an angle to another support structure (e.g., 1018) and/or frame face. In some embodiments, a plurality of support structures is disposed across the sieve mesh. The plurality of support structures may be (substantially) evenly distributed. The plurality of support structures may be unevenly (e.g., sparsely) distributed. In some embodiments, a larger number of support structures are disposed in a region of the sieve cartridge that is distal from the removal region (e.g., distal from 1005). At least one support structure may be disposed below an entry opening of the material (e.g., to reduce impact of the sieve by the incoming material). FIGS. 10B-10D depict examples of various support structure arrangements of sieve cartridges. The support structure may resemble a rib cage. The support structure may form an (e.g., organized) array and/or pattern. At least two of the support structures may be evenly distributed. At least two of the support structures may be parallel to each other. At least two of the support structures may form an angle (e.g., right angle).

In some embodiments, filtering comprises monitoring the flow of the sieved or incoming material. The filtering performance monitoring may comprise a feedback in a filtering control system (e.g., to a controller). For example, a filtering controller may comprise control of (a) the agitator that is operable to move the sieve cartridge, (b) a variable angle of a sieve cartridge, (c) an insertion/removal (e.g., swap) operation of a sieve cartridge, (d) a (e.g., debris) removal operation from the removal container, or (e) an atmospheric purge (e.g., to provide an inert atmosphere) of the sieve assembly.

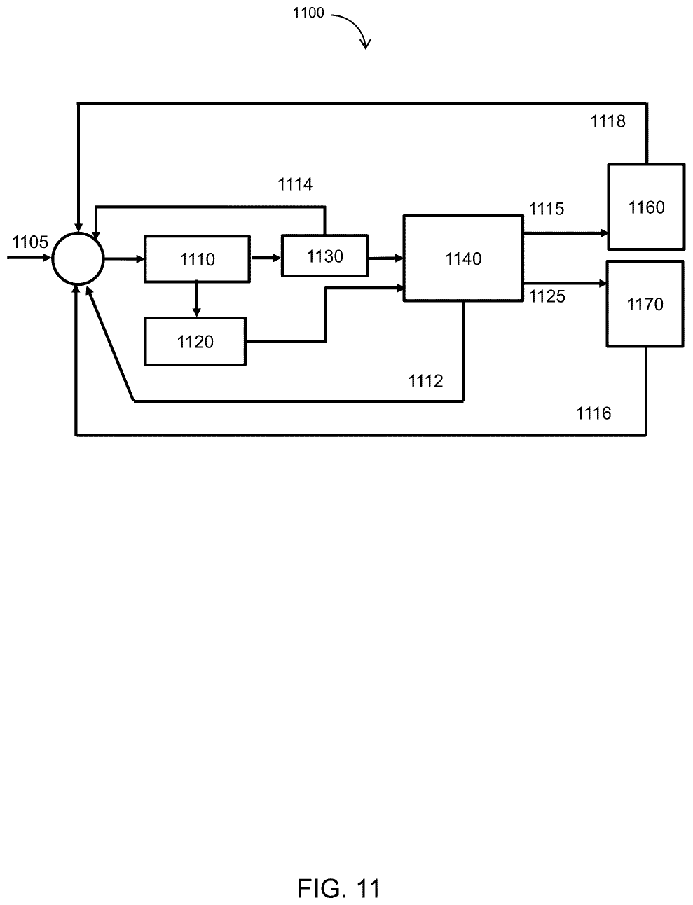

FIG. 11 depicts an example of a sieve assembly control system 1100. The control system may comprise (e.g., at least one) controller. The controller may comprise electrical circuitry and/or a connection to electrical power. The controller may be programmed to implement methods of the disclosure. In the example of FIG. 11 a controller 1110 receives instructions 1105 regarding operation of the sieve assembly system. For example, the instructions may comprise activation and/or deactivation of the agitator and/or of one or more valves in the sieve assembly system. In the example of FIG. 11, the controller is operatively coupled with an agitator 1130, a sieve cartridge changeover (e.g., swap) unit 1120, a sieve assembly 1140, a (e.g., debris) removal container 1160 (e.g., a trash can), and a (e.g., sieved) material container 1170. The cartridge exchange may be manual and/or automatic. For example, the sieve cartridge swap unit may comprise a robotic arm. Considering the received instructions, the controller may cause (I) the agitator to move at a selected amplitude and/or frequency (e.g., of oscillation), and/or (II) one or more valves to open and/or close. The one or more valves may be operable to introduce and/or prevent a flow of (e.g., inert) gas and/or a (e.g., unfiltered) material. For example, the controller may command the agitator to output power of a selected magnitude and/or frequency to move at the selected amplitude and/or frequency. The agitator may be operatively coupled with at least a portion of the sieve assembly (e.g., the sieve cartridge). For example, the controller may command a material inlet valve (e.g., to the sieve assembly), a material removal valve, and a material outlet valve (e.g., to a storage container) to open and/or close. In the example of FIG. 11, instructions 1115 control operation of a (e.g., at least one) valve disposed within a channel between from the sieve assembly to the trash can. In the example of FIG. 11, instructions 1125 control operation of a (e.g., at least one) valve disposed within a channel from the sieve assembly to a (e.g., sieved) material container. The sieve assembly control may comprise feedback from one or more sensors disposed within or adjacent to one or more components of the sieve assembly system. For example, a sensor may be a material level sensor, a material (e.g., flow) rate sensor, and/or a power (e.g., output) sensor. In the example of FIG. 11 feedback data 1112 comprise information regarding (a) a material level at a top surface of a sieve cartridge, (b) a material flow (e.g., flux) through the sieve cartridge, and/or (c) a sieve cartridge movement amplitude and/or frequency. In the example of FIG. 11 feedback data 1114 comprise information regarding an agitator output power parameter (e.g., wattage, voltage, and/or current) for moving the sieve cartridge at the selected amplitude and/or frequency. For example, the agitator output power to maintain a given sieve cartridge movement may vary according to a varying (e.g., inertial mass) condition of the sieve cartridge. A varying inertial mass of the sieve cartridge may be due to a material buildup on (e.g., a top surface of) the sieve cartridge, and/or within (e.g., pores of) the sieve cartridge. In the example of FIG. 11, feedback data 1116 comprise information regarding a material level within and/or a material flux into the (e.g., sieved) material container; and feedback data 1118 comprise information regarding a material level within and/or a material flux into the removal container.

At times, the controller is configured to detect an operating state of the sieve assembly. For example, the operating state may be determined considering feedback from the one or more sensors. The operating state may be: (A) a nominal condition; or (B) a failure condition. The failure condition may comprise (i) an obstructed sieve screen, (ii) a punctured sieve screen, and/or (iii) a de-coupling of the sieve screen and the agitator (e.g., shaft). The material level and/or material flux (e.g., flow rate) at or into respective portions of the sieve assembly may comprise (e.g., characteristic) threshold values. The threshold values may be indicative of operation in a nominal condition. A high or low value may be determined considering a comparison to a given threshold value (e.g., at a respective sieve assembly portion). For example, an obstructed sieve screen condition may be detected based on feedback indicative of (a) a high material level in the top portion of the sieve assembly, (b) a low material flow rate into the bottom portion of the sieve assembly, (c) a high material flow rate into the removal container, and/or (d) an increased power output required by the agitator to maintain a given amplitude of movement. For example, a punctured sieve screen condition may be detected based on feedback indicative of (e) a high material flow rate into the bottom portion of the sieve assembly, (f) a high material flow rate into the (e.g., sieved) material container), and/or (g) a decreased power output required by the agitator to maintain a given amplitude of movement. For example, a de-coupling (e.g., de-coupled) sieve screen from an agitator condition may be detected based on feedback indicative (h) a decreased power output required by the agitator to maintain a given amplitude of movement. In some embodiments, an operating state is determined considering feedback from a combination of sensors. For example, feedback from at least two sensors of a plurality of sensors may be considered in the determination of the operating state. For example, feedback from at least two portions of the sieve assembly is considered in the determination of the operating state.

In some embodiments, the controller is a part of a (e.g., high-speed) computing environment. The computing environment may be any computing environment described herein. The computing environment may be any computer and/or processor described herein. The controller may control (e.g., alter, adjust) the parameters of the components of the 3D printer (e.g., before, after, and/or during at least a portion of the 3D printing). The control (e.g., open loop control) may comprise a calculation. The control may comprise a feedback loop control scheme. In some examples, the control scheme may comprise at least two of (i) open loop (e.g., empirical calculations), and (ii) closed loop (e.g., feed forward and/or feedback loop) control scheme. In some examples, the feedback loop(s) control scheme comprises one or more comparisons with an input parameter and/or threshold. The threshold may be a value, or a relationship (e.g., curve, e.g., function). The threshold may comprise a calculated (e.g., predicted) threshold (e.g., setpoint) value. The threshold may comprise adjustment according to the closed loop and/or feedback control. The controller may use a material level and/or a material flow rate measurement of at least one portion of the sieve assembly. The controller may direct adjustment of one or more systems and/or apparatuses in the 3D printing system. For example, the controller may direct adjustment of an angle at which a sieve cartridge is tilted within a sieve assembly, a flow rate of the material into the sieve assembly, and/or an agitator parameter. The agitation parameter may comprise frequency or amplitude of the agitation. For example, the controller may direct adjustment of (e.g., an amplitude and/or a frequency of) a sieve cartridge movement.

At times, the controller is configured to adjust one or more components and/or parameters of the sieve assembly in response to a detected condition. The adjustment may be performed in real time (e.g., before, during, and/or following at least a portion of the 3D printing). In some embodiments, in response to a detected sieve screen obstruction, the controller may be configured to (I) adjust an angle (e.g., tilt) at which the sieve cartridge is disposed within the sieve assembly, (II) adjust an agitator parameter (e.g., power output) to alter a sieve cartridge movement amplitude, and/or (III) initiate a sieve cartridge swap operation. In some embodiments, in response to a detected sieve puncture the controller may be configured to initiate a sieve cartridge swap operation. A sieve cartridge swap operation may be manual and/or automatic. For example, a sieve cartridge swap operation may be facilitated by a robot (e.g., robotic arm). In some embodiments, in response to a detected de-coupling of the sieve cartridge and the agitator the controller may be configured to initiate a maintenance operation. The maintenance operation may comprise coupling (e.g., re-coupling) the agitator (e.g., shaft) and the sieve cartridge. The maintenance operation may be manual and/or automatic.

At times, a build module of a 3D printing system is configured for operational coupling (e.g., engagement) with an unpacking station. Examples of build modules, unpacking stations, 3D printing systems, control systems, software, and related processes, can be found in International Patent Application Serial Number PCT/US17/39422, titled “THREE-DIMENSIONAL PRINTING AND THREE-DIMENSIONAL PRINTERS,” filed on Jun. 27, 2017, which is incorporated herein by reference in its entirety.

The unpacking station may be configured to engage with at least one build module. The unpacking station may be configured to manipulate (e.g., insert and/or remove) at least one build module to an unpacking chamber. The build module may comprise a platform upon which a 3D object formed by the 3D printing rests and/or is attached. The build module may comprise (e.g., un-transformed) pre-transformed material disposed surrounding the formed 3D object (e.g., a material collection). The unpacking station may be configured to remove (e.g., separate) a formed 3D object from a build plate (e.g., of the build module). The unpacking station may be configured to remove (e.g., recycle) at least some of the pre-transformed material from the build module. The unpacking may comprise a manipulator arm that is configured to grasp and to move a 3D object formed by the 3D printing and/or a build module. The unpacking may be a glove box that is configured to allow an operator in an ambient environment to grasp and to move a 3D object located in an environment different from ambient (e.g., an inert environment). The unpacking station may comprise a gas conveyor system. The unpacking station may comprise an unpacking material conveyor system. The gas and/or material conveyor systems may comprise at least one compressor, at least one blower, or at least one valve. In some embodiments, the unpacking material conveyor system forms a part of a material conveyor system of a coupled 3D printing system. In some embodiments, the unpacking material conveyor system is separate (e.g., distinct) from a material conveyor system of a coupled 3D printing system. The unpacking material conveyor system may comprise any of the components and/or any of the component arrangements of the 3D printing system material conveyor system(s) described herein.

In some examples, the unpacking station material conveyor system may comprise a plurality of gas conveying channels. At least two of the plurality of gas conveying channels may have at least one channel characteristic that is (e.g., substantially) the same. At least two of the plurality of gas conveying channels may have at least one channel characteristic that is different. The gas conveying channel may convey gas to one or more components of the unpacking station material conveyor system. The gas may comprise a pressure. The gas conveying channel may equilibrate pressure and/or content within one or more components of the unpacking station material conveyor system. For example, a gas conveying channel may equilibrate a first atmosphere within an unpacking chamber with a second atmosphere (e.g., of the bulk reservoir and/or of the pressure container(s)). The first atmosphere and/or second atmosphere may be a (e.g., substantially) inert atmosphere. The gas conveying channel may be operatively coupled (e.g., fluidly connected) to at least one of the material conveying channel(s), the pressure container(s), the unpacking chamber, the cyclone separator, the sieve assembly, the trash container, and/or the bulk reservoir.

In some embodiments, a pressure container contains one or more sensors configured to detect a material level within and/or a material flux into the pressure container. The one or more sensors can be any sensor as described herein. In response to a (e.g., detected) filled condition of a pressure container, the unpacking station may be configured to remove at least a portion of the material from the pressure container. The pressure container may be (e.g., fluidly) coupled with a removal channel. The removal channel may facilitate removal of the material from the filled pressure container to the material reservoir. In some embodiments, the removal channel is coupled with a portable vessel. The portable vessel removal channel (e.g., umbilical channel) may be used to facilitate a first transfer of material.

In some embodiments, an amount of material recycled by a recycling system (e.g., and by any of its components) is greater than an amount of material that remains in the material bed. The material that remains in the material bed may be that which remains following removal of excess material after dispensing the material. The material recycled may be excess material. The excess material may be removed (e.g., following a dispensing operation) to the recycling system by a leveling mechanism (e.g., a blade and/or a vacuum). For example, the amount of material recycled for a given deposited material layer may be greater than the amount of material that forms the given layer (e.g., that remains in the material bed). For example, the amount of material recycled (e.g., by the recycling system or any of its components) during formation of a 3D object may be greater than the amount of material deposited within a material bed during the formation of the 3D object. In some embodiments, the amount of material recycled by the recycling system (e.g., and by any of its components) may be a majority of the material dispensed (e.g., by a material dispenser). For example, the amount of material recycled may be at least about 51%, 60%, 70%, 80%, 85%, 90%, 95%, or 98% of the material dispensed by the material dispenser. The amount of material recycled may be any value within a range of the aforementioned values (e.g., from 51% to 98%, from 51% to 70%, or from 70% to 98%). The aforementioned (e.g., percentage) amount of recycled material may refer to a volume of material. The afore-mentioned (e.g., percentage) amount of recycled material may refer to a relative height of material (e.g., on the material bed). The recycling system may be configured to recycle at least 50 kilograms (kg), 100 kg, 200 kg, 500 kg, 1000 kg, 5000 kg, or 10000 kg of material during the printing and/or before the cartridge requires a change (e.g., without exchanging the filter). The recycling system (e.g., and by any of its components) may be configured to support these recycling characteristics.

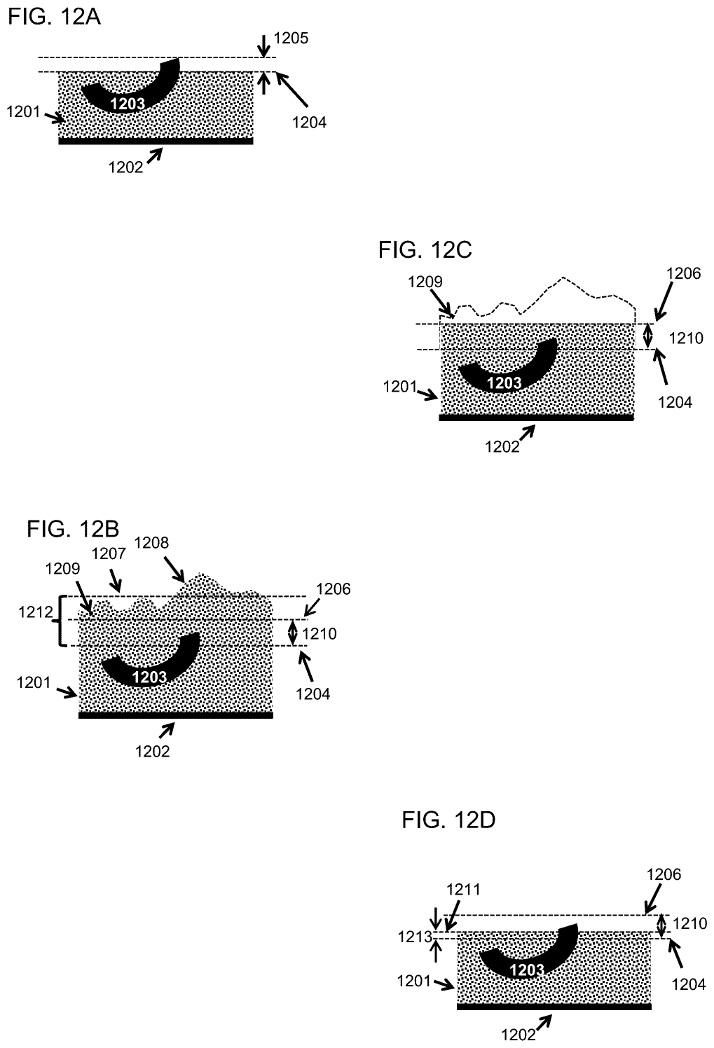

At times, the height of material is with respect to a height over a prior-formed material layer (e.g., having an exposed surface such as in FIG. 12A, 1204). For example, material (e.g., FIG. 12B, 1208) may be deposited (e.g., by the dispenser) to have an average height of at least about 750 μm, 850 μm, 950 μm or 1000 μm above a prior-formed material layer. FIG. 12B depicts an example of a plane 1207 that is situated at the average height 1212 of the material that is deposited above the prior-formed material layer plane 1204. The material may be deposited to have an average height of any value within a range of the aforementioned values (e.g., from about 750 μm to about 1000 μm, from about 750 μm to about 850 μm, or from 850 μm to about 1000 μm). The material recycling may be such as to have a remaining material height (e.g., FIG. 12D, 1213) above the prior-formed layer of at least about 30 μm, 40 μm, 50 μm, 60 μm, 70 μm, or 80 μm. The remaining height above the prior-formed layer may be any value within a range of the aforementioned values (e.g., from about 30 μm to about 80 μm, from about 30 μm to about 50 μm, or from about 50 μm to about 80 μm). In some embodiments, the volume of (e.g., excess) material recycled is at least about a factor of about 5, 8, 10, 15, 20, or 25 times greater than a volume of material that remains in the material bed (e.g., that forms material layers in the material bed). The volume of recycled material may be any value within a range of the aforementioned values (e.g., from 5 to 25, from 5 to 15, or from 15 to 25). The recycling system may recycle the material continuously. The recycling system may recycle the material periodically (e.g., at predetermined times).

FIGS. 12A-D show examples of various stages of a layering method described herein. FIG. 12A shows a powder bed 1201 in which a (bent) 3D object 1203 is suspended in the powder bed and is protruding from the exposed (top) surface of the powder bed by a distance 1205. The exposed surface of the powder bed can be leveled (e.g., as shown in FIG. 12A, having a leveled plane 1204), or not leveled. FIG. 12B shows a succeeding operation where a layer is deposited in the powder bed (e.g., above the plane 1204). The newly deposited layer may not have a planarized (e.g., leveled) top surface (e.g., 1208). The non-planar top (e.g., exposed) surface 1208 includes a lowest vertical point 1209. The plane 1206 is a plane that is situated at or below the lowest vertical point of the non-planar surface, and at or above the protruding height 1205. The plane 1206 is located higher than the top surface 1204 by a height 1210. FIG. 12C shows a succeeding operation where the layer is leveled to the vertical position of the plane 1206 by a leveling mechanism (e.g., FIG. 1, 117). That planarization can comprise shearing of the powder material. That planarization may not displace the excess of powder material to a different position in the powder bed. FIG. 12D shows a succeeding operation where the planar layer is leveled to a lower vertical plane level that is above 1204 and below 1206, and is designated as 1211. This second planarization operation may be conducted by the powder removal mechanism (e.g., FIG. 1, 118), which may or may not contact the exposed layer of the powder bed. This second planarization operation may or may not expose the protruding object. This second planarization operation may be a higher fidelity planarization operation. The average vertical distance from the first top surface to the second planar surface can be at least about 5 μm, 10 μm, 50 μm, 100 μm, 150 μm, 200 μm, 250 μm, 300 μm, 350 μm, 400 μm, 450 μm, or 500 μm. The average vertical distance from the first top surface to the second planar surface can be at most about 700 μm, 500 μm, 450 μm, 400 μm, 350 μm, 300 μm, 250 μm, 200 μm, 150 μm, 100 μm, 50 μm, 10 μm, or 5 μm. The average vertical distance from the first top surface to the second planar surface can be any of the afore-mentioned average vertical distance values. The average vertical distance from the first top surface to the second planar surface can be from about 5 μm to about 500 μm, from about 10 μm to about 100 μm, from about 20 μm to about 300 μm, or from about 25 μm to about 250 μm.

The average vertical distance from the first top surface to the second top surface can be at least about 5 μm, 10 μm, 50 μm, 100 μm, 150 μm, 200 μm, 250 μm, 300 μm, 350 μm, 400 μm, 450 μm, 500 μm, 1000 μm, or 1500 μm. The average vertical distance from the first top surface to the second top surface can be at most about 2000 μm, 1500 μm, 1000 μm, 700 μm, 500 μm, 450 μm, 400 μm, 350 μm, 300 μm, 250 μm, 200 μm, 150 μm, 100 μm, 50 μm, 10 μm, or 5 μm. The average vertical distance from the first top surface to the second top surface can be any of the afore-mentioned average vertical distance values. For example, the average vertical distance from the first top surface to the second top surface can be from about 5 μm to about 2000 μm, from about 50 μm to about 1500 μm, from about 100 μm to about 1000 μm, or from about 200 μm to about 500 μm.

At times, the material conveyor system comprises a gas that carries material to a (e.g., cyclonic) separator. The separator may separate the gas from a material, e.g., a solid material and/or a particulate material. The material carried by the gas may be transported via a channel (e.g., in a dilute conveyance phase). The material may comprise pre-transformed material and/or debris (e.g., fused particles, spatter and/or soot). The cyclonic separator may be configured to separate (e.g., at least a portion of) the material from the gas. For example, a cyclonic separator may be configured to separate (e.g., remove) material having at least a characteristic (e.g., separation) size. In some embodiments, particles of material having at least a characteristic (e.g., separation) FLS are removed from the incoming gas flow within the cyclonic separator. For example, a characteristic separation FLS for a particle of material to be separated from the gas flow within a cyclonic separator may be at least about 10 micron (μm), 15 μm, 20 μm, 50 μm, 100 μm, or 500 μm. The characteristic separation FLS for a cyclonic separator may be any value within a range of the aforementioned values (e.g., from about 10 μm to about 500 μm, from about 10 μm to about 100 μm, or from about 100 μm to about 500 μm). In some embodiments, a plurality of (e.g., cyclone) separators may separate the material from the gas. For example, the first separator may separate bulkier material (having a first maximal or average FLS), and the second separator may separate the final material (having a second maximal or average FLS that is smaller than the first maximal or average FLS respectively).

At times, a gas flow exiting the cyclonic separator comprises remaining material (e.g., that was not removed). For example, soot particles may remain in the gas flow following the (e.g., first) separation of the material from the gas flow. The exiting gas may comprise a remaining material including particles of a fundamental length scale (FLS) of at most about 0.1 μm, 0.5 μm, 1 μm, 2 μm, 5 μm, 8 μm or 10 μm. The remaining material particle FLS may be any value within a range of the aforementioned values (e.g., from about 0.1 μm to about 10 μm, from about 0.1 μm to about 5 μm, or from 5 μm to about 10 μm). The gas exiting the cyclonic separator may undergo a second cyclonic separation. The gas exiting the (e.g., first and/or second) cyclonic separator may be passed through a filter (e.g., scrubbed) to remove any remaining (e.g., fine) material. The filter may be a ventilation filter. The ventilation filter may capture fine particles (e.g., soot and/or powder) from the 3D printing system. The filter may comprise a paper, glass (e.g., fiber), carbon (e.g., fiber), metal (e.g., fiber), High Density Polyethylene, or polyethersulfone (PES) filter. The filter may be a membrane filter. The filter may comprise a high-efficiency particulate arrestance (HEPA) filter (a.k.a., high-efficiency particulate arresting or high-efficiency particulate air filter). The gas exiting the cyclonic separator may be provided (i) to another portion of the 3D printing system (e.g., to the processing chamber, to a pressure container), and/or (ii) to an unpacking station (e.g., unpacking chamber).

In some embodiments, an operation of the separator comprises a vortex separation (e.g., using a cyclone). For example, the operation of the cyclonic separator can comprise a centrifugal separation (e.g., using a cyclone). In some embodiments, an internal compartment of a separator comprises a cyclone. The operation of the cyclonic separator can comprise gravitational separation. The operation of the cyclonic separator can comprise rotation of the (e.g., pre-transformed) material and/or debris (e.g., in the internal compartment of the separator). The separator may be configured to separate gas borne particulates based on their (e.g., average) FLS. In some embodiments, particles of the material having the separation FLS are attracted to and/or thrusted to a wall of the cyclonic separator. The particles attracted to, and/or thrusted to the wall may be removed from the flow of gas that carried the material into the cyclonic separator (e.g., via a removal mechanism). The particles removed from the flow of gas may rest at a position configured to collect the particulate material upon separation, e.g., (i) a depression (e.g., crevice) at a wall of the separator or (ii) the bottom of the internal compartment of the cyclonic separator. Bottom may be towards the gravitational center, and/or towards a target surface. In some embodiments, the removed particles of material may be provided to (e.g., an inlet of) a further separation assembly (e.g., a sieve assembly).

In some embodiments, the flow of gas for carrying the material into the cyclonic separator is generated by a force source (e.g., a vacuum source, a pump, and/or a blower such as a fan). The material carried by the flow of gas may be transported into the internal compartment of the cyclonic separator from: (i) a material bed (e.g., of the processing chamber), (ii) a pressure container, (iii) an unpacking chamber, and/or (iv) a source of new (e.g., pre-transformed) material. The force source may be (e.g., fluidly) coupled with the internal compartment of the cyclonic separator and/or sieve. The gas(es) forced with the carried material into the internal compartment of the cyclonic separator may rotate within at a rotational speed to form a cyclone. The internal compartment may comprise a cone having its long axis perpendicular to the target surface and/or its narrow end pointing towards the target surface. The internal compartment may comprise a cone having its long axis perpendicular to a gravitational field vector and/or its narrow end pointing towards a gravitational field vector. Alternatively, the internal compartment may comprise a cone having its long axis parallel to the target surface and/or the gravitational field vector, and/or its narrow end pointing towards a side wall of the enclosure. The gas may flow in the internal compartment in a helical pattern along the long axis of the cyclone. During an operation of the cyclonic separator, the material moved into the cyclone may concentrate at the walls of the cyclone and gravitate to and accumulate at the depression in the wall of the separator (configured to collect the separating) and/or at the separator's bottom. The accumulated (e.g., pre-transformed and/or debris) material may be removed from the collection area. The accumulated material may be provided to a subsequent separator. In some embodiments, the material collecting at the walls travels to a second separator (e.g., a subsequent cyclone or a sieve assembly). In some embodiments, a subsequent separator comprises a sieve assembly. In some examples, the material that enters the internal compartment of the cyclonic separator is of a first velocity, and is attracted towards the force source. On its way to the force source, the material may lose its velocity in the internal compartment and precipitate toward the bottom of the cyclone and/or towards the collection area. In some examples, the gas that enters the internal compartment of the cyclonic separator is of a first velocity, and is attracted towards the force source (e.g., pump). On its way to the connector, the gaseous material may lose its velocity in the internal compartment, for example, due to an expansion of the cross section of the internal compartments. In some embodiments an obstruction may be placed to exacerbate a volume difference between portions of the cyclone that are closer to the exit opening relative to those further from the exit opening.

At times, the separation and subsequent filtration of the material from the gas flow is performed at predetermined times. For example, after one or more operations of planarizing a layer of pre-transformed material in the material bed, the cyclone may separate (e.g., pre-transformed and/or debris) material from a gas flow. For example, the exiting gas from the cyclonic separator may be filtered (e.g., scrubbed) of any remaining (e.g., soot) particles. Filtration of the exiting gas from the cyclonic separator may occur prior to introduction of the gas into a remaining portion of the 3D printing system (e.g., a processing chamber, an unpacking chamber). In some embodiments, the separation and subsequent filtration of the material from the gas flow is performed (e.g., substantially) continuously (e.g., in real time during at least part of the 3D printing, for example during transformation and/or during operation of the material conveyance system).

At times, the material conveyor system comprises at least two (e.g., cyclonic) separators. In some embodiments, at least two cyclonic separators may be arranged in parallel. For example, a channel comprising a gas carrying material may be an input for at least two cyclonic separators. In some embodiments, at least two cyclonic separators may be arranged in series. For example, a gas exiting from a first cyclonic separator may comprise an inlet gas for a subsequent cyclonic separator. In some embodiments, the gas is an inert gas. In some embodiments, a filter is disposed between an outlet of the cyclonic separator and an inlet to a (e.g., subsequent) compartment. The subsequent compartment may comprise (i) an internal compartment of a (e.g., subsequent) cyclonic separator, (ii) a processing chamber, (iii) a pressure container, and/or (iv) an unpacking chamber. In some embodiments, a plurality of filters is disposed between the outlet of the cyclonic separator and the inlet of the subsequent compartment. In some embodiments, at least two filters of the plurality of filters are configured to remove particles comprising about the same FLS. In some embodiments, at least two filters of the plurality of filters are configured to remove particles comprising a different FLS (e.g., soot from pre-transformed material). In some embodiments, one or more force sources are disposed between the filter(s) and the subsequent compartment(s). In some embodiments, one or more force sources are disposed between a compartment comprising the carried material and a cyclonic separator. The force sources may be any force source disclosed herein (e.g., a pump, or a blower).

At times, a 3D printing cycle corresponds with (i) depositing a (planar) layer of pre-transformed material (e.g., as part of a material bed) above a platform, and (ii) transforming at least a portion of the pre-transformed material to form one or more 3D objects above the platform (e.g., in the material bed). The depositing in (i) and the transforming in (ii) may comprise a print increment. At times, the platform supports a plurality of material beds. One or more 3D objects may be formed in a single material bed during a printing cycle (e.g., print job). The transformation may connect transformed material of a given layer (e.g., printing cycle) to a previously formed 3D object portion (e.g., of a previous printing cycle). The transforming operation may comprise utilizing an energy beam to transform the pre-transformed (or the transformed) material. In some instances, the energy beam is utilized to transform at least a portion of the material bed (e.g., utilizing any of the methods described herein). During a printing cycle, the one or more objects may be printed in the same material bed, above the same platform, with the same printing system, at the same time span, using the same printing instructions, or any combination thereof. A print cycle may comprise printing the one or more objects layer-wise (e.g., layer-by-layer). A layer may comprise a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for each layer of a print cycle within a material bed. In some embodiments, at least two layers of a print cycle within a material bed have different layer heights. A printing cycle may comprise a collection (e.g., sum) of print increments (e.g., deposition of a layer and transformation of a portion thereof to form at least part of the 3D object). A build cycle may comprise one or more build laps (e.g., the process of forming a printed incremental layer,

At times, (e.g., pre-transformed) material is added to the 3D printing system during the 3D printing operation. In some embodiments, the material may be added (e.g., from a bulk reservoir) to the 3D printing system without interruption of at least a portion of the 3D printing. Without interruption may refer to introduction of one or more materials to an environment of the 3D printing system. For example, with minimal introduction of (e.g., ambient air) a reactive agent to an (e.g., any) enclosed portion of the 3D printing system. The reactive agent may be a gas or may be gas borne. The reactive agent may comprise water, hydrogen sulfide, or oxygen. The reactive agent may react with the transformed material (e.g., during and/or after its transformation). Interruption may be regarding at least one process of the 3D printing system (e.g., formation of at least a portion of a 3D object). In some embodiments, the 3D printing system is able to print a plurality of objects without interruption due to a pre-transformed material addition operation. For example, the 3D printing system is able to print at least 1, 5, 10, 15, 50, 100, 500, or 1000 printing cycles without interruption by a pre-transformed material addition operation. The 3D printing system may uninterruptedly print any number of printing cycles within a range of the aforementioned number of printing cycles (e.g., from about 1 to about 1000 cycles, from about 1 to about 500 cycles, or from about 500 to about 1000 cycles). For example, the 3D printing system is able to print (e.g., transform) at least a threshold volume of material without interruption from a pre-transformed material addition operation. In some embodiments, the 3D printing system is able to transform (e.g., print) at a throughput of at least about 6 cubic centimeters of material per hour (cc/hr), 12 cc/hr, 48 cc/hr, 60 cc/hr, 120 cc/hr, 480 cc/hr, or 600 cc/hr. The 3D printing system may print at any rate within a range of the aforementioned values (e.g., from about 6 cc/hr to about 600 cc/hr, from about 6 cc/hr to about 120 cc/hr, or from about 120 cc/hr to about 600 cc/hr). The 3D printing system can operate (e.g., continuously) without interruption for a period of time of at least about 6 hours (hr), 8 hr, 12 hr, 16 hr, 24 hr, 2 days, 7 days, 15 days, or 1 month. The 3D printing system can operate (e.g., continuously) without interruption for a period of time of at least about 100 hours, 200 hours, 400 hours, 500 hours, 700 hours, or 1000 hours. The 3D printing system may operate without interruption for any period of time within a range of the aforementioned values (e.g., from about 6 hr to about 1 month, from about 6 hr to about 15 days, from 15 days to about 1 month, or from about 100 hours to about 1000 hours). In some embodiments, at least two pre-transformed material addition operations may be performed without interruption of the 3D printing system.

In some embodiments, the bulk reservoir (e.g., reversibly) couples with a component of the 3D printing system. For example, the (e.g., target) component with which the bulk reservoir couples to add the pre-transformed material may be (i) a pressure container, (ii) a (e.g., cyclonic) separator, (iii) a sieve assembly, or (iv) any combination thereof. The bulk reservoir may engage with the (e.g., target) component by a channel. The channel may facilitate coupling and/or fluidic connection of the bulk reservoir. Fluidic connection may refer to a flow of a material (e.g., in any material phase). The channel may comprise a gas flow. In some embodiments, pre-transformed material is moved from the bulk reservoir to the target component in a dense phase conveyance. In some embodiments, pre-transformed material is moved from the bulk reservoir to the target component in a dilute phase conveyance. In some embodiments, the bulk reservoir is configured to couple with at least two target components. In some embodiments, the bulk reservoir is configured to couple with the at least two target components (e.g., substantially) simultaneously. In some embodiments, the bulk reservoir is configured to couple with the at least two target components at alternating times. The insertion of the pre-transformed material into the component may be controlled. Control may comprise using one or more valves. The valves may be any valve described herein.

In some embodiments, pre-transformed material is added (e.g., inserted) to the 3D printing system at a predetermined time. In some embodiments, pre-transformed material is added to the 3D printing system in response to a determined state (e.g., a low pre-transformed material level). For example, a low pre-transformed material level (e.g., within a pressure container) may be determined considering data from one or more sensors disposed adjacent to or within a container. For example, a volume of material (e.g., remaining) in the 3D printing system may be determined considering a volume of pre-transformed material that has been transformed (e.g., during formation of at least a portion of a 3D object).

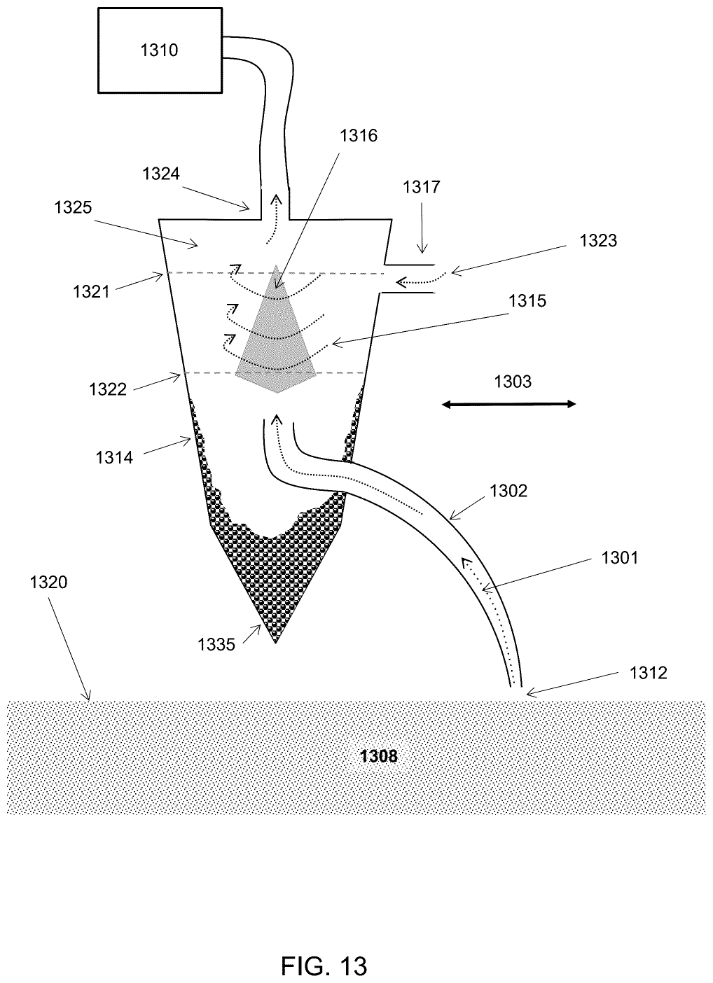

In some embodiments, the operation of a material removal mechanism of the 3D printing system comprises separating the pre-transformed material (e.g., particulate material) from a gas (e.g., in which the pre-transformed material is carried in). The separation can be with or without the use of one or more filters. The operation of the material removal mechanism can comprise a vortex separation (e.g., using a cyclone). For example, the operation of the material removal mechanism can comprise a centrifugal separation (e.g., using a cyclone). FIG. 13 shows an example of an internal compartment 1325 of the material removal mechanism. In some embodiments, the internal compartment of the material removal member comprises a cyclone. In some embodiments, the material removal mechanism comprises a cyclonic separator. In some embodiments, the material removal mechanism comprises cyclonic separation. The operation of the material removal mechanism can comprise gravitational separation. The operation of the material removal mechanism can comprise rotation of the pre-transformed material and/or debris (e.g., in the internal compartment of the material removal mechanism).

In some embodiments, the pre-transformed material (e.g., that is attracted to a force source) rests at the bottom of the internal compartment of the material removal mechanism. Bottom may be towards the gravitational center, and/or towards a target surface (e.g., of a material bed). The force source can be a vacuum source that may be connected to internal compartment (e.g., at a top position, e.g., 1324). The pre-transformed material (e.g., 1308) may be sucked into (e.g., 1301) the internal compartment from the target surface (e.g., 1320) through the nozzle (e.g., 1302) into the internal compartment (e.g., 1325). In some embodiments, the nozzle is separated from the exposed surface of the material bed by a gap (e.g., vertical distance, FIG. 13, 1312). The gap may comprise a gas. The gas may be an atmospheric gas. The gas(es) that is sucked with the pre-transformed material into the internal compartment (e.g., 1315) may rotate within at a rotational speed to form a cyclone. The internal compartment may comprise a cone having its long axis perpendicular to the target surface (and/or a gravitational field vector), and/or its narrow end pointing towards the target surface (and/or a gravitational field vector) (e.g., 1335). Alternatively, the internal compartment may comprise a cone having its long axis parallel to the target surface (and/or a gravitational field vector), and/or its narrow end pointing towards a side wall of the enclosure. The gas may flow in the internal compartment in a helical pattern along the long axis of the cyclone. During the process, the pre-transformed material (and/or debris) sucked into the cyclone, may concentrate at the walls of the cyclone (e.g., 1314) and gravitate to and accumulate at its bottom (e.g., 1335). The accumulated pre-transformed material (e.g., and/or debris) may be removed from the bottom of the cyclone. For example, after one or more operations of planarizing a layer of pre-transformed material in the material bed, the bottom of the cyclone may be opened and the accumulated pre-transformed material (e.g., and/or debris) within may be evacuated. In some examples, the pre-transformed material that enters the internal compartment of the material removal member is of a first velocity, and is attracted towards the force source (e.g., 1310), that is connected to the internal compartment through a connector 1324. On its way to the connector, the pre-transformed material may lose its velocity in the internal compartment and precipitate at the bottom of the cyclone. In some examples, the gas(es) material that enters the internal compartment of the material removal member from the nozzle is of a first velocity, and is attracted towards the force source (e.g., 1310), that is connected to the internal compartment through a connector 1324. On its way to the connector, the gas(es) material may lose its velocity in the internal compartment, for example, due to an expansion of the cross section of the internal compartments (e.g., diameter 1322 is smaller than diameter 1321). An optional hurdle (e.g., 1316) may be placed to exacerbate the volume difference between portions of the cyclone that are closer to the exit opening (e.g., 1324) relative to those further from the exit opening. In some examples, a secondary air flow flows into the cyclone (e.g., 1323) from an optional gas opening port (e.g., 1317). The gas opening port may be disposed adjacent to the nozzle (e.g., at the same side of the nozzle with respect to the direction of travel) (e.g., 1303). The gas opening port may be disposed at a direction relative to the direction of travel, that is different from the direction where the nozzle is disposed. The secondary air flow may reduce abrasion of the internal surface of the internal compartment walls (e.g., 1314). The secondary air flow may push the pre-transformed material from the walls of the internal compartment towards the narrow end of the cyclone (e.g., where it is collected).

In some embodiments, the methods, systems, and/or the apparatus described herein may comprise at least one valve. The valve may be shut or opened according to an input from the at least one sensor, or manually. The degree of valve opening, or valve shutting may be regulated by the control system, for example, according to at least one input from at least one sensor. The systems and/or the apparatus described herein can include one or more valves, such as throttle valves.

In some embodiments, the methods, systems, and/or the apparatus described herein comprise a motor. The motor may be controlled by the control system and/or manually. The apparatuses and/or systems described herein may include a system providing the material (e.g., powder material) to the material bed. The system for providing the material may be controlled by the control system, or manually. The motor may connect to a system providing the material (e.g., powder material) to the material bed. The system and/or apparatus of the present invention may comprise a material reservoir. The material may travel from the reservoir to the system and/or apparatus of the present invention. The material may travel from the reservoir to the system for providing the material to the material bed. The motor may alter (e.g., the position of) the substrate and/or to the base. The motor may alter (e.g., the position of) the elevator. The motor may alter an opening of the enclosure (e.g., its opening or closure). The motor may be a step motor or a servomotor. The methods, systems and/or the apparatus described herein may comprise a piston. The piston may be a trunk, crosshead, slipper, or deflector piston.

In some examples, the systems and/or the apparatus described herein comprise at least one nozzle. The nozzle may be regulated according to at least one input from at least one sensor. The nozzle may be controlled automatically or manually. The controller may control the nozzle. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle.

In some examples, the systems and/or the apparatus described herein comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valve-less pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump. In some examples, the systems and/or the apparatus described herein include one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector.

In some embodiments, the systems, apparatuses, and/or components thereof comprise a communication technology. The communication technology may comprise a Bluetooth technology. The systems, apparatuses, and/or components thereof may comprise a communication port. The communication port may be a serial port or a parallel port. The communication port may be a Universal Serial Bus port (i.e., USB). The systems, apparatuses, and/or components thereof may comprise USB ports. The USB can be micro or mini USB. The USB port may relate to device classes comprising 00 h, 01 h, 02 h, 03 h, 05 h, 06 h, 07 h, 08 h, 09 h, 0 Ah, 0 Bh, 0 Dh, 0 Eh, 0 Fh, 10 h, 11 h, DCh, EOh, EFh, FEh, or FFh. The surface identification mechanism may comprise a plug and/or a socket (e.g., electrical, AC power, DC power). The systems, apparatuses, and/or components thereof may comprise an adapter (e.g., AC and/or DC power adapter). The systems, apparatuses, and/or components thereof may comprise a power connector. The power connector can be an electrical power connector. The power connector may comprise a magnetically attached power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the systems, apparatuses, and/or components thereof comprise one or more controllers. The controller(s) can include (e.g., electrical) circuitry that is configured to generate output (e.g., voltage signals) for directing controlling one or more aspects of the apparatuses (or any parts thereof) described herein. The controllers may be shared between one or more systems or apparatuses. Each apparatus or system may have its own controller. Two or more systems and/or its components may share a controller. Two or more apparatuses and/or its components may share a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of 3D printing systems, control systems, software, and related processes, can be found in U.S. patent application Ser. No. 15/435,065 that is incorporated herein by reference in their entirety.

At times, the methods, systems, and/or the apparatus described herein further comprise a control system. The control system can be in communication with one or more energy sources and/or energy (e.g., energy beams). The energy sources may be of the same type or of different types. For example, the energy sources can be both lasers, or a laser and an electron beam. For example, the control system may be in communication with the first energy and/or with the second energy. The control system may regulate the one or more energies (e.g., energy beams). The control system may regulate the energy supplied by the one or more energy sources. For example, the control system may regulate the energy supplied by a first energy beam and by a second energy beam, to the pre-transformed material within the material bed. The control system may regulate the position of the one or more energy beams. For example, the control system may regulate the position of the first energy beam and/or the position of the second energy beam.

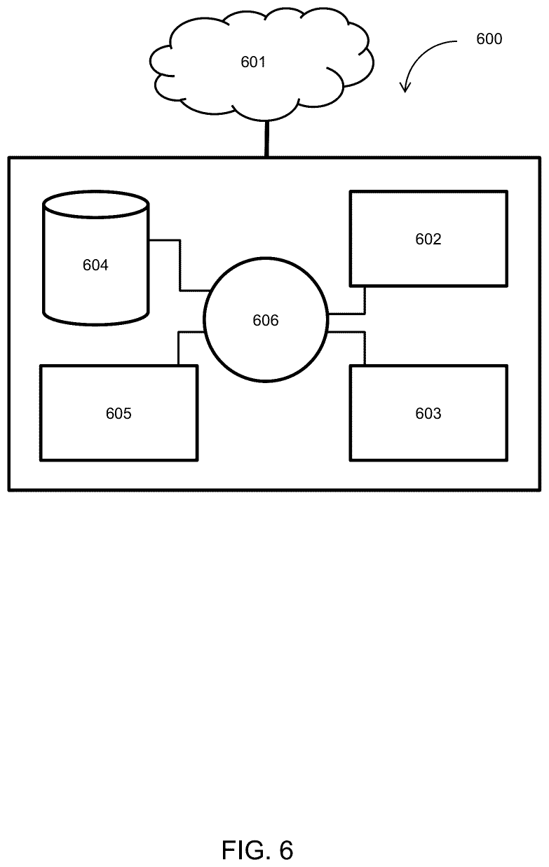

In some embodiments, the 3D printing system comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor (e.g., 3D printer processor) may be programmed to implement methods of the disclosure. The controller may control at least one component of the systems and/or apparatuses disclosed herein. FIG. 6 is a schematic example of a computer system 600 that is programmed or otherwise configured to facilitate the formation of a 3D object according to the methods provided herein. The computer system 600 can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 600 can be part of, or be in communication with, a 3D printing system or apparatus. The computer may be coupled to one or more mechanisms disclosed herein, and/or any parts thereof. For example, the computer may be coupled to one or more sensors, valves, switches, motors, pumps, scanners, optical components, or any combination thereof.

The computer system 600 can include a processing unit 606 (also “processor,” “computer” and “computer processor” used herein). The computer system may include memory or memory location 602 (e.g., random-access memory, read-only memory, flash memory), electronic storage unit 604 (e.g., hard disk), communication interface 603 (e.g., network adapter) for communicating with one or more other systems, and peripheral devices 605, such as cache, other memory, data storage and/or electronic display adapters. The memory 602, storage unit 604, interface 603, and peripheral devices 605 are in communication with the processing unit 606 through a communication bus (solid lines), such as a motherboard. The storage unit can be a data storage unit (or data repository) for storing data. The computer system can be operatively coupled to a computer network (“network”) 601 with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

In some examples, the processing unit executes a sequence of machine-readable instructions, which can be embodied in a program or software. The instructions may be stored in a memory location, such as the memory 602. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 600 can be included in the circuit.

In some examples, the storage unit 604 can store files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet.

In some embodiments, the computer system communicates with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 602 or electronic storage unit 604. The machine executable or machine-readable code can be provided in the form of software. During use, the processor 606 can execute the code. In some cases, the code can be retrieved from the storage unit and stored on the memory for ready access by the processor. In some situations, the electronic storage unit can be precluded, and machine-executable instructions are stored on memory.

At times, the code is pre-compiled and configured for use with a machine have a processer adapted to execute the code, or can be compiled during runtime. The code can be supplied in a programming language that can be selected to enable the code to execute in a pre-compiled or as-compiled fashion.

In some embodiments, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least about 0.2 billion transistors (BT), 0.5 BT, 1BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 0.1 Tera FLOPS (T-FLOPS), 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, from about 0.1 T-FLOP to about 10 EXA-FLOPS).). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

In some embodiments, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processing unit may be able to process computational schemes comprising a matrix or a vector. The core may comprise a complex instruction set computing core (CISC), or reduced instruction set computing (RISC).

In some embodiments, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise a computational scheme.

In some embodiments, the computer system includes configurable computing, partially reconfigurable computing, reconfigurable computing, or any combination thereof. The computer system may include a FPGA. The computer system may include an integrated circuit that performs the computational scheme. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, Ethernet media access control (MAC) blocks, or high-speed serial transceivers. DSP blocks can be DSP slices.

In some embodiments, the computing system includes an integrated circuit that performs the computational scheme (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the computational scheme output in at most about 0.1 microsecond (μs), 1 μs, 10 μs, 100 μs, or 1 millisecond (ms). The physical unit may produce the computational scheme output in any time between the above mentioned times (e.g., from about 0.1 μs, to about 1 ms, from about 0.1 μs, to about 100 μs, or from about 0.1 μs to about 10 μs).

In some instances, the controller uses calculations, real time measurements, or any combination thereof to regulate the energy beam(s). The sensor (e.g., temperature and/or positional sensor) may provide a signal (e.g., input for the controller and/or processor) at a rate of at least about 0.1 KHz, 1 KHz, 10 KHz, 100 KHz, 1000 KHz, or 10000 KHz). The sensor may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during the 3D printing process. The real-time measurements may be in situ measurements in the 3D printing system and/or apparatus. The real-time measurements may be during the formation of the 3D object. In some instances, the processing unit may use the signal obtained from the at least one sensor to provide a processing unit output, which output is provided by the processing system at a speed of at most about 100 min, 50 min, 25 min, 15 min, 10 min, 5 min, 1 min, 0.5 min (i.e., 30 sec), 15 sec, 10 sec, 5 sec, 1 sec, 0.5 sec, 0.25 sec, 0.2 sec, 0.1 sec, 80 milliseconds (msec), 50 msec, 10 msec, 5 msec, 1 msec, 80 microseconds (μsec), 50 μsec, 20 μsec, 10 μsec, 5 μsec, or 1 μsec. In some instances, the processing unit may use the signal obtained from the at least one sensor to provide a processing unit output, which output is provided at a speed of any value between the afore-mentioned values (e.g., from about 100 min to about 1 μsec, from about 100 min to about 10 min, from about 10 min to about 1 min, from about 5 min to about 0.5 min, from about 30 sec to about 0.1 sec, from about 0.1 sec to about 1 msec, from about 80 msec to about 10 μsec, from about 50 μsec to about 1 μsec, from about 20 μsec to about 1 μsec, or from about 10 μsec to about 1 μsec).

At times, the processing unit output comprises an evaluation of the temperature at a location, position at a location (e.g., vertical, and/or horizontal), or a map of locations. The location may be on the target surface. The map may comprise a topological or temperature map. The temperature sensor may comprise a temperature imaging device (e.g., IR imaging device).

At times, the processing unit uses the signal obtained from the at least one sensor in a computational scheme that is used in controlling the energy beam. The computational scheme may comprise the path of the energy beam. In some instances, the computational scheme may be used to alter the path of the energy beam on the target surface. The path may deviate from a cross section of a model corresponding to the requested 3D object. The processing unit may use the output in a computational scheme that is used in determining the manner in which a model of the requested 3D object may be sliced. The processing unit may use the signal obtained from the at least one sensor in a computational scheme that is used to configure one or more parameters and/or apparatuses relating to the 3D printing process. The parameters may comprise a characteristic of the energy beam. The parameters may comprise movement of the platform and/or material bed. The parameters may comprise relative movement of the energy beam and the material bed. In some instances, the energy beam, the platform (e.g., material bed disposed on the platform), or both may translate. Alternatively, or additionally, the controller may use historical data for the control. Alternatively, or additionally, the processing unit may use historical data in its one or more computational schemes. The parameters may comprise the height of the layer of powder material disposed in the enclosure and/or the gap by which the cooling element (e.g., heat sink) is separated from the target surface. The target surface may be the exposed layer of the material bed.

In some embodiments, aspects of the systems, apparatuses, and/or methods provided herein, such as the computer system, are embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some embodiments, the memory comprises a random-access memory (RAM), dynamic random-access memory (DRAM), static random-access memory (SRAM), synchronous dynamic random-access memory (SDRAM), ferroelectric random-access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some embodiments, all or portions of the software are communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

In some embodiments, the computer system includes or is in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

In some embodiments, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some embodiments, the computer system includes, or is in communication with, an electronic display unit that comprises a user interface (UI) for providing, for example, a model design or graphical representation of an object to be printed. Examples of UI's include a graphical user interface (GUI) and web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., monitor) may display various parameters of the printing system (as described herein) in real time or in a delayed time. The display unit may display the requested printed 3D object (e.g., according to a model), the printed 3D object, real time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the pre-transformed material. The display unit may display the amount of a certain gas in the chamber. The gas may comprise oxygen, hydrogen, water vapor, or any of the gasses mentioned herein. The display unit may display the pressure in the chamber. The computer may generate a report comprising various parameters of the methods, objects, apparatuses, or systems described herein. The report may be generated at predetermined time(s), on a request (e.g., from an operator) or at a whim.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the requested result). Examples of 3D printing systems, control systems and related computational schemes (e.g. algorithms), software, and related processes, can be found in U.S. patent application Ser. No. 15/435,065 that is incorporated herein by reference in their entirety.

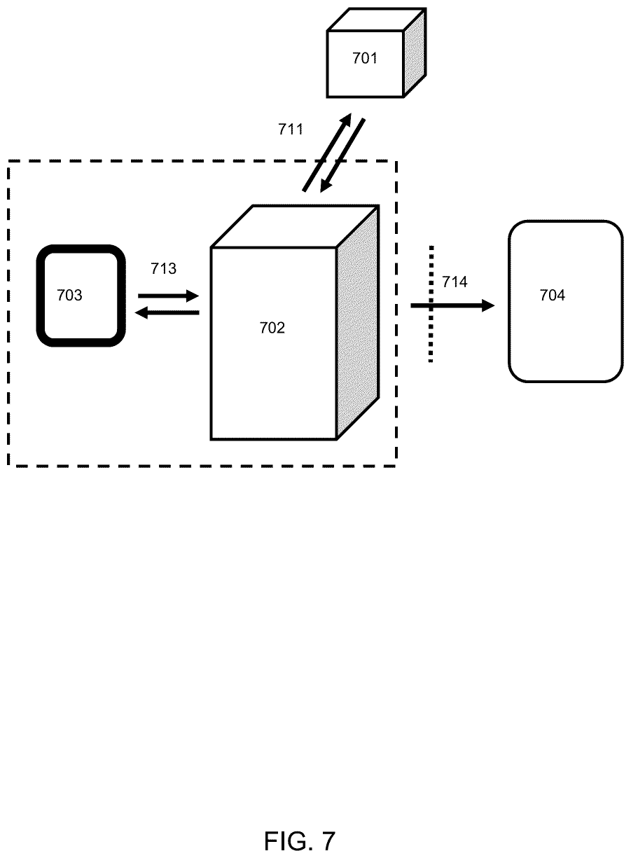

In some embodiments, the 3D printer comprises and/or communicates with a multiplicity of processors. The processors may form a network architecture. Examples of a processor architectures is shown in FIG. 7. FIG. 7 shows an example of a 3D printer 702 comprising a processor that is in communication with a local processor (e.g., desktop) 701, a remote processor 704, and a machine interface 703. The 3D printer interface is termed herein as “machine interface.” The communication of the 3D printer processor with the remote processor and/or machine interface may or may not be through a server. The server may be integrated within the 3D printer. The machine interface may be integrated with, or closely situated adjacent to, the 3D printer 702. Arrows 711 and 713 designate local communications. Arrow 714 designates communicating through a firewall (shown as a discontinuous line). A machine interface may communicate directly or indirectly with the 3D printer processor. A 3D printing processor may comprise a plurality of machine interfaces. Any of the machine interfaces may be optionally included in the 3D printing system. The communication between the 3D printer processor and the machine interface processor may be unidirectional (e.g., from the machine interface processor to the 3D printer processor), or bidirectional. The 3D printer processor may be connected directly or indirectly to one or more stationary processors (e.g., desktop). The 3D printer processor may be connected directly or indirectly to one or more mobile processors (e.g., mobile device). The 3D printer processor may be connected directly or indirectly (e.g., through a server) to processors that direct 3D printing instructions. The connection may be local (e.g., in 701) or remote (e.g., in 704). The 3D printer processor may communicate with at least one 3D printing monitoring processor. The 3D printing processor may be owned by the entity supplying the printing instruction to the 3D printer, or by a client. The client may be an entity or person that requests at least one 3D printing object.

In some embodiments, the 3D printer comprises at least one processor (referred herein as the “3D printer processor”). The 3D printer may comprise a plurality of processors. At least two of the plurality of the 3D printer processors may interact with each other. At times, at least two of the plurality of the 3D printer processors may not interact with each other. Discontinuous line 714 illustrates a firewall.

A 3D printer processor may interact with at least one processor that acts as a 3D printer interface (also referred to herein as “machine interface processor”). The processor (e.g., machine interface processor) may be stationary or mobile. The processor may be on a remote computer system. The machine interface one or more processors may be connected to at least one 3D printer processor. The connection may be through a wire (e.g., cable) or be wireless (e.g., via Bluetooth technology). The machine interface may be hardwired to the 3D printer. The machine interface may directly connect to the 3D printer (e.g., to the 3D printer processor). The machine interface may indirectly connect to the 3D printer (e.g., through a server, or through wireless communication). The cable may comprise coaxial cable, shielded twisted cable pair, unshielded twisted cable pair, structured cable (e.g., used in structured cabling), or fiber-optic cable.

At times, the machine interface processor directs 3D print job production, 3D printer management, 3D printer monitoring, or any combination thereof. The machine interface processor may not be able to influence (e.g., direct, or be involved in) pre-print or 3D printing process development. The machine management may comprise controlling the 3D printer controller (e.g., directly, or indirectly). The printer controller may direct starting a 3D printing process, stopping a 3D printing process, maintenance of the 3D printer, clearing alarms (e.g., concerning safety features of the 3D printer).

At times, the machine interface processor allows monitoring of the 3D printing process (e.g., accessible remotely or locally). The machine interface processor may allow viewing a log of the 3D printing and status of the 3D printer at a certain time (e.g., 3D printer snapshot). The machine interface processor may allow to monitor one or more 3D printing parameters. The one or more printing parameters monitored by the machine interface processor can comprise 3D printer status (e.g., 3D printer is idle, preparing to 3D print, 3D printing, maintenance, fault, or offline), active 3D printing (e.g., including a build module number), status and/or position of build module(s), status of build module and processing chamber engagement, type and status of pre-transformed material used in the 3D printing (e.g., amount of pre-transformed material remaining in the reservoir), status of a filter, atmosphere status (e.g., pressure, gas level(s)), ventilator status, layer dispensing mechanism status (e.g., position, speed, rate of deposition, level of exposed layer of the material bed), status of the optical system (e.g., optical window, mirror), status of scanner, alarm (boot log, status change, safety events), motion control commands (e.g., of the energy beam, or of the layer dispensing mechanism), or printed 3D object status (e.g., what layer number is being printed),

At times, the machine interface processor allows monitoring the 3D print job management. The 3D print job management may comprise status of each build module (e.g., atmosphere condition, position in the enclosure, position in a queue to go in the enclosure, position in a queue to engage with the processing chamber, position in queue for further processing, power levels of the energy beam, type of pre-transformed material loaded, 3D printing operation diagnostics, status of a filter. The machine interface processor (e.g., output device thereof) may allow viewing and/or editing any of the job management and/or one or more printing parameters. The machine interface processor may show the permission level given to the user (e.g., view, or edit). The machine interface processor may allow viewing and/or assigning a certain 3D object to a particular build module, prioritize 3D objects to be printed, pause 3D objects during 3D printing, delete 3D objects to be printed, select a certain 3D printer for a particular 3D printing job, insert and/or edit considerations for restarting a 3D printing job that was removed from 3D printer. The machine interface processor may allow initiating, pausing, and/or stopping a 3D printing job. The machine interface processor may output message notification (e.g., alarm), log (e.g., other than Excursion log or other default log), or any combination thereof. The 3D printer may interact with at least one server (e.g., print server). The 3D print server may be separate or interrelated in the 3D printer.

At times, one or more users may interact with the one or more 3D printing processors through one or more user processors (e.g., respectively). The interaction may be in parallel and/or sequentially. The users may be clients. The users may belong to entities that request a 3D object to be printed, or entities who prepare the 3D object printing instructions. The one or more users may interact with the 3D printer (e.g., through the one or more processors of the 3D printer) directly and/or indirectly. Indirect interaction may be through the server. One or more users may be able to monitor one or more aspects of the 3D printing process. One or more users can monitor aspects of the 3D printing process through at least one connection (e.g., network connection). For example, one or more users can monitor aspects of the printing process through direct or indirect connection. Direct connection may be using a local area network (LAN), and/or a wide area network (WAN). The network may interconnect computers within a limited area (e.g., a building, campus, neighborhood). The limited area network may comprise Ethernet or Wi-Fi. The network may have its network equipment and interconnects locally managed. The network may cover a larger geographic distance than the limited area. The network may use telecommunication circuits and/or internet links. The network may comprise Internet Area Network (IAN), and/or the public switched telephone network (PSTN). The communication may comprise web communication. The aspect of the 3D printing process may comprise a 3D printing parameter, machine status, or sensor status. The 3D printing parameter may comprise hatch strategy, energy beam power, energy beam speed, energy beam focus, thickness of a layer (e.g., of hardened material or of pre-transformed material).

At times, a user may develop at least one 3D printing instruction and direct the 3D printer (e.g., through communication with the 3D printer processor) to print in a requested manner according to the developed at least one 3D printing instruction. A user may or may not be able to control (e.g., locally, or remotely) the 3D printer controller. For example, a client may not be able to control the 3D printing controller (e.g., maintenance of the 3D printer).

At times, the user (e.g., other than a client) processor may use real-time and/or historical 3D printing data. The 3D printing data may comprise metrology data, or temperature data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

The fundamental length scale (e.g., the diameter, spherical equivalent diameter, diameter of a bounding circle, or largest of height, width and length; abbreviated herein as “FLS”) of the printed 3D object or a portion thereof can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object or a portion thereof can be at most about 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. The FLS of the printed 3D object or a portion thereof can any value between the afore-mentioned values (e.g., from about 50 μm to about 1000 m, from about 500 μm to about 100 m, from about 50 μm to about 50 cm, or from about 50 cm to about 1000 m). In some cases, the FLS of the printed 3D object or a portion thereof may be in between any of the afore-mentioned FLS values. The portion of the 3D object may be a heated portion or disposed portion (e.g., tile).

At times, the layer of pre-transformed material (e.g., powder) is of a predetermined height (thickness). The layer of pre-transformed material can comprise the material prior to its transformation in the 3D printing process. The layer of pre-transformed material may have an upper surface that is substantially flat, leveled, or smooth. In some instances, the layer of pre-transformed material may have an upper surface that is not flat, leveled, or smooth. The layer of pre-transformed material may have an upper surface that is corrugated or uneven. The layer of pre-transformed material may have an average or mean (e.g., pre-determined) height. The height of the layer of pre-transformed material (e.g., powder) may be at least about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of pre-transformed material may be at most about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of pre-transformed material may be any number between the afore-mentioned heights (e.g., from about 5 μm to about 1000 mm, from about 5 μm to about 1 mm, from about 25 μm to about 1 mm, or from about 1 mm to about 1000 mm). The “height” of the layer of material (e.g., powder) may at times be referred to as the “thickness” of the layer of material. In some instances, the layer of hardened material may be a sheet of metal. The layer of hardened material may be fabricated using a 3D manufacturing methodology. Occasionally, the first layer of hardened material may be thicker than a subsequent layer of hardened material. The first layer of hardened material may be at least about 1.1 times, 1.2 times, 1.4 times, 1.6 times, 1.8 times, 2 times, 4 times, 6 times, 8 times, 10 times, 20 times, 30 times, 50 times, 100 times, 500 times, 1000 times, or thicker (higher) than the average (or mean) thickness of a subsequent layer of hardened material, the average thickens of an average subsequent layer of hardened material, or the average thickness of any of the subsequent layers of hardened material.

In some instances, one or more intervening layers separate adjacent components from one another. For example, the one or more intervening layers can have a thickness of at most about 10 micrometers (“microns”), 1 micron, 500 nanometers (“nm”), 100 nm, 50 nm, 10 nm, or 1 nm. For example, the one or more intervening layers can have a thickness of at least about 10 micrometers (“microns”), 1 micron, 500 nanometers (“nm”), 100 nm, 50 nm, 10 nm, or 1 nm. In an example, a first layer is adjacent to a second layer when the first layer is in direct contact with the second layer. In another example, a first layer is adjacent to a second layer when the first layer is separated from the second layer by a third layer. In some instances, adjacent to may be ‘above’ or ‘below.’ Below can be in the direction of the gravitational force or towards the platform. Above can be in the direction opposite to the gravitational force or away from the platform.

In some embodiments, the 3D printing system comprises a processing chamber, a garage, a bounceable plate (e.g., deck) configured for material maneuvering, and a sieve configured to receive material from the bounceable plate. The bounceable plate may receive the material that was not used to form one or more 3D objects (e.g., remainder material), e.g., during a printing cycle. For example, the remainder material may comprise material attracted by the layer dispensing mechanism (e.g., recoater. E.g., 234) during generation of a planar layer of pre-transformed material as part of the material bed (e.g., 204). For example, the remainder material may comprise material disposed in the ancillary chamber (e.g., on its floor, or in the layer depositing mechanism, e.g., as it is situated (e.g., parked) in the ancillary chamber. For example, the bounceable plate can be configured to receive remainder material directly and/or indirectly from the layer dispensing mechanism such as when it is disposed (e.g., parked) in the ancillary chamber (e.g., 254 such as a garage), and/or during its operation. For example, the bounceable plate can be configured to receive remainder material from the ancillary chamber. The material may be received from separator(s) such as cyclone(s). The material may be received from the material conveyance system. The sieved material may accumulate in one or more reservoirs. A lower portion of the bounceable plate enclosure may overlap the roof of the sieve assembly enclosure by an overlap region. The overlap region may extend to at least about 50%, 40%, 30%, 20% or 10% of the roof of the enclosure and/or the bottom of the bounceable plate enclosure. The overlap region may extend to at most about 20%, 30%, 40%, 50%, 60%, 70%, or 80% of the roof of the enclosure and/or the bottom of the bounceable plate enclosure. The overlap region may extend to a percentage value of the roof of the enclosure and/or of the bottom of the bounceable plate enclosure between any of the aforementioned percentages (e.g., from about 10% to about 80%, from about 10% to about 70%, or from about 30% to about 80%). The bounceable plate may extend horizontally from one side of its enclosure to the other side, leaving a gap between a side of the bounceable plate and its immediately adjacent vertical wall. The gap may extend to at least about 10%, 20%, or 30%, of the roof of the bounceable plate enclosure. The gap may extend to at most about 5%, 10%, 20%, 30%, or 40% of the roof of the bounceable plate enclosure. The gap may extend to a percentage value of the roof of the enclosure and/or of the bottom of the bounceable plate enclosure between any of the aforementioned percentages (e.g., from about 5% to about 40%, from about 5% to about 30%, or from about 10% to about 40%). The percentages may represent volume per volume percentages, or area per area percentages (e.g., horizontal or vertical cross-sectional area). The bounceable plate may convey material from one compartment of the 3D printing system to another. For example, from the layer dispensing mechanism, the ancillary chamber, and/or the material separator(s); to the sieve.

In some embodiments, the enclosure comprises a material type. In some embodiments, the enclosure comprises a plurality of material types. The material types can be any material disclosed herein. The material may comprise elemental metal, metal alloy, or glass. Th material may be transparent or opaque. For example, one wall of the enclosure may comprise one type of material (e.g., metal alloy such as stainless steel), and another type may comprise glass (e.g., Plexiglas). The wall comprising the transparent material may be utilized for installation, inspecting operation, and/or maintenance. At least one wall of the enclosure may be removable (e.g., during installation, inspection of operation, and/or maintenance). The enclosures directly coupled to each other may include one or more seal therebetween. For example, the bounceable material enclosure may comprise a seal that contacts the sieve assembly enclosure, to couple the bounceable material enclosure to the sieve assembly enclosure. The seal may facilitate maintaining an atmosphere internal to the enclosures different from an ambient temperature external to the enclosure. The seal may facilitate reducing (e.g., eliminating) spillage of any material destined for recycling and/or separations using the coupled enclosures. The material may comprise pre-transformed material. The material may comprise starting material for one or more subsequent (e.g., future) printing cycles.

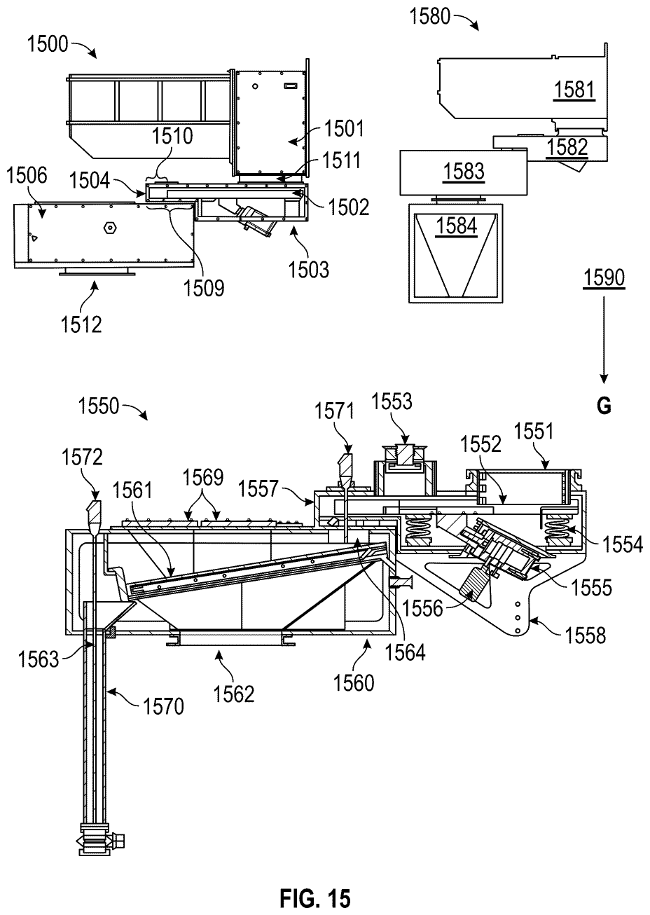

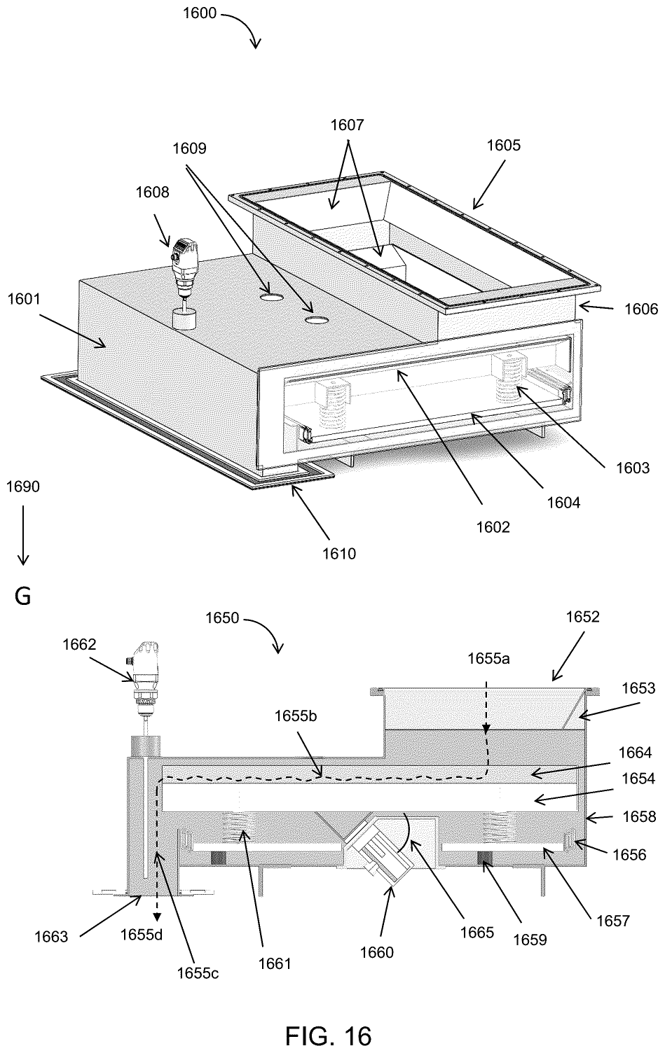

FIG. 15 shows in example 1580 silhouette side view example of a portion of a 3D printing system comprising an ancillary chamber 1581, a bounceable plate enclosure 1582, a sieving assembly enclosure 1583, and a material reservoir 1584, e.g., comprising recycled starting material for subsequent printing cycle(s). FIG. 15 shows in example 1500 a side view example of an ancillary chamber enclosure 1501 coupled to a bounceable plate 1502 disposed in a bounceable plate enclosure 1503 that is coupled to a sieve assembly enclosure 1506 comprising a sieve (not shown). A side wall of the bounceable plate enclosure is removed for didactive purposes. A lower portion of the bounceable plate enclosure 1503 overlaps the roof of the sieve assembly enclosure 1506 with overlap 1509. Bounceable plate 1502 extends horizontally from one side of its enclosure to the other side, leaving a gap 1510 between a side of the bounceable plate 1503 and wall 1504. The sieve assembly enclosure has a bottom opening 1512 configured to facilitate transition of the material from the sieve assembly enclosure to the rest of the material conveyance system (e.g., to a material reservoir such as a hopper). The bounceable plate in example 1500 shows a top opening 1511 disposed at the roof of the material conveyance system operatively coupled to ancillary chamber 1501; and a bottom opening disposed in area 1509 that facilitates pouring of material from the bounceable plate to the sieve assembly enclosure for separation. FIG. 15 shows in example 1550 vertical cross-sectional example of a bounceable plate 1552 dispose in an enclosure 1557 having a top opening 1551 configured to receive material originating from an ancillary chamber, and one or more top openings 1553 configured to receive material from a layer dispensing material (e.g., during its operation such as during printing). Bounceable plate 1552 is operatively coupled to springs such as 1554, and to actuator 1555, both of which facilitate its bouncing motion. Actuator 1555 is a pneumatic actuator receiving gas (e.g., air) pressure, e.g., from, or through, gas source 1556. Bounceable plate enclosure 1557 is supported by a supporting structure 1558 coupled to the bottom of bounceable plate enclosure 1557. Bounceable plate enclosure 1557 overlaps in a portion of its lower portion distant from opening 1551, a sieve assembly enclosure 1560 having sieve 1561 disposed therein, which sieve 1561 is tilted with respect to the horizon. Sieve assembly enclosure 1560 has a first exit opening 1562 disposed at its bottom, and a second exit opening 1563 also disposed at the bottom towards the edge of the sieve assembly chamber, and is configured to facilitate large remainders of material not sieved by the sieve, e.g., to a removal container (e.g., 962) such as a garbage container. The second exit opening is operatively coupled to channel 1570 that may lead to the removal container (e.g., comprising material for trashing). Sieve assembly container 1560 comprises one or more to openings 1569 that may be covered with a window and/or plaque. Sieve assembly container 1560 comprises an opening 1564 that may be covered with a window and/or plaque. Bounceable plate enclosure 1557 comprises at its top an opening filling sensor 1571, and sieve assembly enclosure 1560 comprises at its top an opening fitting sensor 1572. Sensor 1571 can extend into sieve assembly opening 1560. Sensor 1572 can extend into channel 1568 that direct the material to a removal container (not shown). Sensor 1572 can optionally extend into the removal container. Sensors 1571 and 1572 can be configured to measure temperature, pressure, or material level. Sensor 1571 and 1572 can be of the same type or of different type. Examples 1500, 1580, and 1550 are aligned with respect to gravitational vector 1590 pointing towards gravitational center G. Up, down, below, above, top, and bottom in relation to FIG. 15, are with respect to gravitational vector 1590. FIG. 16 shows in example 1600 a perspective view of bounceable plate enclosure 1601 having bounceable plate 1602 coupled to springs such as 1603. The springs are disposed on a platform that may be stationary. Bounceable plate enclosure 1601 has a first top opening 1605 to which a vertical extension 1606 is coupled and configured to attach to the ancillary chamber enclosure. Vertical extension 1606 comprises internal slated planes such as 1607 to facilitate flow of material from the ancillary chamber (e.g., garage) enclosure to bounceable plate enclosure 1601. Bounceable plate enclosure has a second top opening configured to accommodate sensor 1608, and additional top openings 1609 configured to couple (e.g., indirectly) to the layer dispensing mechanism and/or material separator(s) (e.g., FIG. 3, 345). Bounceable plate enclosure 1601 comprises a bottom opening 1610 configured to facilitate material flow from bounceable plate 1602 outward from bounceable plate enclosure 1601, e.g., to a sieving assembly enclosure to be separated by a sieve. Examples 1600 and 1650 are aligned with respect to gravitational vector 1690 pointing towards gravitational center G. Up, down, below, above, top, and bottom in relation to FIG. 16, are with respect to gravitational vector 1690.

In some embodiments, the bounceable plate (e.g., material receiver plate) is coupled to an actuator. The actuator may comprise a linear actuator. The actuator may cause the plate to move up as it pushes a pin in a vertical direction towards the bounceable plate and against the gravitational vector pointing towards a gravitational center. Repeated pushing and pulling of the pin may cause the plate to bounce, which may cause any material deposited thereon to bounce. Without wishing to be bound to theory, this may be due to actions of the actuator and pulling of the gravitational force). The bouncing of the material on the plate may be respective to the pulling and pushing of the actuator pin coupled to the plate in an opposite direction to the material. When the actuator pushes the plate at an angle, it may bounce at a direct of the angle (e.g., bounce in directional movement). The directional bouncing of the plate may in turn cause any material disposed on it to bounce in that direction until it reaches an edge of the plate and falls in a vertical direction towards the gravitational center (e.g., due to gravitational attraction). If the direction is pointing towards an exit opening, the material will fall through that exit. When the material comprises liquid or a particular material of appropriate amount, falling of the material from the edge of the plate may generate a material fall.

The actuator may be disposed such that it is situated crossing the center of gravity of the bounceable plate (e.g., vibrating material receiving plate). Placing the actuator at the center of gravity of the bounceable plate may attenuate (e.g., prevent) a turbulence or vertex motion (e.g., no torque or offset motion) of the materials (e.g., of particles) during its bouncing on the plate. Placing the actuator at the center of gravity of the bounceable plate may promote migration of the material (e.g., substantially) linearly in the direction of the edge of the bounceable plate (e.g., the vibrating material receiving plate). The material (e.g., particles thereof) may propagate uniformly along the bouncing plate. The actuator may facilitate constant and/or adjustable rate of material flow from the edge (e.g., side) of the bouncing plate (e.g., and towards the sieve). When material constantly falls on the bouncing plate at a (e.g., substantially constant rate), and/or the actuator actuates and contracts at prescribed repetitions, an amount of material falling from the bouncing plate may be anticipated (e.g., predicted). Control of (i) material accumulation rate on the bouncing plate, (ii) direction of actuator action repetition, (iii) rate of repetition, (iv) force of actuated movement of the plate by the actuator, and/or (v) positional placement of the actuator with respect to the bouncing plate and/or center of gravity thereof; may facilitating control of an amount of material falling off the edge of the bouncing plate (e.g., and fed to the sieve). The bounceable plate may be a horizontal plate, or may be tilted with respect to the horizon, e.g., at its resting position. In other embodiments, the actuator is in a position different from the center of gravity of the structure.

FIG. 16 shows in example 1650 a cross section of bounceable plate 1654 disposed in bounceable plate enclosure 1688 having opening 1652 a vertically upwards extension that includes one or more internal slanted sections such as 1653. Opening 1652 is configured to facilitate material to flow therethrough as along arrow 1655a. The slanted sections shown in example 1650 are disposed adjacent to one side wall of the upwards extension and is absent from its opposing side wall of the extension. Another side wall 1664 is coupled to bounceable plate 1654. Bounceable plate 1654 is coupled to springs such as 1661 that facilitates its bouncing motion aided by actuator 1660 disposed at angle 1665 relative to the bottom of bounceable plate 1654. The springs are disposed on platform 1657 (e.g., baseplate) supported by supports such as 1659 disposed at bottom of the bounceable plate enclosure 1658. Bounceable plate enclosure 1658 is coupled to sensor 1662 extending from a top portion of the bounceable enclosure opposing a bottom opening 1663. Platform 1657 may be stationary. The spring platform (e.g., baseplate) may bounce at a smaller amplitude as compared to the bounceable plate. Platform 1657 is secured to walls of the bounceable plate enclosure 1658 with coupling aids (e.g., railings) 1656. The fastening aids may comprise chains, brackets, or railings. For example, the railings can be similar to a drawer railing system, which easy installation, inspection, and/or maintenance. The bounceable plate enclosure can be configured the facilitate easy removal of bounceable plate and components coupled thereto, from the bounceable plate enclosure. The components coupled to the bounceable plate may include springs, baseplate, baseplate supports, actuator, actuator mounting, side walls, internal walls, and/or slanted plates. Easy removal of the bounceable plate and its associated components may by sliding on railings. Material enters into a vertical upwards extension in opening 1652 onto bounceable plate 1654, e.g., using gravity. Actuator 1660 may push bounceable plate at the angle 1615, causing material (e.g., particulate material such as powder) disposed on bounceable plate to be pushed upwards. Once actuator 1660 retracts, the springs contract and pull bounceable plate 1654 towards its former resting position, causing the material to fall onto the bounceable plate (now bouncing). The actuator may push and retract at (e.g., prescribed) repetitive intervals causing the material to bounce respectively. Since the actuator pushes the bounceable plate 1654, which pushing is horizontally angled towards exit opening 1663, the material bouncing respectively with the bounceable (now bouncing) plate 1654 will propagate horizontally towards exit opening 1663. Bouncing of the material along bounceable plate 1654 is illustrated in 1655b. Once the material reaches beyond an edge of bounceable plate 1654, it will fall towards exit opening 1655d in a direction 1655c, thus creating a material fall.

The atmosphere in at least one (e.g., all of) the three enclosures (e.g., ancillary chamber enclosure, bounceable plate enclosure, and sieve assembly enclosure) have an atmosphere different than an ambient atmosphere external to the respective enclosure. The atmosphere can be (e.g., substantially) the atmosphere residing in the processing chamber. For example, the atmosphere can have a pressure above ambient pressure (e.g., positive pressure), and have a lower content of reactive species (e.g., be an inert or a substantially inert atmosphere) as compared to the ambient atmosphere. The reactive species may react with the remainder and/or pre-transformed material. The reactive species may comprise oxygen, hydrogen, or water (e.g., vapor). The bounceable plate enclosure and/or the sieve assembly enclosure can (e.g., each) comprise one or more sensors (e.g., a plurality of sensors) be configured to measure temperature, pressure, or material level. The sensor can be any sensor disclosed herein, and measure any property disclosed herein. At least two of the plurality of sensors can be of a different type. At least two of the plurality of sensors can be of the same sensor type.

In some embodiments, the bounceable plate enclosure comprise one or more seals. The seal may aid in reducing (e.g., preventing) material splatter during bouncing of the bounceable plate. The seal the atmosphere inside the bounceable plate enclosure. The seal may increase a tolerance to misalignment between the bounceable plate enclosure and its vertical extension; or between the bounceable plate enclosure and the sieve assembly enclosure may comprise any material disclosed herein (e.g., elemental metal, metal alloy, ceramic, or an allotrope of elemental carbon). The seal may comprise a pressable material. The material may comprise a polymer or resin. The material may comprise carbon or silicon. The bounceable plate enclosure, its vertical extension, and the sieve assembly enclosure may comprise any material disclosed herein (e.g., elemental metal, metal alloy, ceramic, or an allotrope of elemental carbon). For example, the material may comprise aluminum or stainless steel. For example, the bounceable plate (e.g., vibrating deck) may comprise sheet metal alloy such as stainless steel.

In some embodiments, the bounceable plate comprises one or more walls attached thereto, e.g., to aid directing the flow of material during its (e.g., directional) bouncing towards its side and/or towards an exit opening the bounceable plate enclosure. At least one of the walls can be material directing walls. For example, the directing wall can be symmetrically arranged with a vertical mirror symmetry plane disposed in the middle of the bounceable plane from a side of a material entrance port towards its opposing side where the material exit port is disposed. At least one of the directing walls can be disposed normal to the exposed planar surface of the bounceable plate, or at an angle relative to the planar surface. For example, beneath the material entrance port, the walls may be angled (e.g., slanted). For example, closer to the material exit side of the bounceable plate, the walls may be disposed normal to the planar surface of the bounceable plate. The bounceable plate may be configured to connect to, or accommodate a portion of, springs in disposed on a side of the bounceable plate opposite the wall(s). The bounceable plate may be configured to attach one or more spring cups. The walls configured to direct flow of the material from one side of the plate to its opposing side, may form a narrowing intermediate space between opposing walls such that the length of the space at the material receiving side of the bounceable plate is larger than the space at the material departing side of the plate. Larger may be by at least about 1.1, 1.2, 1.3, 1.4, 1.5, 1.8, 2.0 or 2.5 times larger. Larger may be by at most about 1.2, 1.3, 1.4, 1.5, 1.8, 2.0, 2.5, or 3.0 times larger. Larger may be between any of the aforementioned multiplication values (e.g., from about 1.1 to about 3.0, from about 1.1 to about 1.8, or from about 1.3 to about 3.0). The larger side may have a FLS (e.g., span) of at least about 100 millimeters (mm), 300 mm, 600 mm, 900 mm, 1200 mm, or 1500 mm. The larger side may have a FLS (e.g., span) of any value between the aforementioned values. The angle between the actuator (e.g., pushing pin thereof) and the bounceable plate may be at most about 10°, 20°, 30°, 40°, 45°, 60°, 70°, or 80°. The angle may be between any of the aforementioned angles (e.g., from about 10 to about 80, from about 10° to about 45°, or from about 40° to about 80°). The pin of the actuator pushing the bounceable plate may extend to (e.g., be displaced) at most 0.1 millimeters (mm), 0.2 mm, 0.4 nm, 0.5 mm, 0.7 mm, 1.0 mm, 1.3 mm, 1.5 mm, 1.7 mm, 2.0 mm, or 2.5 mm. The pin of the actuator pushing the bounceable plate may extend between any of the aforementioned values (e.g., from about 0.1 mm to about 2.5 mm). Displacement may be along the axis of the pin. The displacement may be along the X, Y, and/or Z direction.

At least one of the walls can be a strengthening wall. The bounceable plate may have one or more walls surrounding its circumference. For example, the bounceable plate may have 2 or 3 side walls. The bounceable plate may be missing one side wall, e.g., at a side where the material is configured to fall from the bounceable plate (e.g., and onto the sieve). The side wall(s) are disposed at sides of the bounceable plate (e.g., along its circumference).

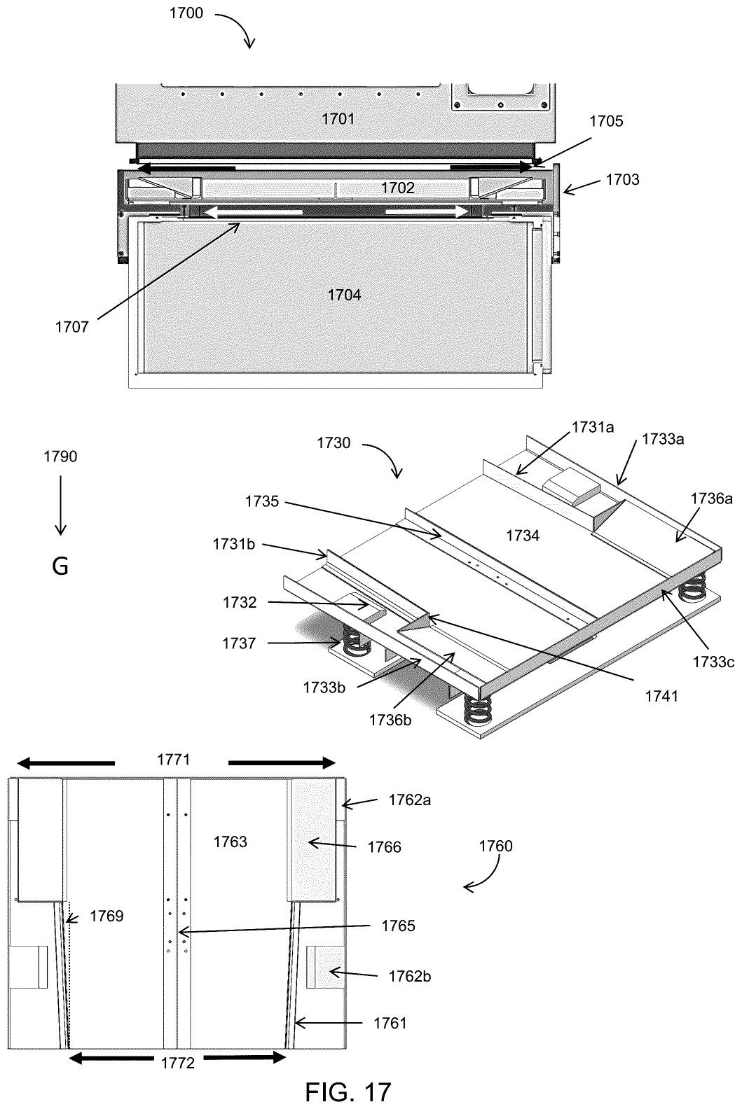

FIG. 17 shows a side view example in 1700 having an enclosure portion of an ancillary chamber (e.g., garage) 1701 disposed above bounceable plate 1702 disposed in a bounceable plate enclosure 1703, and sieve assembly enclosure 1704. Thick arrow pair 1705 designates a maximal horizontal span of a material fall from the bounceable plate 1702 onto the sieve disposed in sieving assembly enclosure 1704, and thick arrow pair 1707 designate a maximal horizontal span of a material receiving portion of bounceable plate 1702 from the ancillary chamber having enclosure portion 1701. FIG. 17 shows a perspective view example in 1730 of bounceable plate 1734 having a middle wall 1735 constituting a supportive wall. Middle wall 1735 is coupled to a top surface of bounceable plate 1734 and to a side wall 1733c disposed at a side of bounceable plate 1734 opposing the side of bounceable plate 1734 from which the material is configured to fall from bounceable plate 1734. Bounceable plate 1734 comprises two additional side walls 1733a and 1733b disposed along its circumference at opposing sides of bounceable plate 1734, and normal to side wall 1733c. Bounceable plate 1734 comprises two slanted (e.g., angled) planar portions 1734a and 1734b (e.g., angled receiver walls) disposed at opposing side of bounceable plate 1734, e.g., configured to be situated below the ingress opening of the material to the bounceable plate enclosure. Bounceable plate 1734 comprises two wall portions 1731a and 1731b (e.g., funnel walls) disposed at opposing side of bounceable plate 1734 and normal thereto, e.g., towards a side of the bounceable plate from which the material is configured to fall, which side is devoid of a side wall. Wall portion 1731a is connected to slanted portion 1736a, and wall portion 1731b is connected to slanted portion 1736b. Springs (e.g., four springs) such as spring 1737, are coupled to the bounceable plate at its bottom which is a side opposing the side of the bounceable plate to which walls 2435, 1731a, 1731b are coupled. The springs may be coupled to the bounceable plate at a coupling area covered with spring covering (e.g., spring cups) such as 1732. In some embodiments, the bounceable plate may be devoid of strengthening wall 1735. In some embodiments, walls 1731a and/or 1731b may be angled with respect to a planar surface of the bounceable plate, having angle 1741. In some embodiments, planar portion(s) 1731a and/or 2431b may be disposed normal to a planar surface of the bounceable plate. Walls 1735, 1731a, 1731b, 1736a and 1736b are internal to the bounceable plate. The arrangement of coupled components (e.g., spring coverings, planar portions, and walls) are symmetric with respect to a vertical plane disposed along middle wall 1735, forming a mirror symmetry plane. In some embodiments, at least one of those internal walls is absent. In some embodiments, the bounceable plate may be devoid of one or more spring coverings connected thereto. The arrangement of coupled components (e.g., spring coverings, planar portions, and/or walls) may have a vertical mirror symmetry plane disposed along a middle section of the bounceable plane extending from a receiving material side to a material fall side of the bounceable plate. FIG. 17 shows a top view example in 1760 of bounceable plate 1763 having middle wall 1765 extending between a material receiving side and a material fall side of the bounceable plate. The material receiving side of the bounceable plate is coupled to two slanted planar portions such as 1766, disposed at opposing side of the middle wall 1765, which slanted planar portions are disposed parallel to middle wall 1765 (e.g., T support bar). The material fall side of the bounceable plate includes walls such as 1761 (e.g., funnel walls) disposed at an angle 1769 with respect to middle wall 1765. The bounceable plate is coupled to spring coverings such as 1762a and 1762b. the arrangement of components couped to the bounceable plane are arranged symmetrically with respect to a vertical mirror symmetry plane running through middle wall 1765. The receiving side of the bounceable plate is configured to receive material in an area spanning length 1771. The material fall side of the bounceable plate is configured to expel material in an area spanning length 1772 that is smaller than length 1771. Examples 1700 and 1730 are aligned with respect to gravitational vector 1790 pointing towards gravitational center G. Up, down, below, above, top, and bottom in relation to FIG. 17, are with respect to gravitational vector gravity. One or more directing and/or strengthening components (e.g., walls) of the bounceable plate contain (e.g., or may be made of) a material type that is different from that of the bounceable plate. For example, the walls may contain aluminum, while the bounceable plate contains from stainless steel. For example, the slanted portion may contain brass, while the bounceable plate contains Inconel.

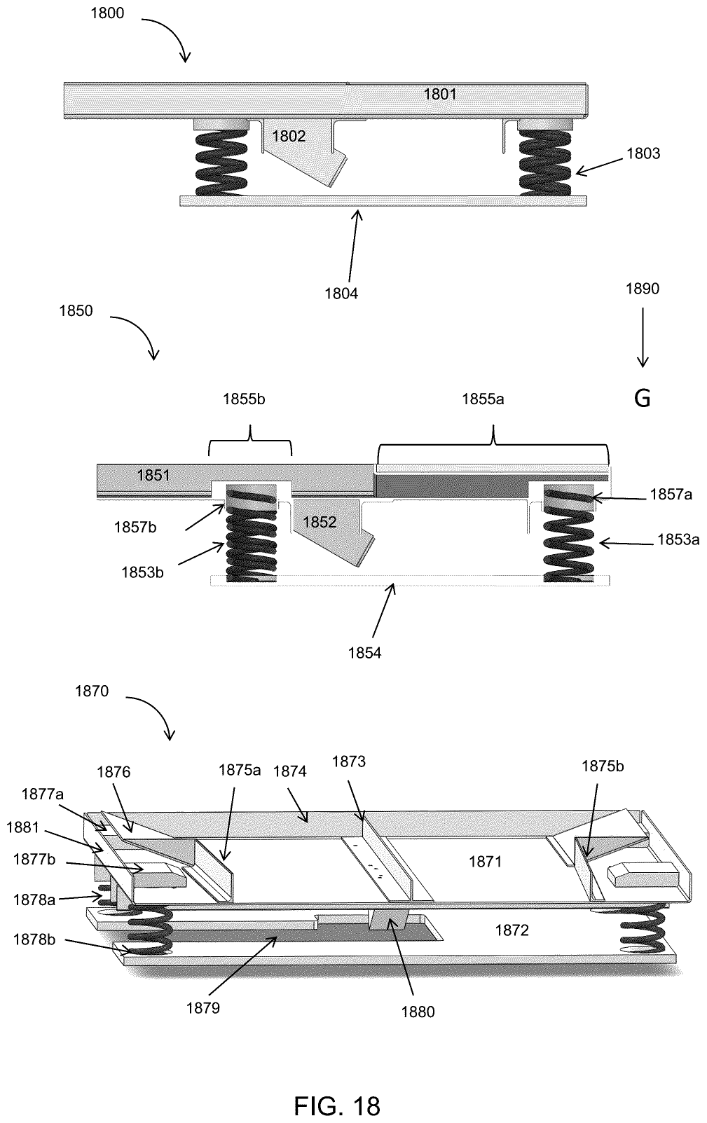

In some embodiments, the bounceable plate is coupled to spring coverings at its top surface. In some embodiments, the bounceable plate is coupled to spring springs penetrating it from its bottom side to its top side. In some embodiments, the bounceable plate is devoid of spring coverings at its top surface. In some embodiments, the bounceable plate is coupled to spring springs penetrating it from its bottom side that do not emerge from its top side. In some embodiments, the springs are coupled to and do not penetrate the bounceable plate. For example, the springs may not protrude from a top surface of the bounceable plate. FIG. 18 shows a side view example in 1800 of bounceable plate 1801 (e.g., shaker deck) coupled to springs (e.g., 1803) at its bottom side, which springs are disposed on a baseplate 1804. The bounceable plate is coupled to an actuator (e.g., shaker) mounted in actuator mount 1802. FIG. 18 shows a side view example in 1850 of bounceable plate 1851 (e.g., shaker deck) coupled to springs 1853a and 1853b at its bottom side, which springs are disposed on a baseplate 1854. The bounceable plate is coupled to an actuator (e.g., shaker) mounted in actuator mount 1852. A portion of bounceable plate 1851 is exposed for didactic purposes in area 1855a, showing spring cup 1857a of spring 1853a. A portion of bounceable plate 1851 is exposed for didactic purposes in area 1855b, showing spring cup 1857b of spring 1853b. Examples 1800 and 1850 are aligned with respect to gravitational vector 1890 pointing towards gravitational center G. Up, down, below, above, top, and bottom in relation to FIG. 18, are with respect to gravitational vector gravity.

The actuator may be a pneumatic actuator. The actuator may operate at a pressure of at least about 40 pounds per square inch (PSI), 50 PSI, 80 PSI or 120 PSI. The actuator may operate at any pressure between the above-mentioned pressures. The actuator may exert on the bounceable plate a force of at least about 0.05 Kilo Newtons (KN), 0.1 KN, 0.2 KN, 0.25 KN, 0.5 KN, 0.8 KN, 1.1 KN, 1.5 KN, 1.8 KN, 2.0 KN, or 2.5 KN. The actuator may exert on the bounceable plate a force between the above-mentioned forces (e.g., from about 0.05 KN to about 2.5 KN, from about 0.05 KN to about 0.5 KN, from about 0.25 KN to about 1.5 KN, or from about 0.8 KN to about 2.5 KN). The mass of the bounceable plate and/or the material thereon, may be at least about 5 Kilograms (Kg), 10 Kg, 25 Kg, 50 Kg, 60 Kg, 70 Kg, 80 Kg, 100 Kg, 200 Kg, or 300 Kg). The mass of the bounceable plate and/or the material thereon, may be between any of the aforementioned values (e.g., from about 5 Kg to about 300 Kg, from about 5 Kg to about 100 Kg, or from about 25 Kg to about 300 Kg). The migration of the material from the receiving side of the bounceable plate to the material fall at its opposing side can take at most about 2 seconds (s), 5 s, 8 s, 10 s, 20 s, 30 s, or 60 s. The migration of the material from the receiving side of the bounceable plate to the material fall at its opposing side can take any period between the aforementioned times (e.g., from about 2 s to about 60 s, from about 2 s to about 20 s, or from about 20 s to about 60 s). The spring may have a constant of at least about 2 kilogram-force per millimeter (KgF/mm), 5 KgF/mm, 7 KgF/mm, 10 KgF/mm, 20 KgF/mm, 50 KgF/mm, 70 KgF/mm, 90 KgF/mm, 100 KgF/mm, or 200 KgF/mm. The spring may have a constant of a value between any of the aforementioned values (e.g., from about 2 KgF/mm to about 200 KgF/mm, or from 2 KgF/mm to about 20 KgF/mm).

FIG. 18 shows in perspective view example 1870 bounceable plate 1871 coupled to a first side wall 1874 and two parallel side walls (e.g., 1881) disposed normal to side wall 1864; two side walls 1875a and 1875b are disposed at opposing sides of middle wall 1873. Side walls 1875a and 1875b are non-parallel to each other and angle towards each other as they reach an edge of the bounceable plate 1871 that is devoid of a wall. Two parallel slanted plates (e.g., 1876) and coupled to bounceable plate 1871 on either side of the middle wall 1873, which angles form a funnel shape towards a top surface of the bounceable plate. The bounceable plate is coupled to four springs (e.g., 1878a and 1878b). Spring covering (e.g., cups) (e.g., 1877a and 1877b) are disposed above the springs. The springs are disposed on a support (e.g., baseplate) 1872 having an opening 1879. An actuator mount 1880 is disposed in the center of mass of bounceable plate 1871. The center of mass can be of the bounceable plate (1) with or without the coupled walls and slanted plates and/or (2) with or without the material to be maneuvered by the directional bouncing of the bounceable plate. Opening 1879 may facilitate installation, monitoring, and/or maintenance of an actuator disposed in actuator mount 1880. Examples 1870 is aligned with respect to gravitational vector 1890 pointing towards gravitational center G. Up, down, below, above, top, and bottom in relation to FIG. 18, are with respect to gravitational vector gravity.

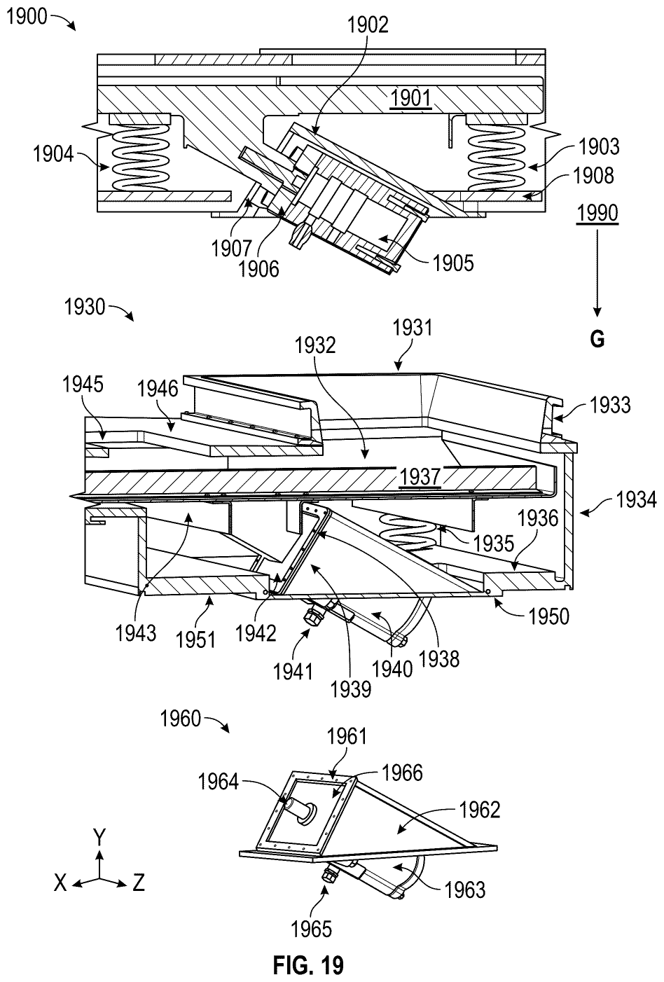

FIG. 19 shows in example side view 1900 of a bounceable plate 1901 coupled to springs 1903 and 1904 disposed on platform (e.g., base plate) 1908, and to actuator (e.g., shaker) 1905 at least in part by coupling to actuator mount 1902 housing actuator 1905. Actuator mount 1902 has an adapter 1906 and a seal (e.g., silicone seal) 1907 coupled to mount 1902. The seal can be of any material disclosed herein. FIG. 19 shows in example perspective sectional view 1930 of a bounceable plate 1937 coupled to springs such as 1935 disposed on platform (e.g., base plate) 1936, and to actuator (e.g., shaker) 1940 at least in part by coupling to actuator mount 1939 housing actuator 1940. Actuator mount 1939 has a clamp 1939 and a seal (e.g., silicone seal) 1942 coupled to mount 1939. The actuator is a pneumatic actuator (e.g., a pneumatic rotatory actuator). The frequency of operation of the actuator may be controlled, e.g., manually and/or using one or more controllers (e.g., using the control system of the 3D printer or separate controller(s)). The controller(s) can comprise a microcontroller. Controlling (e.g., tuning) the frequency of actuator operation may be dependent or independent to tuning one or more other components of the 3D printing system. For example, tuning the operation of the actuator can be independent. The operation of the actuator may comprise pushing and retracting a pin. The actuator has an adapter opening 1941 configured for adapting to a gas source. An actuator pin extension is covered by covering 1953 having support extending to the rear side of bounceable plate enclosure 1934 to stabilize a position of mount 1939. Actuator mount 1939 is coupled to base plate 1950 that is coupled to the floor 1951 of bounceable plate enclosure 1934. Bounceable plate enclosure 1934 has a first opening 1931 in its roof 1936 having an extension 1933 to the opening. Roof 1946 has a second opening 1945. Material can ingress the bounceable plate enclosure 1934 through the first opening 1931 and/or the second opening 1945, and be disposed on bounceable plate 1937. Bounceable plate 1937 is coupled to angled planar surface 1932 that is tilted with respect to the planar surface of bounceable plate 1937. Actuator 3740 comprises an inlet adaptor 1941 configured to facilitate supply of gas (e.g., air) from a gas source. Actuator 1940 is a pneumatic actuator. Actuator mount 1939 is covered by seal 1942 that is operatively coupled to actuator mount 1939 at least in part by clamp 1938. The actuator can be a pneumatic, electric, magnetic actuator, or the like. The actuator can be controlled by one or more controllers (e.g., as part of the control system, e.g., of the 3D printing system). Actuator 1940 is deposed at an angle with respect to bounceable plate 1937. FIG. 19 shows in perspective view example 1960 actuator 1963 having adapter 1963 for coupling to a gas source. Actuator 1963 is disposed in actuator mount 1963 having a (e.g., flexible) seal 1966 mounted at least in part by clamp 1961, to actuator mount 1963. Actuator 1963 is configured to reversibly contract and extend pin 1964. Examples 1900, 1930, and 1960 are aligned with respect to gravitational vector 1990 pointing towards gravitational center G. Up, down, below, above, top, and bottom in relation to FIG. 19, are with respect to gravitational vector gravity.

In some embodiments, the sieve in the sieving assembly is vibrated. The vibrations of the sieve may be effectuated by a vibration (e.g., ultrasonic vibration) generator. The vibration generator may be coupled to a waveguide (e.g., a flexible waveguide). The vibration generator may comprise a vibration converter such as a vibration transducer. The vibration generator may be affixed to the frame of the sieve. For example, the vibration generator may be attached to an outer boundary (e.g., circumference or perimeter) frame. The outer boundary frame may be more rigid than the inner frame. The inner frame may comprise the support structures, the inner frame being disposed within the outer boundary of the sieve. A times, the inner frame may be an integral part of the outer boundary of the sieve. For example, the inner frame may be inseparable from the outer boundary of the sieve. At times, the inner frame by be separable, e.g., be a non-integral part of the outer frame. An example of an outer boundary frame (e.g., circumference or surrounding frame) is shown in FIG. 10A, 1008. An example of an inner frame (e.g., support structure) is shown in FIG. 10A, 1018. At times, affixing the vibration generator (or any component thereof) to the frame (e.g., in the perimeter or circumference of the sieve; or in the inner frame) presents hardships such as (a) any portion of the framing not having resonance frequencies (e.g., substantially) at the frequencies of the vibration generator (or any component thereof), (b) the vibrational conduit (e.g., ultrasonic horn) delivering the vibrational energy not having resonance frequencies (e.g., substantially) at the frequencies of the vibration generator (or any component thereof), (c) high-amplitude vibration that is concentrated at the edges of the sieve, which concentrated energy becomes an interface that may be prone to stress concentration at the sieve, (d) high-amplitude vibration that is concentrated at the edges of the sieve frame, which concentrated energy becomes an interface that may be prone to stress concentration at the sieve frame, or (e) any combination of (a), (b), (c), and (d). Not being resonant may comprise not having a resonance frequency (e.g., substantially) matching a frequency of the vibration generator. Any of these stress concentrations may cause damage to the sieve, e.g., before, during, and/or after operation of the sieve. For example, any of the stress concentrations may cause tearing of the sieve, e.g., before, during, and/or after operation of the sieve. At times, the vibration generator (or any component thereof) is coupled to (e.g., attached to) a rigid frame disposed within the sieve outer boundary, e.g., as part of a sieve skeleton. At times, the material to be sieved may be reactive, e.g., with the reactive agents in the ambient and/or interior atmosphere of the sieve assembly. The reactive species may comprise water or oxygen. Coupling of the vibration generator (or any component thereof) to a portion (e.g., the interior) of the sieve outer boundary may expose the vibration generator (or any component thereof) to the material to be sieved and to the reactive agents during their reaction with each other. Such coupling may run into hardship(s) comprising: (i) the vibration generator (or any component thereof) disposed in the interior of the sieve outer boundary will have to be configured to withstand the reaction conditions. Coupling of the vibration generator (or any component thereof) to the exterior of the sieve outer boundary may result in vibrational losses. At times, the sieve (e.g., mesh) is held by an inner frame and a rigid outer frame (e.g., about the sieve's circumference). The rigid outer boundary frame may or may not be coupled to the inner frame (e.g., interior framing). Vibrating of any of these frame portions (e.g., the inner frame and/or the outer frame) may cause stresses in the sieve that may cause its rupture (e.g., tearing). The stresses may arise due to differences in (e.g., discrepancies between) the acoustic impedance of the rigid outer boundary frame and the inner frame. Such impedance differences may result in reduced efficiency of vibrational transfer from the vibration generator (or any component thereof) to the sieve (e.g., mesh). The above hardships may be alleviated by using a waveguide strip. The waveguide strip may or may not be flexible. In some embodiments, delivery of vibrational (e.g., ultrasonic) energy to the sieve (e.g., mesh) may be at least in part via a waveguide from a (e.g., stationary) vibration generator disposed outside the sieve frame and/or outside of the sieve enclosure. The waveguide may be flexible. The waveguide may be thin. An FLS of the waveguide (e.g., a thickness) may be less than another FLS of the waveguide (e.g., a width). For example, a thickness of the waveguide may be at most about 50 percent (%), 25%, 12.5%, 6.25%, or less of the width of the waveguide. The vibration generator may be stationarily positioned. In some embodiments, the waveguide strip is flexible. The waveguide may comprise an elemental metal or a metal alloy (e.g., 304 stainless steel). The waveguide strip may be operatively coupled (e.g., attached) to the vibration generator (or any component thereof). Such coupling may allow the sieve to withstand induced vibrations without tearing. For example, when the waveguide strip is flexible (e.g., during vibrations of the sieve), while the vibration generator (or any component thereof) is rigid. The waveguide strip may have an impedance that is better matched to that of the sieve (e.g., mesh). For example, the waveguide strip may have an impedance that is (e.g., approximately, or substantially) matched to the impedance of the sieve (e.g., mesh). The impedance may comprise an acoustic impedance. The better matching of the impedance between that of the sieve and that of the waveguide, may result in a more efficient vibrational transfer, as compared to a situation in which the waveguide is not utilized to induce vibration in the sieve (e.g., mesh) and the vibration generator is coupled to the framing such that the vibrations may propagate through the framing. The waveguide may have a small mass such that stress imposed by the shaking sieve to which it is coupled, will be minimal e.g., and not cause its tearing at least during operation of the sieve such as when vibrations are induced in the sieve. A mass of the waveguide may be selected such that stress imposed on the vibrating sieve to which it is coupled will be minimal. For example, the waveguide affixed to the sieve causes minimal damage to the sieve at least during operation of the sieve, e.g., when the waveguide induces vibration in the sieve. The small mass of the waveguide may be below the fatigue limit of a typical material used to make the sieve (e.g., mesh). The force applied by the waveguide on the sieve may be less than a fatigue limit of the material used to make the sieve. The waveguide may be at most about 10*, 20*, 30*, 40*, or 50* the mass of the sieve, wherein “*” designates the mathematical operation of “times”. The mass of the waveguide may be heavier than the mass of the sieve by any value between the aforementioned values (e.g., from about 10* to about 50*).

In some embodiments, the sieve in the sieving assembly is vibrated. The vibrations of the sieve may be effectuated by a vibration (e.g., ultrasonic vibration) generator. The vibrations may propagate through the frame of the sieve cartridge. The vibrations may propagate through the sieve. The vibrations may propagate through waveguides disposed on, or adjacent to, the sieve and/or framing of the sieve cartridge. The sieve can be disposed in a sieve assembly having a frame. The sieve be operatively coupled to (e.g., contacts) one or more (e.g., elongated) rods that facilitate propagation of the (e.g., ultrasonic) vibrations to the sieve, material for separation disposed on the sieve, and/or material for separation disposed adjacent to the sieve. The strip may act as a waveguide (e.g., for the vibrations). The strip may comprise a straight portion. The strip may comprise a curved portion. The strip may flexible, e.g., such that it can withstand vibrations during its standard operation. The spring may be capable of bending without breaking on application of force, e.g., force applied during its standard operation such as vibrational force. The spring may be elastic, e.g., during its standard operation. The strip may comprise a springy (e.g., flexible) curved portion. The strip may be disposed at any position of the sieve. The ultrasonic sound may cause the sieve and/or any material disposed thereon (e.g., for sieving) to vibrate. For example, the material may be particulate material such as powder. A framing of the sieve may be supported. The support of the framing may be with a skeleton, e.g., including one or more beams. The beam may comprise a curved portion or a straight portion. The strip may act as a waveguide, e.g., for ultrasonic waves. The rod(s) may or may not be disposed symmetrically with respect to the sieve cartridge. The symmetric disposition may include mirror symmetry plane, rotational symmetry axis (e.g., C₂, C₃, C₄, C₅, or C₈ symmetry axis), or inversion symmetry. The mirror symmetry plane and/or rotational symmetry axis may be normal to the plane of the cartridge. The symmetry axis and/or mirror symmetry plane, may run through a middle of the framing.

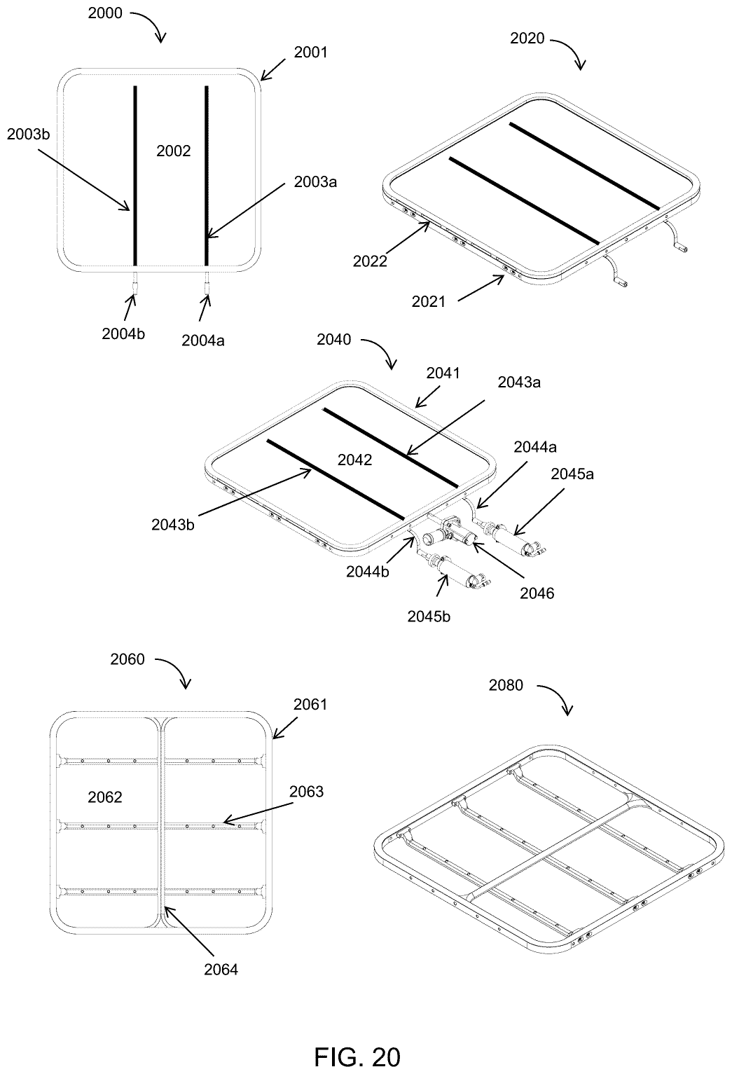

FIG. 20 shows in top view example 2000 a sieve cartridge comprising a sieve 2002 framed by framing 2001, which sieve is coupled to two waveguide rods 2003a and 2003b configured to propagate ultrasonic waves onto the sieve and/or material disposed on the sieve or adjacent thereto. The waveguides may be disposed at the top of the sieve, or at the bottom of the sieve (e.g., glued to the sieve). Top and bottom are with respect to the gravitational center (top in a direction against gravitational center and bottom in a direction towards the gravitational center). Top and bottom are with respect to the direction of flow of the material to be sieved (top in a direction against the direction of flow and bottom in a direction with the direction of flow. The waveguides may adhere to the sieve, e.g., using an adhesive such as glue (e.g., epoxy). The sieve cartridge comprises, or is coupled to, two connectors 2004a and 2004b configured to connect the waveguides to ultrasonic sound generator(s). Example 2020 shows a perspective view of 2000. FIG. 20 shows a perspective view example of sieve cartridge comprising a sieve 2042 framed by framing 2041, which sieve is coupled to two waveguide rods 2043a and 2043b configured to propagate ultrasonic waves onto the sieve and/or material disposed on the sieve or adjacent thereto. The sieve cartridge comprises, or is coupled to, two connectors 2044a and 2004b configured to connect the waveguide rods to ultrasonic wave generator(s) (e.g., transducers) 2045a and 2045b respectively. FIG. 20 shows an example of a shaker 2046 (e.g., low frequency shaker). The shaker may be configured to facilitate spreading of the powder on the sieve (e.g., mesh). The shaker may vibrate in a frequency lower than the frequency of the ultrasound traveled through the waveguide(s). The ultrasonic generators (e.g., transducers) may help in preventing, or reducing occurrence of, blinding of powder to the sieve (e.g., mesh or screen). The ultrasonic generators (e.g., transducers) may help in allowing the powder to be fluidized.

In some embodiments, the screen requires occasional and/or reoccurring tensioning. The tensioning may be to reduce (e.g., prevent) deformation of the screen during and/or after its operation. The sieve may be rigidized by one or more beams (e.g., skeleton). The skeleton may or may not contact the sieve (e.g., mesh or screen). The skeleton may be disposed under the sieve, with the direction of the flow of powder and/or towards the gravitational center. The framing of the sieve may comprise one or more fasteners (e.g., screws) such as fasteners 2021, that facilitate coupling the skeleton to the framing, e.g., to facilitate tensioning of the sieve for example during its operation.

In some embodiments, a framing of the sieve facilitates removal of non-sieveable material (e.g., trash). For example, the framing may comprise one or more slits disposed on side(s) of the framing. The side may be a side through which non-sieveable material is collected for disposal (e.g., collected as trash). FIG. 20 shows an example of five slits arranged in a single file, including slit 2022 on the side of framing. The slits (e.g., 2022) are disposed above double fasteners (e.g., 2021) configured to connect beams of the skeleton to the framing.

In some embodiments, the sieve framing and/or sieve is strengthened by a support structure (e.g., skeleton). The supportive structure may or may not contact the sieve, e.g., at its resting state and/or during sieving. The supportive structure may have any structure disclosed herein supportive (also referred to herein as “support structure”). FIG. 20 shows in bottom view example 2060 a sieve cartridge comprising a sieve 2062 framed by framing 2061 having a supportive structure. The supportive structure is coupled to framing 2061. The supportive structure comprise three parallel beams, each spanning from a first side of framing 2061 to its opposing second side, and beam 2064 spanning from a third side of the framing to its opposing fourth side. Beam 2064 is normal to the three beams (e.g., 2063). Example 2020 shows a perspective view of 2000.

In some embodiments the ultrasonic vibrations generated by the transducers may have a repetition frequency of at least about 30 KHz, 40 KHz, 50 KHz, 60 KHz, 70 KHz, 80 KHz, 90 KHz, or 100 KHz. The pulse energy beam may have a repetition frequency of at most about 40 KHz, 50 KHz, 60 KHz, 70 KHz, 80 KHz, 90 KHz, 100 KHz, or 150 KHz. The pulse energy beam may have a repetition frequency between any of the aforementioned repetition frequencies (e.g., from about 30 KHz to about 100 KHz, or from about 40 KHz to about 80 KMHz).

In some embodiments, the sieve may be operational for several printing cycles, e.g., without requiring maintenance (e.g., without being damaged and/or requires tensioning (e.g., stretching)). Several printing cycles may be at least about 2, 4, 10, 20, or 30. In some embodiments, the sieve may be operational for without requiring maintenance when sieving an amount of material. The amount of material sieved before it requires maintenance may be at most about 200 kilograms (Kg), 500 Kg, 1000 Kg, 1500 Kg, 2000 Kg, 5000 Kg, 10000 Kg, or 20000 Kg. The amount of material sieved before the sieve requires maintenance may be any amount between the aforementioned amount ((e.g., from about 200 Kg to about 20000 Kg, from about 500 Kg to about 2000 Kg, or from about 200 Kg to about 5000 Kg). In some embodiments, the sieve requires tensioning after each printing cycle. In some embodiments, a sequence of vibrations is induced in the sieve to increase a throughput of the sieve. The sequence of vibration may comprise a pulsing sequence. The pulsing may be fast, e.g., fast relative to time for the particulate material to flow a length of the incline of the sieve. Fast pulsing may comprise a pulse length and/or delay period between pulses of at most about 2000 milliseconds (ms), 1500 ms, 1000 ms, 500 ms, 250 ms, 100 ms, 75 ms, 50 ms, 25 ms, 10 ms, 5 ms, 2 ms, or less. Fast pulsing may comprise any value between the aforementioned values, for example, from about 2000 ms to about 100 ms, from about 500 ms to about 5 ms, from about 75 ms to about 2 ms. The pulses of the pulsing sequence may have a high amplitude such that vibrations are induced (e.g., in the sieve) by the pulse(s) having a root mean square velocity of at least about 0.15 meters/second (m/s), 0.3 m/s, 0.5 m/s, 0.7 m/s, 1.0 m/s, 1.3 m/s or more. The pulsing may have a high amplitude sufficient to induce vibrations having a root mean square velocity of any value between the aforementioned values, for example, from about 0.15 m/s to about 0.7 m/s, from about 0.5 m/s to about 1.0 m/s, or from about 0.3 m/s to about 1.3 m/s. The pulsing sequence may have a low amplitude (e.g., delay period(s) between pulses) such that vibrations induced (e.g., in the sieve) between the pulses are at most about 0.1 meters/sec (m/s), 0.05 m/s, 0.01 m/s/, 0.005 m/s, 0.001 m/s, 0.0005 m/s, or less. The low amplitude may induce vibrations having a root mean square velocity of any value between the aforementioned values, for example, from about 0.1 m/s to about 0.001 m/s, from about 0.05 m/s to about 0.005 m/s, or from about 0.01 m/s to about 0.0005 m/s. An “ON” and an “OFF” state can be defined between a highest amplitude and a lowest amplitude, respectively, where a vibrational motion of the sieve (e.g., mesh) is induced in the “ON” state and zero or substantially zero (e.g., undetectable) vibrational motion of the sieve (e.g., mesh) is induced in the “OFF” state. The vibrations may comprise ultrasonic vibrations. The vibrations may be induced in the sieve via at least one waveguide, e.g., as disclosed herein. The sieve (e.g., mesh) may include openings (e.g., holes) having openings that are at most about 20%, 15%, 10%, 5%, or 1% larger than the central tendency of the FLS of the particulate matter (e.g., powder) it is sieving. Each of the openings (e.g., holes) of the sieve may be (e.g., substantially) equal to a central tendency of an FLS of the particle (e.g., a diameter of the particle). The openings of the sieve may be about 0.9 times (*), 0.95*, 1.0*, 1.05*, 1.1*, or 1.15* an FLS of the central tendency of the FLS of the particle (e.g., diameter of the particle). The central tendency may comprise mean, median, or mode. The central tendency may comprise an average. Vibrating the sieve may facilitate (e.g., may induce) dislodging particulate matter that is stuck in the sieve openings (e.g., prevent sieve blinding). At times, vibrating the sieve (e.g., in a pulsing sequence) may facilitate increased throughput per unit area for particulate matter through the sieve. At times, pulse(s) of the pulsing sequence may induce vibrational motion in the sieve (e.g., ultrasonic vibrations), which may facilitate removal of particulate matter from being engaged with (e.g., stuck in) the openings of the sieve. At times, the induced vibrational motion may prevent the particulate matter (e.g., powder) (i) from traversing the sieve, (ii) from being sieved, (iii) from going through the openings of the sieve, or (iv) any combination of (i), (ii), and (iii). At times, when the sieve is vibrated (e.g., using the pulse(s) of the pulsing sequence) the particulate matter floats on top of the sieve and does not traverse through its holes. The sieve throughput per unit area may be increased (e.g., significantly) when the vibrations (e.g., ultrasound vibrations) is pulsed between “off” and “on” (e.g., at a high amplitude) at fast rate. The fast rate of the on-off switching can be if at most about 1500 milliseconds (ms), 500 ms, 250 ms, 100 ms, 75 ms, 50 ms, 25 ms, 10 ms, 5 ms or less. In some embodiments, vibrations (e.g., pulsed vibrations) may assist in spreading the material to be sieved about a surface of the sieve. The vibrations of the sieve may result in (i) more efficiently use the sieve area (ii) reduce (e.g., avoid) agglomeration of the material to be sieved, (iii) reduce (e.g., avoid) concentration (e.g., piling up) of material to be sieved, which may reduce a sieve blinding time. The vibrations may be pulsed in a pulsing sequence. The pulsing sequence may comprise a sequence of pulses having respective pulses shapes (e.g., pulse envelopes), which may be shaped by a combination of one or more of, square waves, rectangular waves, triangle waves, sawtooth waves, sinusoidal waves, or irregular pulse waveforms. The pulsing sequence may comprise a sequence of input control signals (e.g., amplitude pulses), e.g., to induce vibration in the sieve. The pulsing sequence may comprise periodic pulses. The pulsing sequence may comprise non-periodic pulses. The pulsing sequence may comprise a set of pulses having a first amplitude, e.g., a peak amplitude. A pulse of the pulsing sequence may comprise a pulsing period, e.g., a period at which the first amplitude is maintained. Two or more pulses of the pulsing sequence may have a same pulsing period. Two or more pulses of the pulsing sequence may have a different pulsing period. The pulsing sequence may comprise a delay period between pulses, where the delay period between pulses comprises a second amplitude, e.g., delay amplitude. The second amplitude may comprise substantially zero amplitude. The second amplitude may be lower than the first amplitude. The second amplitude may comprise a sufficiently low input amplitude such that an induced vibration is substantially zero (e.g., no detectable vibration). The pulsing sequence may include a first type of pulse(s) and a second type of pulse(s). The first type of pulse(s) and second type of pulse(s) may differ in (a) a first amplitude of pulse (e.g., peak pulse amplitude), (b) a shape of the pulse, (c) a duration of the pulse, (d) a periodicity of the pulse, (e) a dwell time between pulses, (f) a second amplitude between pulses, or (g) any combination of (a) to (f). The pulsing sequence may comprise at least two pulses having (e.g., substantially) the same first amplitude (e.g., peak amplitude). The pulsing sequence may comprise at least two pulses having different first amplitudes (e.g., different peak amplitudes). The pulsing sequence may comprise a delay period between at least two pulses having (e.g., substantially) the same second delay amplitude (e.g., no amplitude). The pulsing sequence may comprise at least two delay periods between respective pulses having different delay amplitudes (e.g., no amplitude). The last pulse in the pulsing sequence can be of a different duration than the previous pulses in the pulsing sequence. The last pulse in the peak sequence can have a different amplitude (e.g., higher peak amplitude) than the previous pulses in the pulsing sequence. For example, the last pulse in the pulsing sequence is longer than the previous pulse(s) in the pulsing sequence. For example, the last pulse in the pulsing sequence has a higher amplitude (e.g., higher peak amplitude) than the previous pulse(s) in the pulsing sequence. The higher (e.g., increased) amplitude may be the high (e.g., peak) amplitude.

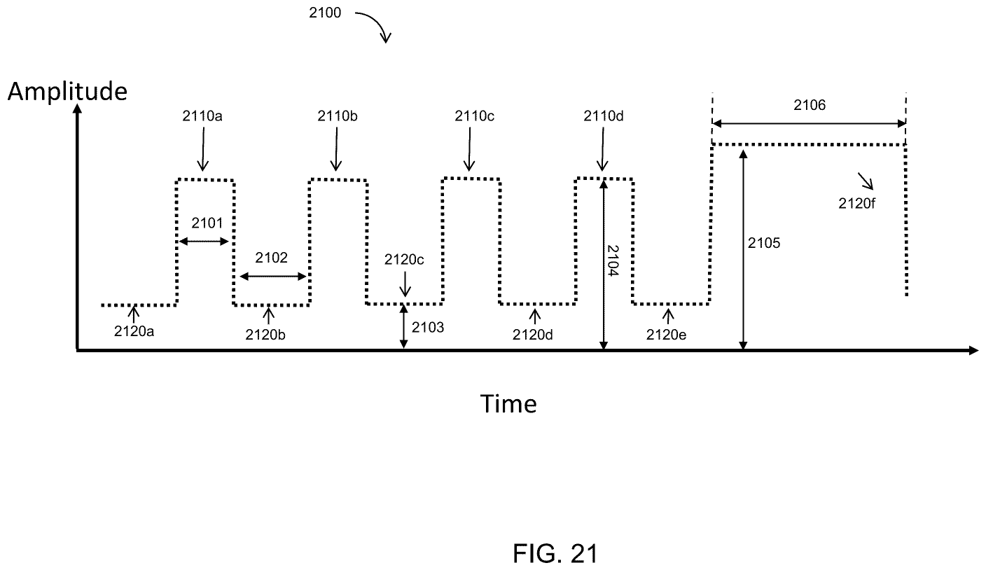

FIG. 21 shows an example of a pulsing sequence 2100 depicted as amplitude vs. time. Pulsing sequence 2100 has pulses 2110a-e comprising periods of high (e.g., peak) amplitude 21 (e.g., “ON” periods), and delay periods 2120a-e between pulses comprising periods of low amplitude 21 (e.g., “OFF” periods). Pulsing sequence 2100 has at least two pulses (e.g., two periods of high amplitudes) that differ in terms of their amplitude and in terms of their duration. For example, a high (e.g., peak) amplitude of pulse 2110a is different from a high amplitude of pulse 2120e in terms of amplitude and in terms of duration. In pulsing sequence 2100, pulses 2110a-d are each (e.g., substantially and/or detectibly) the same in terms of their amplitude and in terms of their duration. In pulsing sequence 2100, delay periods 2110a-e are each (e.g., substantially and/or detectibly) the same in terms of their amplitude and in terms of their duration. Pulsing sequence 2100 depicts top-hat type (e.g., rectangular) pulse shapes in a pulsing sequence. Each of the high amplitude pulses 2110a-d has a time duration such as 2101 and an amplitude such as 2104. Each of the low amplitude delay periods 2120a-e has a time duration such as 2102, and an amplitude such as 2103. The low amplitude may be zero or greater than zero. In pulsing sequence 2100, each of low amplitude delay periods 2120a-e has an amplitude such as 2103 that is greater than zero and lower than each of high (e.g., peak) amplitudes of pulses 2110a-e. High amplitude pulse 2120e has a time span 2106 and a high (e.g., peak) amplitude 2105. In pulsing sequence 2100, the last high amplitude pulse 2120f is longer than the previous high amplitude pulses (e.g., any of pulses 2110a-d) in the pulsing sequence. In pulsing sequence 2100, the last high amplitude pulse 2120f in the peak sequence has a higher amplitude (e.g., higher peak amplitude) than the previous high amplitude pulses (e.g., any of pulses 2110a-d) in the pulsing sequence. The pulsing sequence may be utilized to vibrate a sieve, e.g., as disclosed herein. The pulsing sequence may be utilized to filter particulate material.

In some embodiments, the sieve assembly comprises a sieve cartridge reversibly engaged and disengaged from a sieve assembly enclosure. The sieve cartridge may be reversibly engaged (e.g., affixed) and disengaged (e.g., removed) with the sieve cartridge assembly. The engagement and disengagement may be performed at least in part manually. The engagement and disengagement may be performed at least in part automatically, e.g., using at least one controller. The at least one controller may be any controller disclosed herein. For example, the controller(s) may be integrated in the control system of the 3D printer. At times, an alert may be communicated to engage and/or disengage the cartridge. The alert may be communicated to a controller(s) and/or to a user. The sieve cartridge assembly may be supportive of the sieve cartridge before, during, and after use of the sieve cartridge (e.g., to process particulate matter). A wall of an enclosure of the sieve cartridge assembly may comprise openings to allow connectors to be accessible to the sieve cartridge. For example, the sieve assembly enclosure may comprise openings to allow one or more connectors to be accessible to sieve cartridge, e.g., to connect to one or more strips (e.g., rods) of the sieve cartridge. The connectors may be ultrasonic connectors. The connectors may be configured to allow transmission of vibrations, e.g., ultrasonic vibrations. The transmission of vibrations through the connector(s) may be without (e.g., substantial) damping of the vibrations generated by the vibration generator. The transmission of vibrations through the connectors may (e.g., substantial) preserve of the generated vibrations by the vibration generator. The connector(s) may comprise a straight portion and/or a curved portion. The connector(s) may comprise an extendable and/or adjustable portion, e.g., to accommodate installation of the connector(s) to the one or more strips (e.g., rods) of the sieve cartridge. The extendable and/or adjustable portion may comprise a spring-like tension to accommodate stretching (e.g., extending) of the portion to accommodate movement of the connector(s) with respect to the one or more strips (e.g., rods) and/or the sieve assembly enclosure. The connector(s) may be reversibly engaged and disengaged with the sieve cartridge, for example, with the cartridge frame of the sieve cartridge. The sieve assembly may comprise a translatable support system configured to retain the sieve cartridge and reversibly translate the sieve cartridge from a first position to a second position. For example, translate the sieve cartridge from a loading position to an operation position, where the operation position corresponds to a three-dimensional printing process. The translatable support system may comprise a railing system to enable translation of the sieve cartridge from the first position to the second position. For example, the railing system may comprise rails located on opposing sides of the sieve cartridge. The railing system may comprise open or shielded railing (e.g., labyrinth type railing). The translatable support system may be configured to affix to an outer frame of the sieve cartridge, e.g., via mounting hardware.

In some example, pre-transformed material (e.g., powder) is deposited and is sieved by the sieve disposed in the sieving assembly. The rate of powder deposition may be at least about 1 kilogram per minute (Kg/min), 2.5 Kg/min, 5 Kg/min, 10 Kg/min, 15 Kg/min, 20 Kg/min, or 50 Kg/min. this rate may also correspond to the rate in which the sieve is sieving the powder. The sieving assembly may operate the sieve before, after, and/or during the 3D printing. The sieve may be configured for continuous operation of at least about 1, 2, 5, 10, or 50 printing cycles. The sieve may be configured for continuous operation of at least about 100 hours, 200 hours, 400 hours, 500 hours, 700 hours, or 1000 hours. The sieve may be vibrated during operation. The vibration may be sonic vibrations. The vibrations may be at a frequency of at least about 10 kilohertz (KHz), 20 KHz, 40 KHz, 50 KHz, 80 KHz, or 100 KHz. The vibrations may be intermittent (e.g., using a pulsing sequence). The intermittent vibrations may be at a rate of at least about 2.5 pulses per second (pls/sec), 3.6 pls/sec, 4.4 pls/sec, 5.7 pls/sec, or 9.6 pls/sec.

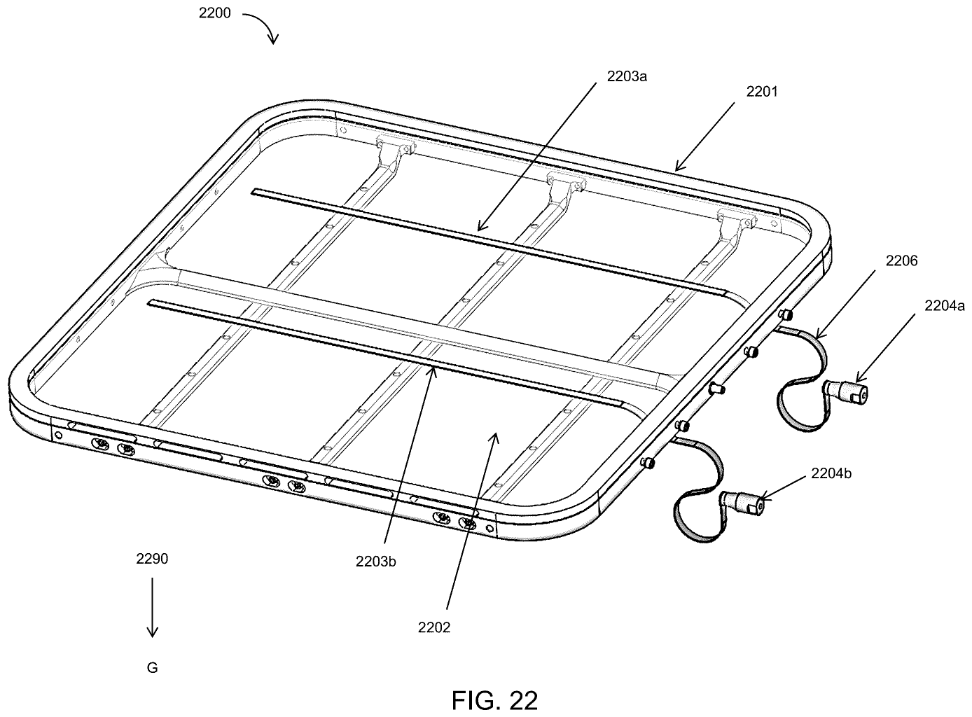

FIG. 22 depicts an example partial view of a sieve assembly. As depicted, a sieve cartridge 2200 comprising a sieve 2202 framed by framing 2201. The sieve 2202 is coupled to two waveguide strips 2203a and 2203b configured to propagate ultrasonic waves onto the sieve and/or material disposed on the sieve or adjacent to the sieve. The waveguides strips 2203a and 2203b may be in contact (e.g., adhered to) a surface of the sieve. For example, the waveguide strips 2203a and 2203b may be in contact with a top surface or a bottom surface, relative to the gravitational vector 2290. The waveguide strips 2203a and 2203b may be adhered to the sieve 2202, for example, using an adhesive (e.g., epoxy). The sieve cartridge 2200 comprises, or is coupled to, two connectors 2204a and 2204b configured to connect the waveguide strips 2203a and 2203b to vibration generator(s), e.g., ultrasonic acoustic generators. The waveguide strips 2203a and 2203b include respective curved portions, e.g., curved portion 2206. The curved portion, e.g., curved portion 2206, can be adjustable (e.g., flexible) to accommodate movement of the sieve cartridge 2200 relative to a sieve assembly enclosure, e.g., to facilitate connecting the connectors 2204a and 2204b of respective waveguide strips 2203a and 2203b to vibration generator(s) (not shown).

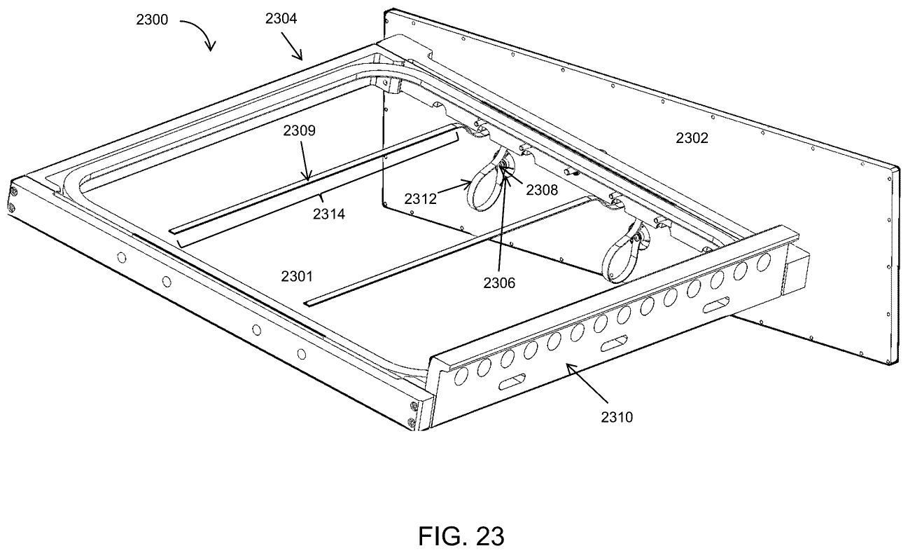

FIG. 23 depicts a partial view example of a sieve assembly. Sieve assembly 2300 includes a sieve assembly enclosure 2302 configured to retain the sieve cartridge 2304 including a sieve 2301. The sieve assembly enclosure 2302 includes openings, e.g., opening 2306, through which an ultrasonic connector, e.g., ultrasonic connector 2308 of the sieve cartridge 2304 pass(es) through to an exterior of the sieve assembly enclosure 2302. The ultrasonic connector(s), e.g., connector 2308, connect respective waveguide strips, e.g., waveguide strip 2309, to a vibration generator (not shown) which may be located in an environment exterior to an interior environment of the sieve assembly enclosure 2302. The sieve assembly enclosure includes a translatable railing system 2310 configured to retain the sieve cartridge 2304 and translate from a loading position to an operation position. The waveguide strips include a curved portion and a straight portion, e.g., waveguide strip 2309 includes a curved portion 2312 and a straight portion 2314. The straight portion of the waveguide strip is contacting the sieve 2301 of the sieve cartridge 2304.

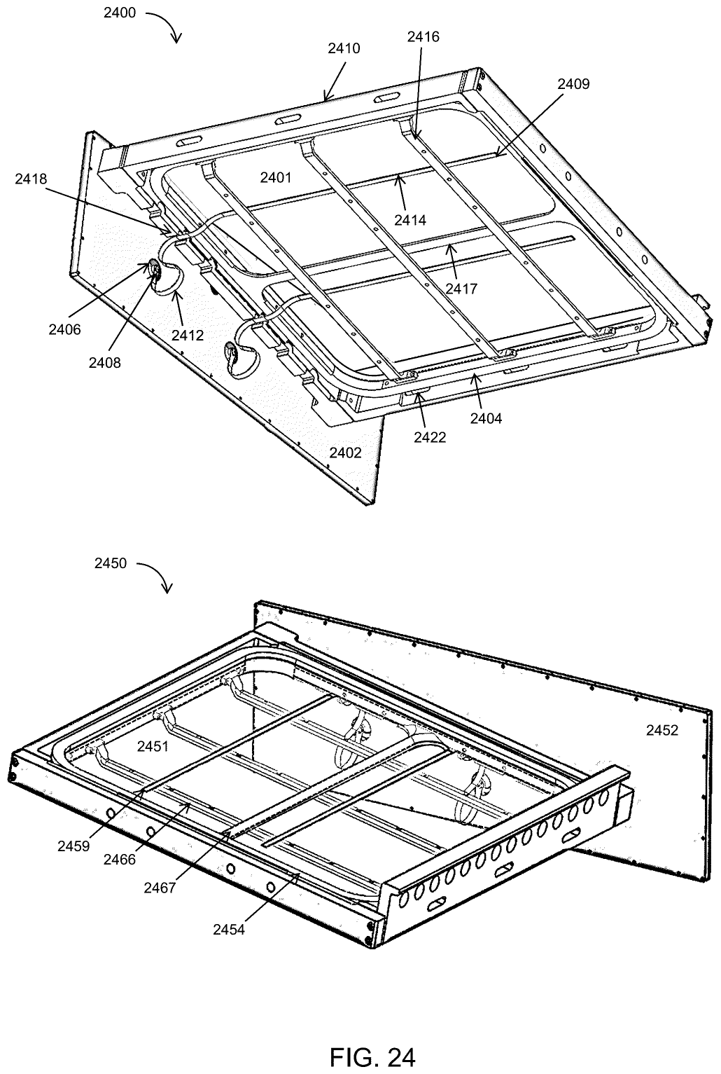

FIG. 24 depicts example partial views of sieve assemblies. As depicted, sieve assembly 2400 includes a sieve assembly enclosure 2402 configured to retain the sieve cartridge 2404 including sieve 2401. The sieve assembly enclosure 2402 includes openings, e.g., opening 2406, through which an ultrasonic connector, e.g., ultrasonic connector 2408 of the sieve cartridge 2404 pass(es) through to an exterior of the sieve assembly enclosure 2402. The ultrasonic connector(s), e.g., connector 2408, connect respective waveguide strips, e.g., waveguide strip 2409, to a vibration generator (not shown) which may be located in an environment exterior to an interior environment of the sieve assembly enclosure 2402. The sieve assembly enclosure includes a translatable railing system 2410 configured to retain the sieve cartridge 2404 and translate from a loading position to an operation position. The waveguide strips include a curved portion and a straight portion, e.g., waveguide strip 2409 includes a curved portion 2412 and a straight portion 2414. The straight portion of the waveguide strip is contacting the sieve 2401 of the sieve cartridge 2404. The sieve cartridge 2404 includes skeleton structures supportive of the sieve 2401. The inner framing (e.g., support structure) comprises skeleton structures 2416 and 2417, are disposed with respect to a surface of the sieve 2401 and may, at times, contact the surface of the sieve 2401. The straight portion is disposed between a surface of the sieve 2401 and skeleton structures, e.g., skeleton structure 2416. The waveguide strip 2409 may be guided through a slot, e.g., slot 2418, of the sieve assembly enclosure 2402, where the slot is configured to accommodate the waveguide strip without (e.g., substantially) dampening a vibration of the waveguide strip. Sieve cartridge 2404 is retained (e.g., affixed) within the sieve assembly enclosure 2402 by slot(s) configured to receive the sieve cartridge 3024, e.g., slot 2420.

FIG. 24 depicts sieve assembly 2450 including a sieve assembly enclosure 2452 configured to retain the sieve cartridge 2454 including a sieve 2451. The sieve cartridge 2454 includes skeleton structures supportive of the sieve 2451. Skeleton structures, e.g., skeleton structure 2466 and 2467, are disposed with respect to a surface of the sieve 2451 and may, at times, contact the surface of the sieve 2451. A portion of the waveguide, e.g., waveguide strip 2459, is disposed between a surface of the sieve 2451 and skeleton structures, e.g., skeleton structure 2466.

In some embodiments, a bounceable plate is disposed in a bounceable plate enclosure forming a pressure boundary that encloses an atmosphere different from an ambient atmosphere external to the bounceable plate enclosure. An internal atmosphere within the bounceable plate enclosure may be depleted of one or more reactive species and/or at an elevated pressured with respect to an atmosphere external to the bounceable plate enclosure. In some embodiments, the bounceable plate is operatively coupled to one or more actuators (e.g., two actuators) via the bounceable plate enclosure such that the one or more actuators are external to the internal atmosphere of the bounceable plate enclosure. The one or more actuators can be disposed externally to the bounceable plate enclosure, or operatively coupled thereto. In some embodiments, the bounceable plate is operatively coupled to spring(s) via the bounceable plate enclosure such that the spring(s) are external to the internal atmosphere of the bounceable plate enclosure. The bounceable plate enclosure may comprise openings operatively coupled to the three-dimensional printing system, e.g., configured to receive pre-transformed material and/or debris. For example, the bounceable plate enclosure may comprise at least one inlet opening, e.g., coupled (I) to an ancillary chamber coupled and/or (II) to at least one separator (e.g., cyclone(s)). For example, the bounceable plate enclosure may comprise at least one outlet opening, e.g., coupled to a sieve assembly. The inlet opening(s) and/or the outlet opening(s) may be (e.g., each) coupled to respective vertical extension serving as a coupler (e.g., connector). The vertical extension couplers may facilitate coupling to other components of the 3D printing system. For example, the vertical extension connected to the inlet opening may be coupled to an ancillary chamber (e.g., garage). For example, the vertical extension of the outlet opening may be coupled to the sieving enclosure. The vertical extension can be stiff or flexible. The vertical extension may comprise a bellow. At least two of the vertical extension(s) may comprise at least one characteristic that is the same. At least two of the vertical extension(s) may comprise at least one characteristic that is different. The at least one characteristic of the vertical extension(s) may comprise a thickness, a FLS, or a material (e.g., any material disclosed herein). For example, a first vertical extension coupled to the first opening and a second vertical extension coupled to the second opening of the bounceable plate enclosure, may comprise a same material (e.g., silicone) and/or a same thickness. For example, a first vertical extension coupled to the first opening and a second vertical extension coupled to the second opening of the bounceable plate enclosure, may comprise a different material (e.g., silicone) and a different thickness. The vertical extension coupler may comprise a seal, e.g., any seal disclosed herein. The seal may be configured to enclosure (i) the atmosphere and/or (ii) the pre-transformed material within the bounceable plate enclosure. A vertical extension comprising a flexible material may facilitate compensation for any misalignment between the body of the bounceable plate, and any other components to which it is coupled, e.g., the sieving assembly and/or the ancillary chamber. The moving elements (e.g., springs) may comprise an elemental metal or a metal alloy, e.g., steel.

In some embodiments, operation of the bounceable plate and/or sieving mechanism may generate vibrations. The vibrations may comprise mechanical or acoustic vibrations. At times, such vibrations may propagate to one or more other components of the 3D printing system. At least some of these components may require stable and/or quiet operation. Damping of the vibrations may comprise (I) using quieter actuator(s) and/or (II) using dampers such as flexible material, e.g., polymeric material. In some embodiments, the vertical extension may comprise a flexible material (e.g., a polymer). The vertical extension may be configured to reduce (e.g., damp) vibrations caused during operation (I) of the bounceable plate and/or (II) of the sieving mechanism, from propagating throughout other components of the 3D printer. The other components may be susceptible to vibrations. The other components may require stable and/or precise operation. The other components may comprise an optical assembly, e.g., may comprise a scanner of the energy beam. Compromising the scanner may cause defects in the resulting 3D object. In some embodiments, the actuators (e.g., shakers) may comprise electronic shakers. The electronic actuator may operate quieter as compared to the pneumatic actuator. The vertical extension may be operatively coupled to one or more O-rings. A body of the enclosure may comprise an elemental metal, metal alloy, ceramic, or an allotrope of elemental metal. For example, the body of the enclosure may comprise aluminum. The enclosure body may comprise a coating, e.g., that is resilient to abrasion of (e.g., pre-transformed) material traveling through the enclosure. The bounceable plate and/or sieve may comprise a coating, e.g., that is resilient to abrasion of (e.g., pre-transformed) material contacting the bounceable plate and/or sieve, during operation. The pre-transformed material may comprise powder. The pre-transformed material may comprise a starting material, a remainder, or debris, relating to three-dimensional printing process. For example, the pre-transformed material may comprise an elemental metal, a metal alloy, a ceramic, or an allotrope of elemental carbon. For example, the pre-transformed material may comprise metallic powder. The coating may be an anodized coating. The coating may comprise a durable metallic coating that is harder, stiffer, and/or more resilient, than an interior (e.g., bulk) of the enclosure body, of the bounceable plate, and/or of the sieve. More resilient is to friction of the surface by the pre-transformed material during operation. The interior may be of aluminum, and the coating may comprise chromium, nickel, alumina, or anodized aluminum. The enclosure may comprise a bounceable plate enclosure or a sieving assembly enclosure.

In some embodiments, pre-transformed material disposed on the bounceable plate is displaced during its operation (e.g., during its bouncing motion). The bounceable plate may translate pre-transformed material that is fed at a rate of at least 10 kilograms per minute Kg/min, 15 Kg/min, 30 Kg/min, 45 Kg/min, or 60 Kg/min. The pre-transformed material may be displaced on the bounceable plate at rate of at least 10 kilograms per minute Kg/min, 15 Kg/min, 30 Kg/min, 45 Kg/min, or 60 Kg/min. The bounceable plate may have a (neat) weight of at least about 10 Kg, 20 Kg, 30 Kg, 40 Kg, 50 Kg, 60 Kg, or 70 Kg, which neat weight is devoid of any pre-transformed material which the bounceable plate maneuvers during operation. The bounceable plate may have an accumulated weight of at least about 80 Kg, 100 Kg, 120 Kg, 140 Kg, or 200 Kg, which accumulated weight includes any pre-transformed material which the bounceable plate maneuvers during operation.

In some embodiments, the bounceable plate comprises, or is operatively coupled to, actuators. For example, the bounceable plate may comprise or may be operatively coupled to at least 2, 3, 5, or 10 actuators. At least two of the actuators be of the same type. At least two of the actuators be of a different type. The actuators may be of an even number. The actuators may be asymmetrically arranged with respect to each other. The actuators may comprise pneumatic, magnetic, or electronic actuating force. The actuators may comprise or more output properties that are tunable. The tunable output properties may comprise tunable output frequency or tunable output force. In some embodiments, the actuators comprise rotary electric motors. The actuators may be configured to rotate (e.g., clockwise or counterclockwise). The tunable property may comprise a direction of rotation, a velocity or rotation, or an acceleration of rotation. At times, at least two of the actuators rotate in the same direction. At times, at least two of the actuators rotate in opposing directions. The at least two actuators may actuate in respective rotary motion to generate a combined motion incident on the bounceable plate. At times, the two rotary electric motors may actuate in respective rotary motion with paired (e.g., matching or counter-matched) frequencies and/or forces, e.g., to generate a combined linear motion incident on the bounceable plate. At least two of the actuators may be oriented at an angle with respect to a plane (e.g., bottom surface) of the bounceable plate such that the angle of incidence of the actuating motion is non-normal, e.g., less than about 90° (degrees) or greater than about 90°. The angle of incidence of the actuating motion relative to a plane normal of the bounceable plate, may be at most about 85°, 75°, 60°, 45°, or 30°. The angle of incidence of the actuating motion relative to a plane normal of the bounceable plate, may be between the aforementioned values, e.g., from about 85° to about 45°, or from about 75° to about 30°. The frequency of rotation may comprise a pattern in which the period in which the actuator's motion push the plate is (e.g., substantially) the same as the period in which the actuator's motion release the plate. The one or more actuators may (e.g., collectively) press upon the bounceable plate with a frequency of at least about 20 Hertz (Hz), 30 Hz, 60 Hz, or 90 Hz. The one or more actuators may press upon the bounceable plate with a (e.g., collective) force of at least about 50 Kilogram Force (KgF), 100 KgF, 200 KgF, 300 KgF, or 500 KgF. The actuator may comprise a rotating actuator such as a rotating motor. The actuator may rotate at a speed of at least about 2000 revolutions per minute (RPM), 2400 RPM, 3000 RPM, 3600 RPM, or 4000 RPM.

In some embodiments, a sensor is employed to sense the pre-transformed material falling off of the bounceable plate in the material fall. For example, a sensor is employed to sense the powder material falling off of the bounceable plate in the powder fall. At times sensors are employed to sense the powder The sensor(s) may comprise a temperature sensor, an optical density sensor, a pulsed waveguide, a reader, a proximity sensor, a contact sensor, or a weight sensor. Examples of powder sensors such as pulsed waveguides, 3D printers, related control system, related methods, apparatuses, systems, and program instructions (e.g., software), can be found in U.S. Provisional Patent Application Ser. No. 63/324,551 filed on Mar. 28, 2022, titled “MATERIAL LEVEL DETECTION SYSTEMS,” which is incorporated herein by reference in its entirety.

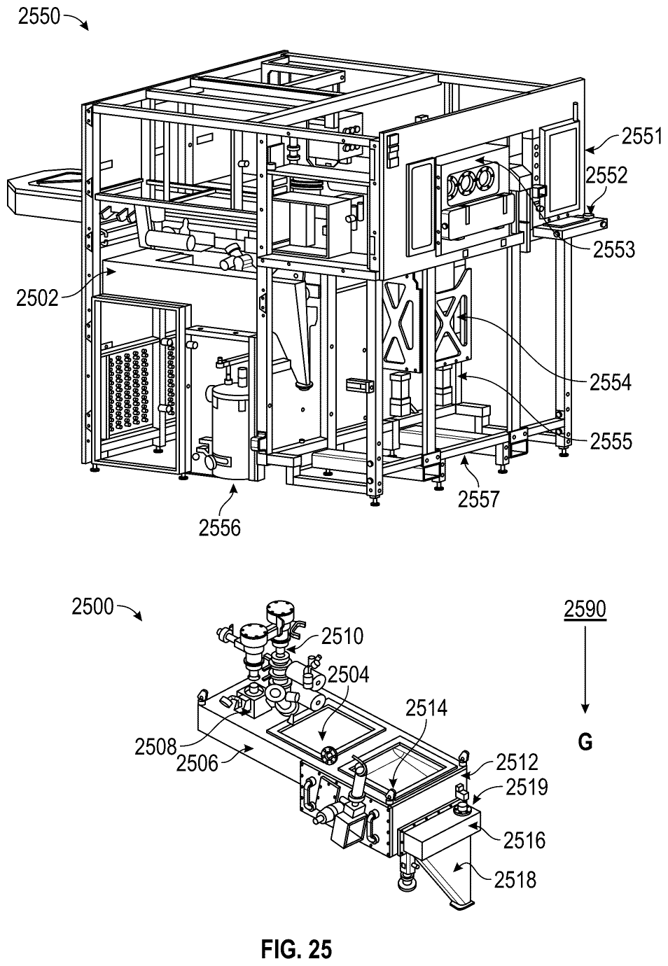

FIG. 25 shows various example views of portions of a three-dimensional printing system. A portion 2502 of a 3D printing system 2550 includes a bounceable plate 2504 disposed in an enclosure 2506 having a top opening 2508 configured to receive material via one or more separators (e.g., cyclones), e.g., separator 2510. Bounceable plate enclosure 2506 overlaps with a sieve assembly enclosure 2512 having sieve 2514 disposed within. Sieve assembly enclosure 2512 has an exit opening 2516 disposed at its bottom operatively coupled to material reservoir 2518 that may lead to the removal container (e.g., comprising material for trashing). The sieving mechanism comprises a sensor 2519, e.g., a powder sensor such as a pulsed waveguide. Portion 2502 of the 3D printing system is depicted in silhouette in perspective view 2550 of 3D printing system. The 3D printing system is depicted with respect to gravitational vector 2590 pointing towards the environmental center. 3D printing system 2550 comprises monitor 2551 and input station 2552 (e.g., keyboard). 3d printing system comprises door 2553 to a processing chamber, the door having three viewing windows and a secondary door, e.g., similar to a glovebox. The 3D printing system comprises a build module operatively coupled to the processing chamber 2554 that is movable using actuators operatively coupled to encoders such as 2555. 3D printing system 2550 includes a container 2556 in which pre-transformed material and/or debris can be disposed. 3D printing system 2550 comprises structural supports such as 2557, that may be aligned via aligning screws. Up, down, below, above, top, and bottom in relation to FIG. 25, are with respect to gravitational vector 2590 pointing toward an environmental gravitational center (e.g., Earth's gravitational center).

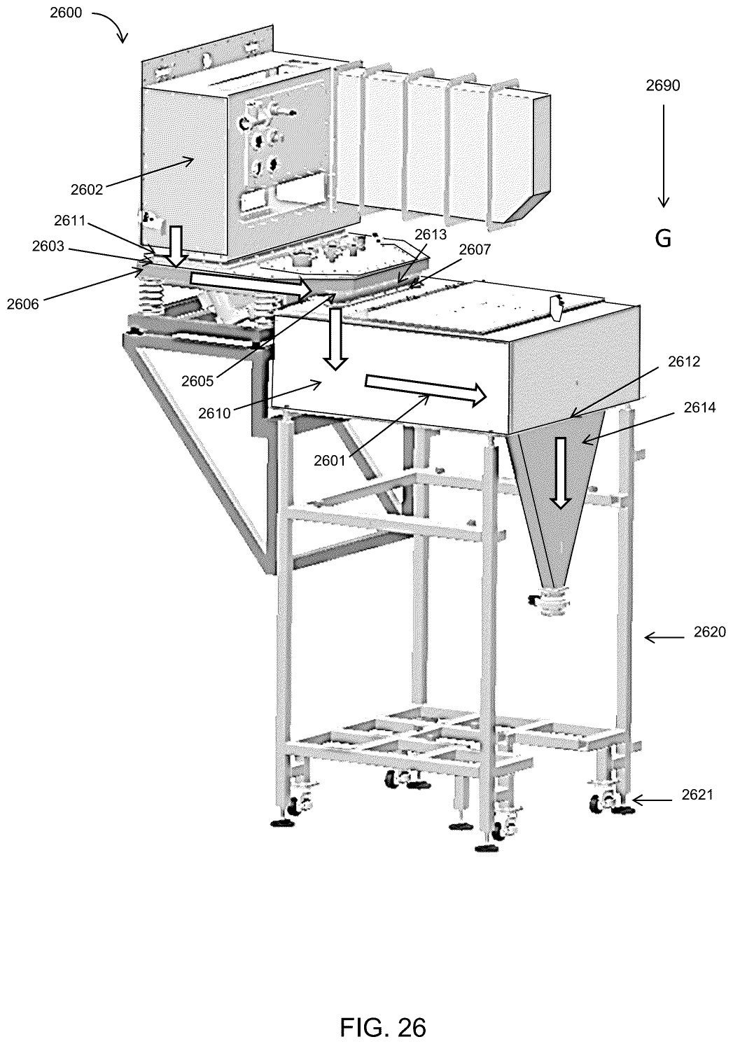

FIG. 26 shows an example perspective view 2600 of a portion of a 3D printing system comprising an ancillary chamber 2602, a bounceable plate enclosure 2606 of which the floor is the bounceable plate, a sieving assembly enclosure 2610. View 2600 depicts a flow of material (e.g., powder material) from ancillary chamber 2602 to a material conveyance system, indicated by arrows, e.g., arrow 2601. An ancillary chamber 2602 is operatively coupled to, or a part of, a processing chamber (not shown). The ancillary chamber 2602 comprises an opening at a bottom portion of the ancillary chamber (e.g., with respect to gravitational vector 2690) that is operatively coupled to a first opening 2603 of a bounceable plate (not shown) comprising a bounceable plate enclosure 2606 via a first vertical extension 2611 (e.g., flexible coupler). A second opening 2605 of bounceable plate enclosure 2606 is coupled to a third opening 2607 of a sieve assembly enclosed within a sieve assembly enclosure 2610 via a second vertical extension 2613 (e.g., flexible coupler). A fourth opening 2612 of the sieve assembly enclosure 2610 is coupled to a funnel 2614 that can be coupled to a material conveyance system (not shown). 3D printing system portion 2600 comprises structural supports such as 2620, that may be aligned via aligning screws such as 2621.

In some embodiments, the bounceable plate is disposed in an enclosure that forms a pressure boundary. The bounceable plate can be coupled to movable supports (e.g., springs) attached to a baseplate, all of which are disposed in the enclosure. The bounceable plate can be a moving tray. The enclosure can be a packaging of the bounceable plate. At times, pre-transformed material (e.g., powder) that is maneuvered by the bounceable plate during operation, may spill out of the bounceable plate, e.g., and accumulate beneath it in the bounceable plate enclosure. For example, the spilled pre-transformed material may form a bypass route for pre-transformed material to accumulate in unwanted location of the bounceable plate enclosure. For example, the spilled pre-transformed material may bounce off the bounceable plate and accumulate adjacent to the springs disposed in the bounceable plate enclosure. The empty bounceable plate (e.g., weight to be moved by the actuators) may weight at most about 20 Kg, 40 Kg, 50 Kg, or 100 Kg.

In some embodiments, the bounceable plate forms a pressure boundary enclosure. For example, the bounceable plate comprises sides and a roof to form a gas tight enclosure configured to hold pressure above the ambient pressure external to the enclosure. The bounceable plate can be coupled to movable supports (e.g., springs) attached to a baseplate. While the bounceable plate forms its own pressure tight enclosure, the movable supports and baseplate can be disposed outside of the enclosure. The enclosure can be a packaging of the bounceable plate. In the configuration in which the bounceable plate forms its own enclosure, bypass route of pre-transformed material (e.g., powder) to unwanted locations may be minimized (e.g., avoided). In the configuration in which the bounceable plate forms its own enclosure, pre-transformed material maneuvered by the bounceable plate cannot spill into the vicinity of the movable supports (e.g., springs), but only through the exit opening. Such configuration may require flexible couplers between the enclosure and other components of the 3D printing system to which the bounceable plate enclosure couples to, e.g., ancillary chamber and/or sieve assembly. For example, the flexible couplers may comprise a polymer. The flexible couples may comprise silicone rubber, or nitrile rubber. The empty bounceable plate (e.g., weight to be moved by the actuators) may weigh at least about 150 pounds, 200 pounds, 250 pounds, or 300 pounds. The flexible coupler may couple the bounceable plate enclosure to a source of pre-transformed material (e.g., a reservoir, a channel, or any other enclosure). For example, the flexible coupler may be of a form comprising a channel, a sleave, or a hose.

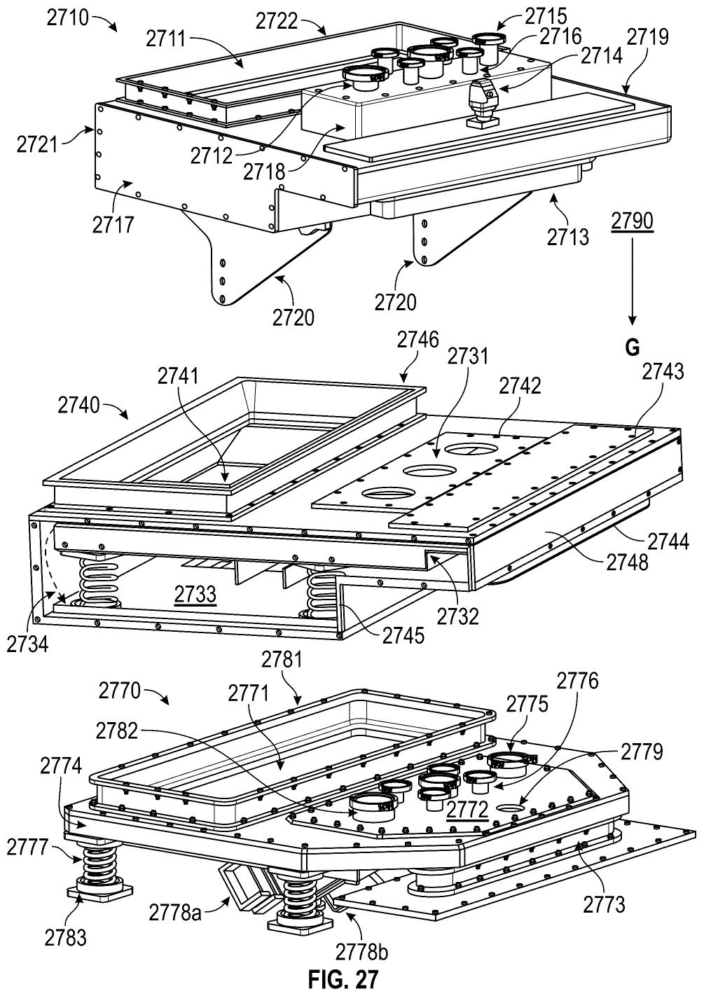

FIG. 27 shows in example 2710 a perspective view of bounceable plate enclosure body 2717 configured to enclosure a bounceable plate (not shown). Enclosure body 2717 comprises several sides fastened by fasteners (e.g., screws) such as fastener 2721. Enclosure 2710 may be gas tight. Enclosure body 2717 may be configured to prevent spillage of the pre-transformed material (e.g., powder) through connections of the sides. Enclosure body 2717 is supported by support structures 2720, e.g., configured to couple to, or as part of, a body of a 3D printer. Bounceable plate enclosure body 2717 has a first top opening 2711 to which a vertical extension 2722 is coupled and configured to attach, e.g., to the ancillary chamber enclosure. Bounceable plate enclosure has a second top opening accommodating sensor 2714 disposed in sensor assembly 2719 that may be openable. The sensor may sense one or more parameters relating to the pre-transformed material, e.g., powder sensor such as a pulsed waveguide. Top inlet openings such as 2712 and 2715 may facilitate ingress of pre-transformed material, e.g., at least in part by facilitate optional coupling to pre-transformed material source(s) such as a layer dispensing mechanism and/or material separator(s), and are disposed in an opening manifold 2718. Top inlet openings 2712 and/or 2715 may connect to a component of the 3D printing system comprising: (i) a cyclone, (ii) a material conveyance system (e.g., reservoir thereof), or (iii) a layer dispensing mechanism such as a reservoir thereof (e.g., recoater hopper thereof). Top inlet opening such as 2716 may couple to a pressure equalization port, e.g., to allow for atmospheric flow such as when pre-transformed material is dropped onto the bounceable plate, e.g., through openings utilized for conveyance of pre-transformed material such as openings 2712 and/or 2715. Bounceable plate enclosure body 2717 comprises a bottom outlet opening 2713 configured to facilitate material flow from bounceable plate outward from bounceable plate enclosure body 2717, e.g., to a sieving assembly enclosure to be separated by a sieve. In example 2710, the springs (now shown) are disposed in enclosure body 2717. Example 2710 is aligned with respect to gravitational vector 2790 pointing towards gravitational center G. Up, down, below, above, top, and bottom in relation to FIG. 27, are with respect to gravitational vector 2790.

FIG. 27 shows in example 2740 a perspective view of bounceable plate enclosure body 2717 having bounceable plate in which the bounceable plate is disposed. Enclosure body 2748 comprises several sides fastened by fasteners (e.g., screws). Enclosure body 2748 may be gas tight. Enclosure body 2748 may be configured to prevent spillage of the pre-transformed material (e.g., powder) through connections of the sides. Bounceable plate enclosure body 2717 has a first top opening 2741 to which a vertical extension 2746 is coupled and configured to attach, e.g., to the ancillary chamber enclosure. Bounceable plate enclosure 2748 has a second top opening 2743 that may accommodate one or more sensors (not shown), and/or may be reversibly openable or closed, e.g., during operation. Second top opening 2747 may comprise a transparent or opaque material. For example, it may be transparent and facilitate view of the enclosure body 2748 interior during operation. Top inlet openings such as 2742 may facilitate ingress of pre-transformed material, e.g., at least in part by facilitate optional coupling to pre-transformed material source(s) such as a layer dispensing mechanism and/or material separator(s), and are disposed in an opening manifold having body 2731. In the example shown in 2740, the openings in manifold 2731 are the same. However, in other embodiments, the openings may be different in FLS. The number of openings may be more or less than the three openings shown in manifold 2731. Bounceable plate enclosure body 2748 comprises a bottom outlet opening 2744 configured to facilitate material flow from bounceable plate outward from bounceable plate enclosure body 2748, e.g., to a sieving assembly enclosure to be separated by a sieve. Bounceable plate enclosure body 2748 comprises springs such as 2745 configured to support bounceable plate 2732. The springs are disposed on a baseplate 2733. In example 2740, the springs (e.g., 2745) are disposed in enclosure body 2748. Broken arrow 2734 designates a possible bypass route for unwanted powder bouncing off the bounceable plate 2732 during operation, and accumulating in the vicinity of a spring on baseplate 2733. Example 2740 is aligned with respect to gravitational vector 2790 pointing towards gravitational center G.

FIG. 27 shows in example 2770 a perspective view of bounceable plate enclosure body 2774 configured to enclose a bounceable plate that is a floor of the enclosure. Enclosure body 2774 comprises several sides fastened by fasteners (e.g., screws). Enclosure body 2774 may be gas tight, e.g., and configured to hold a positive pressure above ambient pressure outside of enclosure body 2774. Enclosure body 2774 may be configured to prevent spillage of the pre-transformed material (e.g., powder) through connections of the sides. Bounceable plate enclosure body 2774 has a first top opening 2771 to which a vertical extension 2781 is coupled and configured to attach, e.g., to the ancillary chamber enclosure. Bounceable plate enclosure 2774 has a second top opening 2779 disposed in manifold 2772, which opening 2779 may accommodate one or more sensors (not shown). Manifold 2772 may comprise a transparent or opaque material. For example, it may be transparent and facilitate view of the enclosure body 2774 interior during operation. Top inlet openings such as 2775 and 2782 may facilitate ingress of pre-transformed material, e.g., at least in part by facilitate optional coupling to pre-transformed material source(s) such as a layer dispensing mechanism and/or material separator(s), and are disposed in an opening manifold 2772. Top inlet openings 2775 and/or 2782 may connect to a component of the 3D printing system comprising: (i) a cyclone, (ii) a material conveyance system (e.g., reservoir thereof), or (iii) a layer dispensing mechanism such as a reservoir thereof (e.g., recoater hopper thereof). Top inlet opening such as 2776 may couple to a pressure equalization port, e.g., to allow for atmospheric flow such as when pre-transformed material is dropped onto the bounceable plate, e.g., through openings utilized for conveyance of pre-transformed material such as openings 2775 and/or 2782. In the example shown in 2770, some of the material ingress couplings are the same and some of the material ingress openings are different. The number of openings may be more or less than the three openings shown in manifold 2772. Bounceable plate enclosure body 2774 comprises a bottom outlet opening 2773 configured to facilitate material flow from bounceable plate outward from bounceable plate enclosure body 2774, e.g., to a sieving assembly enclosure to be separated by a sieve. Bounceable plate enclosure body 2774 is operatively coupled to springs such as 2777 configured to support bounceable plate disposed in enclosure body 2774. In example 2770, the springs (e.g., 2777) are disposed outside of enclosure body 2774. Enclosure body 2774 is coupled to actuator 2778a and 2778b configured to cause the bounceable plate (not shown) to bounce in a direction. The springs (e.g., 2777) are each configured to couple using bottom 2783, to a baseplate (not shown). Example 2770 is aligned with respect to gravitational vector 2790 pointing towards gravitational center G.

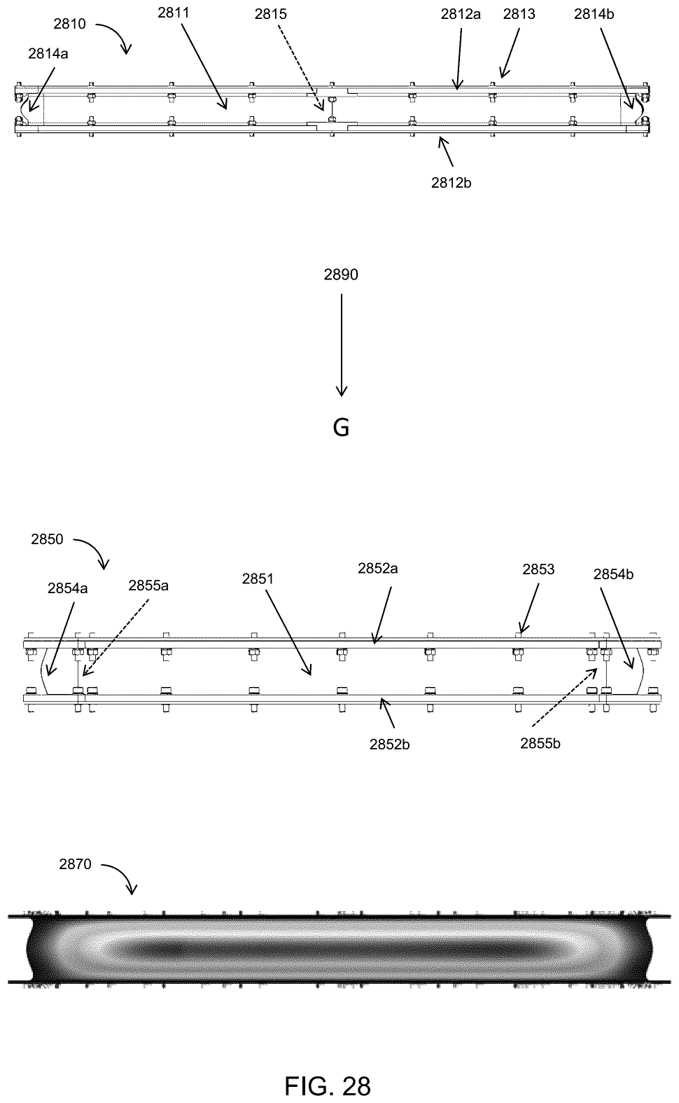

FIG. 28 shows in example 2810 a side view of vertical extension body comprising a bellow (e.g., made of a flexible material) having top portion 2812a and bottom portion 2812b configured to couple to the bounceable plate enclosure body. The top portion may be configured to couple to an ancillary chamber (e.g., garage). The sides 2814a and 2814b of the vertical extension body are disposed at opposing sides and are coupled to the top and bottom portions 2812a and 2812b. An optional overlapping clamp 2815 may be inserted to secure the bellow. Example 2810 is aligned with respect to gravitational vector 2890 pointing towards gravitational center G.

FIG. 28 shows in example 2850 a side view of vertical extension body comprising a bellow (e.g., made of a flexible material), having top side 2852a configured to couple to the bounceable plate enclosure body and bottom side 2852b. The bottom side may be configured to couple to the sieve assembly. The sides 2854a and 2854b of the vertical extension body are disposed at opposing sides and are coupled to the top and bottom portions 2852a and 2852b. Optional overlapping clamps 2855a and 2855b may be inserted to secure the bellow. Example 2850 is aligned with respect to gravitational vector 2890 pointing towards gravitational center G. Example 2870 shows a corresponding force diagram corresponding to 2850 (e.g., during compression control) in which the vertical extension comprises silicone rubber.

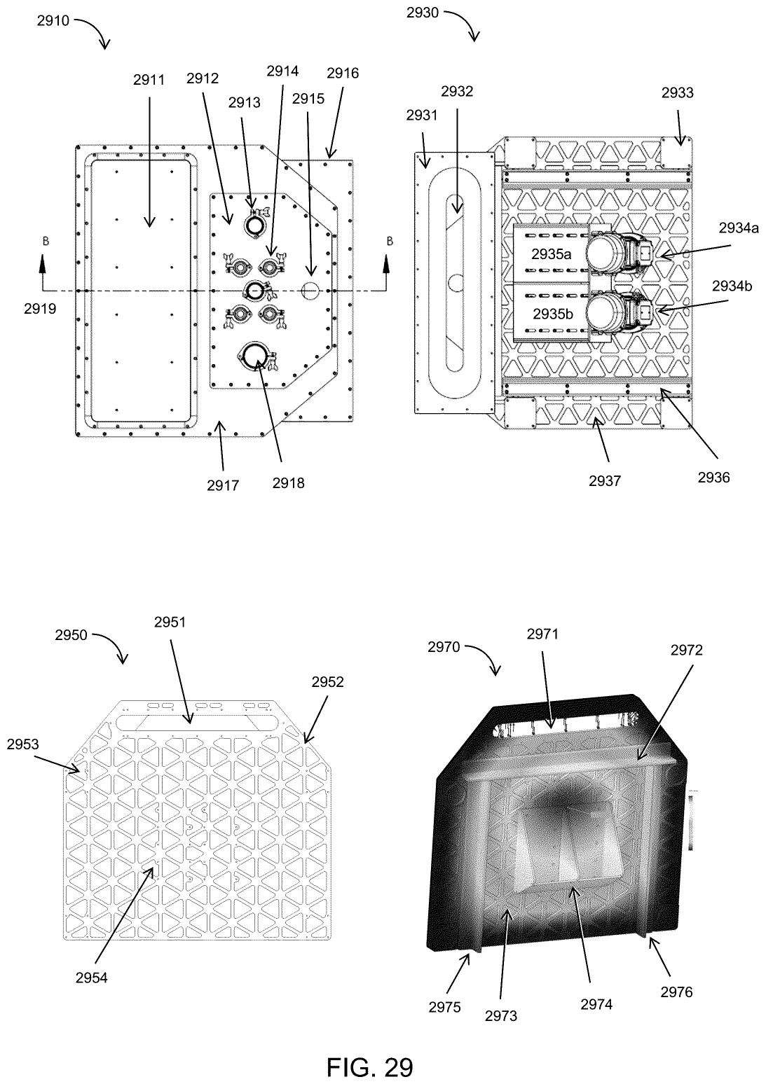

FIG. 29 shows in example 2910 a top view of bounceable plate enclosure body 2917 configured to enclose a bounceable plate (not shown). Enclosure body 2917 comprises several sides fastened by fasteners (e.g., screws). Enclosure body 2917 may be gas tight. Enclosure body 2917 may be configured to prevent spillage of the pre-transformed material (e.g., powder) through connections of the sides. Bounceable plate enclosure body 2917 has a first top opening 2911 that may be configured to attach to a pre-transformed material source, e.g., to the ancillary chamber enclosure. Bounceable plate enclosure 2917 includes an opening manifold 2912, which opening 2915 may accommodate one or more sensors (not shown). Manifold 2912 may comprise a transparent or opaque material. For example, it may be transparent and facilitate view of an interior of enclosure body 2917, e.g., during operation. Top inlet openings such as 2918, and 2913 may facilitate ingress of pre-transformed material, e.g., at least in part by facilitate optional coupling to pre-transformed material source(s) such as a layer dispensing mechanism and/or material separator(s), and are disposed in an opening manifold 2912. Top inlet openings 2913 and/or 2918 connect to a component of the 3D printing system comprising: (i) a cyclone, (ii) a material conveyance system (e.g., reservoir thereof), or (iii) a layer dispensing mechanism such as a reservoir thereof (e.g., recoater hopper thereof). Top inlet opening such as 2914 may couple to a pressure equalization port, e.g., to allow for atmospheric flow such as when pre-transformed material is dropped onto the bounceable plate, e.g., through openings utilized for conveyance of pre-transformed material such as openings 2913 and/or 2918. In the example shown in 2910, some of the material ingress couplings are the same and some of the material ingress openings are different. The number of openings may be more or less than the three openings shown in manifold 2912. Bounceable plate enclosure body 2917 comprises a bottom outlet opening connected to a coupling plate 2916, which opening (not shown) is configured to facilitate material flow from bounceable plate outward from bounceable plate enclosure body 2917, e.g., to a sieving assembly enclosure to be separated by a sieve. Enclosure body 2718 (excluding sieve assembly 2912) is symmetrical across symmetry plane 2919.

In some embodiments, at least a portion of a body of the bounceable plate enclosure is stiff and light, e.g., at least in part by comprising a fortified (e.g., reinforced) structure. The stiffness of the bounceable plate may be configured to retain (e.g., sufficient) planarity of the surface on which pre-transformed material is to be maneuvered during operation. The stiffness of the bounceable plate may be configured to minimize (e.g., prevent) accumulation of pre-transformed material on portion of the bounceable plate surface where it should be maneuvered during operation. The portion of the body may be a bottom portion such as a floor of the bounceable plate enclosure. The bottom portion (e.g., floor) may act as the bounceable plate maneuvering the pre-transformed material during operation. For example, the bottom portion (e.g., floor) may comprise a fortified structure at its external side, and a planar surface at its internal side, the planar surface acting as a surface on which the bounceable plate maneuvers the pre-transformed material during operation. The fortified structure may comprise a skeleton. The fortified structure may be a reinforced structure. The skeleton may comprise a lattice. The lattice may comprise space filling polygons, e.g., polygons comprising rectangles, triangles, hexagons (e.g., honeycomb structure), or the like. The stiffness may be sufficient to ensure that the body remains (e.g., substantially) planar during operation. The enclosure may comprise one or more sides such as a floor. At least one side of the enclosure may comprise a fortified structure, e.g., a lattice structure. The fortified structure may be machined, or 3D printed. The fortified structure may have a high strength. For example, a weight to deflection ratio of the bounceable plate having the fortified structure may be at least about 70 kilograms per millimeters (Kg/mm), 60 Kg/mm, 50 Kg/mm, or 40 Kg/mm, the weight to deflection ratio being measured at a pressure in the bounceable plate enclosure, the pressure being of about 5 pounds per square inch (i.e., about 34.5 KPa) above ambient pressure (e.g., atmospheric pressure of about 101 KPa). For example, for a bounceable plate weighting about 33 kilograms, the deflection may be about 0.68 millimeters, as measured at a pressure residing in the bounceable plate enclosure, the pressure being of about 5 PSI above ambient pressure. The fortified structure may displace during operation, the displacement being at most 0.1 mm, 0.3 mm, 0.6 mm, or 1.0 mm. The fortified structure may be disposed (e.g., also) in at least a portion of a body of the sieve enclosure. The pressure at which the bounceable plate operates can be any operating pressure disclosed herein. The pressure in the bounceable plate enclosure can be at least about 20 Kilo Pascal (KPa), 18 KPa, 16 KPa, 14 KPa, 12 KPa, 10 KPa, or 5 KPa above atmospheric pressure, e.g., above 101 KPa. The pressure in the bounceable plate enclosure can be between any of the aforementioned values (e.g., from about 20 KPa to about 5 KPa, or from about 20 KPa to about 10 KPa), the pressure being above ambient pressure external to the bounceable plate enclosure such as atmospheric pressure.

FIG. 29 shows in example 2930 a bottom view of bounceable plate enclosure body shown in example 2910. The bottom view of the fortified structure 2937 acts at its opposing side (now shown) as the bounceable plate that maneuvers pre-transformed material during operation. The enclosure body shown in 2930 comprises a fortified bottom having fortification structure 2937 (e.g., skeleton structure) that facilitates a stiff and planar bottom that is lightweight as compared to a structure devoid of such skeleton having similar weight, and retains its planarity during operation such as planarity of its opposing side facing the interior of the bounceable plate enclosure. The bounceable plate enclosure body comprises a bottom outlet opening 2932 connected to a coupling (e.g., adapter) plate 2931, which opening (not shown) is configured to facilitate material flow from bounceable plate outward from bounceable plate enclosure body, e.g., to a sieving assembly enclosure to be separated by a sieve. Opening 2938 is configured for a sensor (not shown). The bottom of the enclosure body is couped to two actuators 2934a and 2934b coupled to supporting structure 2935a and 2935b being brackets that coulee the actuators to the fortified structure 2937 of the bottom plate. The bottom plate is coupled to support braces 2936a and 2936b. The fortified bottom plate comprises four connectors such as 2933 configured to couple to sprints (not shown).

FIG. 29 shows in example 2950 a horizontal view of fortified structure that act as a floor of the bounceable plate enclosure that can also act as a bounceable plate at its opposing side (not shown). The fortified structure has a skeleton 2952 that is stiffer and/or thicker than the structure's interior portions, e.g., 2953. The fortified structure has an opening 2951 that facilitates egress of material from the fortified structure, e.g., via a material fall. The fortified structure is configured to attach to fasteners, e.g., 2954. These can be fasteners for bracket such as 2935a or 2935b, to actuators such as 2934a or 2934b, to support braces such as 2936a or 2936b, or to any other structure. The support brace may comprise a railing.

FIG. 29 shows in example 2970 a perspective bottom view of fortified structure that can be a bottom plate of the bounceable plate enclosure, e.g., 2937. The bottom view of the fortified structure 2973 can act at its opposing side as the bounceable plate that maneuvers pre-transformed material during operation. The fortified structure has a skeleton that is stiffer and/or thicker than the structure's interior portions. The fortified structure has an opening 2971 that facilitates egress of material from the fortified structure, e.g., via a material fall. The fortified structure is connected to brackets 2974, e.g., facilitating coupling of the actuators (not shown) to the fortified structure. Support braces 2976, 2975, and 2972 are coupled to the structure, e.g., to increase its stiffness such as during operation. Example 2970 shows a force simulation of the fortified structure during operation.

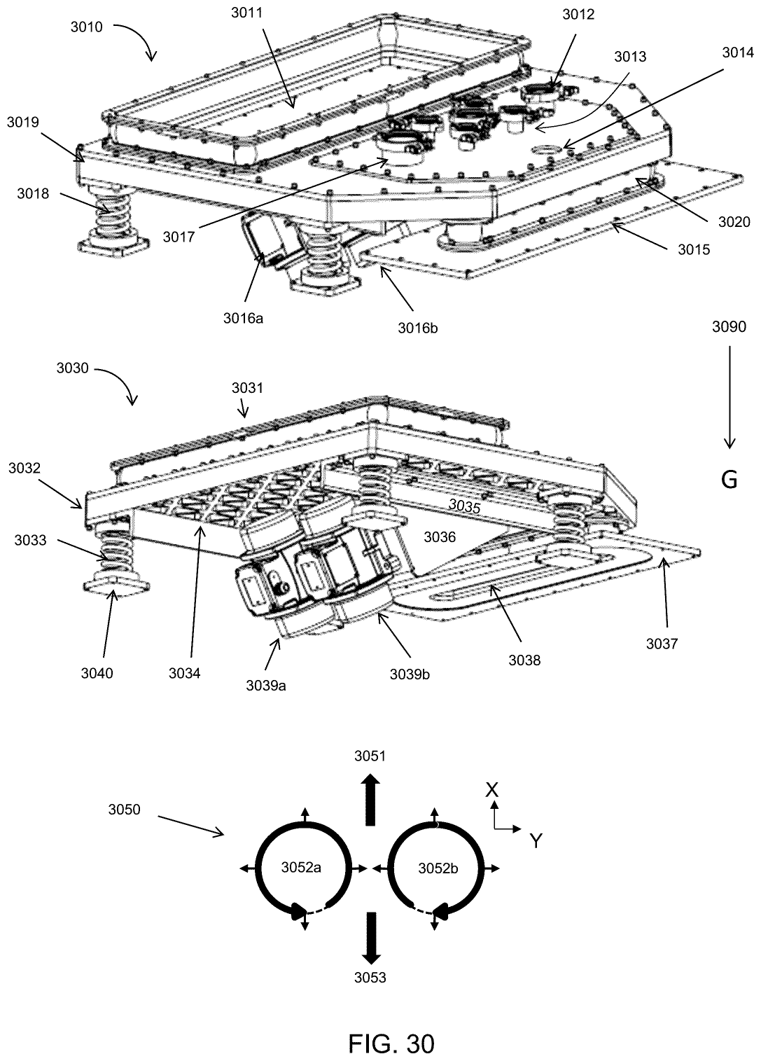

FIG. 30 shows in example 3010 a perspective top view of bounceable plate enclosure body 3019 configured to enclosure a bounceable plate that forms a bottom of the enclosure. Enclosure body 3019 comprises several sides fastened by fasteners (e.g., screws). Bounceable plate enclosure body 3019 has a first top opening 3011 to which a vertical extension 3021 is coupled and configured to attach, e.g., to the ancillary chamber enclosure. Bounceable plate enclosure 3019 has a second top opening 3014 disposed in manifold 3022, which opening 3014 may accommodate one or more sensors (not shown). Manifold 3022 may comprise a transparent or opaque material. Top inlet openings such as 3012 and 3017 may facilitate ingress of pre-transformed material, e.g., at least in part by facilitate optional coupling to pre-transformed material source(s) such as a layer dispensing mechanism and/or material separator(s), and are disposed in an opening manifold 3022. Top inlet openings 3012, and/or 3017 may connect to a component of the 3D printing system comprising: (i) a cyclone, (ii) a material conveyance system (e.g., reservoir thereof), or (iii) a layer dispensing mechanism such as a reservoir thereof (e.g., recoater hopper thereof). Top inlet opening such as 3013 may couple to a pressure equalization port, e.g., to allow for atmospheric flow such as when pre-transformed material is dropped onto the bounceable plate, e.g., through openings utilized for conveyance of pre-transformed material such as openings 3012, and/or 3017. In the example shown in 3010, some of the material ingress couplings are the same and some of the material ingress openings are different. The number of openings may be more or less than the three openings shown in manifold 3022. Bounceable plate enclosure body 3019 comprises a bottom outlet opening 3020 configured to facilitate material flow from bounceable plate outward from bounceable plate enclosure body 3019, e.g., to a sieving assembly enclosure to be separated by a sieve, coupled by coupling plate 3015. Bounceable plate enclosure body 3019 is operatively coupled to springs such as 3018 configured to support bounceable plate disposed in enclosure body 3019. In example 3010, the springs (e.g., 3018) are disposed outside of enclosure body 3019. Enclosure body 3019 is coupled to actuator 3016a and 3016b configured to cause the bounceable plate (not shown) to bounce in a direction. The springs (e.g., 3018) are each configured to couple using bottom 3023, to a baseplate (not shown). Example 3010 is aligned with respect to gravitational vector 3090 pointing towards gravitational center G.

FIG. 30 shows in example 3030 a perspective bottom view of bounceable plate enclosure body 3032 configured to enclosure a bounceable plate having a fortified bottom portion 3034 that faces outside from the enclosure, which bottom portion serves to bounce the pre-transformed material at its opposing side facing the interior of the bounceable plate enclosure. Enclosure body 3032 comprises several sides fastened by fasteners (e.g., screws). Bounceable enclosure body 3032 has a first top opening 3031 to which a vertical extension is coupled and configured to attach, e.g., to the ancillary chamber enclosure. Bounceable plate enclosure body 3032 comprises a bottom outlet opening 3038 configured to facilitate material flow from bounceable plate outward from bounceable plate enclosure body 3032, e.g., to a sieving assembly enclosure to be separated by a sieve, coupled by coupling plate 3037. Bounceable plate enclosure body 3032 is operatively coupled to springs such as 3033 configured to support bounceable plate disposed in enclosure body 3032. In example 3030, the springs (e.g., 3033) are disposed outside of enclosure body 3032. Enclosure body 3032 is coupled to actuator 3039a and 3039b configured to cause the bounceable plate (not shown) to bounce in a direction. Actuators 3039a and 3039b are coupled to fortified bottom 3034 via brackets 3036. The fortified bottom 3034 is coupled to support braces such as 3035. The springs (e.g., 3033) are each configured to couple using bottom 3040, to a baseplate (not shown). Example 3030 is aligned with respect to gravitational vector 3090 pointing towards gravitational center G.

In some embodiments, a synchronized combination of rotary actuators results in a linear motion. For example, when two rotary actuators rotate in opposing phases but otherwise have the same characteristic (e.g., rotational speed, force, and angle of placement), their rotating forces may combine to linear forces, e.g., by canceling out forces in one axis, and adding forces in a second axis normal to the one axis. The actuators may comprise electrical actuators, e.g., electrical motors.

FIG. 30 shows in example 3050 a schematic diagram representing rotation of the actuators in opposing phases and associated forces. For example, a first actuator rotates in a phase direction 3052a according to its large circular arrow, and a second actuator rotates in a phase direction 3052b according to its large circular arrow, with rotations 3052a and 3052b being in opposing phases. Such rotations will result in forces 3051 and 3053 in the X direction to add up, while forces in the Y direction cancel each other out. Such synchronized rotation being of opposing phases will result in rotational motion of the two actuators translating into a linear motion. Such synchronization can convert two rotary outputs into a linear up and down motion along the X direction of FIG. 30.

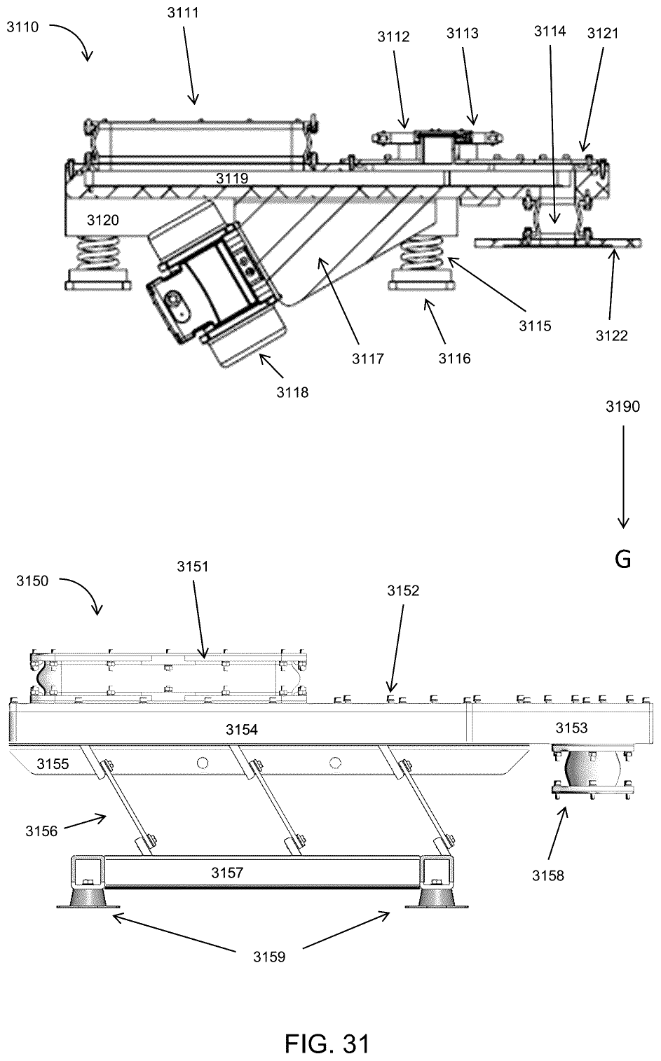

FIG. 31 shows in example 3110 a side view of bounceable plate enclosure body 3120 configured to enclosure a bounceable plate that serves also as a floor of the enclosure body. Enclosure body 3120 comprises several sides fastened by fasteners (e.g., screws) such as 3121. Bounceable enclosure body 3120 has a first top opening 3111 to which a vertical extension is coupled and configured to attach, e.g., to the ancillary chamber enclosure. Bounceable plate enclosure body 3120 comprises a bottom outlet opening 3114 configured to facilitate material flow from bounceable plate outward from bounceable plate enclosure body 3120, e.g., to a sieving assembly enclosure to be separated by a sieve, coupled by coupling plate 3122. Bounceable plate enclosure body 3120 is operatively coupled to springs such as 3115 configured to support bounceable plate disposed in enclosure body 3120. In example 3110, the springs (e.g., 3115) are disposed outside of enclosure body 3120. Enclosure body 3120 is coupled to actuator 3118 configured to cause the bounceable plate (not shown) to bounce in a direction. Actuator 3118 is coupled to the enclosure body bottom via bracket 3117. The springs (e.g., 3115) are each configured to couple using bottom 3116, to a baseplate (not shown). Additional actuators and/or brackets may be possible, e.g., disposed parallel to actuator 3118 and bracket 3117, e.g., as shown in FIG. 30, 3050. Example 3110 is aligned with respect to gravitational vector 3190 pointing towards gravitational center G.

FIG. 31 shows in example 3150 a side view of bounceable plate enclosure body 3154-3153 configured to enclosure a bounceable plate that serves as a floor of the enclosure body. Enclosure body 3154-3153 comprises several sides fastened by fasteners (e.g., screws) such as 3152. Bounceable enclosure body 3154-3153 has a first top opening 3151 to which a vertical extension is coupled and configured to attach, e.g., to the ancillary chamber enclosure. Bounceable plate enclosure body 3154-3153 comprises a bottom outlet opening 3158 configured to facilitate material flow from bounceable plate outward from bounceable plate enclosure body 3154-3153, e.g., to a sieving assembly enclosure to be separated by a sieve, coupled by coupling plate 3122. Bounceable plate enclosure body 3154-3153 is operatively coupled to moving elements (e.g., springs) such as 3156 configured to support bounceable plate disposed in enclosure body 3154-3153. The moving may comprise flexure springs. In example 3150, the moving element (e.g., 3156) are disposed outside of enclosure body 3154-3153 and are coupled to base plate 3157 having legs 3159. Example 3150 is aligned with respect to gravitational vector 3190 pointing towards gravitational center G.

In some embodiments, the bounceable plate is planar. In some embodiments, the bounceable plate may comprise a planar exposed surface configured to accept incoming pre-transformed material thereon. The planar exposed surface may be configured to remain (e.g., substantially) planar during operation, e.g., to reduce generating accumulation of a portion of pre-transformed material that mounters slower (e.g. or does not maneuver) as the maneuverable pre-transformed material by the bounceable plate during operation. The bounceable plate may have an aspect ratio of length to width that is different than 1:1. For example, the aspect ratio of the length to width (L:W) can be at least about 10:9.5, 10:9, 10:8, 10:7, 10:6, or 10:5. The bounceable plate may have a FLS (e.g., length or width) of at least about 50 centimeters (cm), 70 cm, 90 cm, 100 cm, or 150 cm.

Examples. The following are illustrative and non-limiting examples of methods of the present disclosure.
Example 1: Inconel-718 powder having a diameter distribution of from about 15 micrometers to about 53 micrometers was provided to a bounceable plate assembly at a rate of 32 Kg/min, the bounceable plate weighing (neat) about 20 Kg and having dimensions of 900 mm by 700 mm, which bounceable plate was made of Aluminum. The bounceable plate was disposed in a bounceable plate enclosure under an atmosphere that is less reactive with the powder than the ambient atmosphere external to the bounceable plate enclosure. The internal atmosphere of the bounceable plate enclosure comprised argon, oxygen, and humidity. The oxygen as at a concentration of at most about 1000 ppm, and the humidity had a dew point from about −15° C. to about −55° C. The internal bounceable plate enclosure atmosphere had a pressure of about 16 KPa above atmospheric pressure (e.g., above 101 KPa), and was at ambient temperature. A pneumatic actuator (Pneumatic Piston Vibrator) was disposed at an angle of about 30 degrees relative to the bounceable plate (e.g., about 30 degrees relative to normal to the bounceable plate surface), the pneumatic actuator pounding the bounceable plate at a rate of 30 Hz with a force of about 100 Kilogram Force (KgF). The bounceable plate being disposed on steel springs having a spring constant K of about 20.7 Kg/cm. The springs were disposed in the bounceable plate enclosure, the bounceable plate being devoid of a fortified lattice structure. The configuration of the bounceable plate enclosure resembled the one shown in FIG. 16.

Example 2: Inconel-718 powder having a diameter distribution of from about 15 micrometers to about 53 micrometers was provided to a bounceable plate assembly at a rate of 32 Kg/min, the bounceable plate weighing about 45 Kg and having dimensions of 1000 mm by 900 mm, which bounceable plate was made of Aluminum. The bounceable plate acts as a floor of a bounceable plate enclosure under an atmosphere that is less reactive with the powder than the ambient atmosphere external to the bounceable plate enclosure. The internal atmosphere of the bounceable plate enclosure comprised argon, oxygen, and humidity. The oxygen as at a concentration of at most about 1000 ppm, and the humidity had a dew point from about −15° C. to about −55° C. The internal bounceable plate enclosure atmosphere had a pressure of about 16 KPa above atmospheric pressure (e.g., above 101 KPa), and was at ambient temperature. Two electric actuators (unbalanced vibrators) were disposed at an angle of about 30 degrees relative to the bounceable plate (e.g., about 30 degrees relative to normal to the bounceable plate surface). The actuators were pounding the bounceable plate at a rate of 60 Hz, each with a force of about 291 Kilogram Force (KgF), having rotational speed of 3600 RPM in opposing directions. The bounceable plate being disposed on steel springs having a spring constant K of about 70 Kg/cm. The springs were disposed outside of the bounceable plate enclosure. The bounceable plate was fortified by a lattice structure. The configuration of the bounceable plate enclosure resembled the one shown in FIG. 30.
Example 3: Inconel-718 powder having a diameter distribution of from about 15 micrometers to about 53 micrometers was provided to a sieve assembly at a rate of from about 5 kilograms per minute (Kg/min) to about 15 Kg/min, the sieve assembly having two strips coupled to the sieve. Each of the two strips was guiding ultrasonic waves therethrough and induced ultrasonic vibrations in the sieve and in the powder dispensed on the sieve. Each of the strips was made of aluminum and was coupled to an ultrasonic wave transducer in a configuration similar to that in FIG. 22. The sieve was disposed in a sieve assembly enclosure under an atmosphere that is less reactive with the powder than the ambient atmosphere external to the sieve assembly enclosure. The internal atmosphere of the sieve assembly enclosure comprised argon, oxygen, and humidity. The oxygen as at a concentration of at most about 1000 ppm, and the humidity had a dew point from about −15° C. to about −55° C. The internal sieve assembly enclosure atmosphere had a pressure of about 16 KPa above atmospheric pressure (e.g., above 101 KPa), and was at ambient temperature. The sieve was sieving the powder at a rate of from about 5 kg/min to about 15 kg/min without blinding for about 500 hours of continuous operation. The ultrasonic vibrations were at a frequency of about 40 kHz, operated intermittently at a rate of about 4.4 pulses per second.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A device for directional powder displacement in three-dimensional (3D) printing, the device comprising:
a planar body;
springs coupled to the planar body; and
at least one actuator configured to repeatedly alter a position of the planar body in a first direction to cause powder disposed on the planar body to repeatedly displace in a second direction relative to the planar body, the at least one actuator being operatively coupled to the planar body, the second direction being different from the first direction,
the device being configured to operatively couple to an enclosure in which one or more 3D objects are printed during the 3D printing, the enclosure being of a 3D printer, the device being configured to facilitate displacement of the powder in the second direction away from the enclosure.

2. The device of claim 1, wherein the at least one actuator is configured for tunability of at least one property comprising (I) force output, (II) frequency output, or (III) directional output.

3. The device of claim 1, wherein the at least one actuator comprises actuators configured for rotary motion that results in a collective linear motion.

4. The device of claim 1, wherein the at least one actuator comprises a first actuator and a second actuator, and wherein the first actuator and the second actuator are (i) of a same type, (ii) configured to rotate in a synchronized manner, (iii) configured to rotate at the same speed, (iv) configured to rotate opposing directions and/or phases, (v) configured to exert the same magnitude of forces, or (vi) any combination of (i) (ii) (iii) (iv) and (v).

5. The device of claim 1, wherein the at least one actuator exerts linear motion on the planar body in the first direction that is incident to the planar body at an angle with respect to a normal to the planar body, the angle being less than about 90 degrees.

6. The device of claim 5, wherein the at least one actuator exerts linear motion on the planar body in the first direction that is incident to the planar body at an angle with respect to a normal to the planar body, the angle being at most about 70 degrees.

7. The device of claim 1, wherein altering the position of the planar body comprises perturbations by the at least one actuator, the perturbations comprising (i) mechanical perturbations or (ii) acoustic perturbations.

8. The device of claim 1, wherein the device further comprises, or is operatively coupled to, one or more flexible couplers configured to couple the device to the enclosure.

9. The device of claim 8, wherein the flexible couplers are configured to damp vibrational motion of the device from one or more other components of the 3D printer, wherein damping of the vibrational motion is such that the 3D printer prints the one or more 3D objects according to their requested tolerances.

10. The device of claim 9, wherein the vibrational motion comprises (I) acoustic vibrational motion or (II) mechanical vibrational motion.

11. The device of claim 1, wherein the enclosure is a first enclosure, and wherein a second enclosure comprises an internal atmosphere different from an ambient atmosphere external to the device.

12. The device of claim 11, wherein the internal atmosphere comprising (I) a pressure above ambient pressure external to the device, or (II) depletion of a reactive agent relative to its concentration in an ambient atmosphere external to the device, the reactive agent being configured to react with the powder at least during 3D printing.

13. The device of claim 11, wherein the second enclosure is configured to enclose (i) the planar body, (ii) the springs, (iii) the at least one actuator, or (iv) any combination of (i) (ii) and (iii).

14. The device of claim 11, wherein the second enclosure is configured to include the planar body as part of a body of the second enclosure.

15. The device of claim 1, wherein the powder is a remainder of a starting material utilized in a first printing cycle of the 3D printing during which of the one or more 3D objects is printed by the 3D printing, and wherein the device is configured to facilitate recycling the remainder to be used in the first printing cycle or in a second printing cycle to print one or more other 3D objects by the 3D printing.

16. The device of claim 1, wherein (I) the powder is disposed in the second direction to a housing in which a sieve is disposed to sieve the powder, the sieve is coupled to a frame that is reversibly retractable and insertable relative to the housing, (II) during operation of the sieve, the framing is tilted with respect to a horizon, (III) the device is operatively coupled to a powder conveyance system configured to convey the powder against an environmental gravitational force, (IV) the device is operatively coupled to a layer dispensing mechanism comprising a cyclonic separator, (V) the enclosure comprises a processing chamber coupled to an ancillary chamber coupled to it, the ancillary chamber configured to house the layer dispensing mechanism, or (VI) any combination of (I) (II) (III) (IV) and (V).

17. The device of claim 1, wherein the device is configured to displace at least 10 kilograms of powder per minute along the second direction.

18. An apparatus for the directional powder displacement in the 3D printing, the apparatus comprising at least one controller configured to: (a) couple to a power source and operatively couple to the device of claim 1; and (b) direct one or more operations associated with the device for the directional powder displacement.

19. Non-transitory computer readable program instructions that, when read by one or more processors operatively coupled to the device of claim 1, cause the one or more processors to execute one or more operations associated with the device for the directional powder displacement, the program instructions being stored on at least one non-transitory computer readable medium.

20. A method of directional powder displacement in the 3D printing, the method comprising (a) providing the device of claim 1, and (b) using the device for the directional powder displacement.
